(19) United States
(12) Patent Application Publication
(10) Pub. No.: US 2005/0159962 A1
(43) Pub. Date: Jul. 21, 2005

(54) System and method for advising buyers how much to pay for goods and services based on the buyers subjective and objective criteria and tradeoffs of prices and referring buyers to sellers of these goods and services

(76) Inventors: Lawrence D. Weiss, Shaneateles, NY (US); John P. Weiss, Shaneateles, NY (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 09/807,443

(22) Filed: Aug. 21, 2001

Related U.S. Application Data
(60) Provisional application No. 60/103,456, filed on Oct. 2, 1998.

(30) Foreign Application Priority Data
Oct. 1, 1999 (WO) PCT/US99/22904

(51) Int. Cl. G06F 17/60

(52) U.S. Cl. 705/1; 705/37

(57) ABSTRACT

A system and method for advising consumers how much to pay for goods and services by matching consumers' specific objective needs for product or service characteristics as well as subjective needs, such as certainty, closure, security, style or brand. The system and method provides an interactive method of providing this advice, information, referral and transaction capability in a step-by-step intuitive manner over an on-line network.

This application is a continuation in part application of Provisional Application Ser. No. 60/103,456, filed Oct. 2, 1998.

### FIELD OF THE INVENTION

This invention relates to a system and method for advising consumers how much to pay for goods and services by matching consumers' specific objective needs for product or service characteristics as well as subjective needs, such as certainty, closure, security, style or brand. In particular, this system and method provides an interactive method of providing this advice, information, referral and transaction capability in a step-by-step intuitive manner over an on-line network.

### BACKGROUND OF THE INVENTION

Commerce has existed in a variety of forms since the days the first caveman bartered with the second. Commerce began as a one-on-one transaction between two individuals, each of whom wanted something that the other had to offer. At first, commerce began as a random encounter, and then developed as traveling merchants began to identify new markets, and peddle their wares in marketplaces near and far. In recent history, the Internet has exploded as a medium for selling goods and services. The current systems of on-line shopping enable sellers of goods and services to display their wares and attempt to lure buyers to their sites.

For the consumer, the Internet is a unique forum for finding the best price for goods or services without regard to the geographic location of the service provider. Many options exist. Some suppliers offer discounted pricing against a limited range of products, features, or services. Other suppliers charge a higher price but offer immediate availability or the precise selection of product features. Consumers are often confused, however, about what price/feature trade-offs are associated with any specific offer, because the electronic marketplace is so large. In addition, systems have developed to conduct “auctions” for services, such as airline travel. In such “auction” systems, the consumer offers a bid for a particular service, which is accepted at the decision of the service provider. These systems further confuse consumers, because they do not provide consumers with the data that they need to make an informed decision about what price to offer or bid for a specific product or service.

The consumer has no structured way of determining what competitors are charging for the same service in the marketplace, nor, in the “auction” setting, what range of bid is likely to be accepted. Furthermore, each consumer has individual subjective needs in addition to the product characteristics. These include needs for certainty, precision of features, closure, and timing. The consumer has no structured way to evaluate the impact on price of meeting these individual subjective criteria. The consumer must do his or her own research to achieve the confidence and peace of mind that the service meets his or her individual needs and criteria for availability or precise features at an appropriate price.

### SUMMARY OF THE INVENTION

The present invention provides an improved system for needs-based buying and/or selling. The invention provides a systematic way to solicit and analyze a consumer's objective and subjective needs for goods and services and provide an array of choices of goods, services, prices and sources that meet the consumer's needs.

It is an object of the invention to overcome limitations of the current methods of buying goods and services on an interactive electronic basis. These goods or services can include any tangible good or service ranging from toothpaste to antiques, to airline tickets, mail services, mutual funds, insurance or travel services. It is another object of this invention to provide easy access to consumers over an electronic terminal to an expert system that can analyze their product and individual needs, provide information and recommendations on price ranges versus product and individual trade-offs, and, based on consumer choice, direct them to providers of the goods and services. It is a further object of this invention to identify bids that the buyer might make in an “auction” with various probabilities of successfully obtaining the goods or services that he or she wants and meeting individual needs for availability and other criteria, all at the price he or she is willing to pay.

It is another object of this invention to provide a system and method for identifying consumers' needs and matching them with sellers who can satisfy those needs through a remote terminal connecting to a host computer over an on-line network. The system, through a simple interactive step-by-step process, allows the customer to precisely match his or her needs to the provider's product, service and price. Unlike database marketing, which assists the provider in attempting to identify customers ready to buy his product or service, this system creates a customer-controlled match between consumer needs and provider. When the customer chooses to use the system to contact the provider, the customer is fully qualified and at the point of purchase.

These objects and others are achieved through a method and apparatus of analyzing the consumer's needs, identifying the purchase options, and either referring the consumer to sellers that can match those needs through data terminals, telephones, and computers connected to an on-line communications network, or to a sponsor conducting “auction” sales through data terminals and computers connected to an on-line communications network. The system has access to available vendor information, price quotes, and successful “auction” price behaviors.

The above and other objects of the invention will become readily apparent to those of skill in the relevant art from the following detailed description and figures, wherein only the preferred embodiments of the invention are shown and described, simply by way of illustration of the best mode of carrying out the invention. As is readily recognized the invention is capable of modifications within the skill of the relevant art without departing from the spirit and scope of the invention.

### DETAILED DESCRIPTION OF THE DRAWINGS

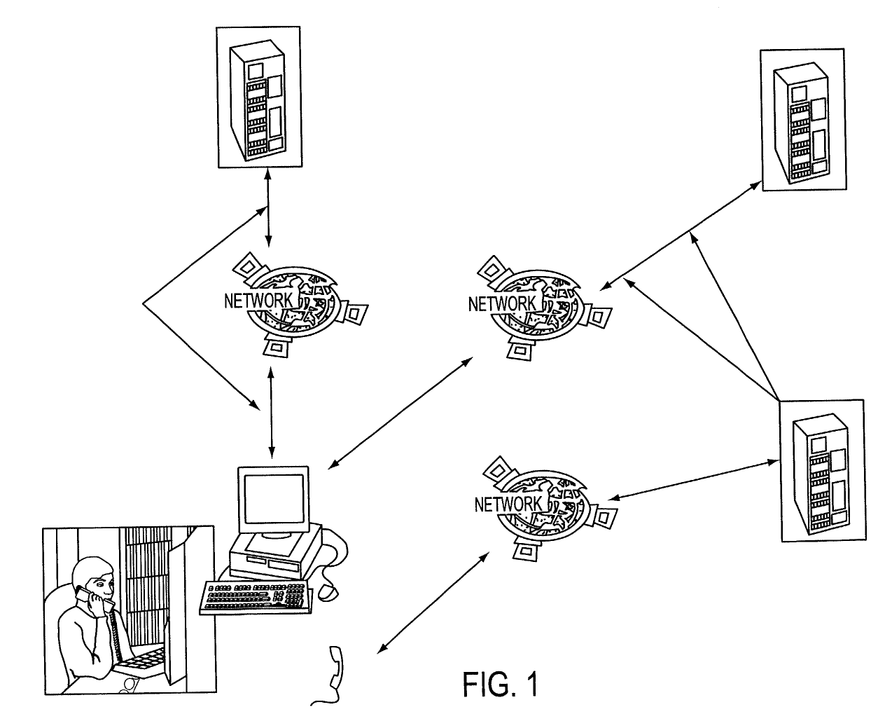

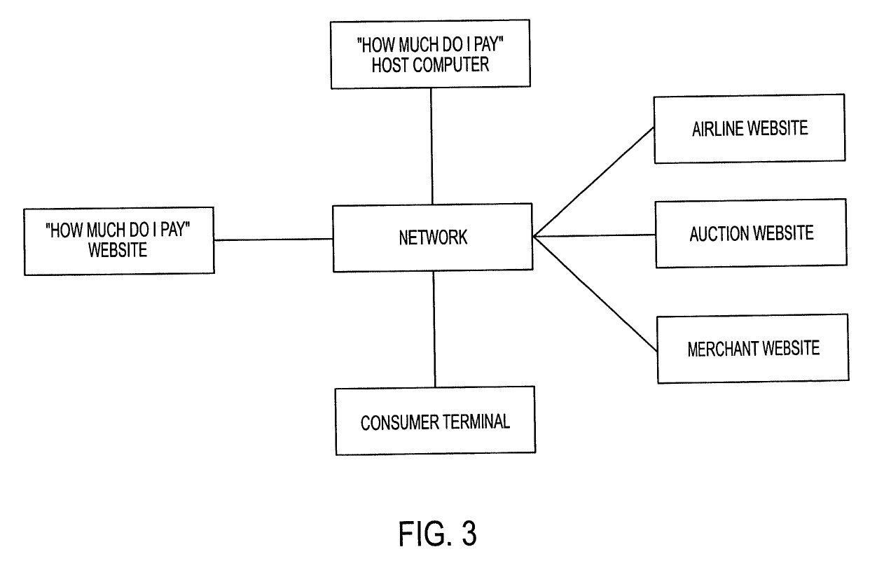

FIGS. 1-3 are high level views of an embodiment of the integrated system of the present invention.

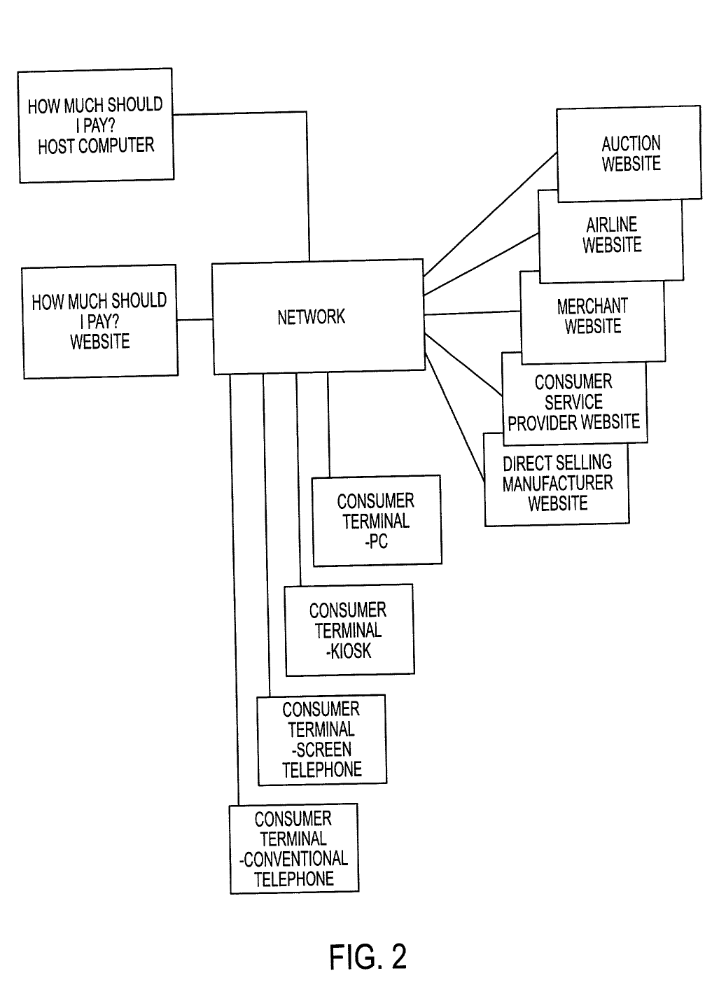

FIG. 2 is a block diagram showing the steps of an embodiment of a method of advising a customer what he should buy, how much should he pay, and how should he buy it.

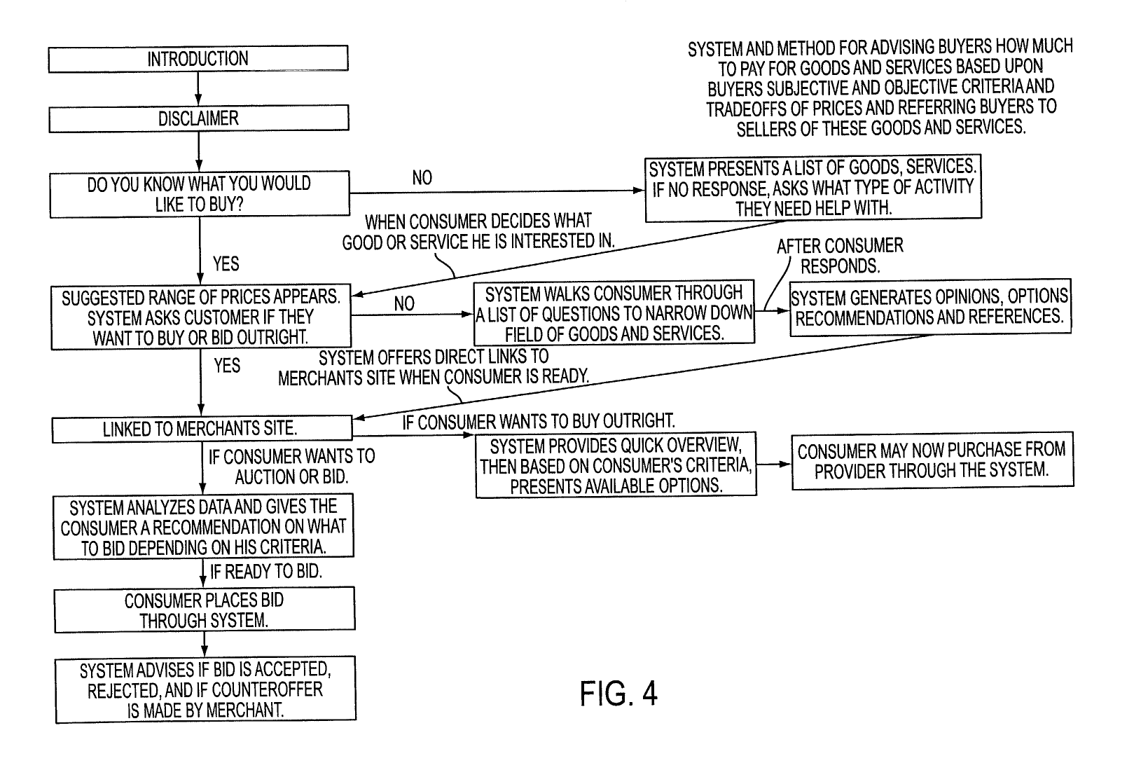

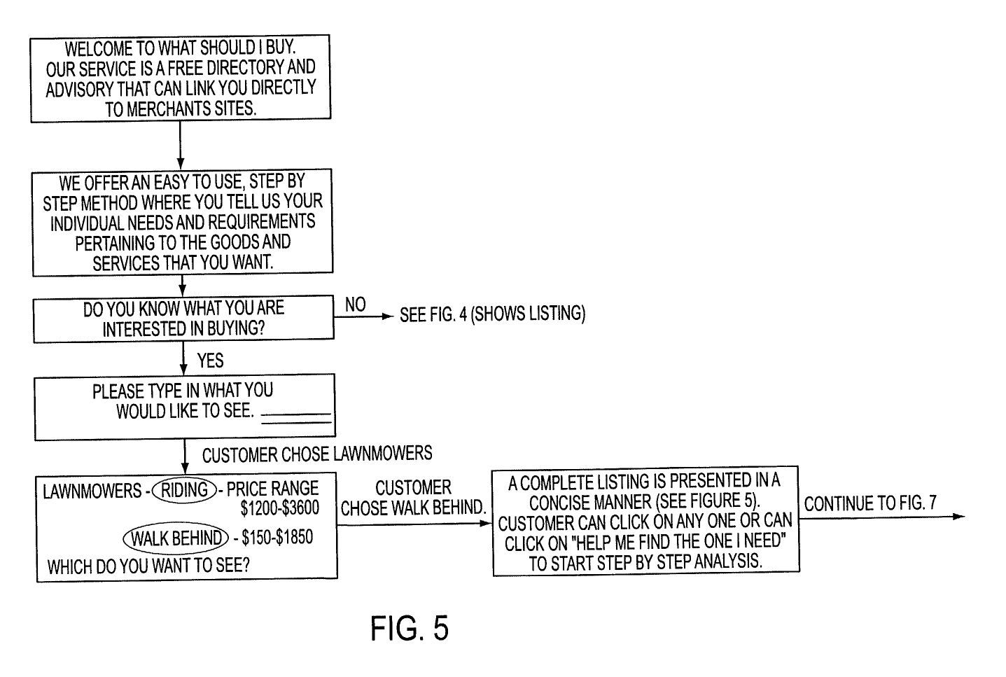

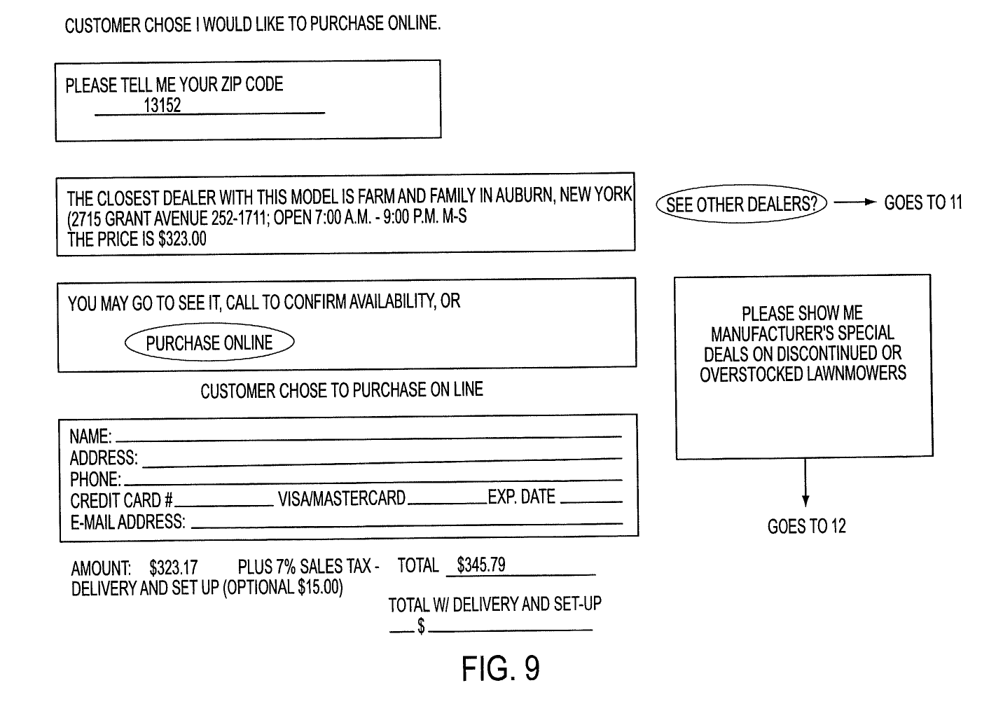

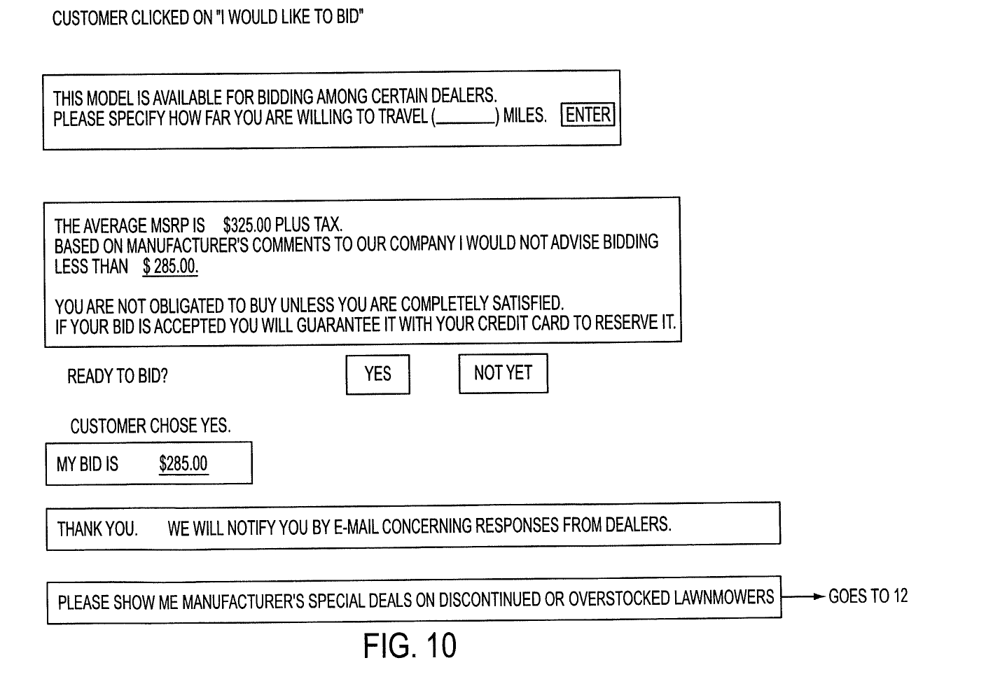

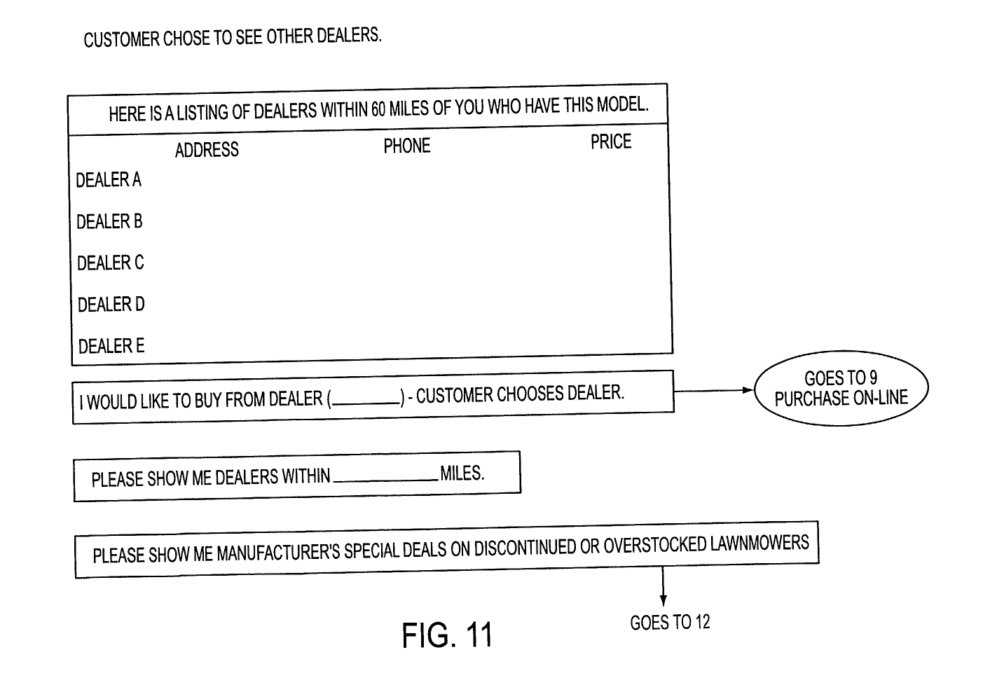

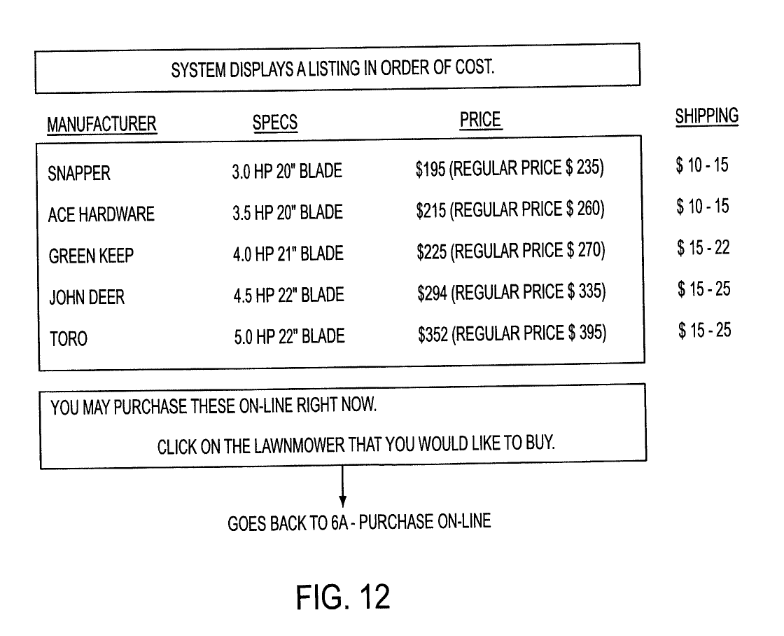

FIGS. 4-14 are flow charts showing an embodiment of the process involved in the steps of helping the user decide what he wants to buy based on the user's objective and subjective criteria.

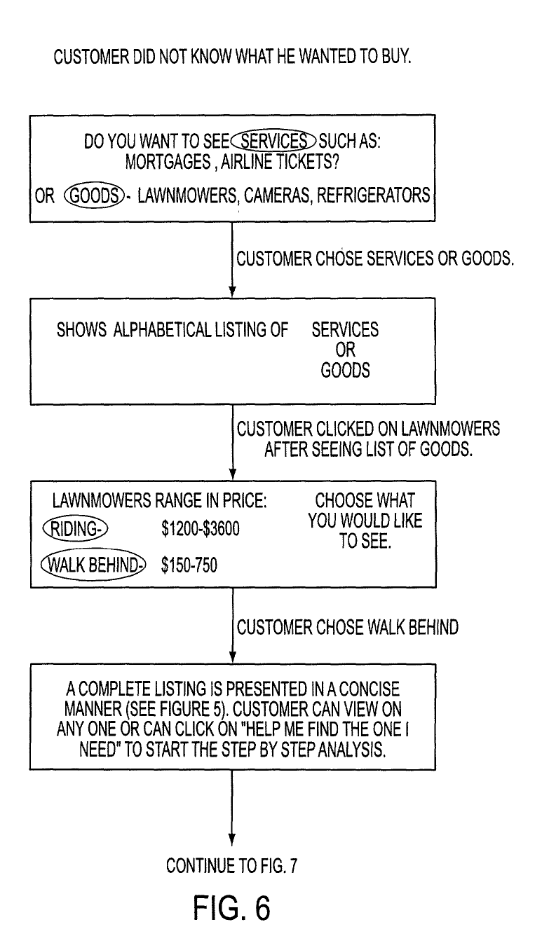

FIGS. 5 and 6 are flow charts of an embodiment of the step of building the user's profile and displaying purchase options based on the user's criteria.

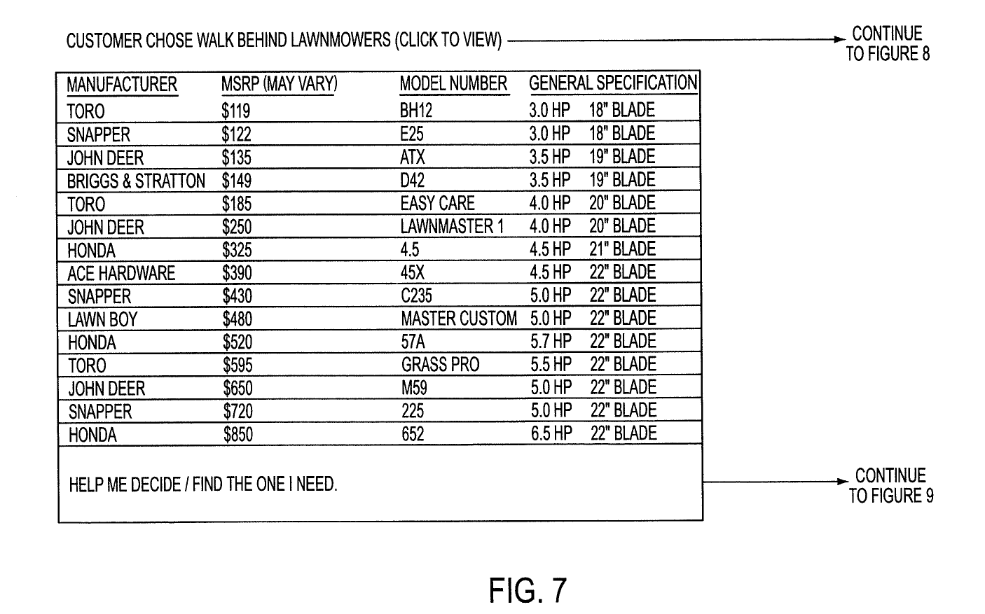

FIG. 7 is a flow chart of an embodiment of the step of displaying purchase options based on the user's subjective and objective criteria.

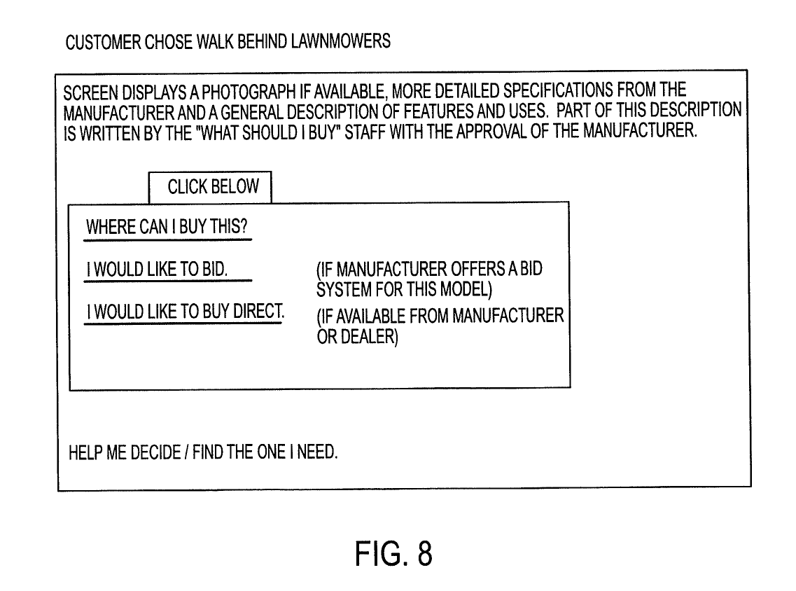

FIGS. 8-12 are a flow chart of an embodiment of the step of displaying useful detail of the user's purchase options based on the user's subjective and objective criteria, plus the step of enabling the user to act on his decision.

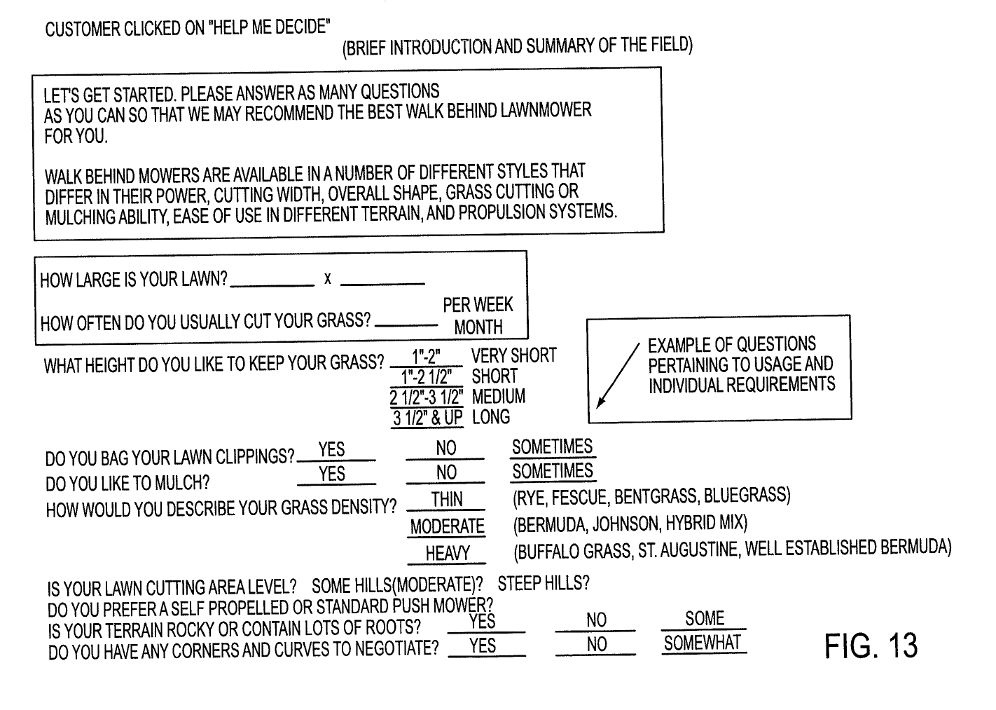

FIG. 13 is a flow chart of an embodiment of the step of displaying an interactive method of assessing the user's objective and subjective criteria to filter possible purchase options.

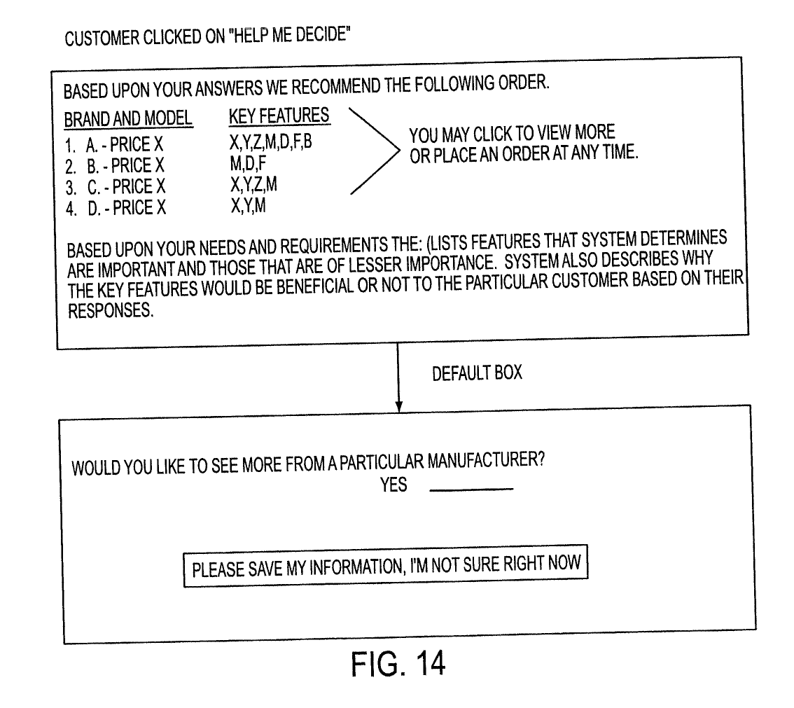

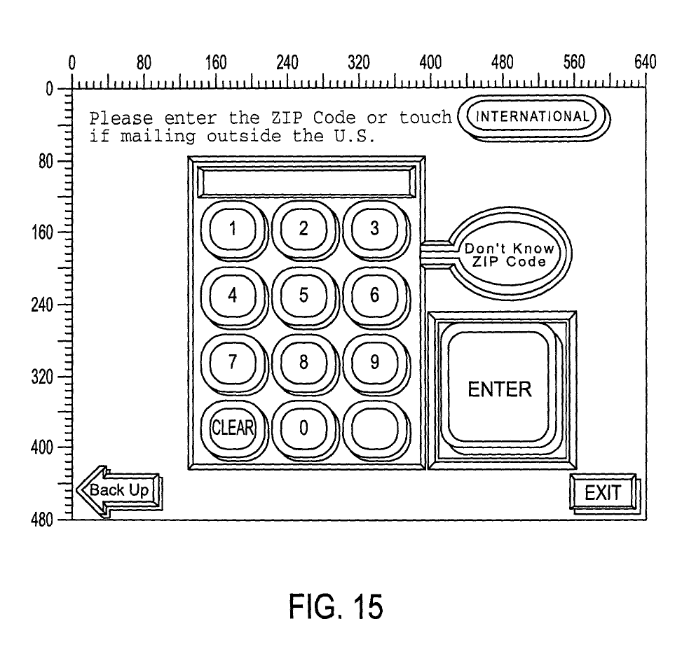

FIG. 14 is a flow chart of an embodiment of the step of advising the user of purchase options based on the user's subjective and objective criteria.

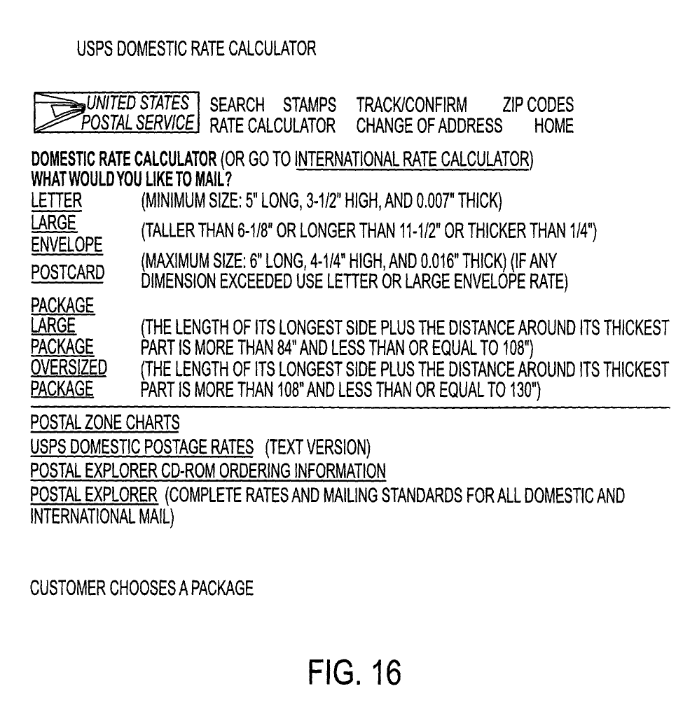

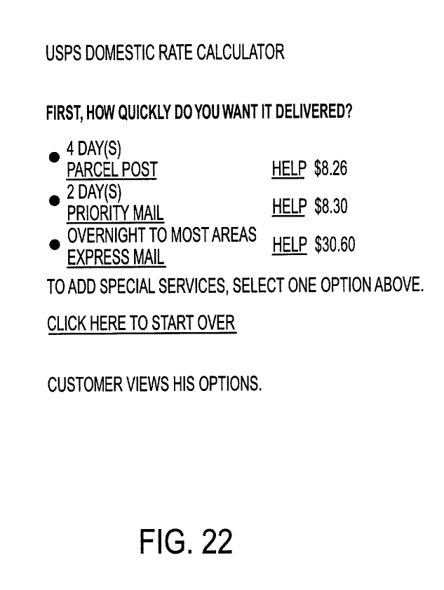

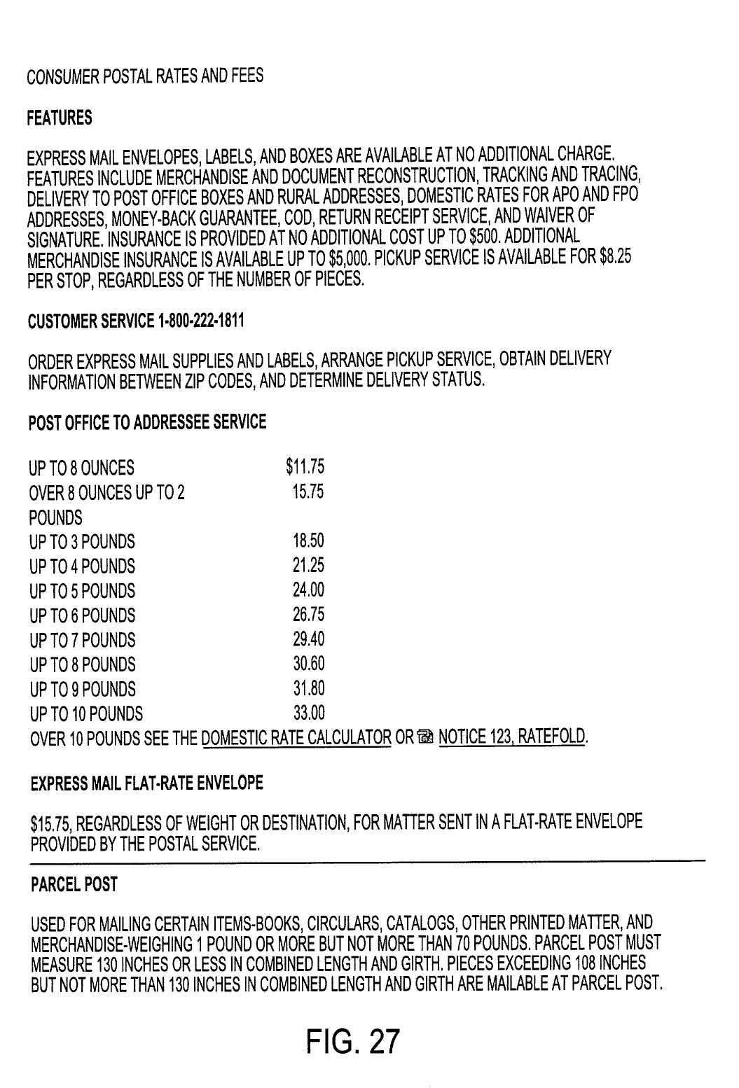

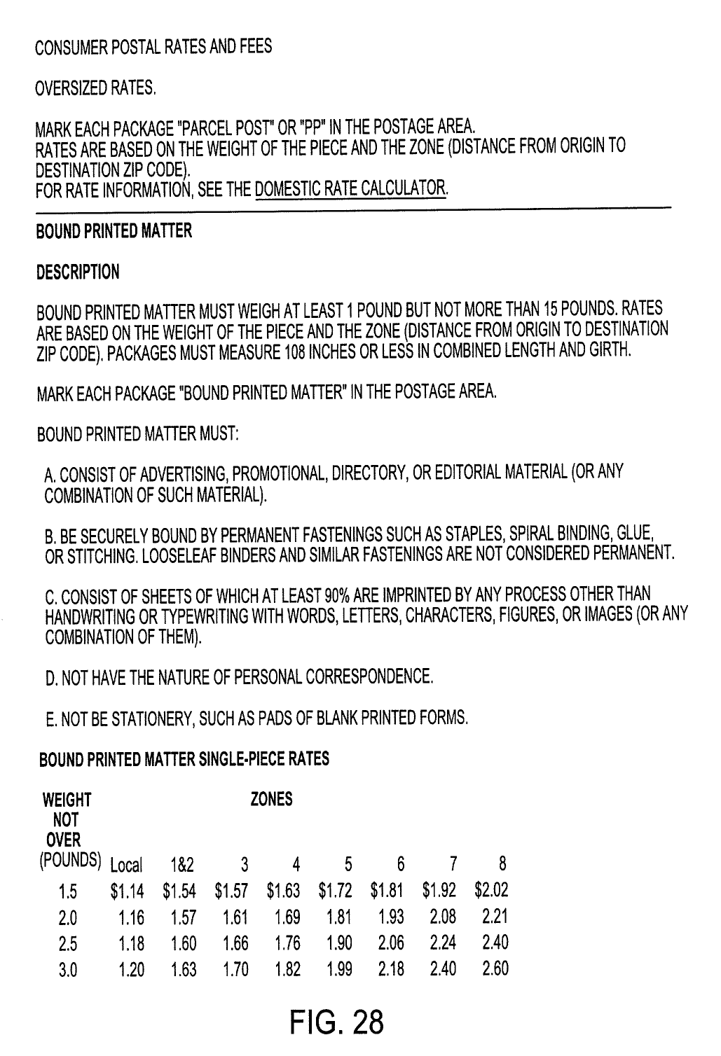

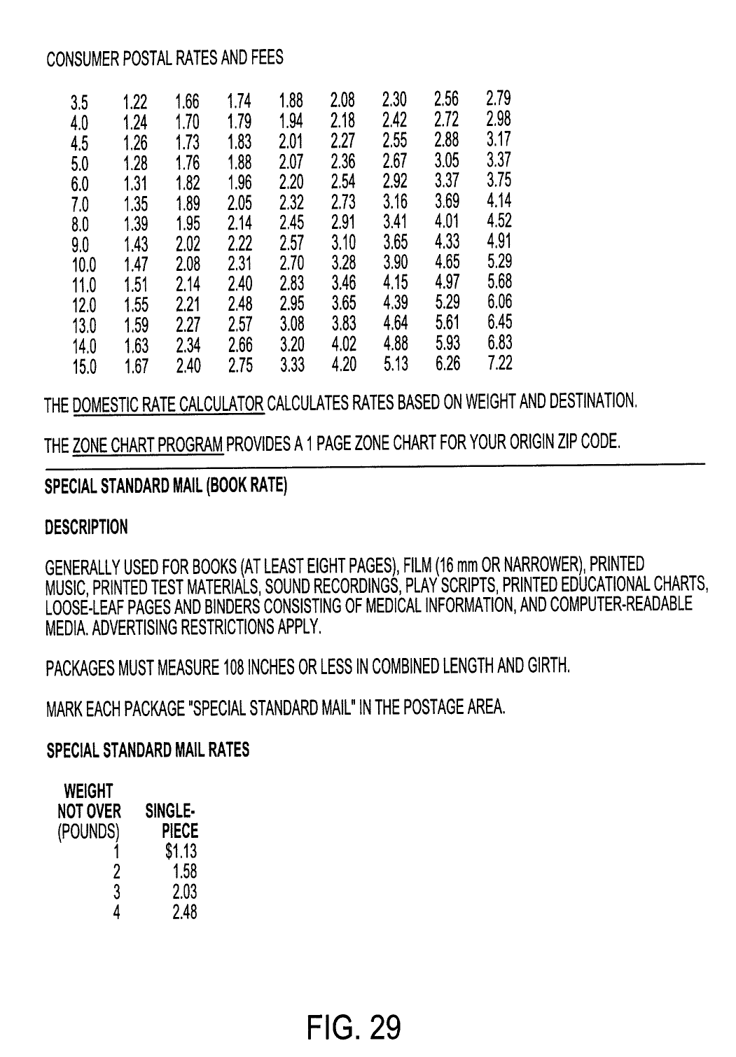

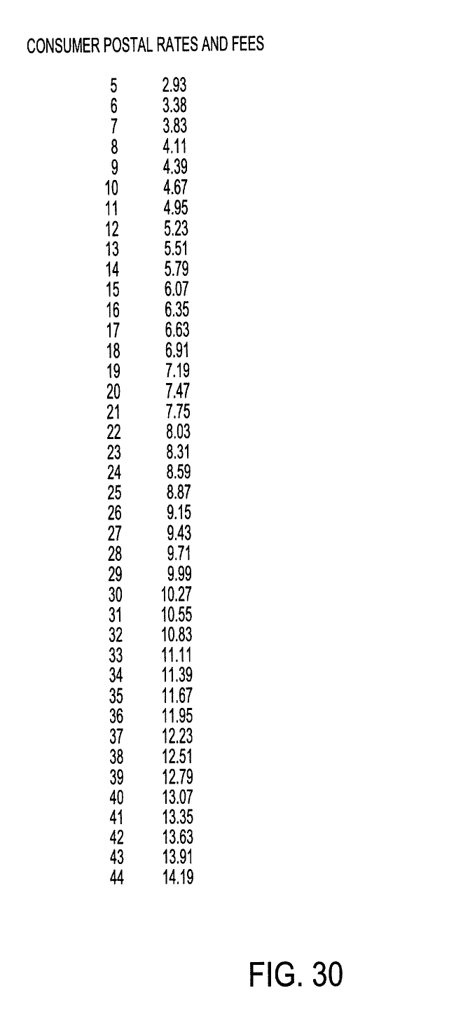

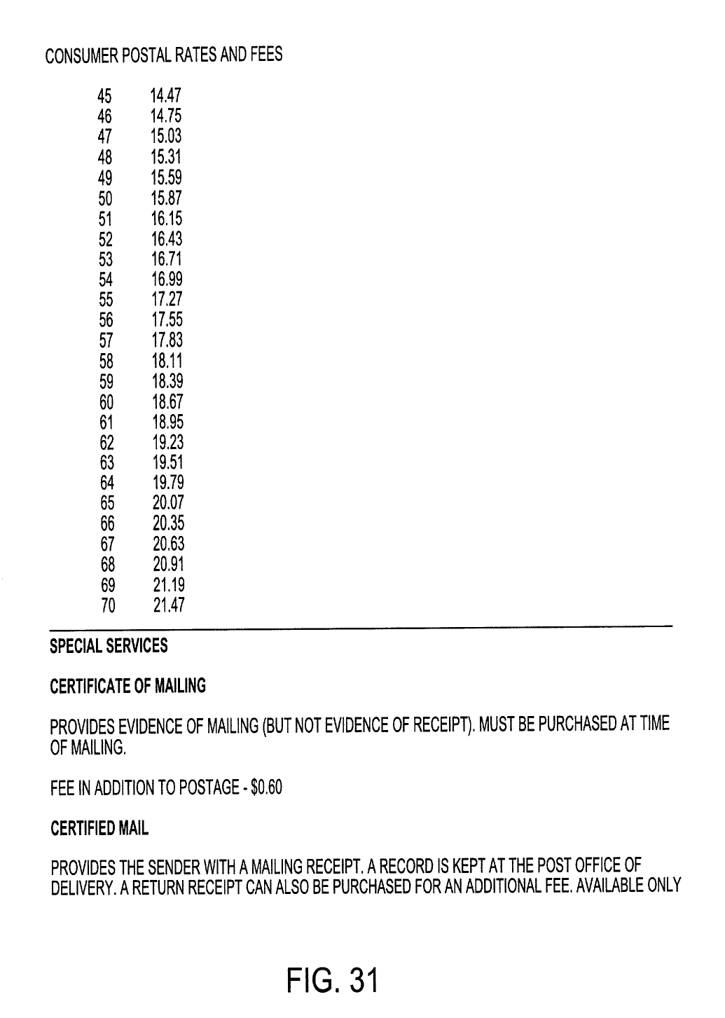

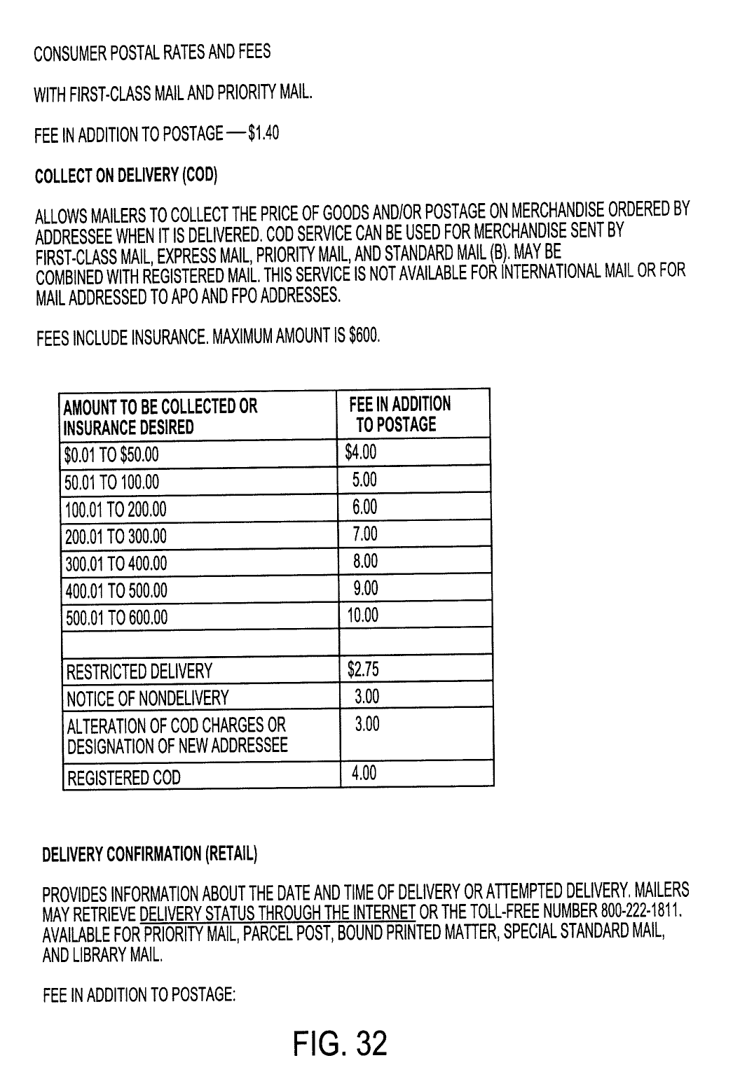

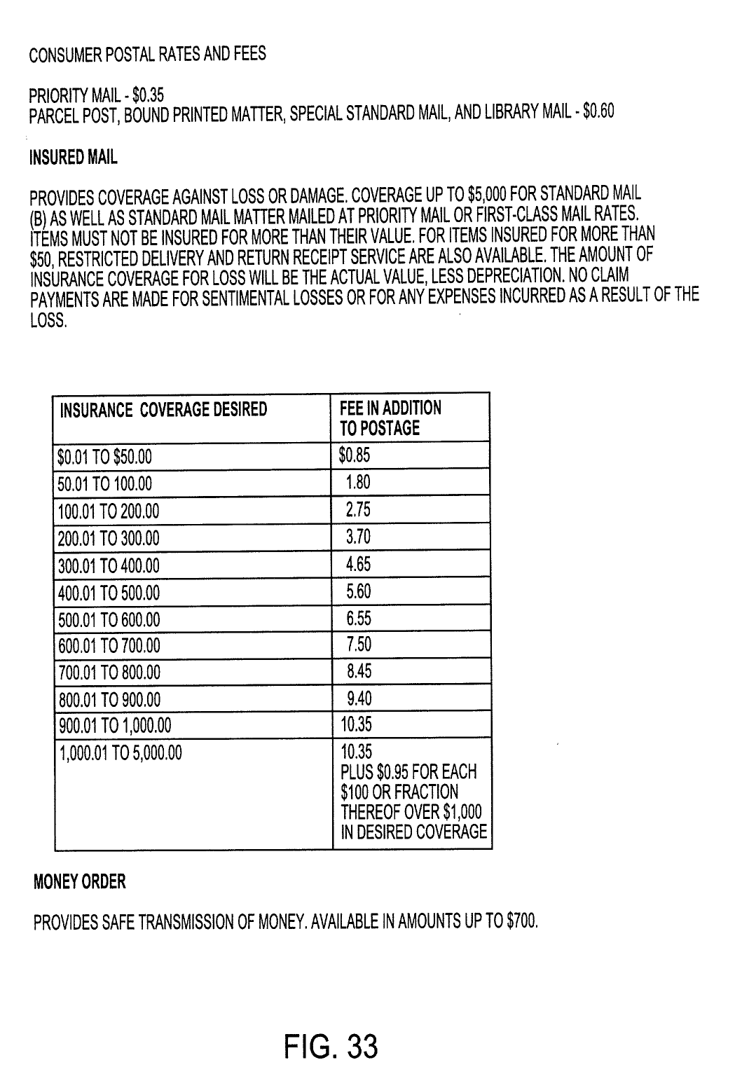

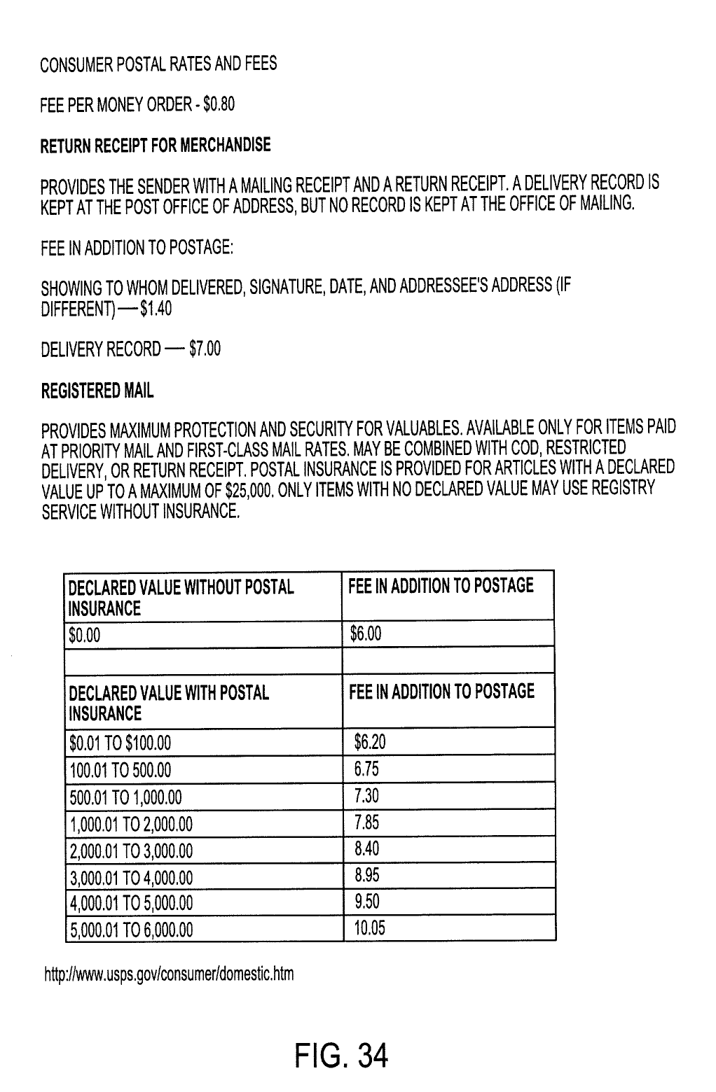

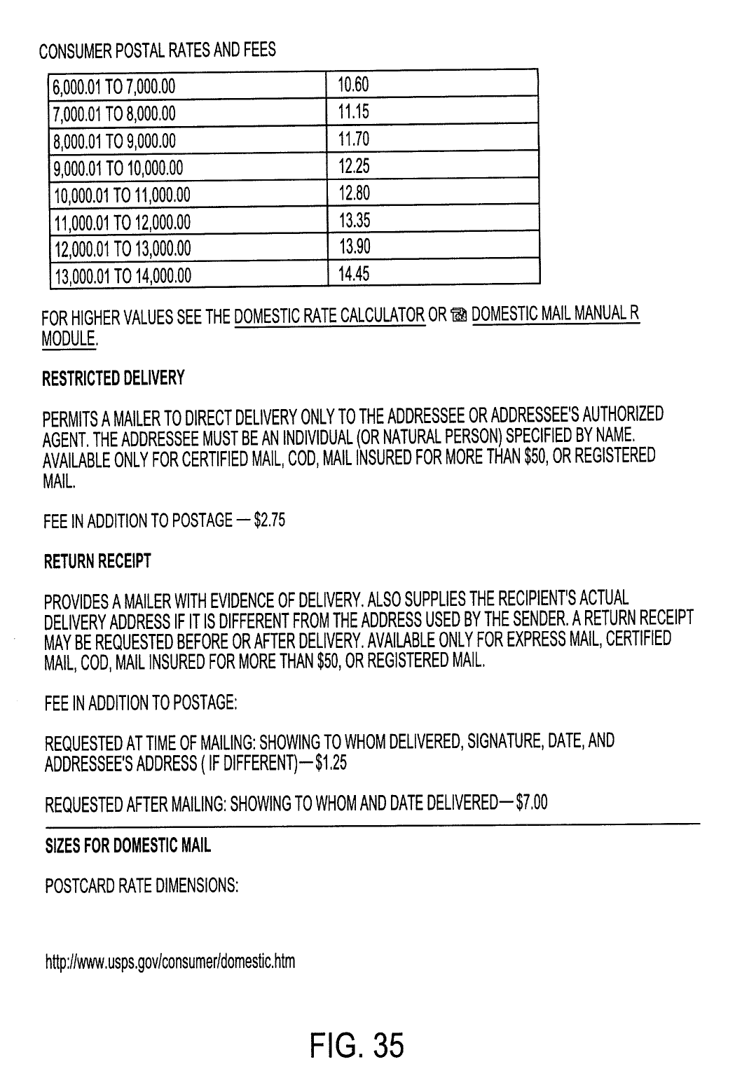

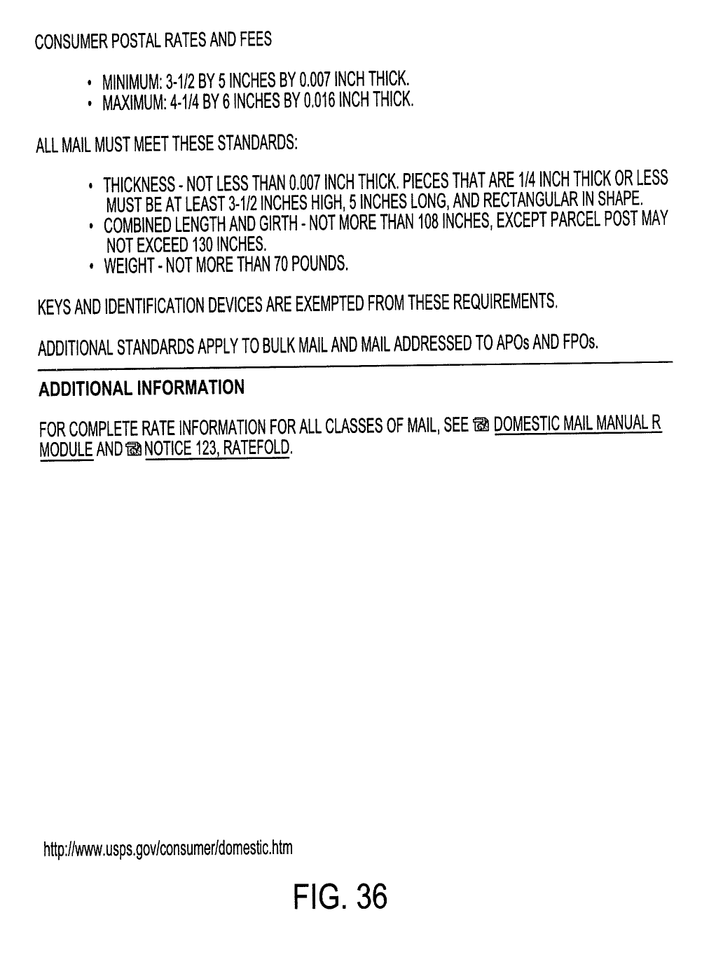

FIGS. 16-41 show screens for the calculation of postal rates.

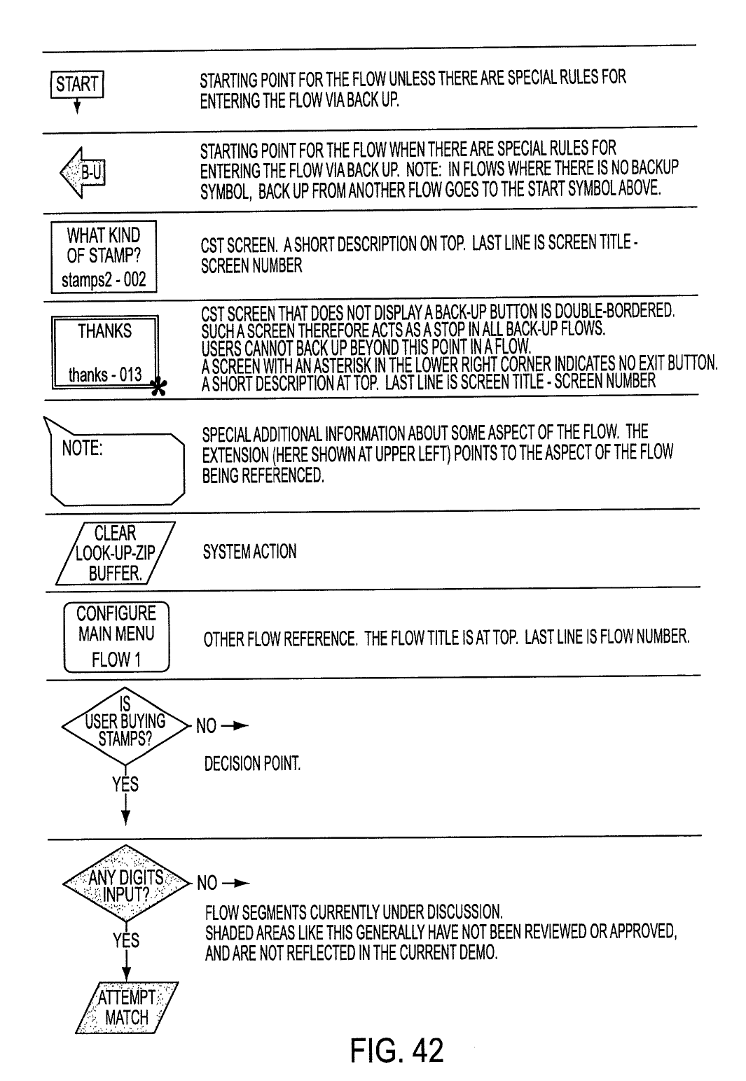

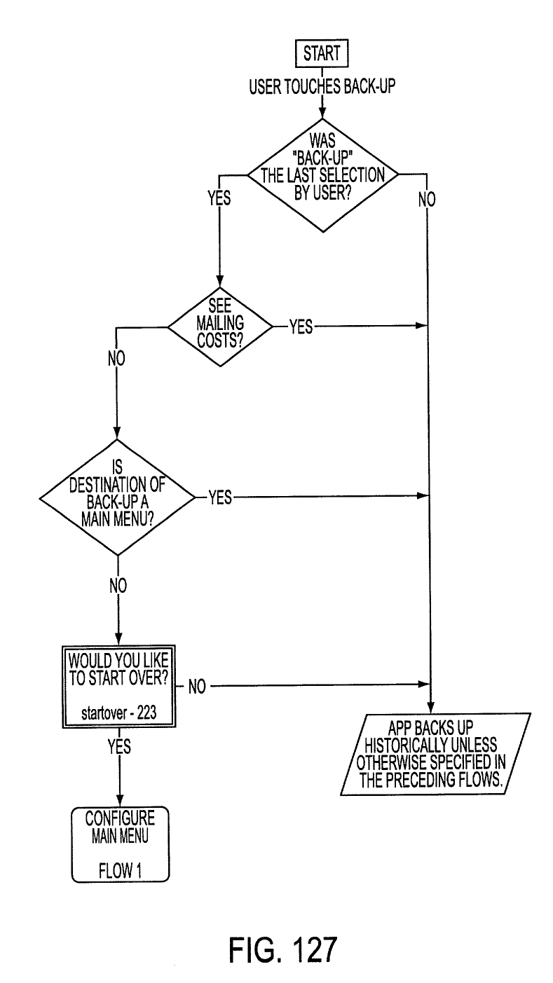

FIGS. 42-127 show an overview of an embodiment of the present invention of an interactive method of advising customers which postal services to buy and how much to pay.

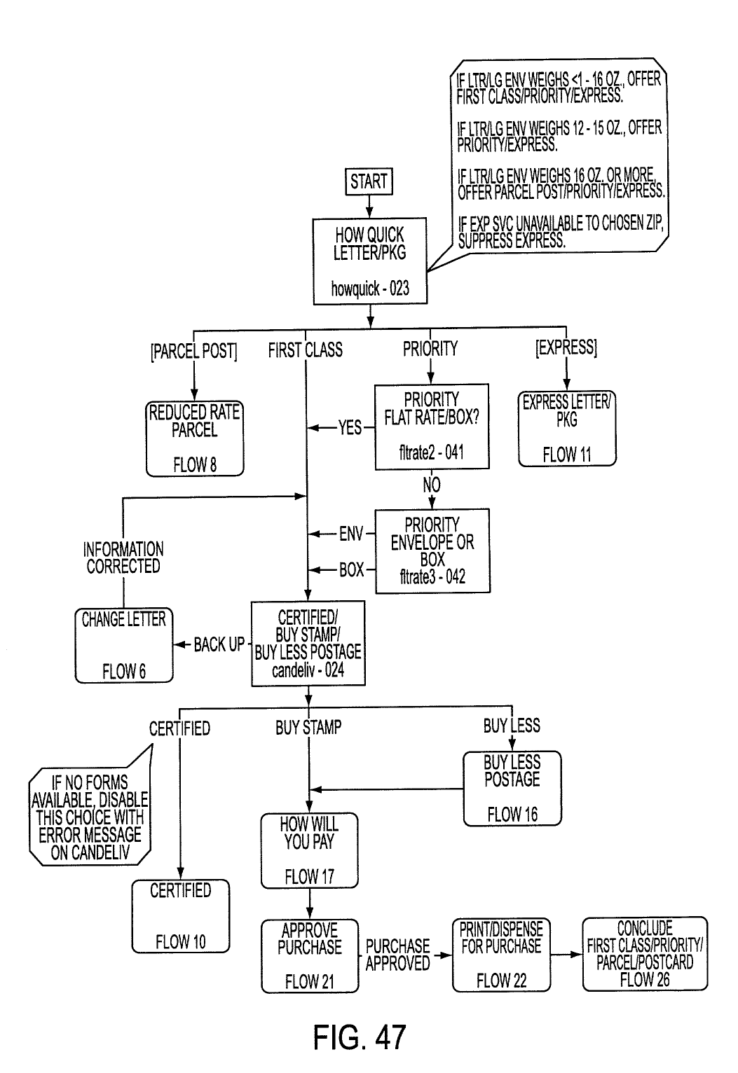

FIG. 47 shows a scheme of how to Mail Letter—Flow 5 is a flow chart of an embodiment of the present invention for advising customers how to select a class of mail services and how much to pay based on the customer's subjective criteria of how quickly the customer wants the letter or package to arrive.

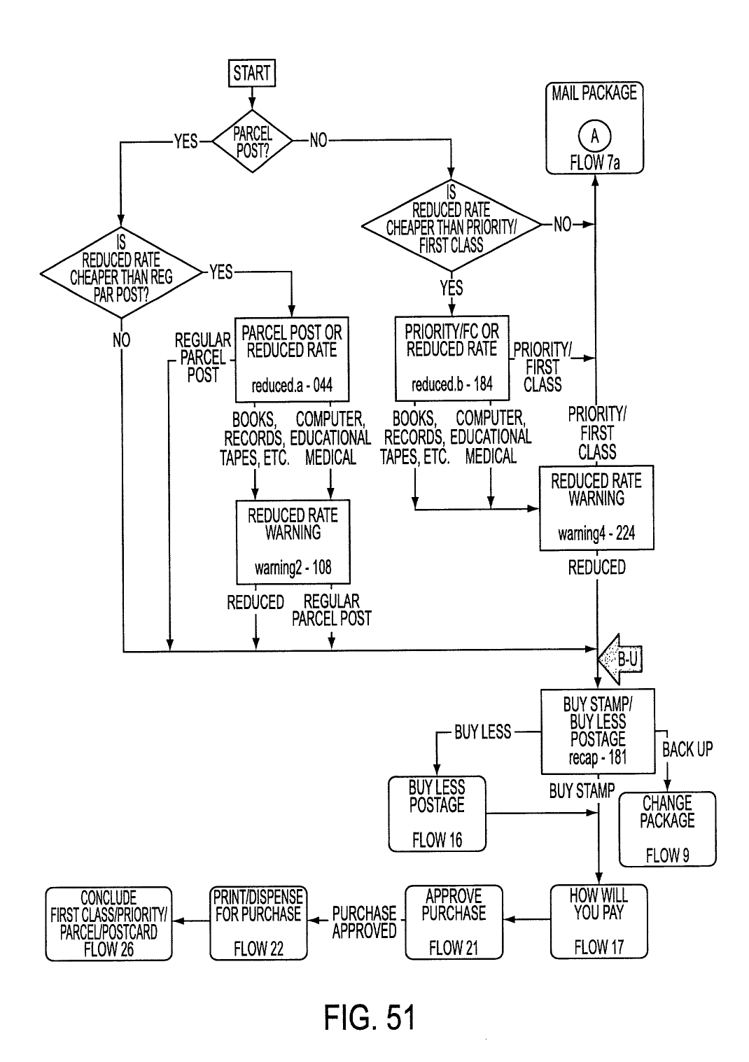

FIG. 51 shows a scheme for a Reduced Rate Parcel—Flow 8 is a flow chart of an embodiment of the present invention for an interactive method of providing customers with the information and advice necessary for the customer to determine whether his or her package qualifies for reduced rate postage.

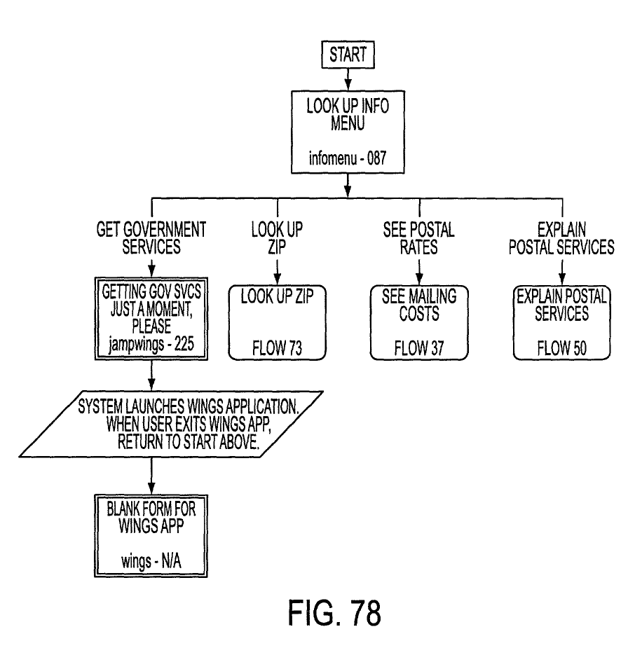

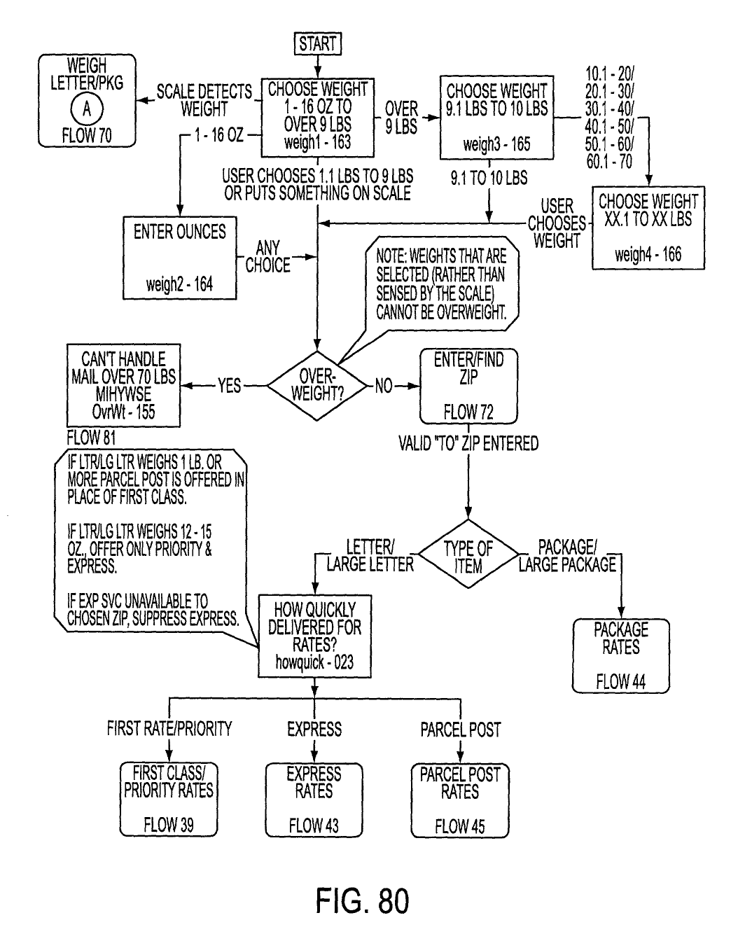

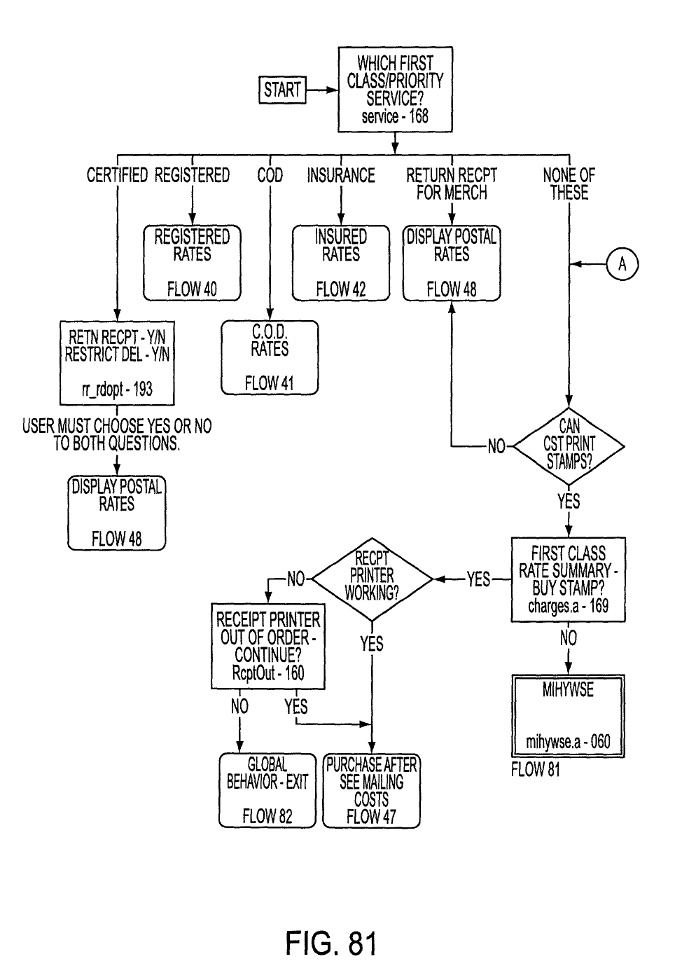

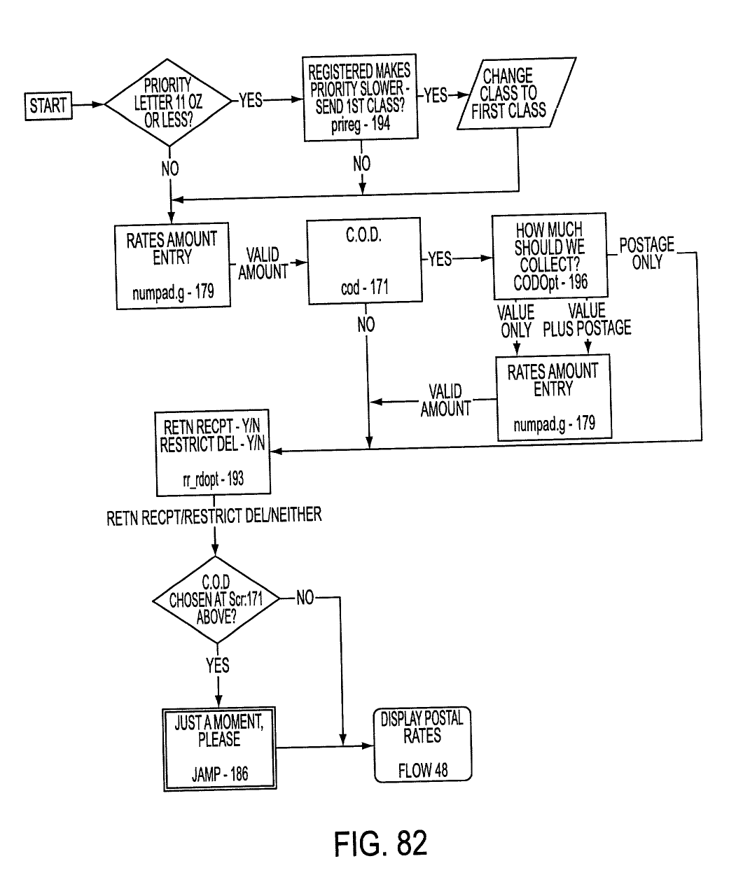

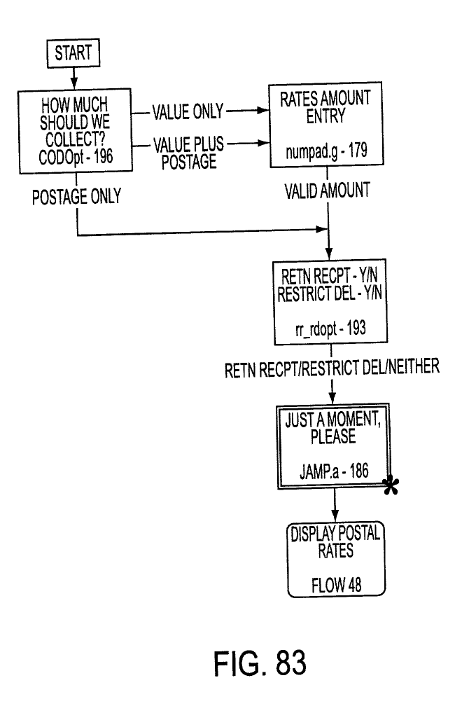

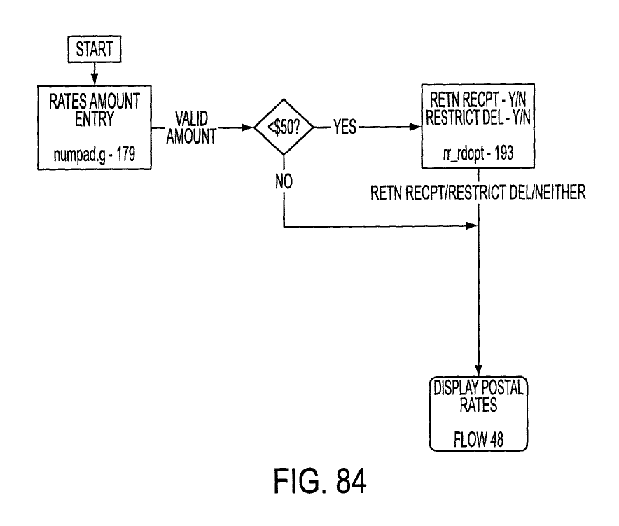

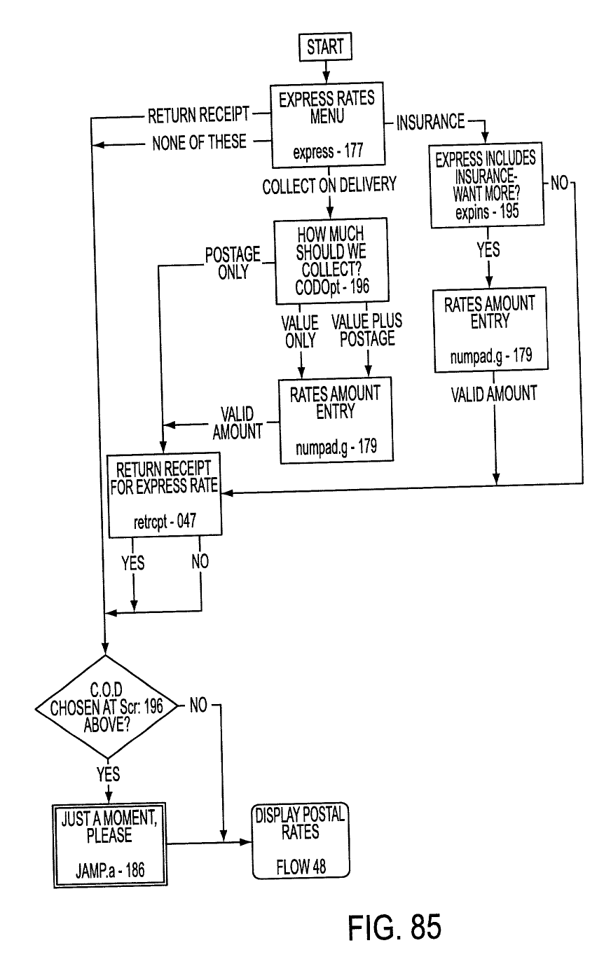

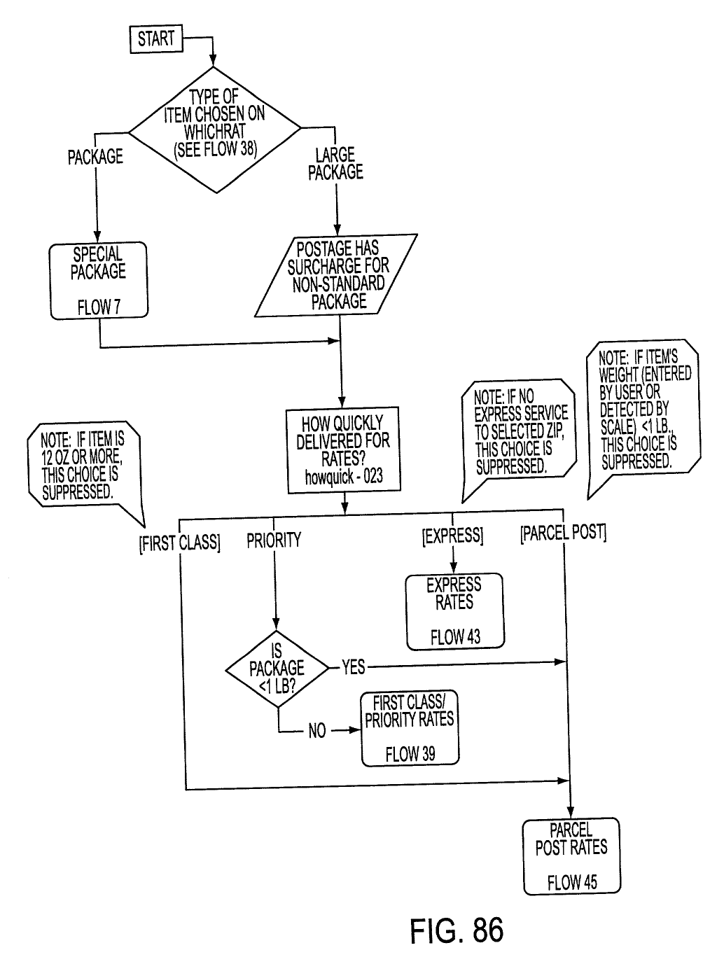

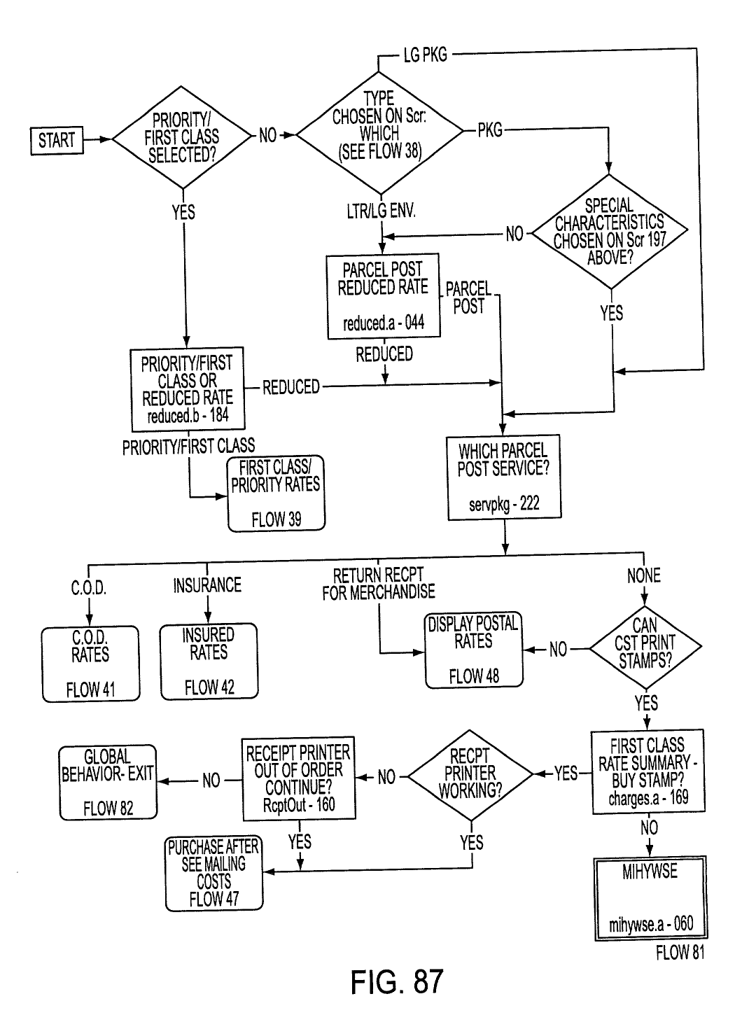

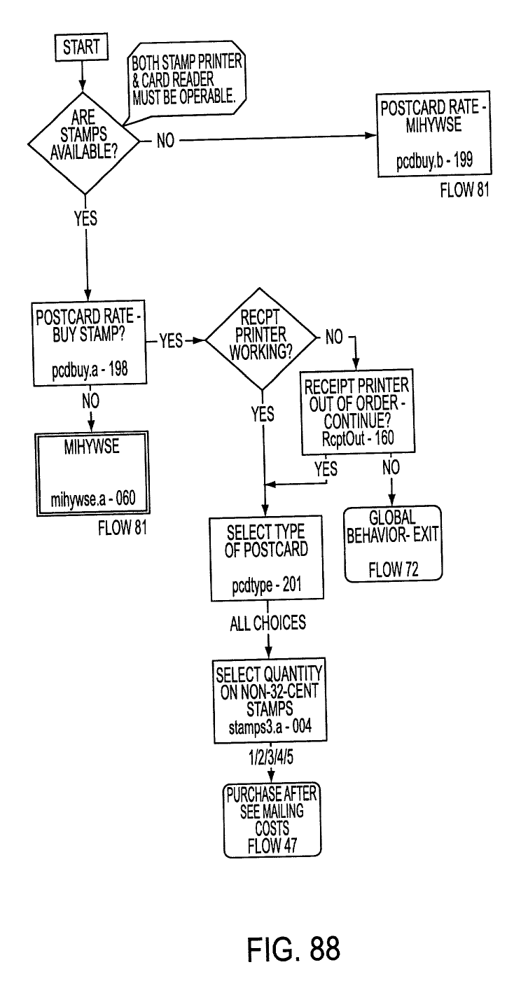

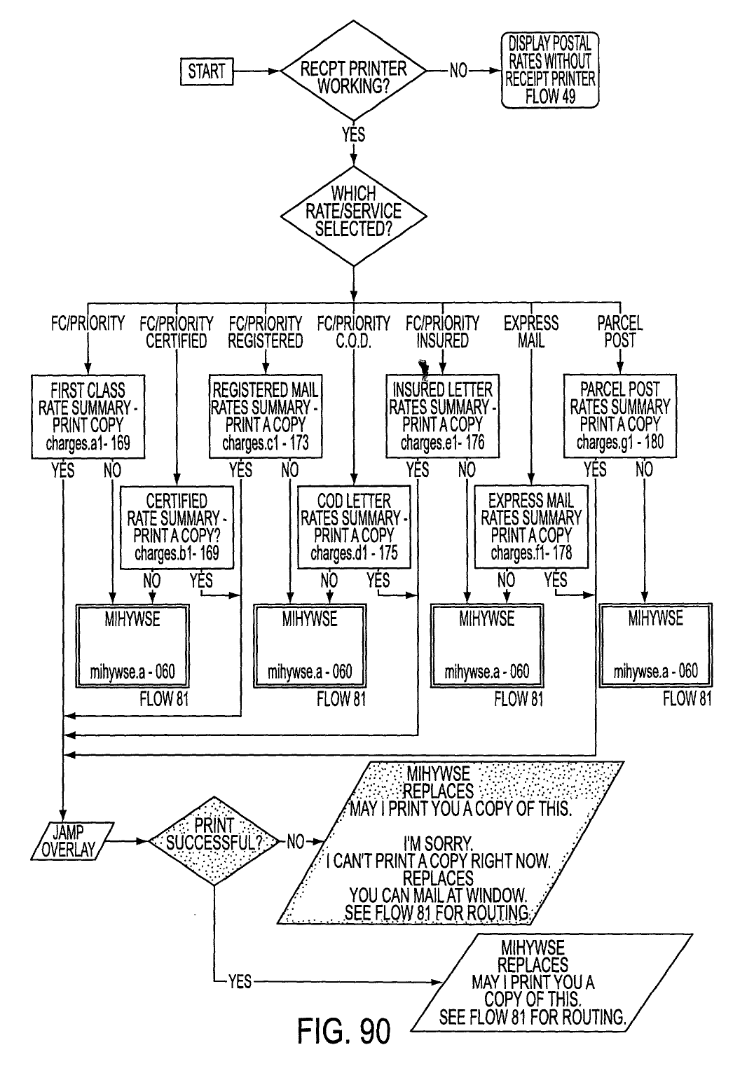

FIGS. 78-91 shows a scheme for determining Mailing Costs—Flow 36-Flow 49 are flow charts of an embodiment of the present invention of an interactive method of advising customers how much to pay for mailing services based on the customers objective criteria, such as weight or size of package and subjective criteria, such as how quickly the package would arrive and the customer's need for certainty and closure (certified mail, return receipt requested.)

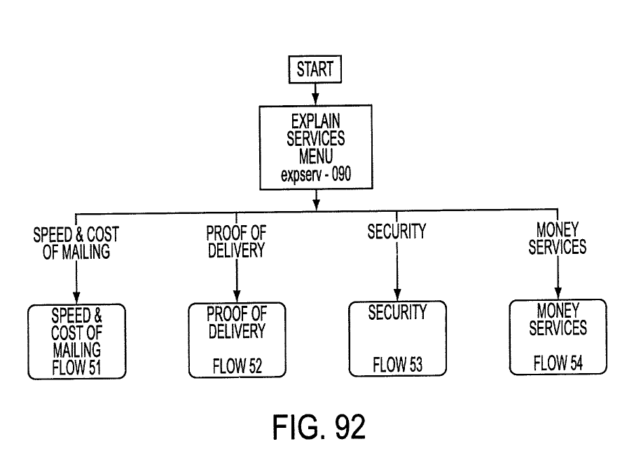

FIG. 92-96 shows an explanation of Postal Services—Flows 50-54 is a flow chart of an embodiment of the present invention of an interactive method of advising customers which postal services to select based on the customer's subjective criteria of “SPEED & COST OF MAILING” and need for certainty and closure (“PROOF OF DELIVERY” and SECURITY), as well as objective criteria (“MONEY SERVICES MENU”).

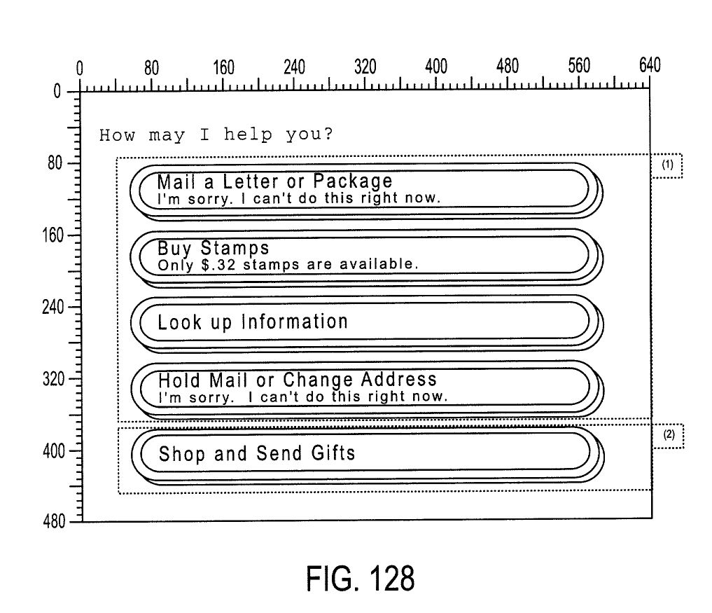

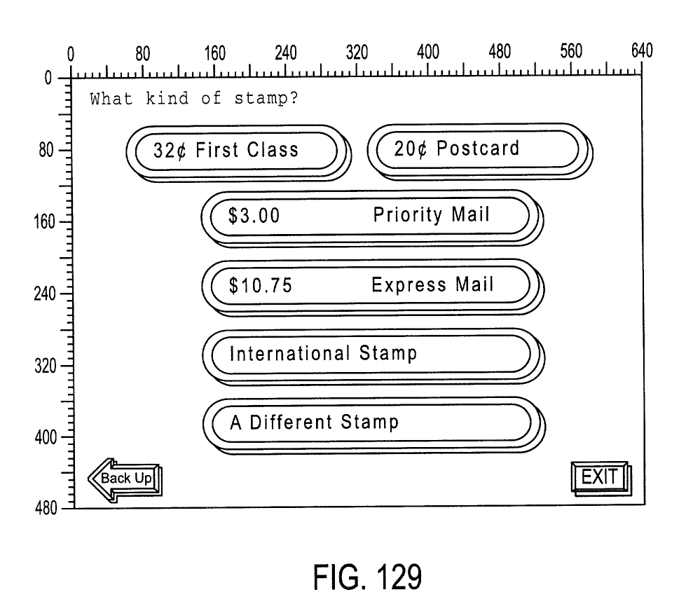

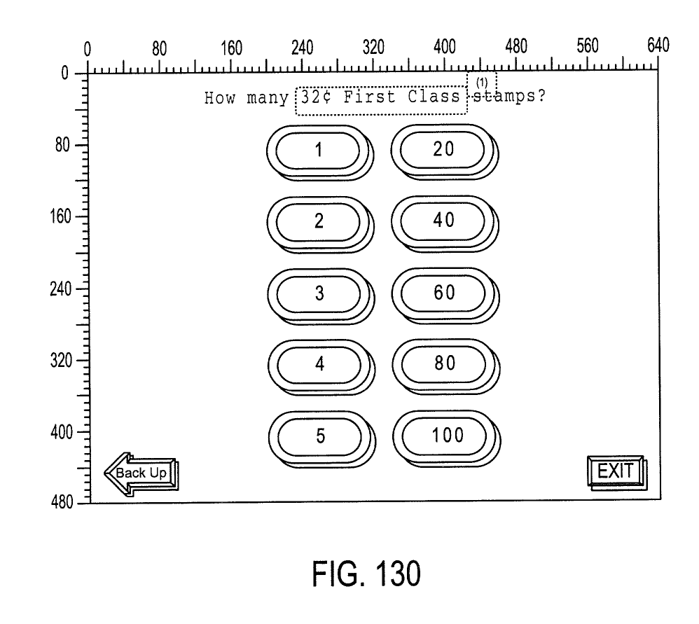

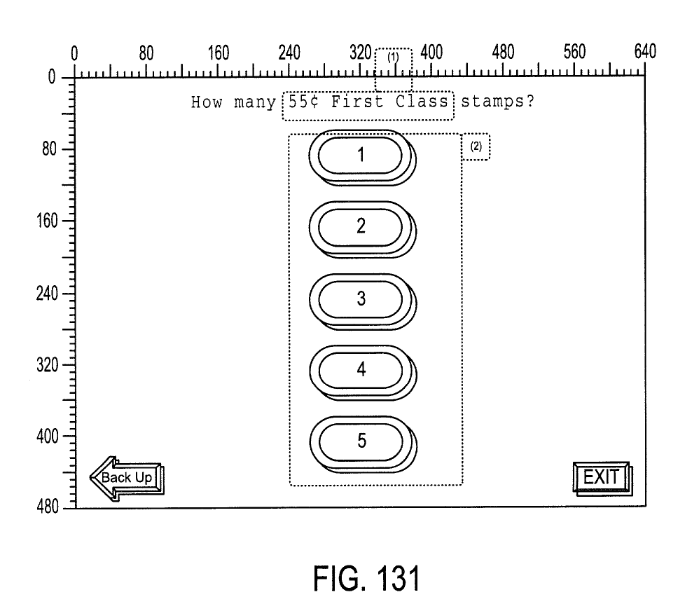

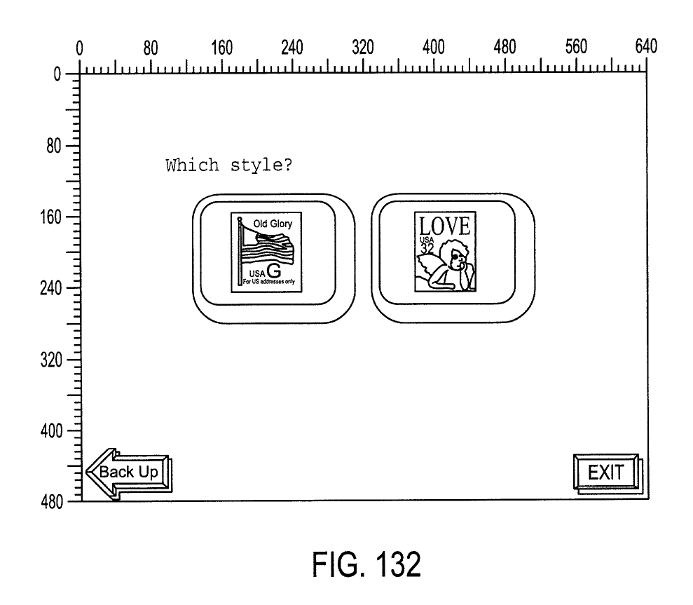

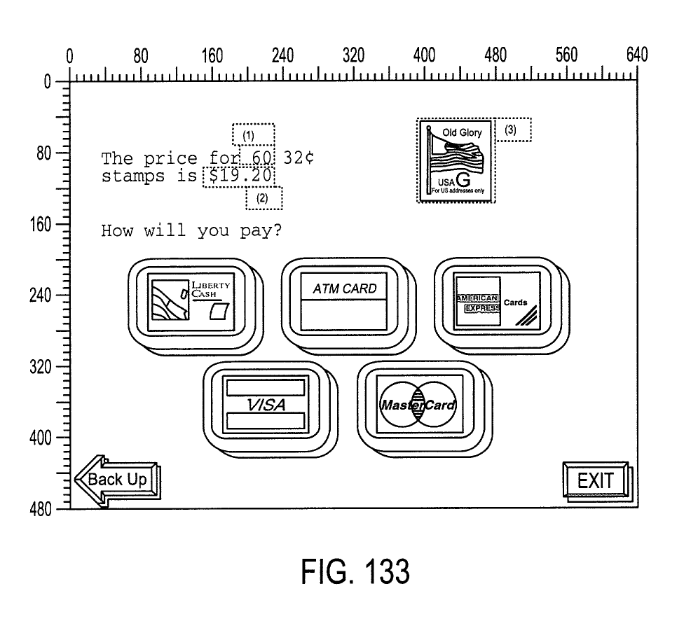

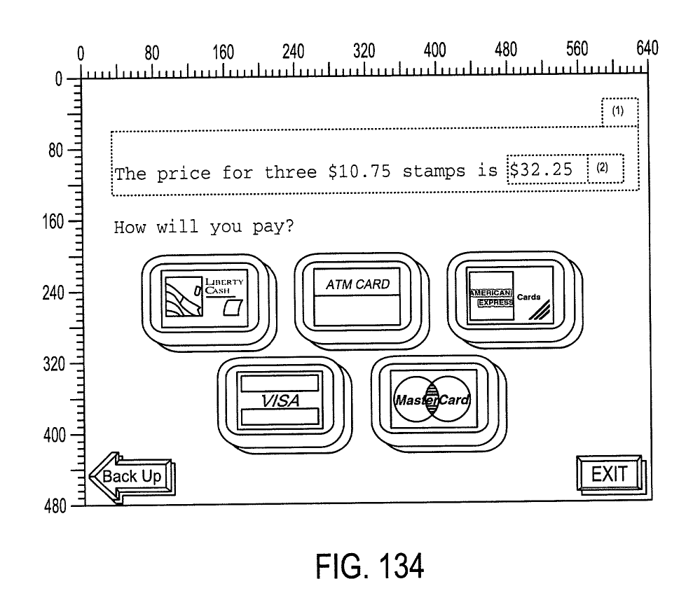

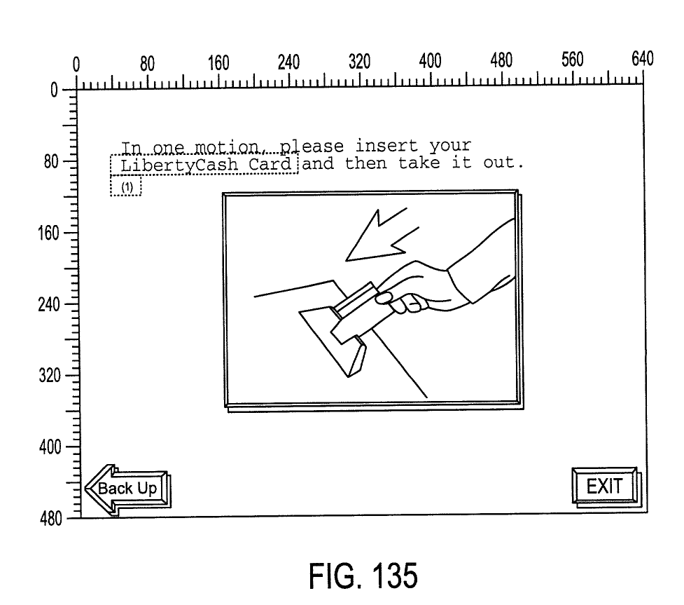

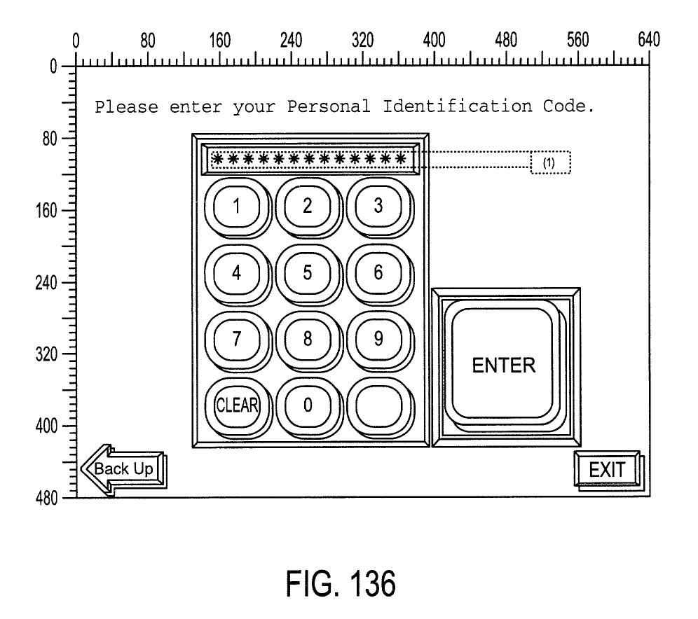

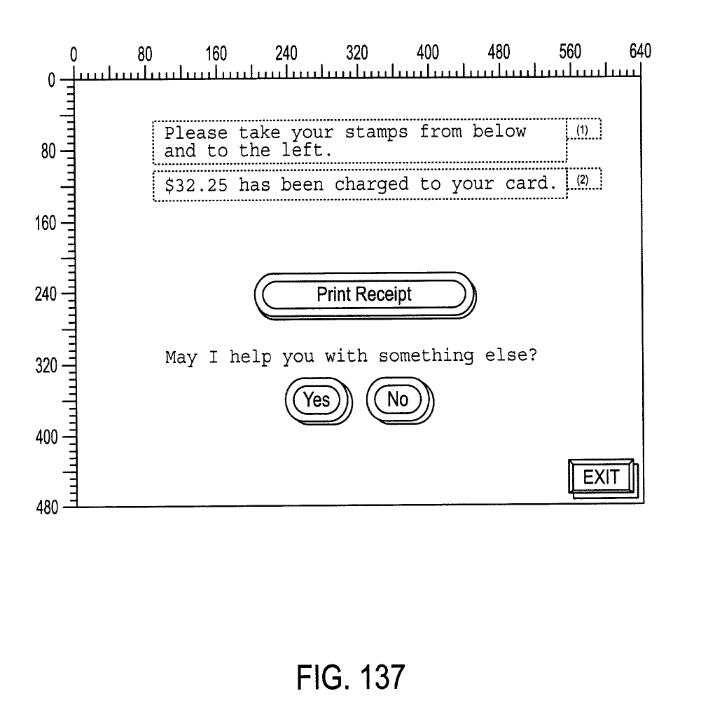

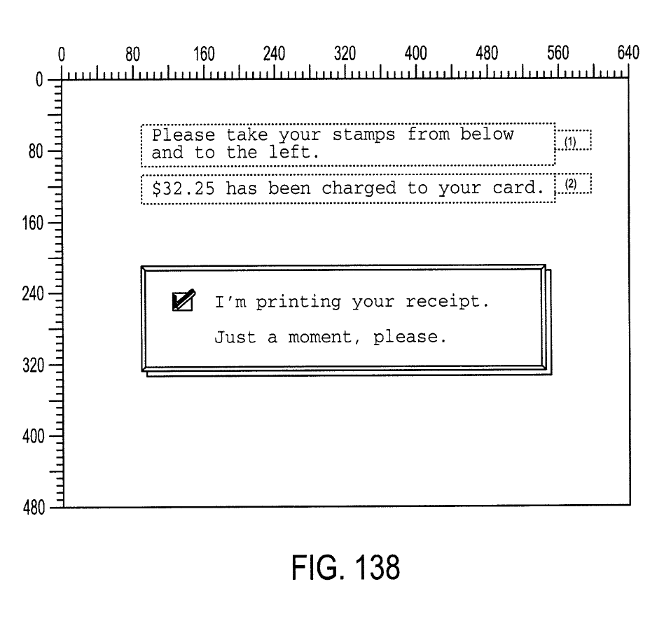

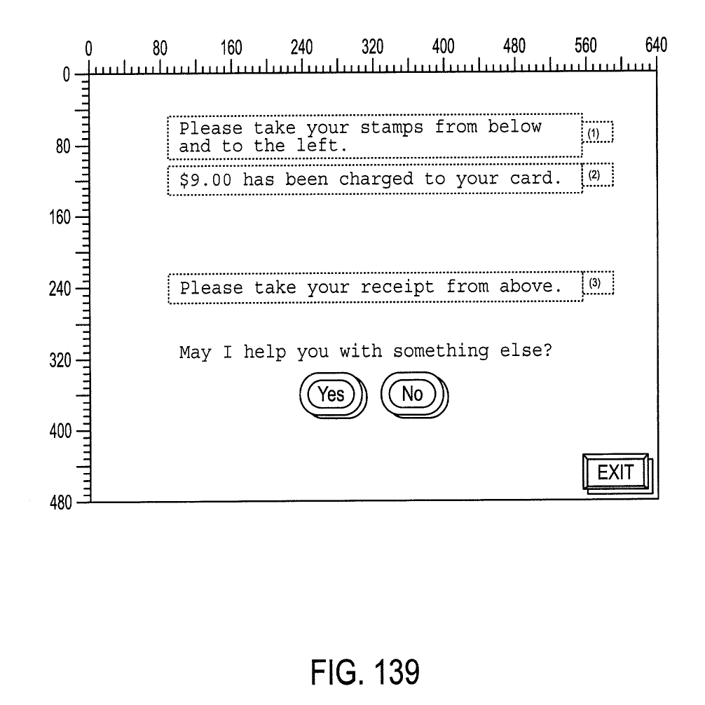

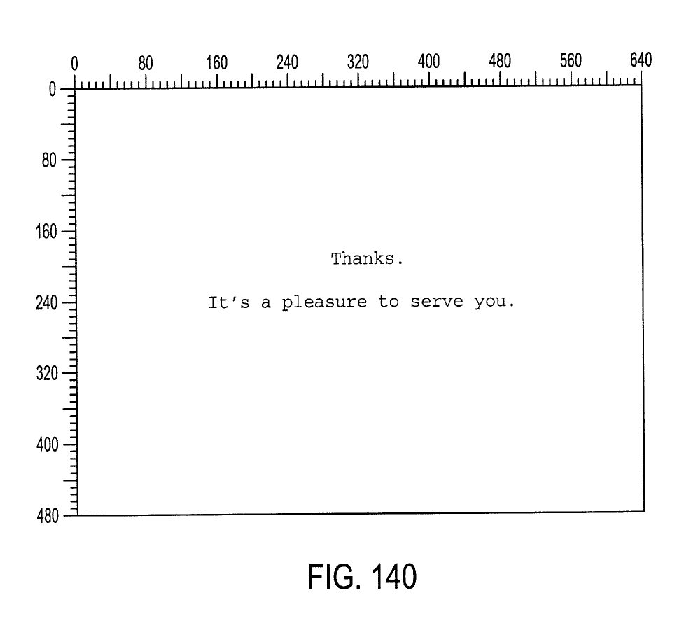

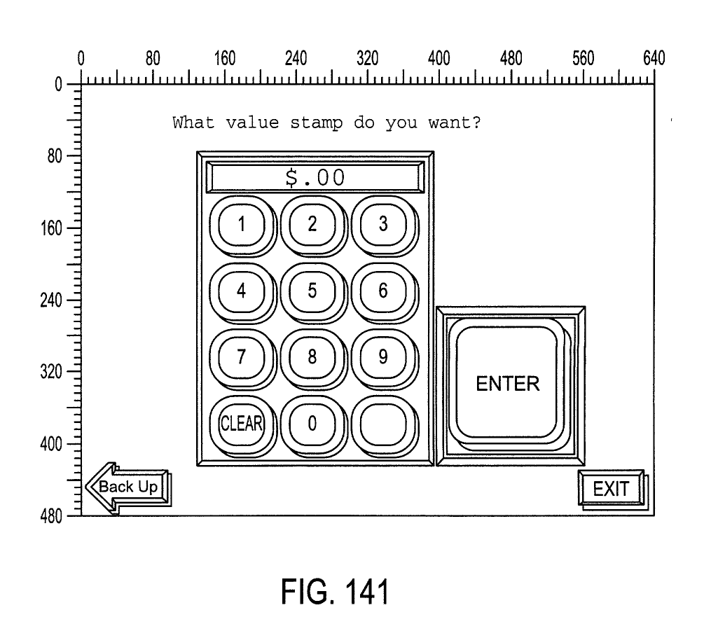

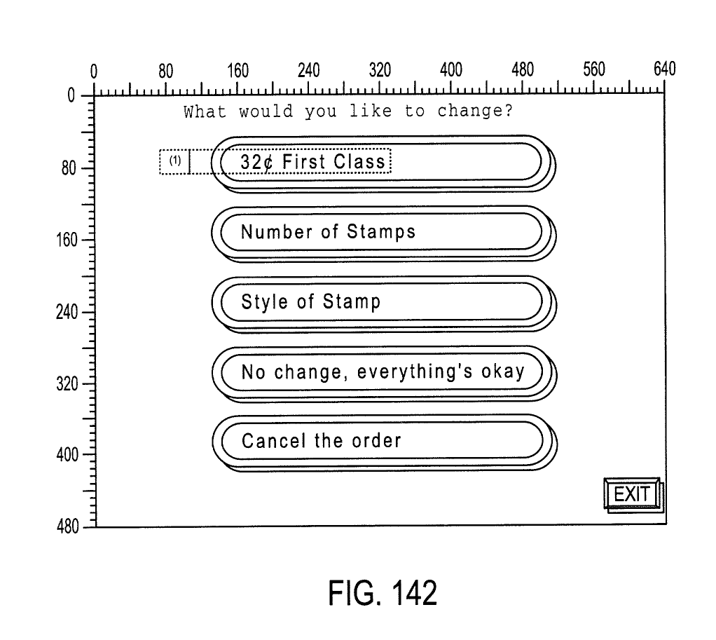

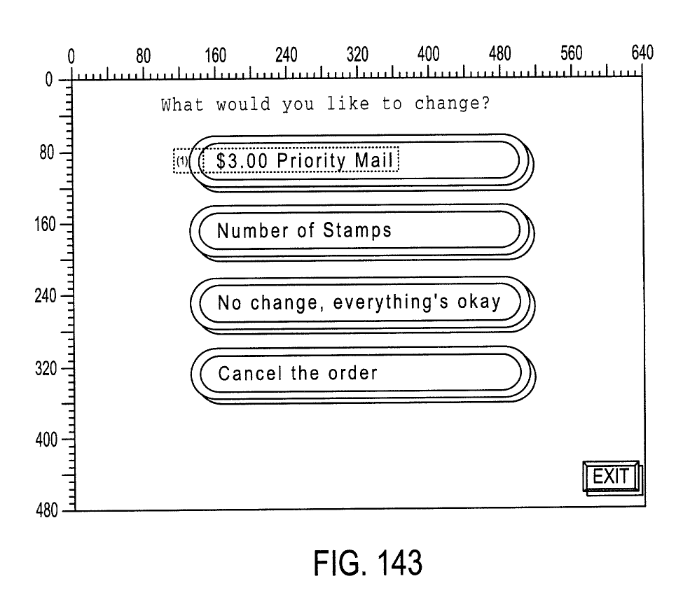

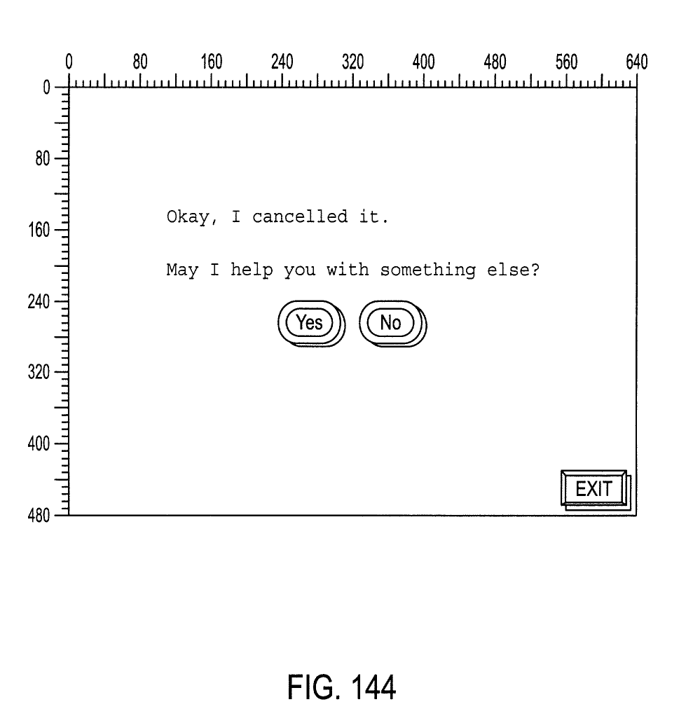

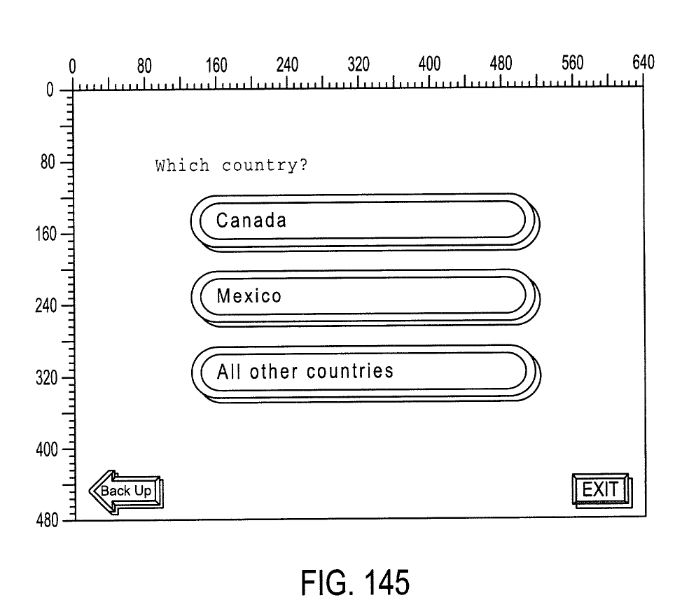

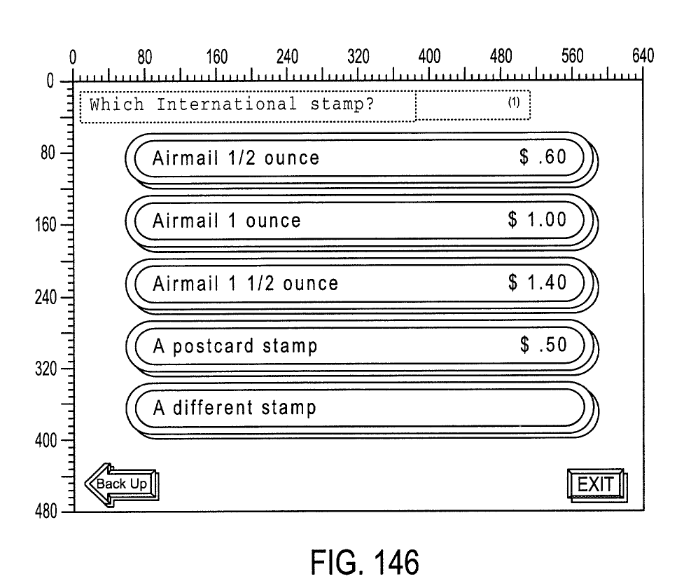

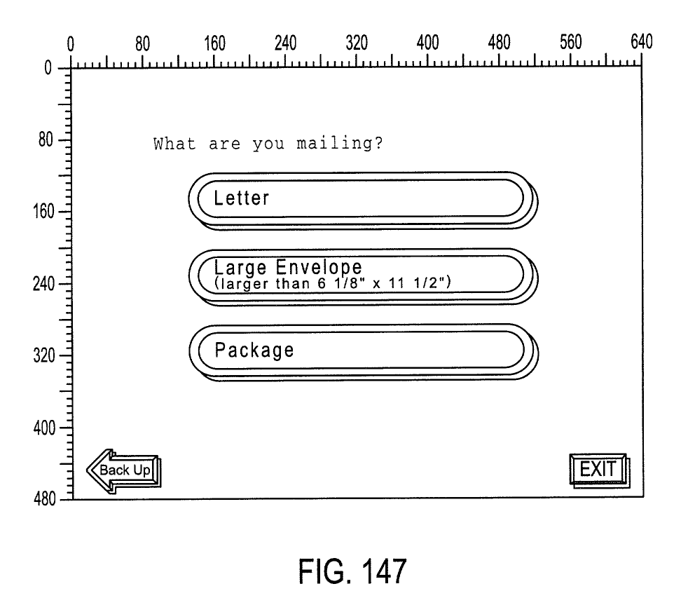

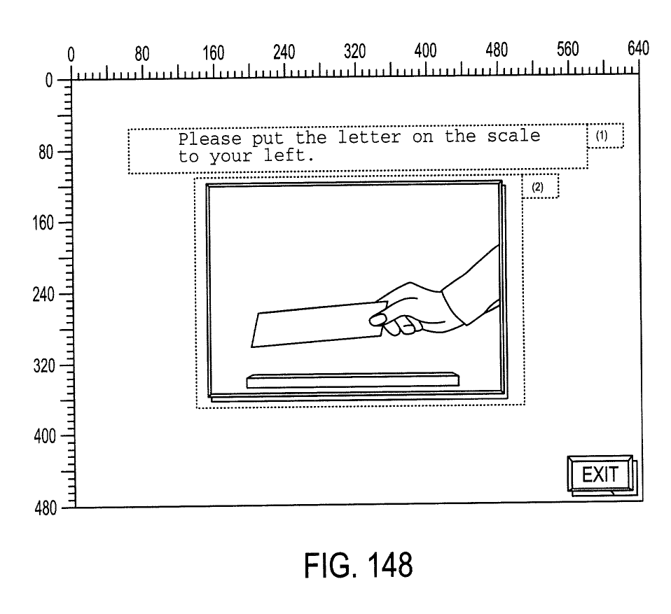

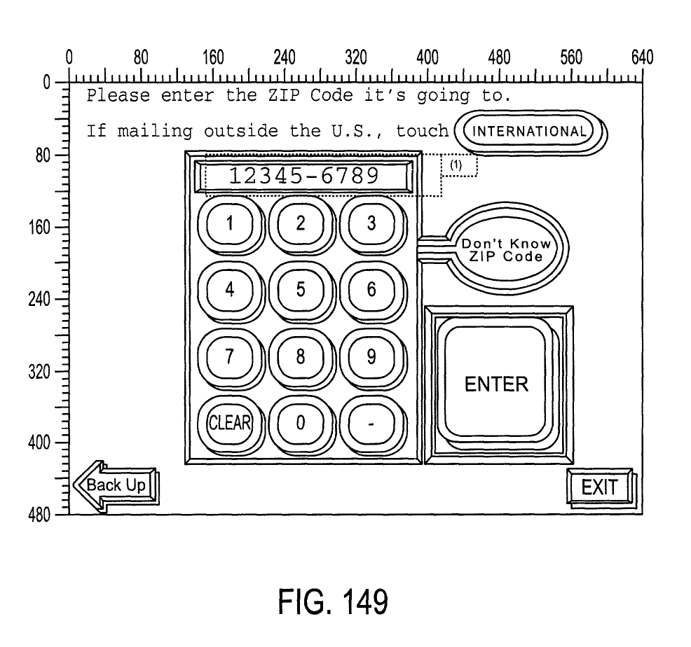

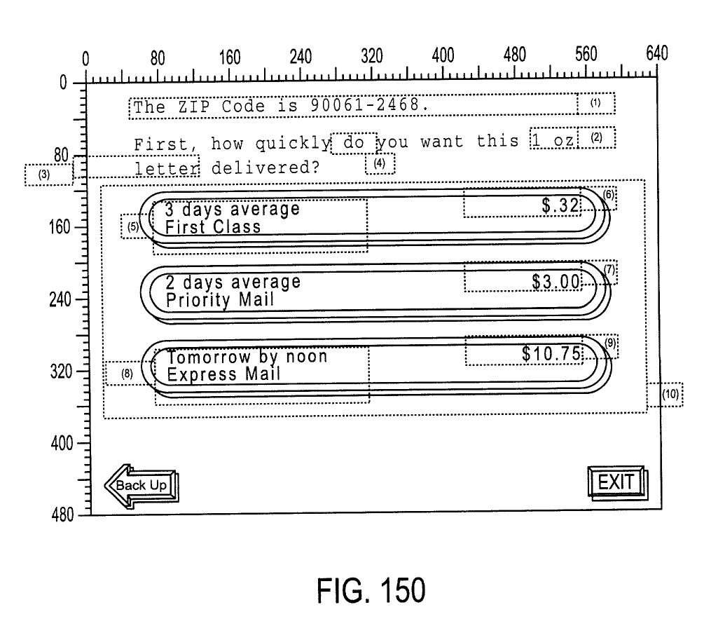

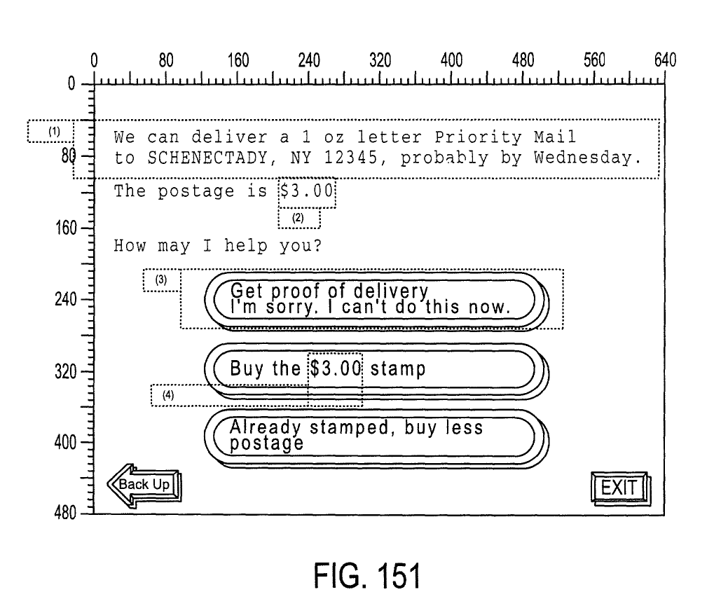

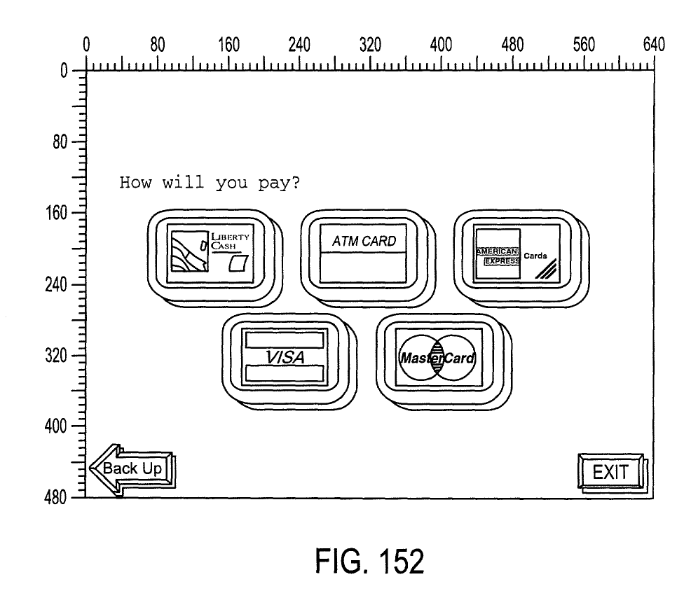

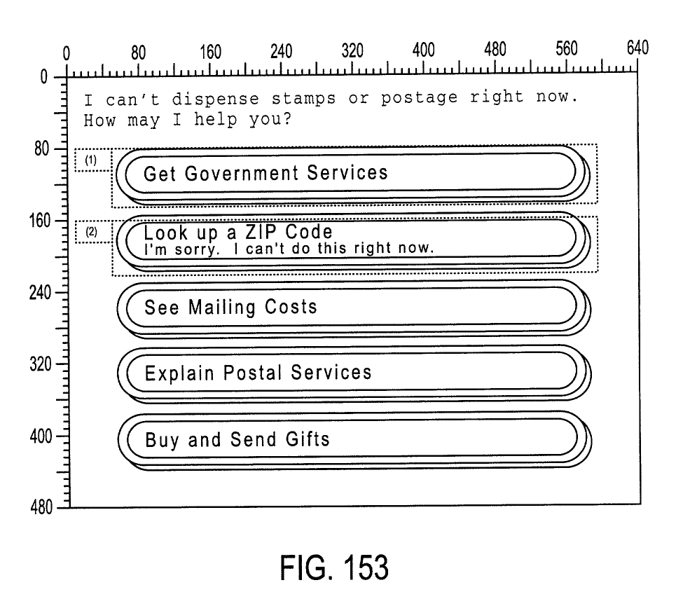

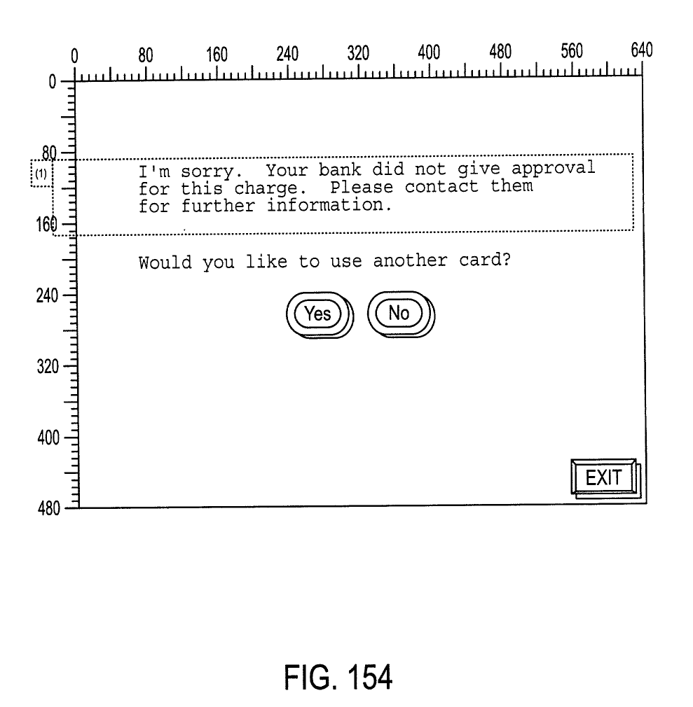

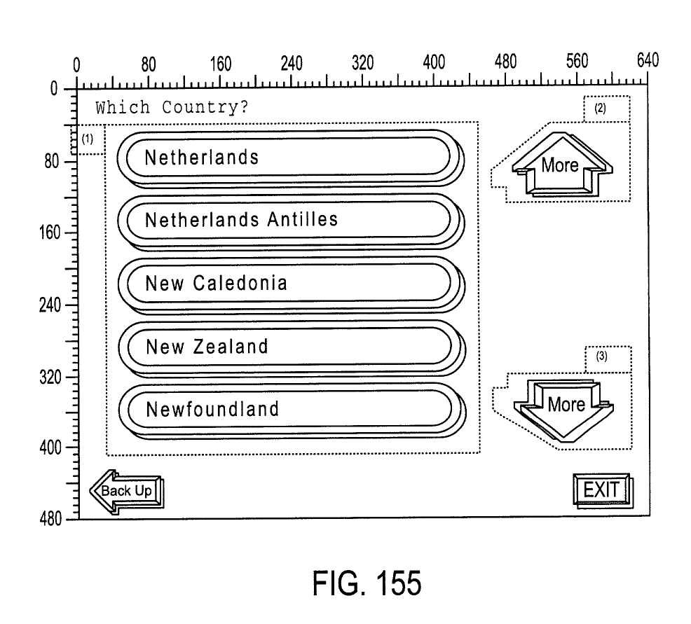

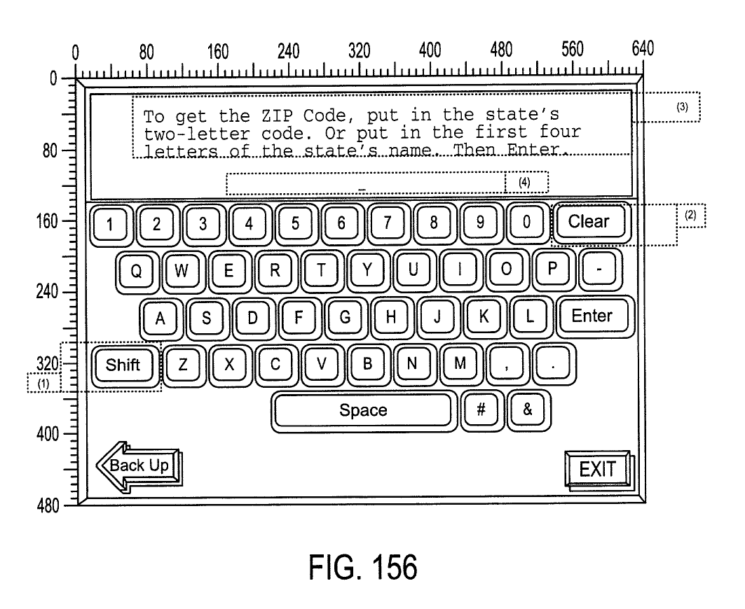

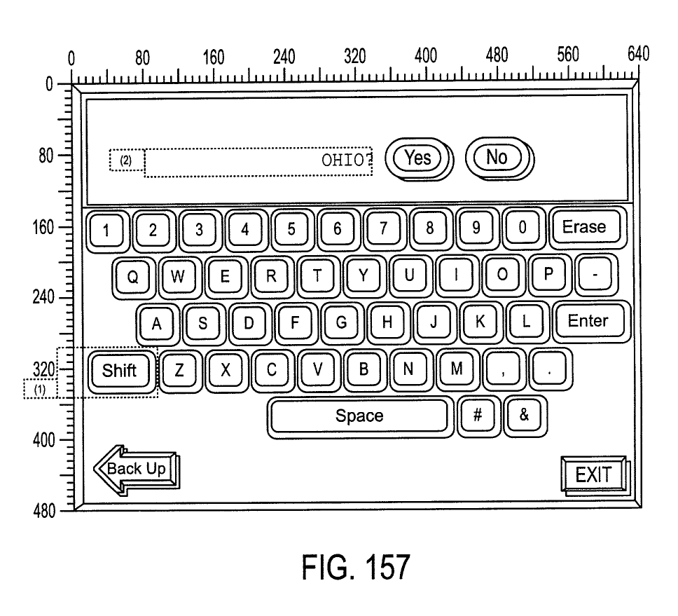

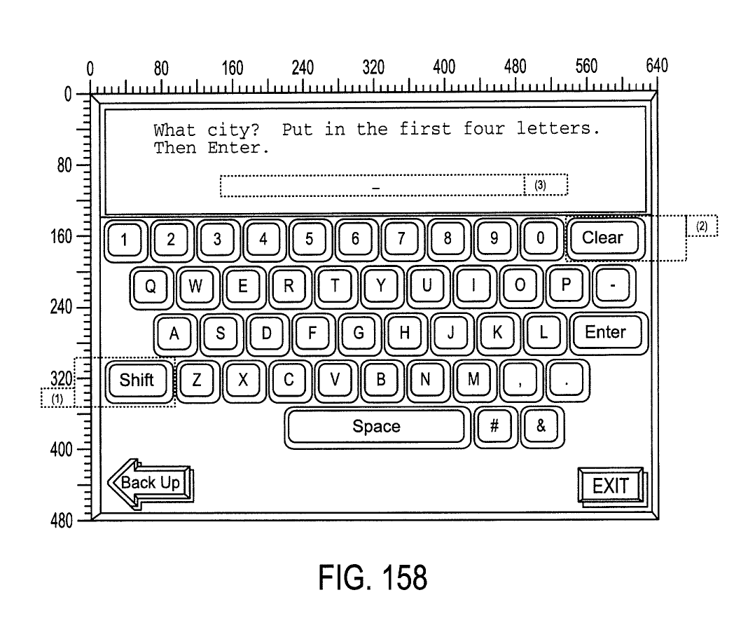

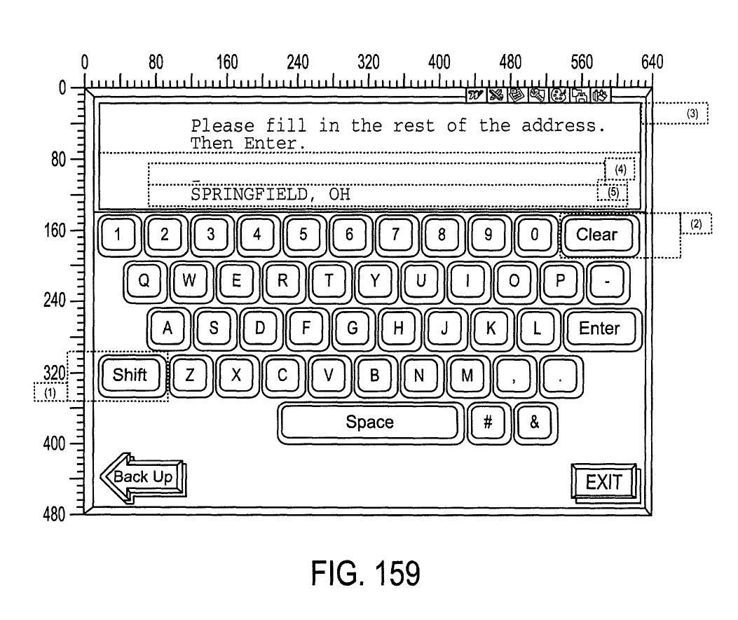

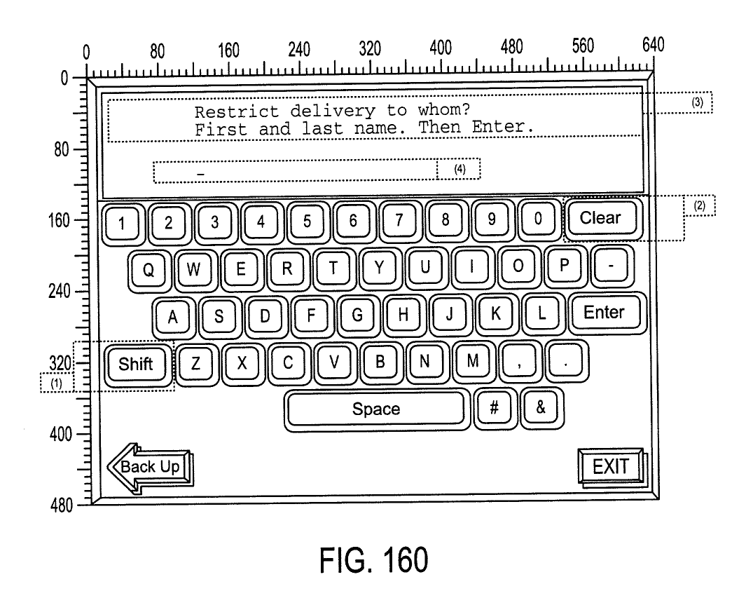

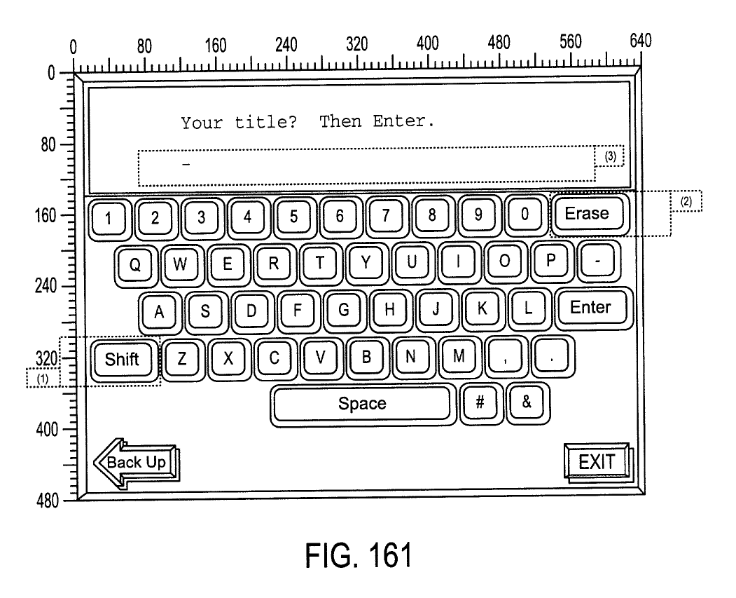

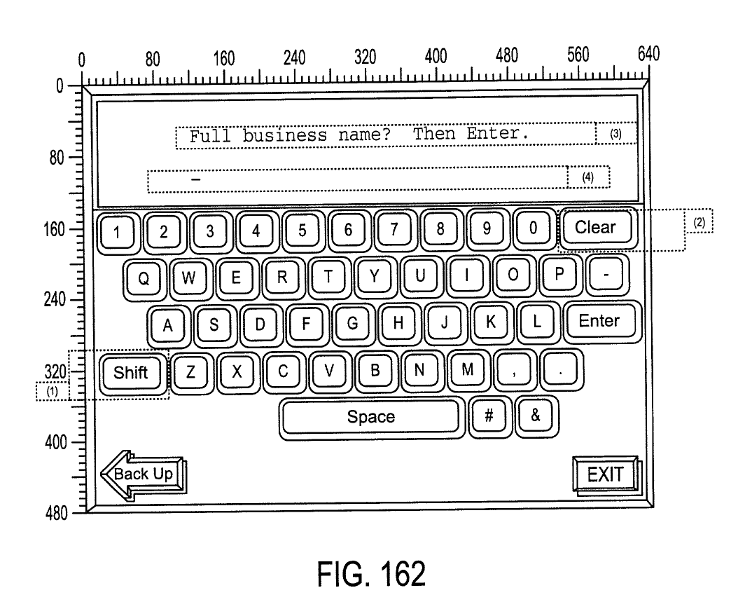

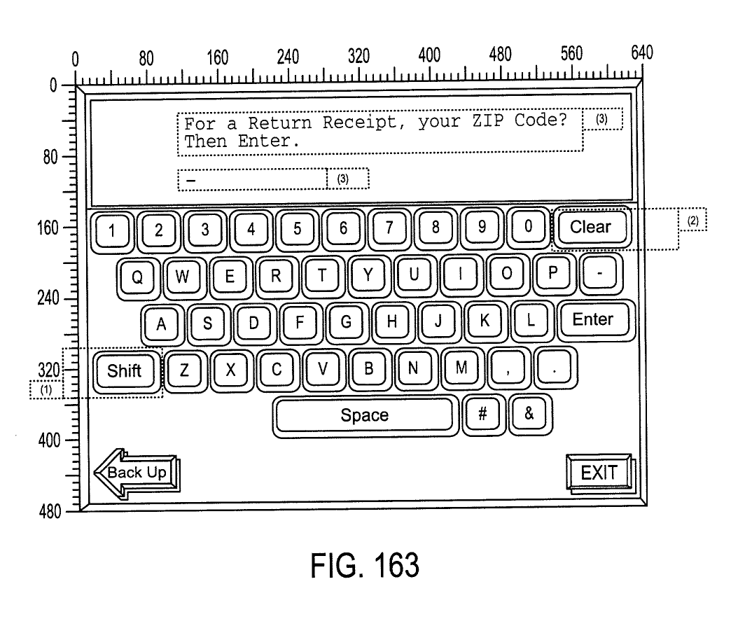

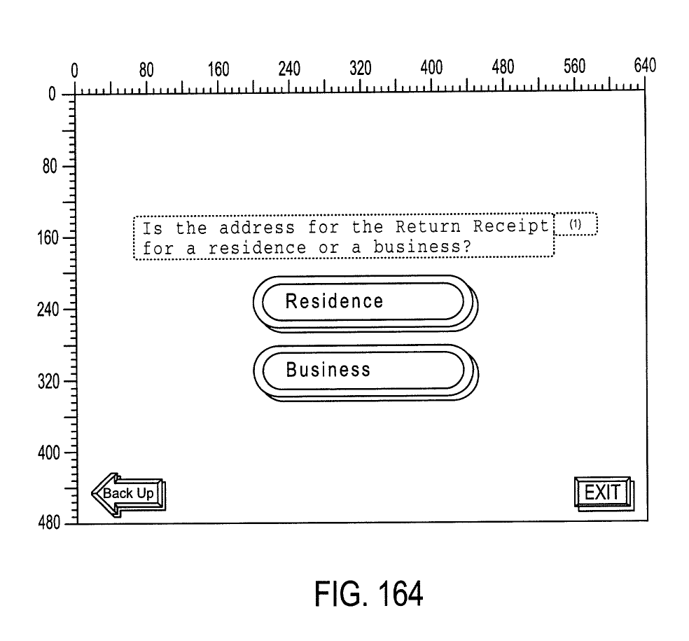

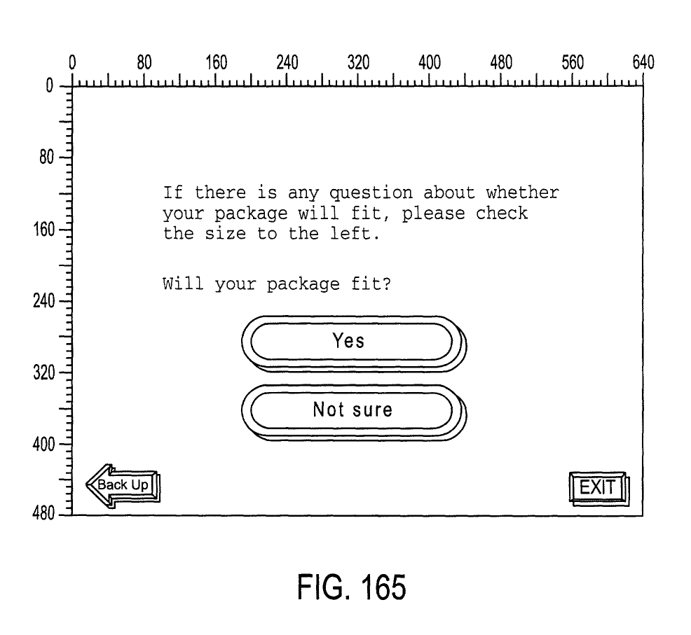

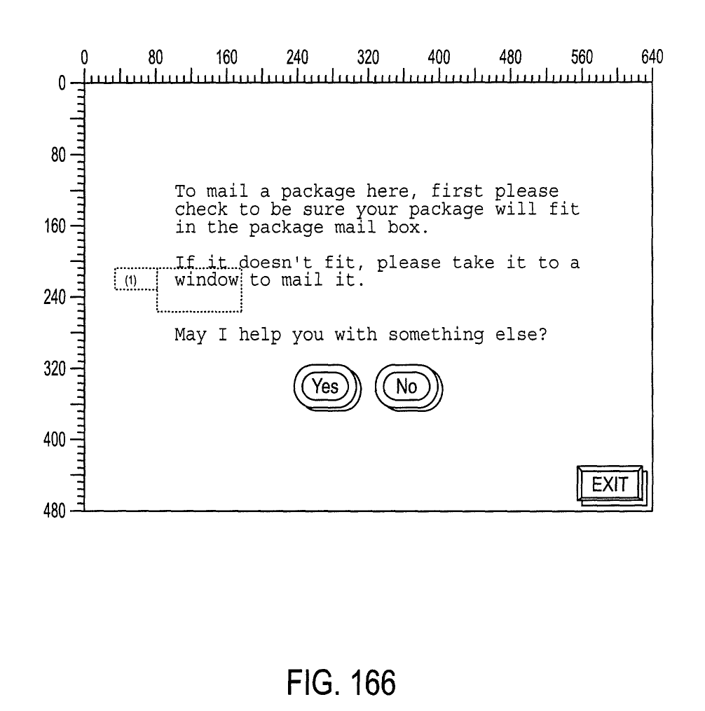

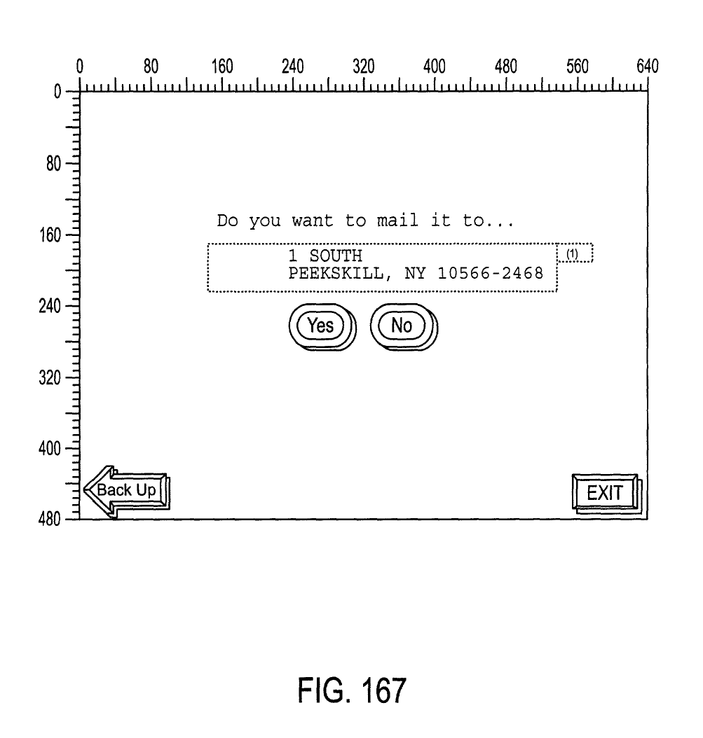

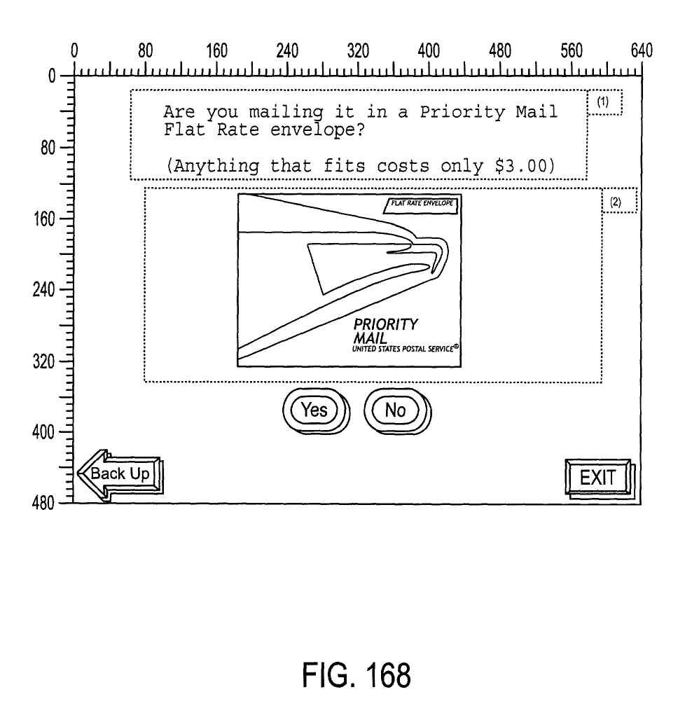

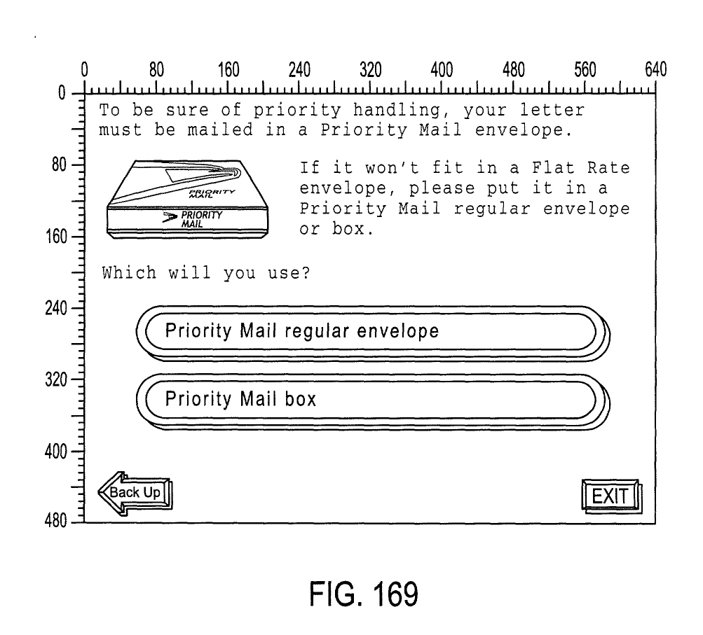

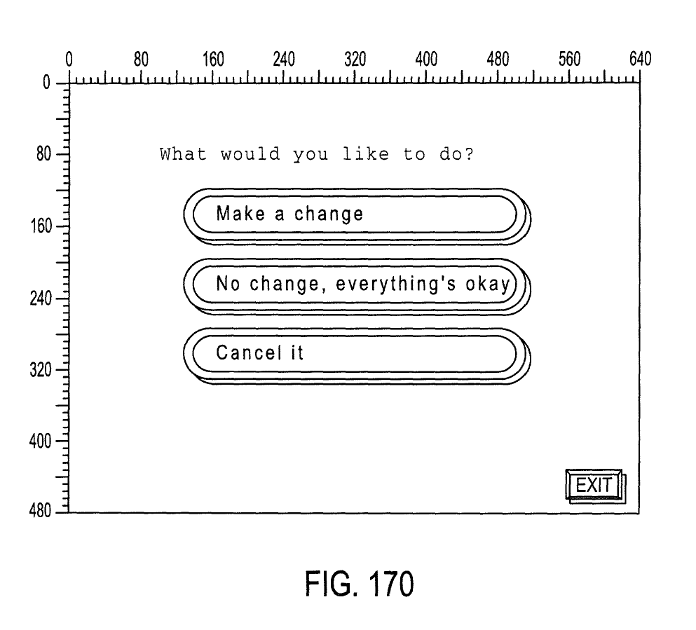

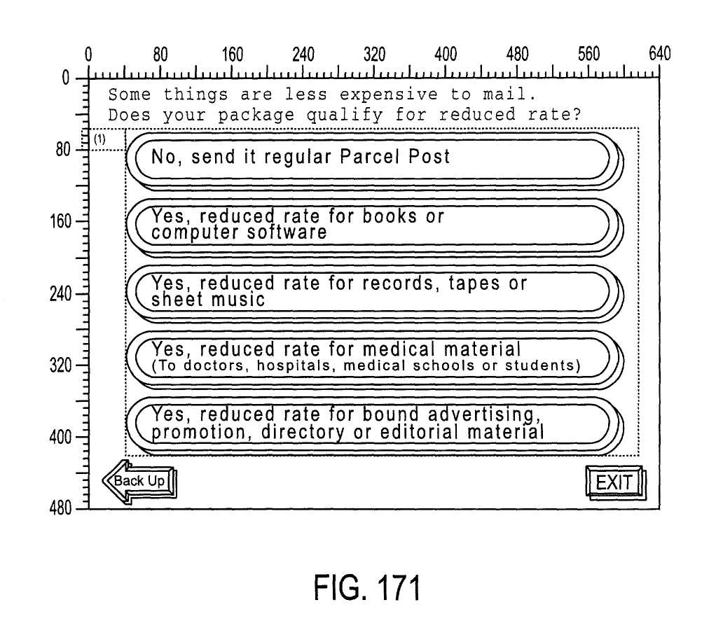

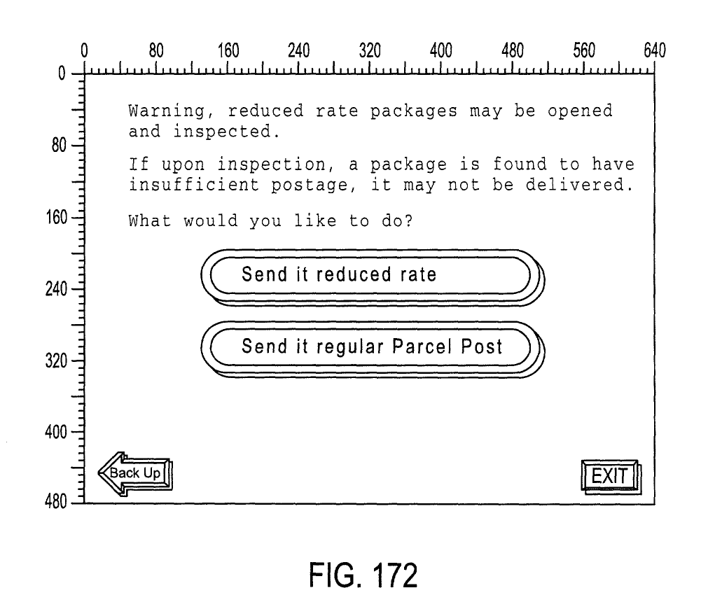

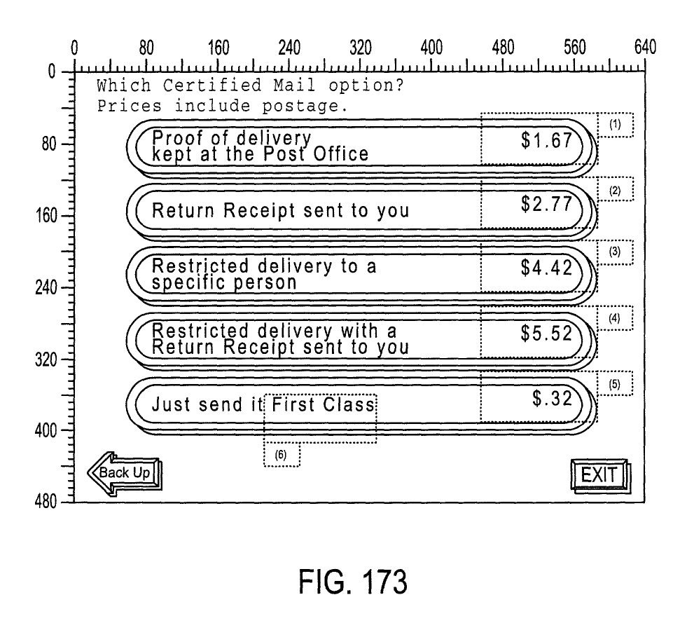

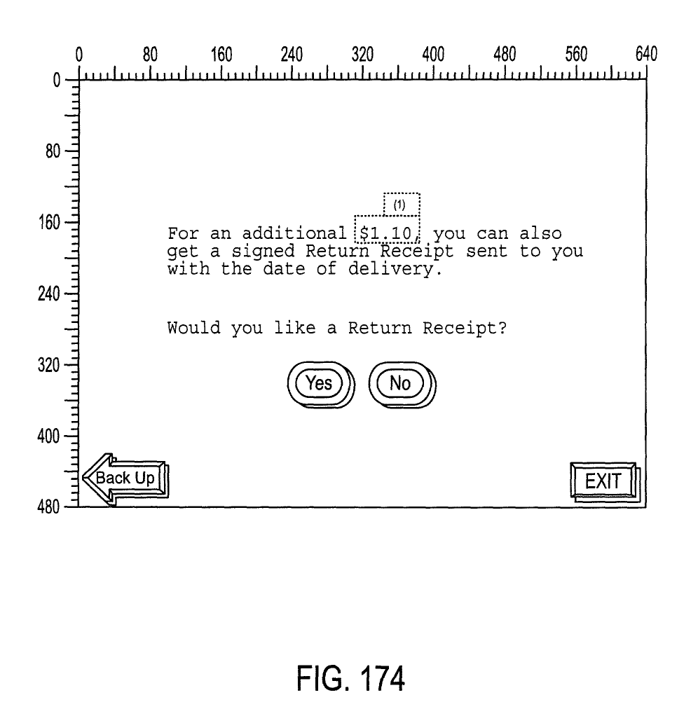

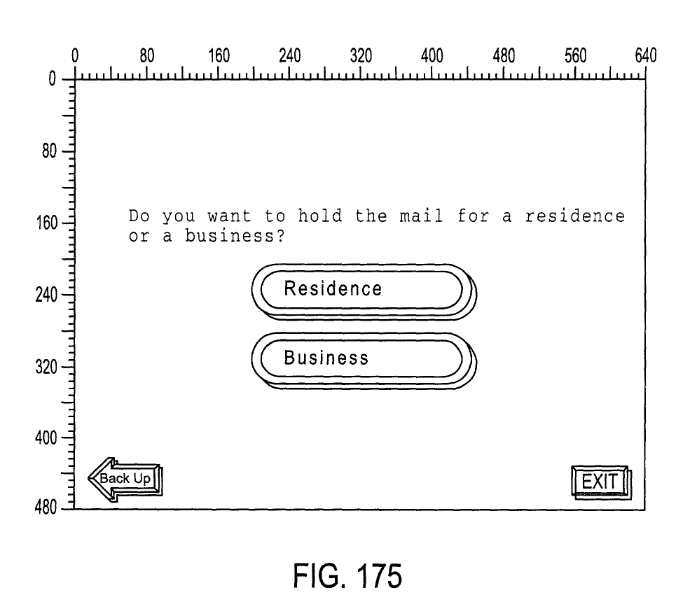

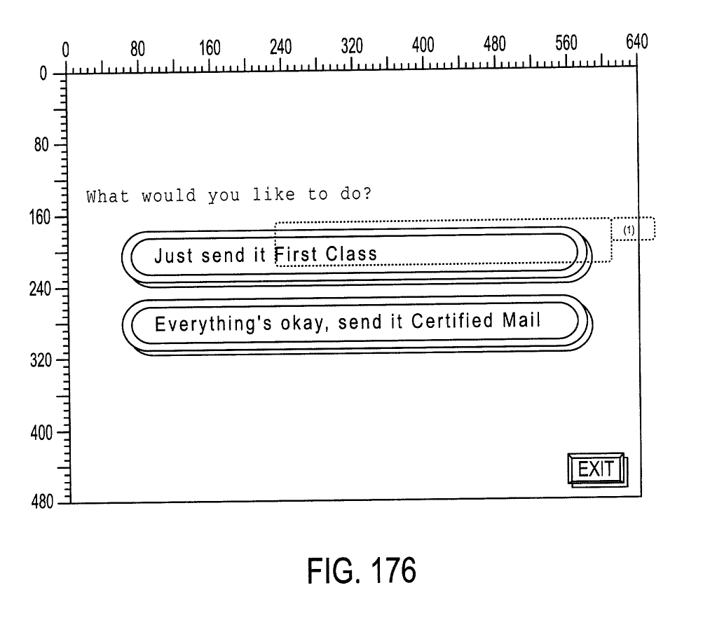

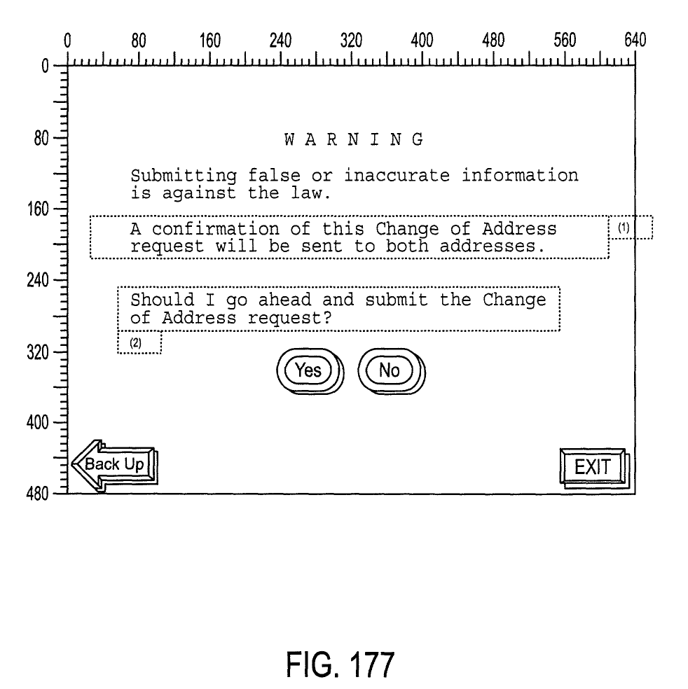

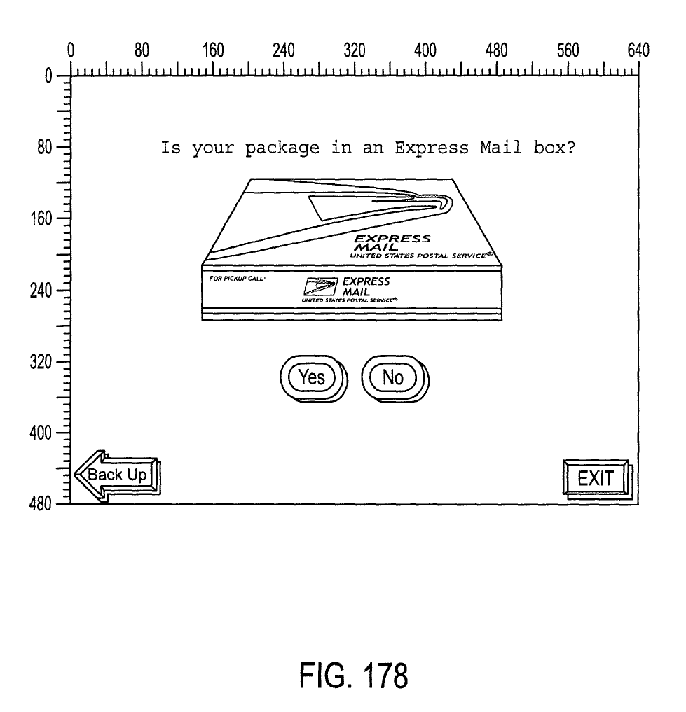

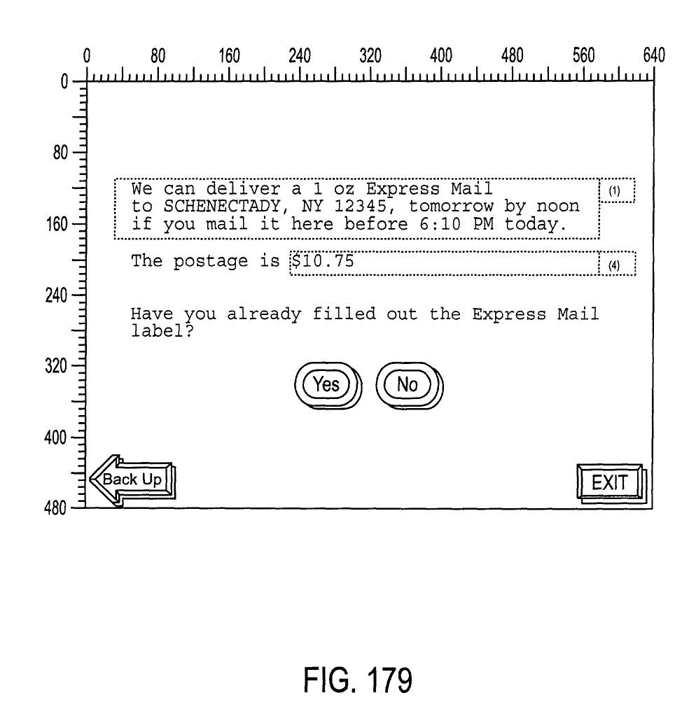

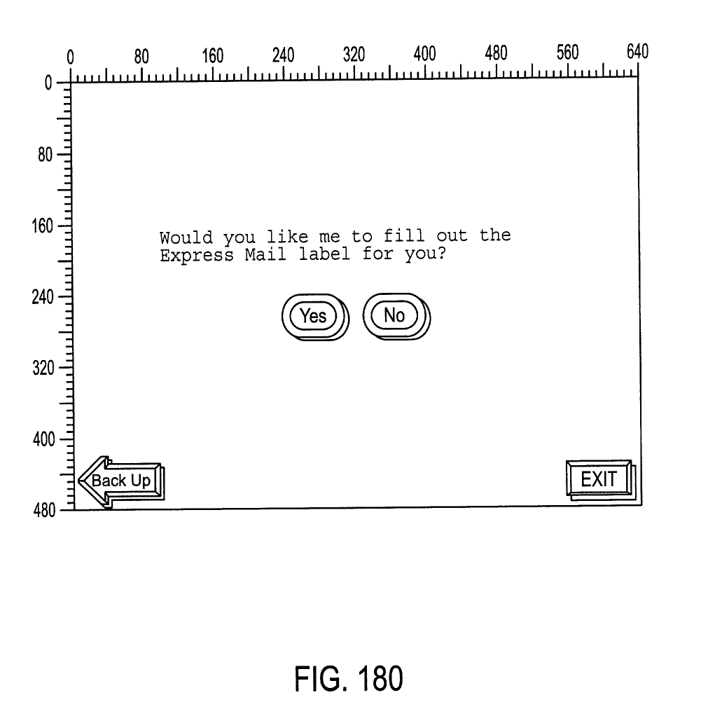

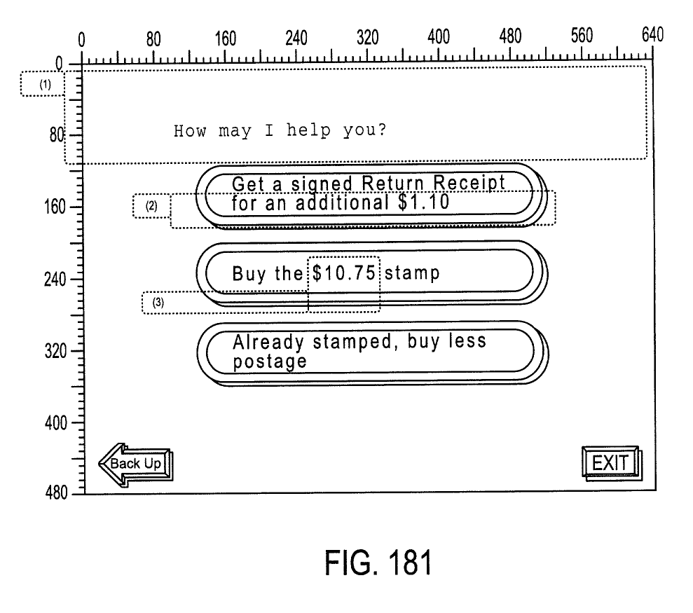

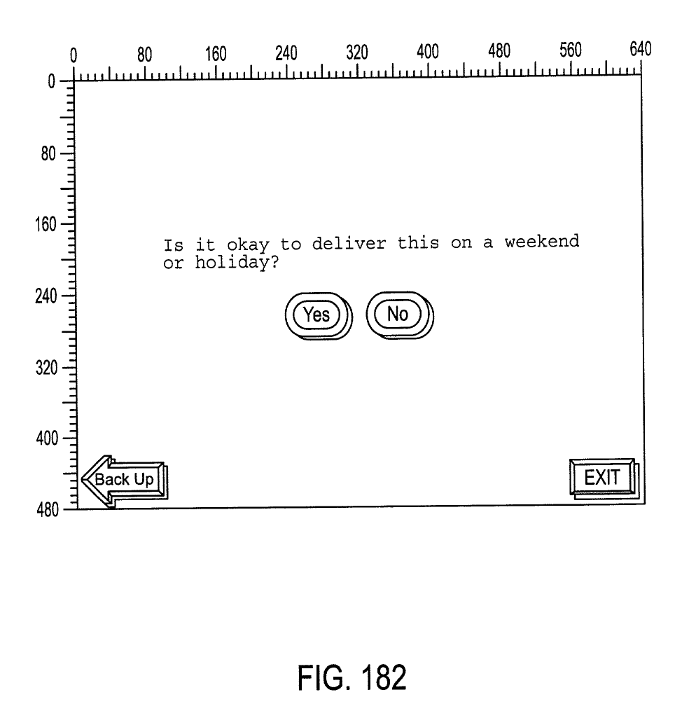

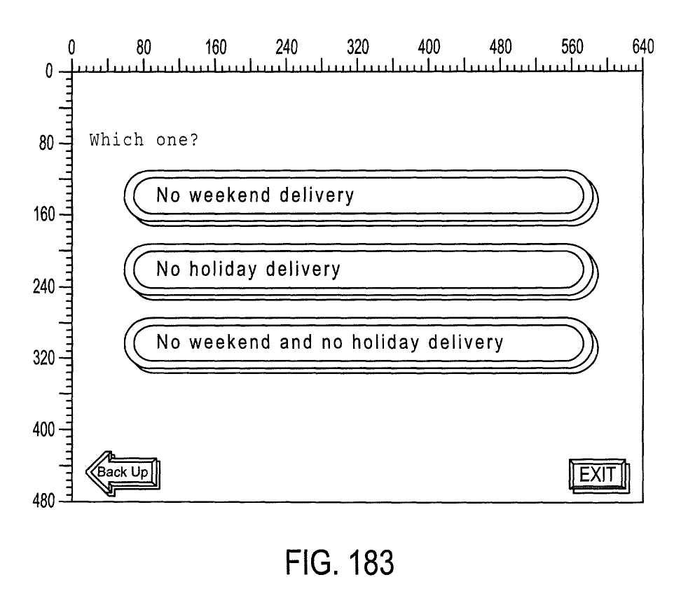

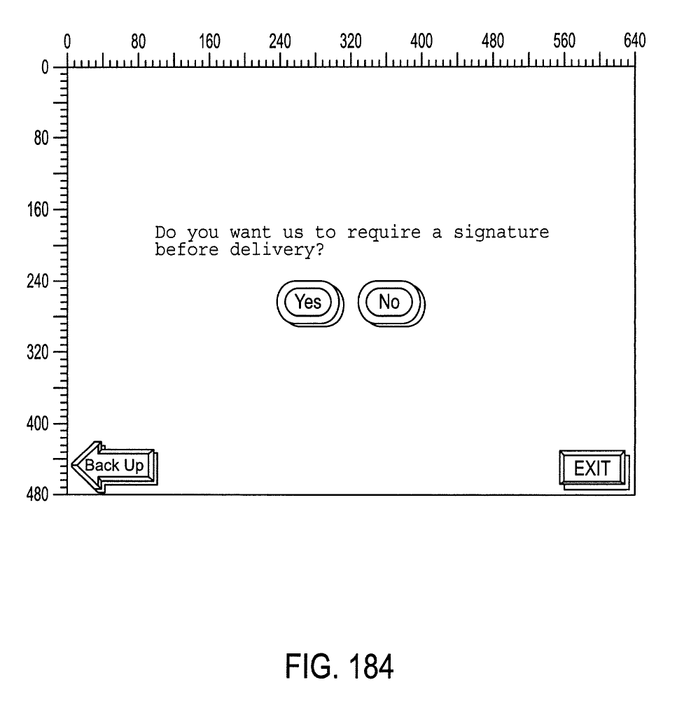

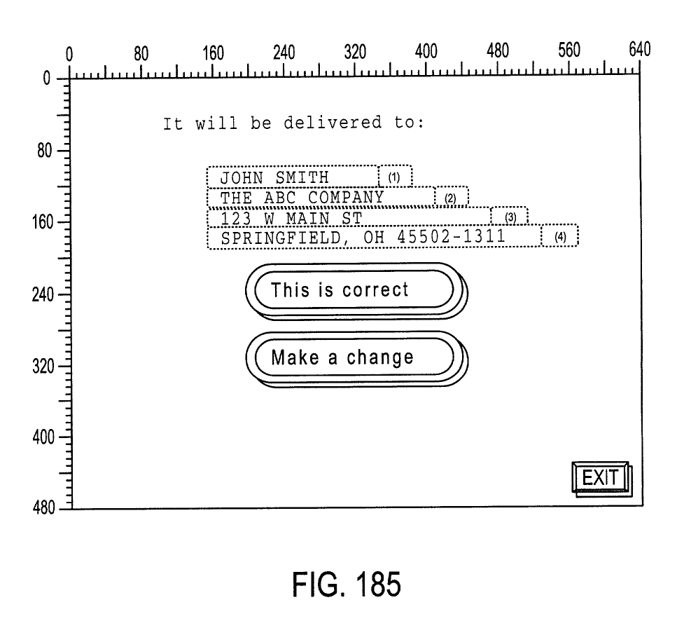

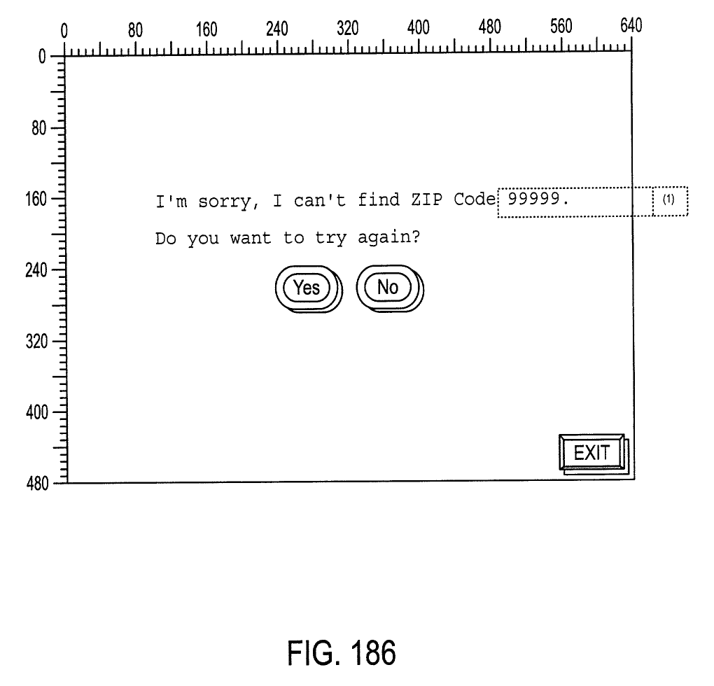

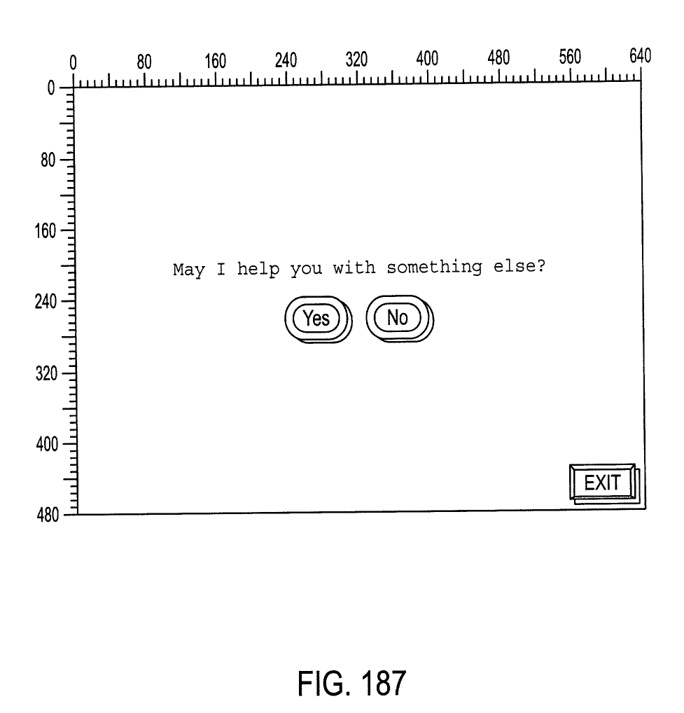

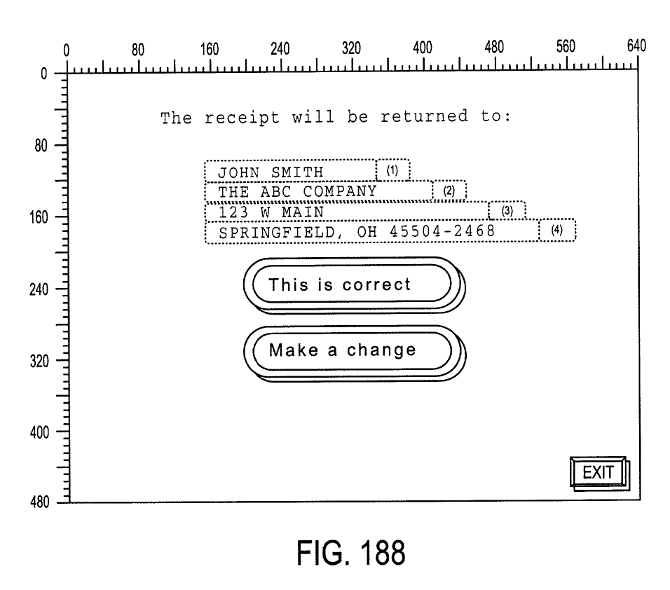

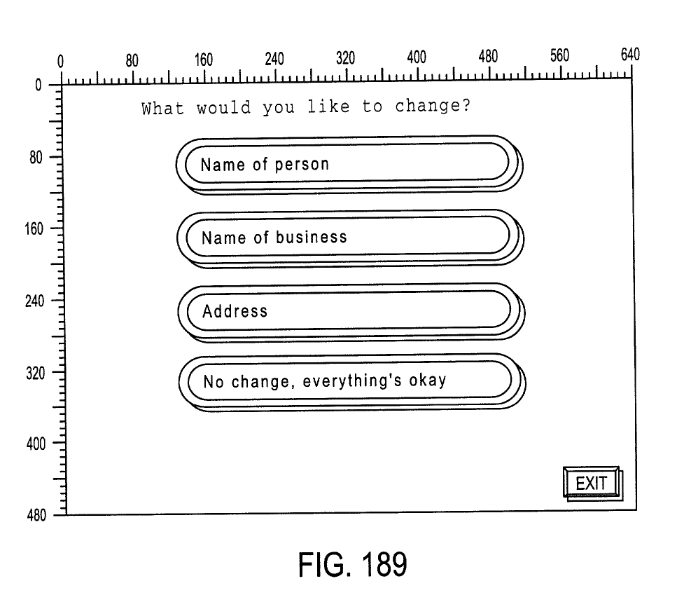

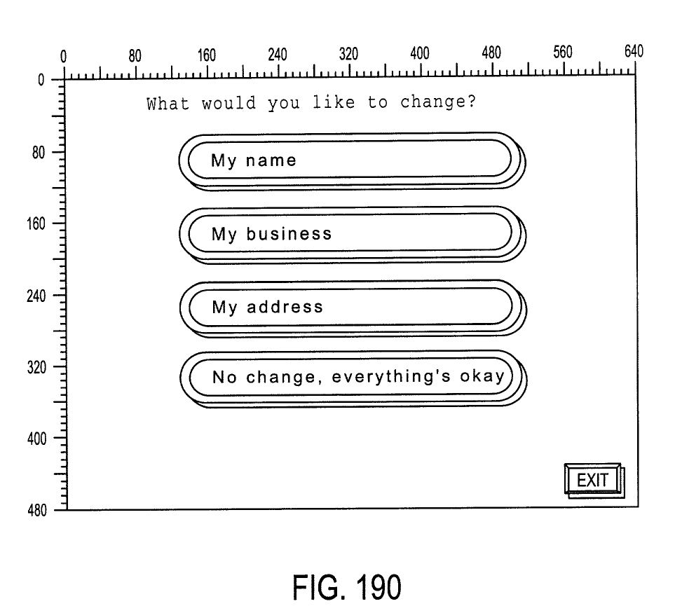

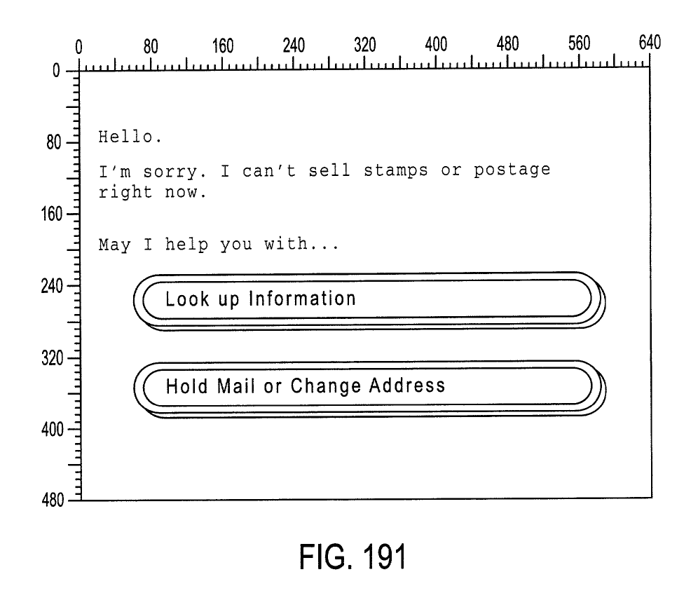

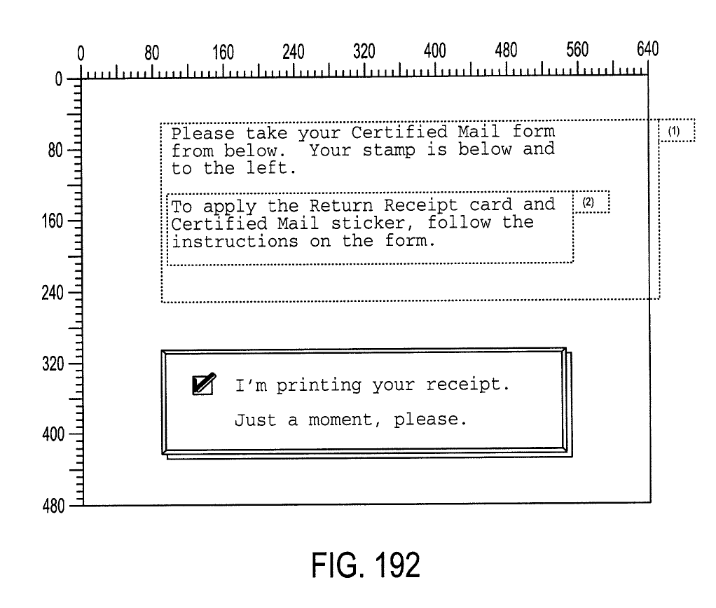

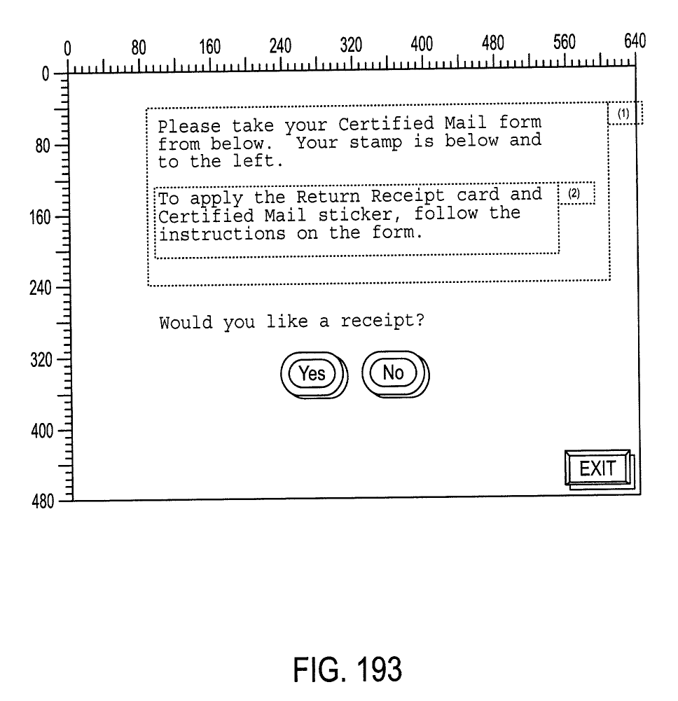

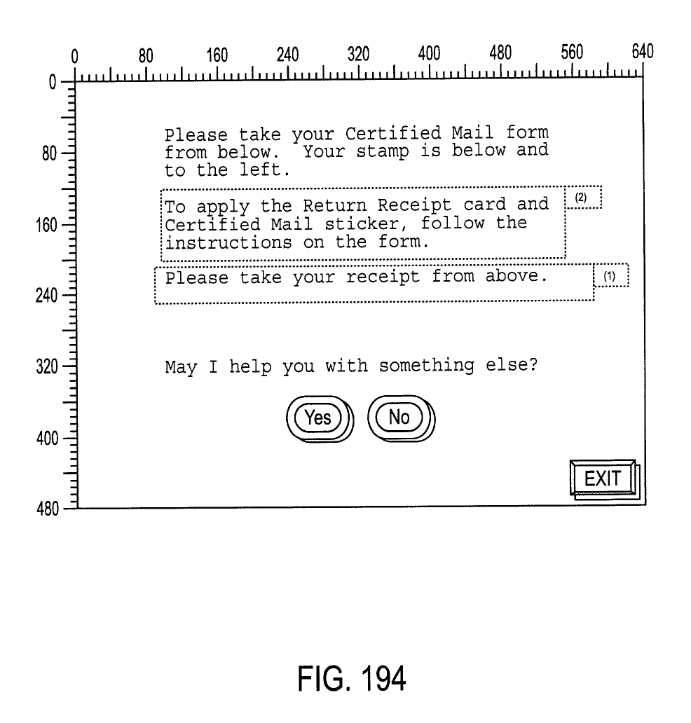

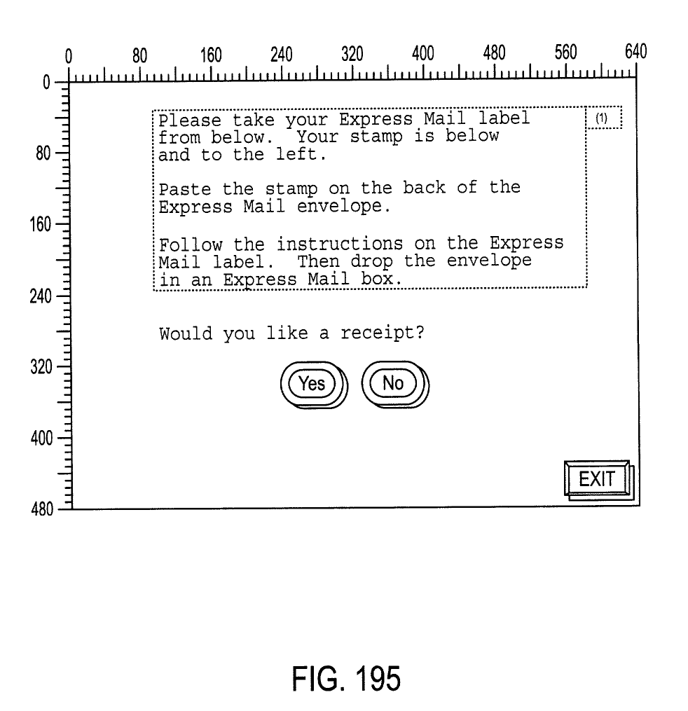

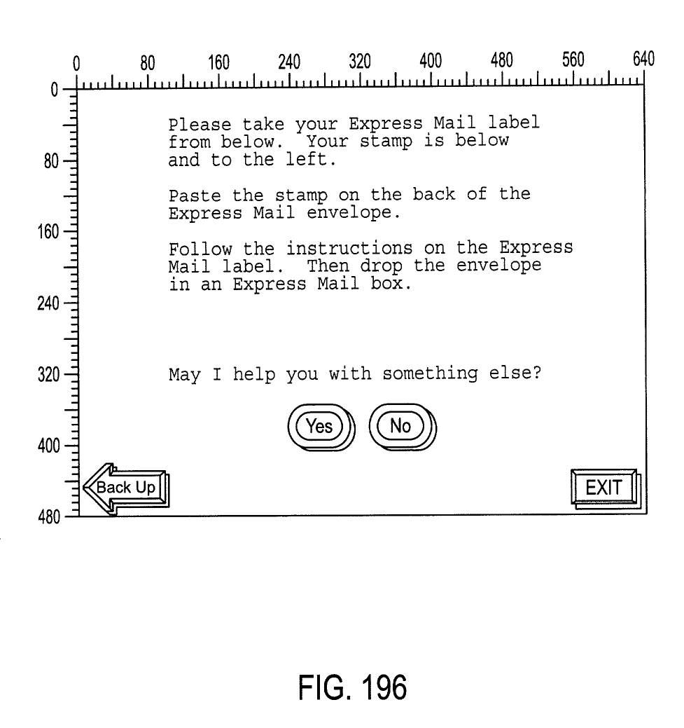

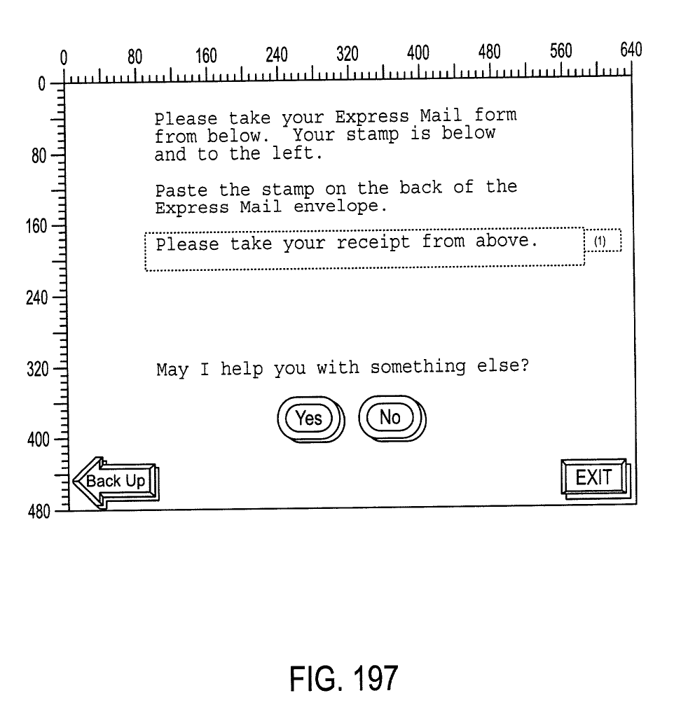

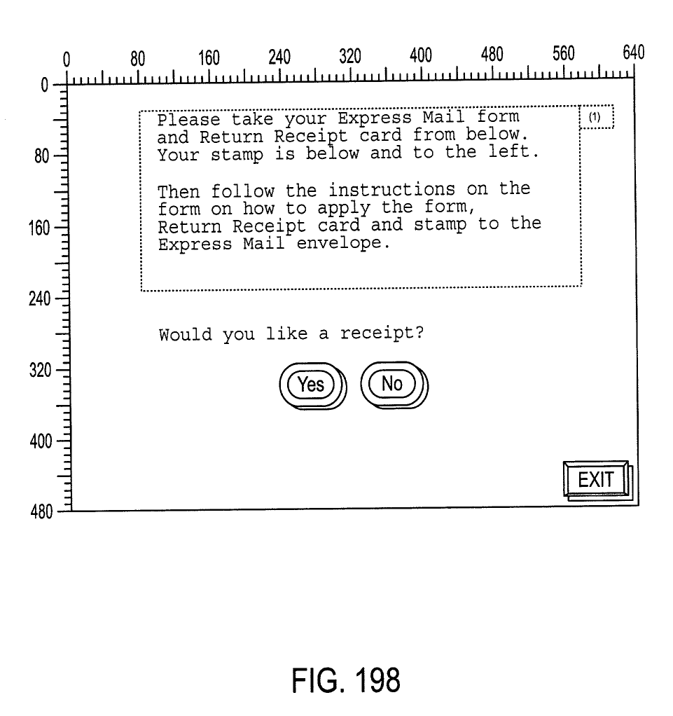

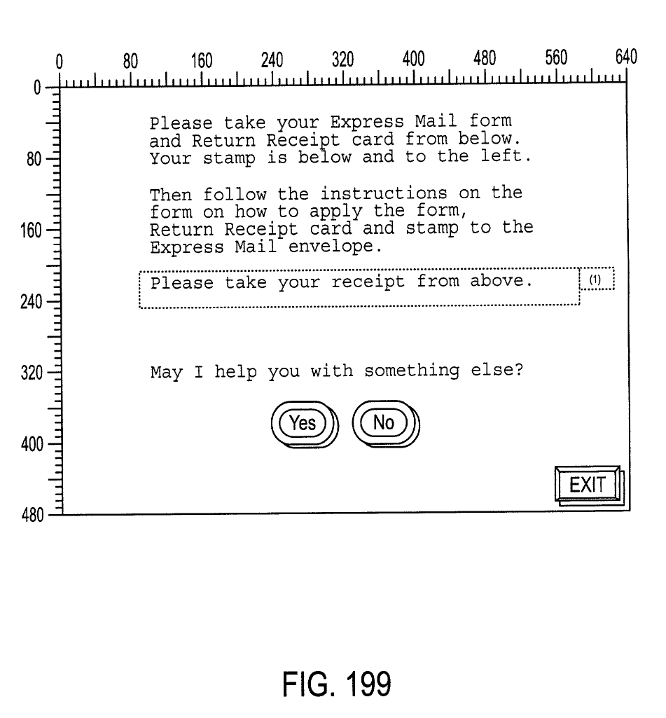

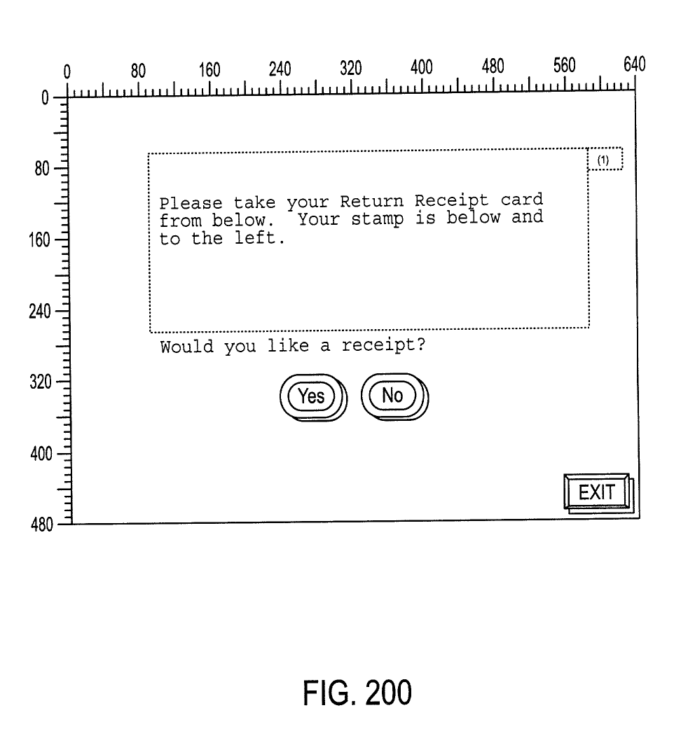

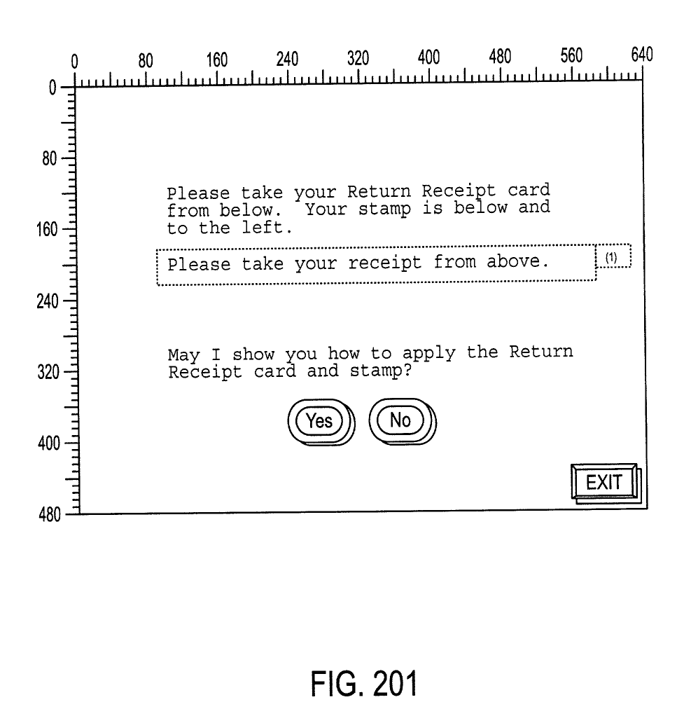

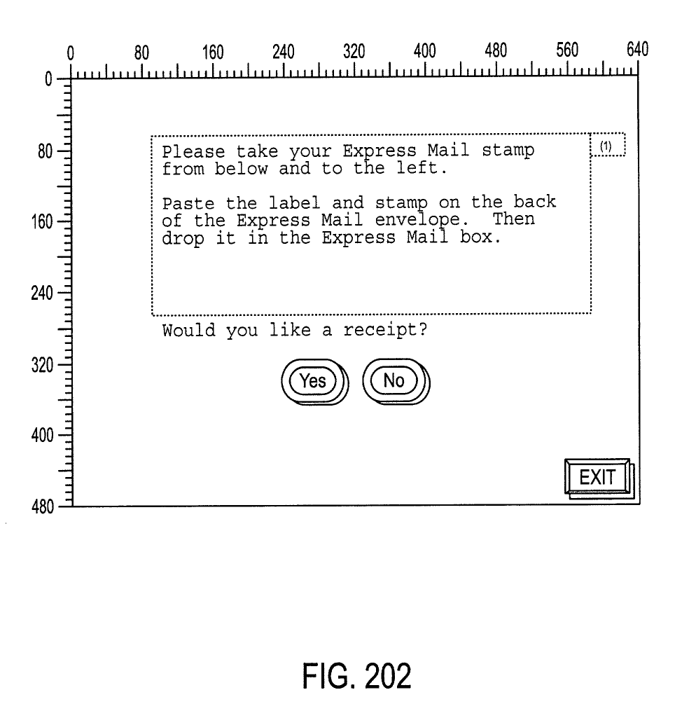

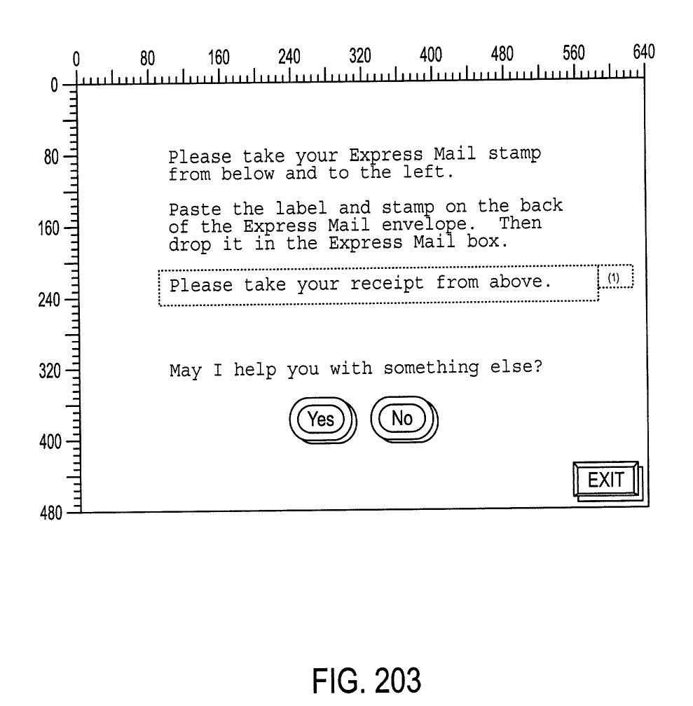

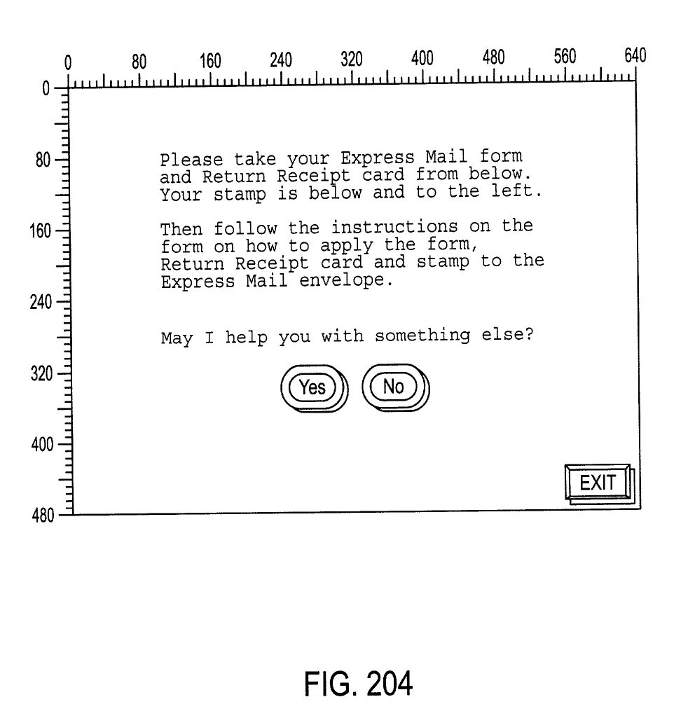

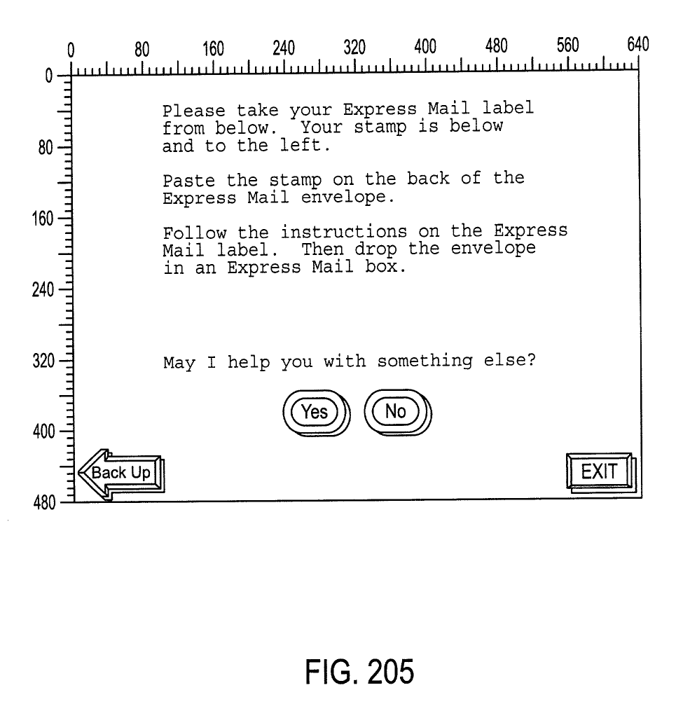

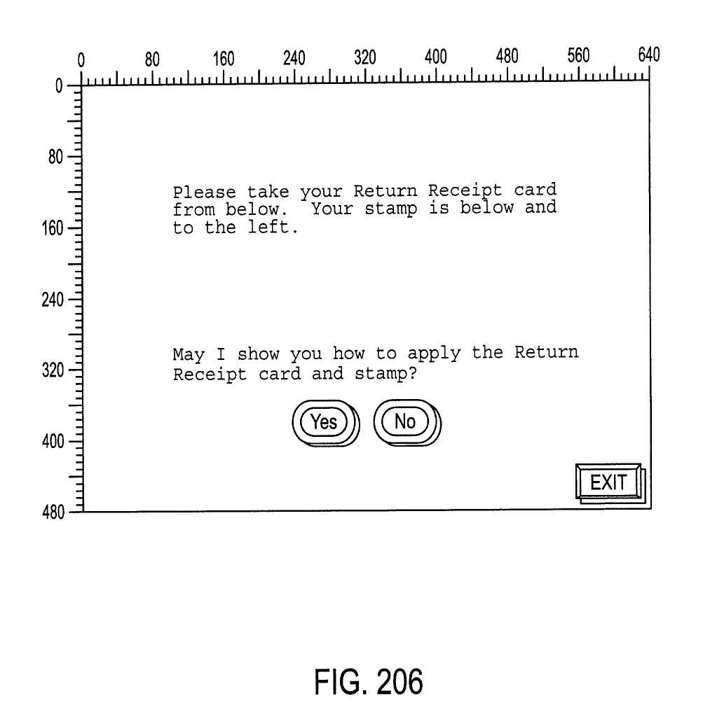

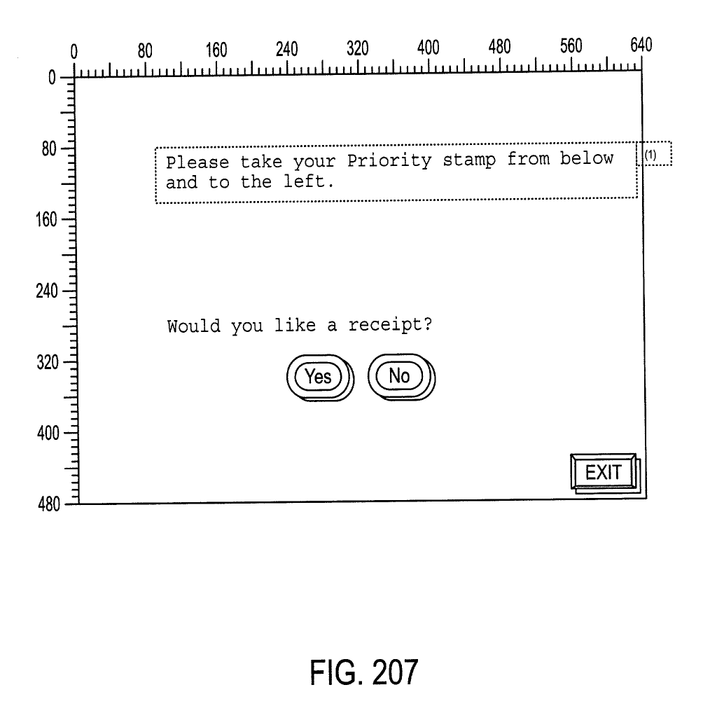

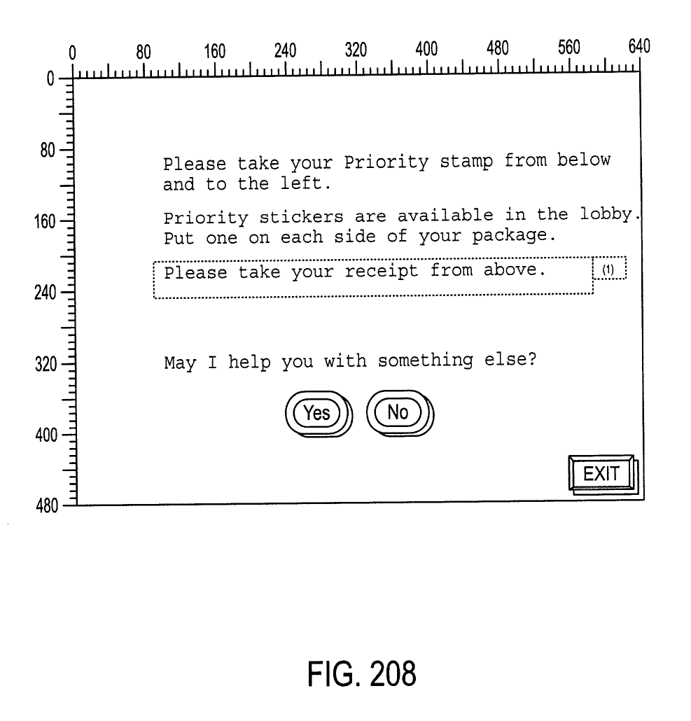

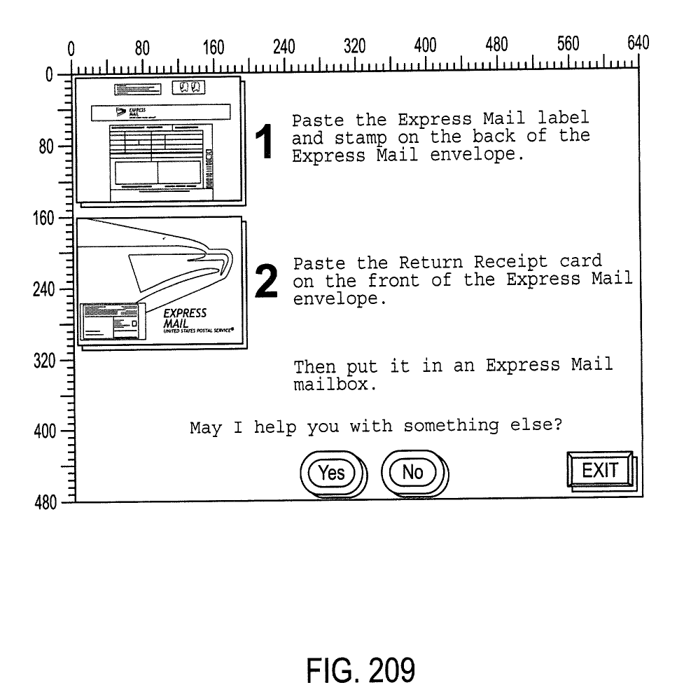

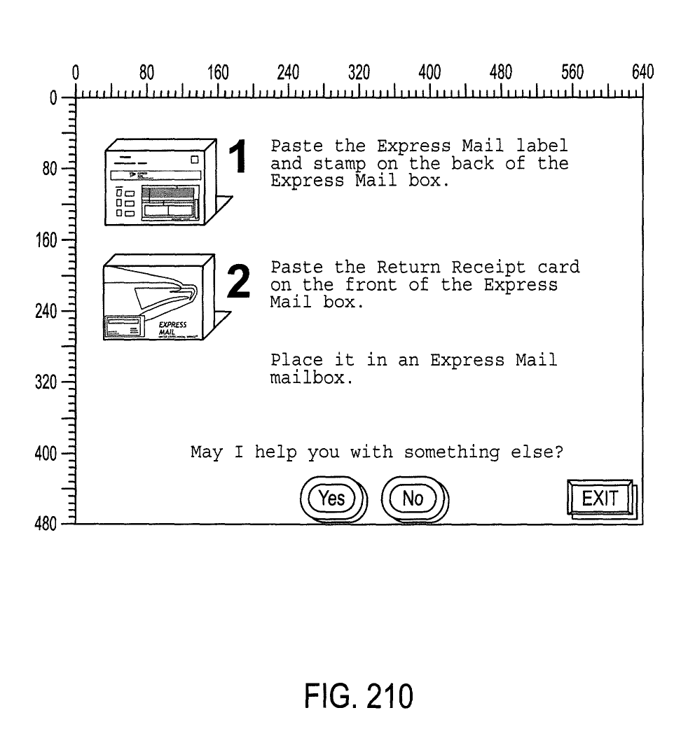

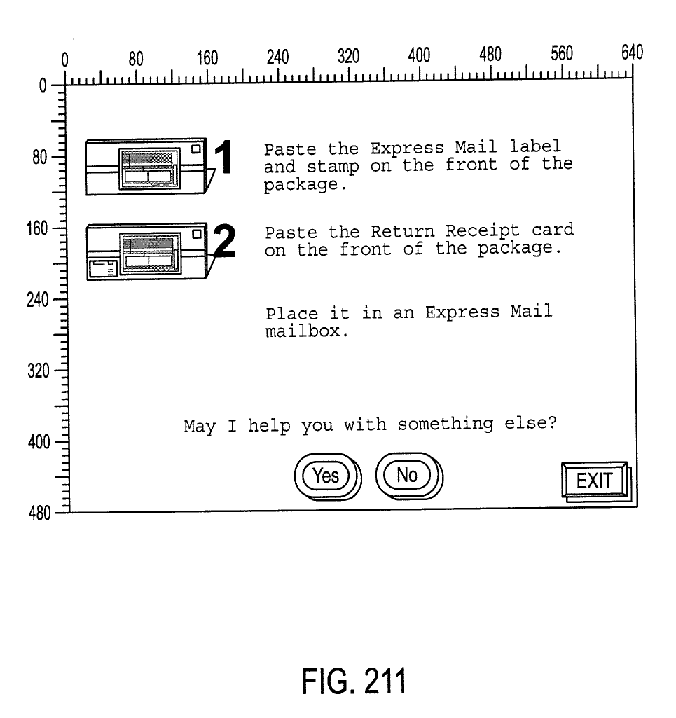

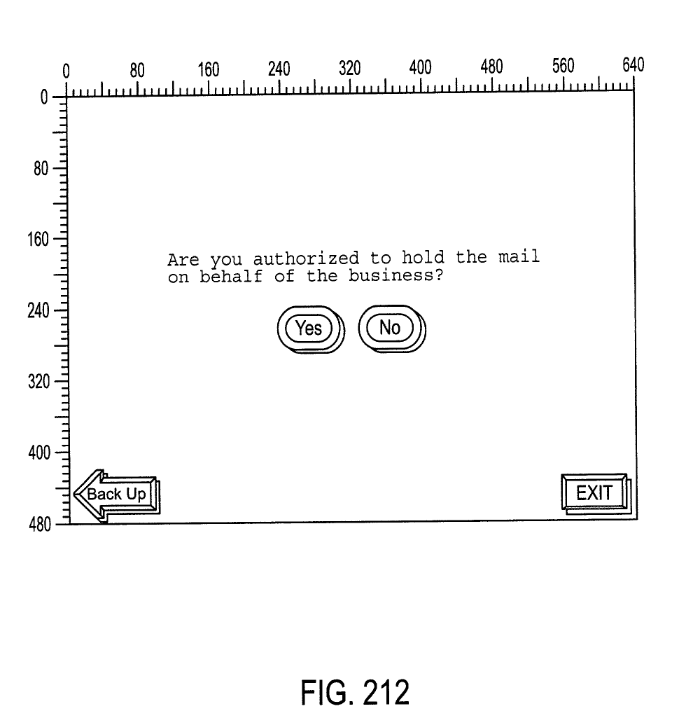

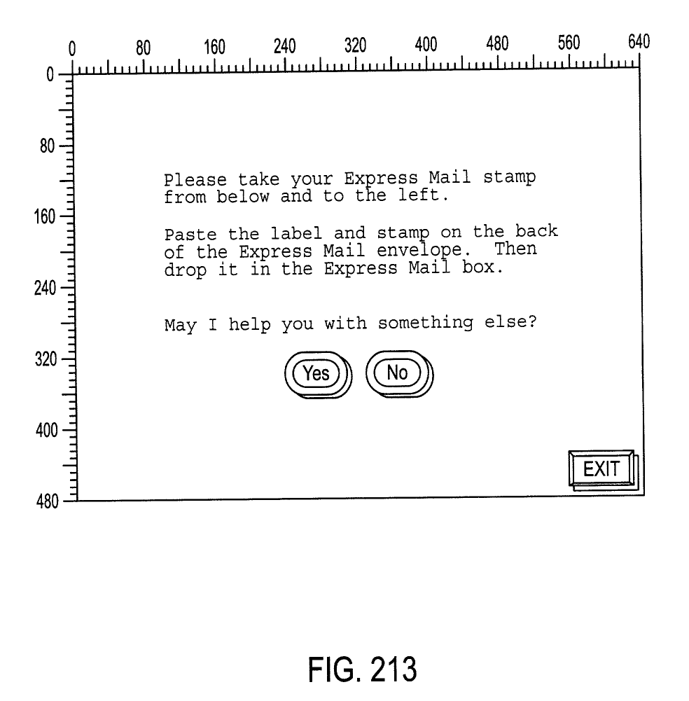

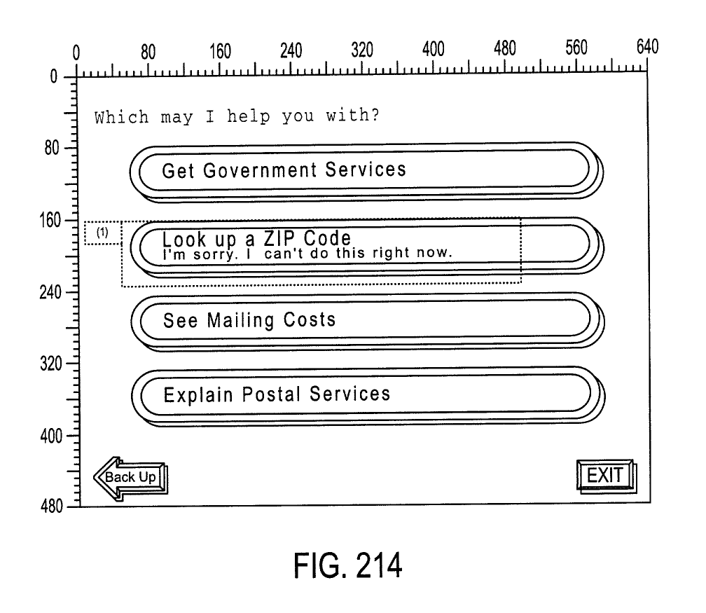

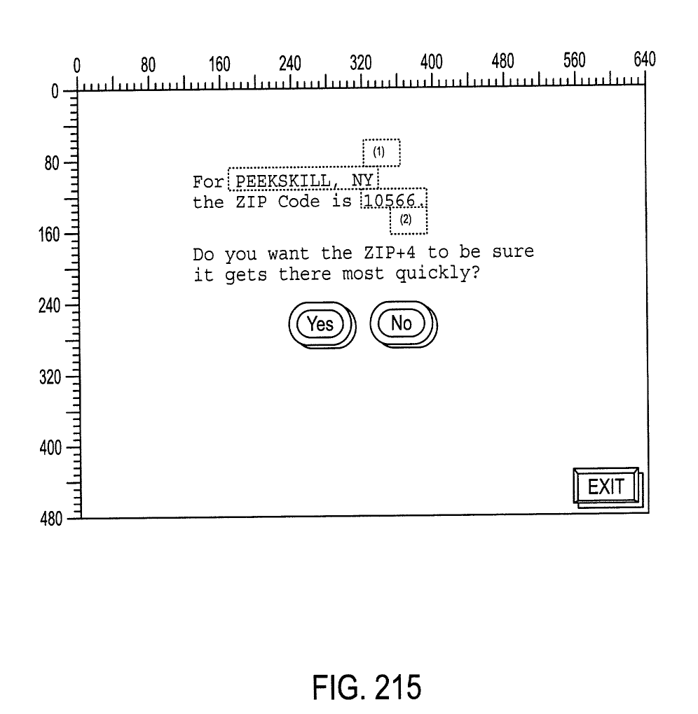

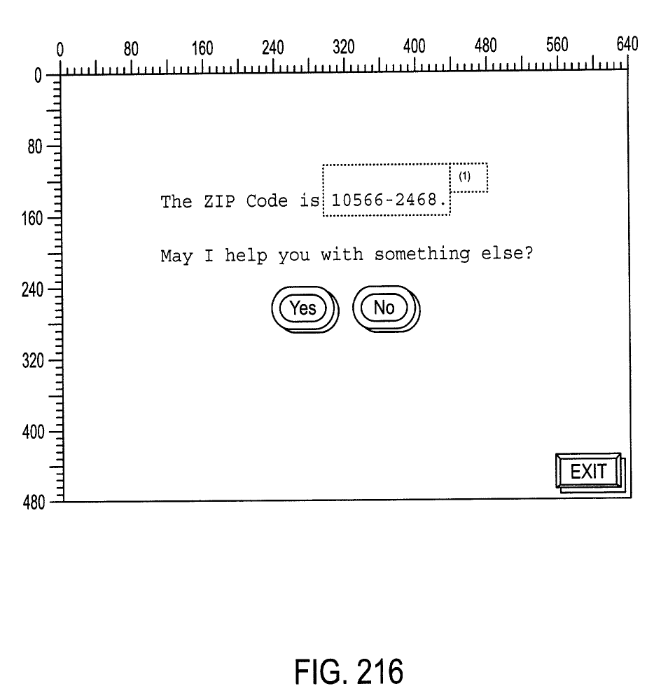

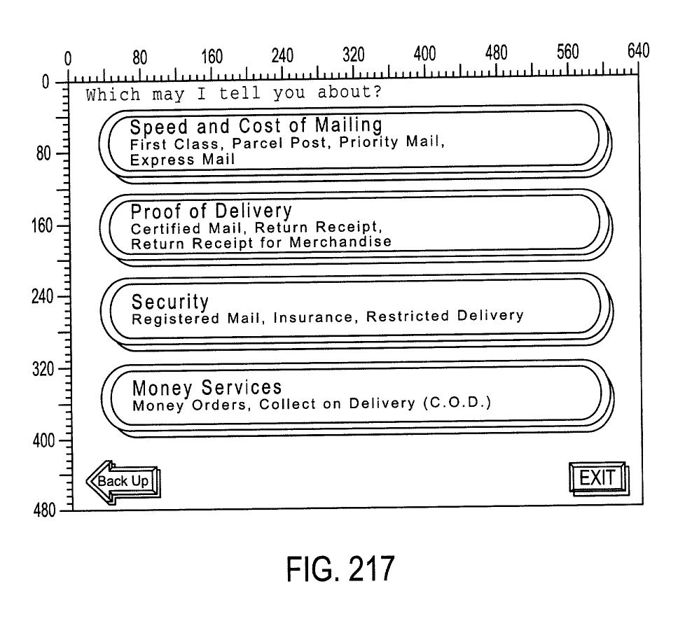

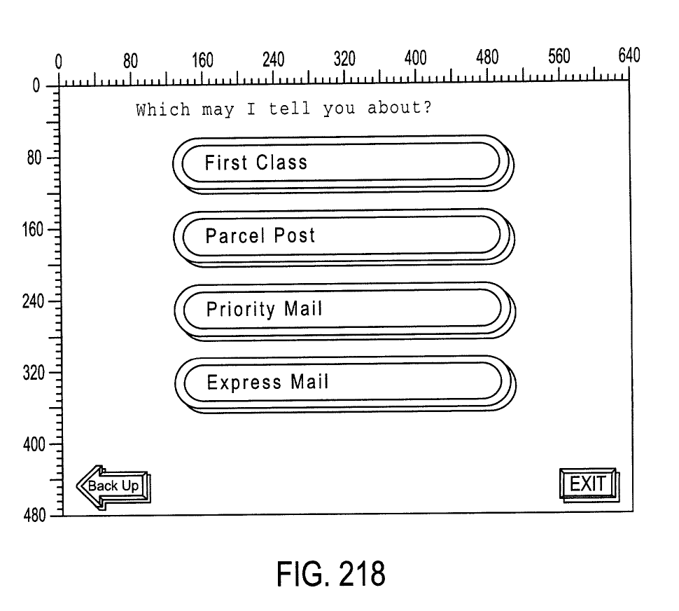

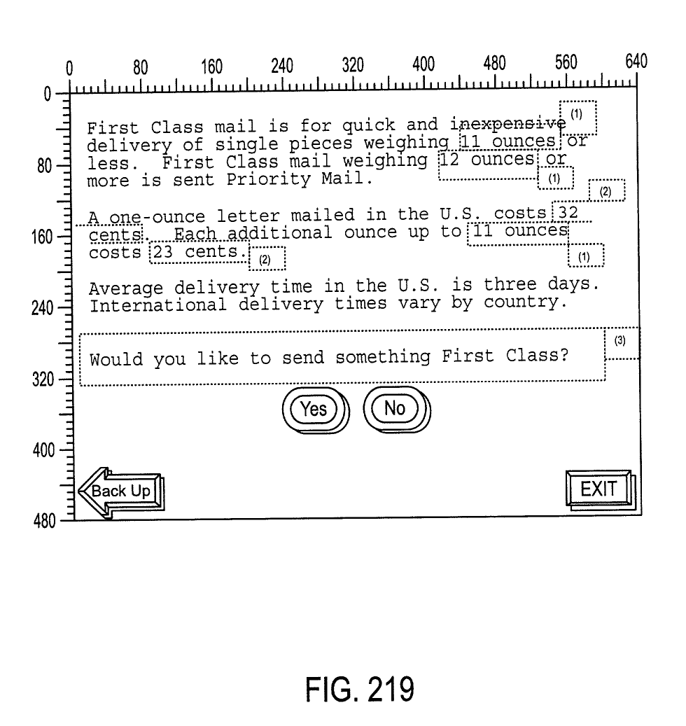

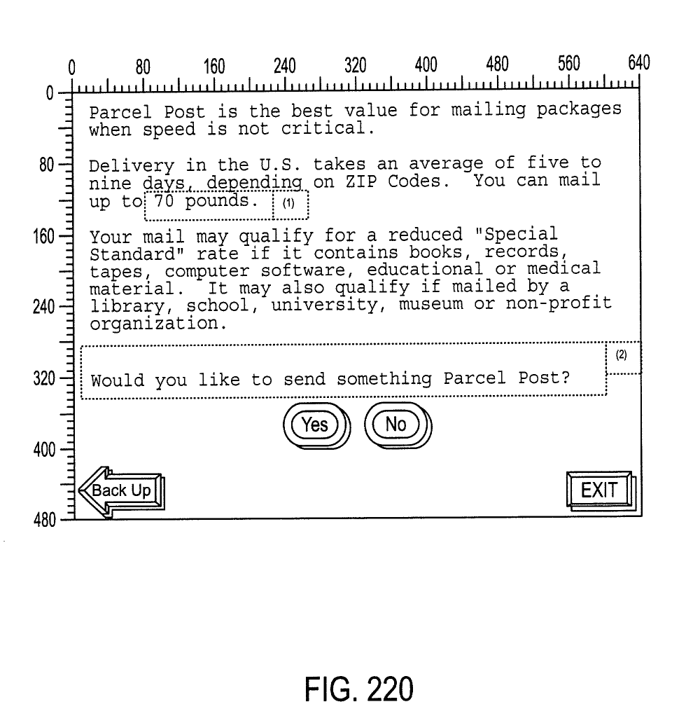

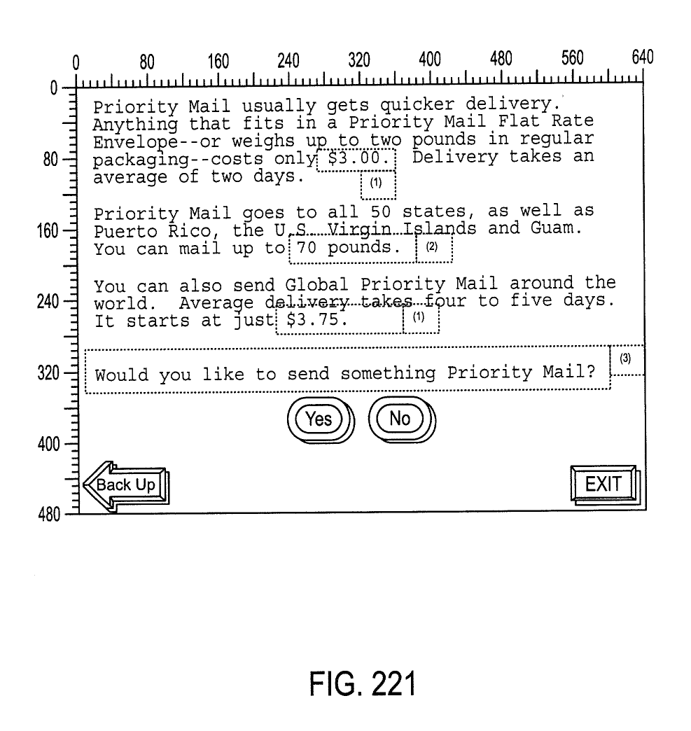

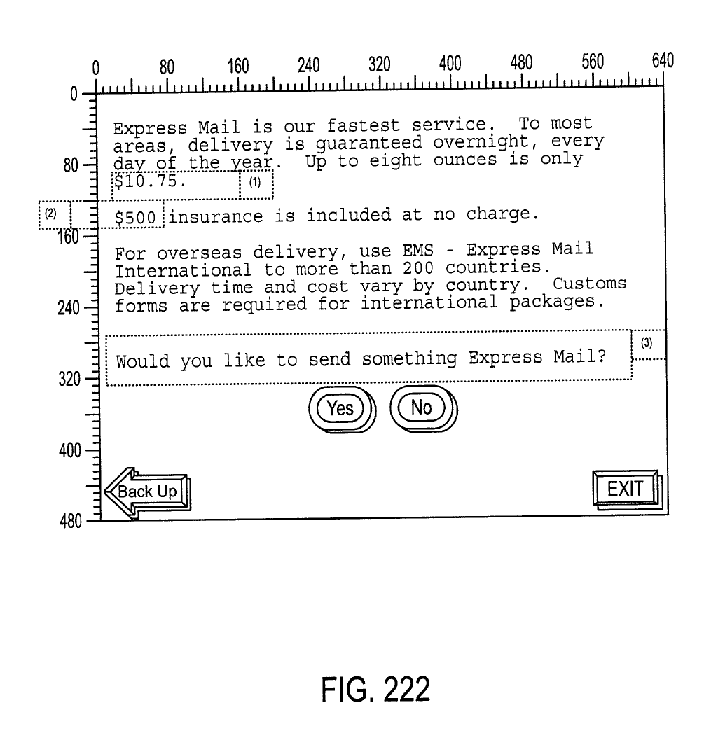

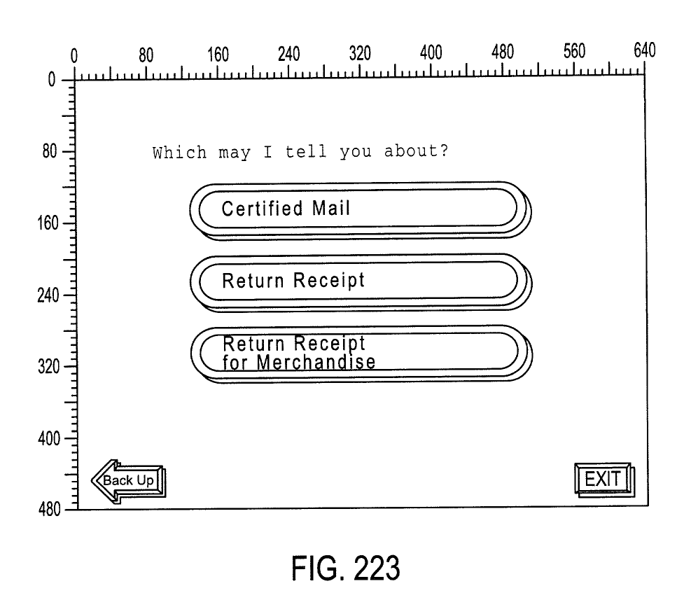

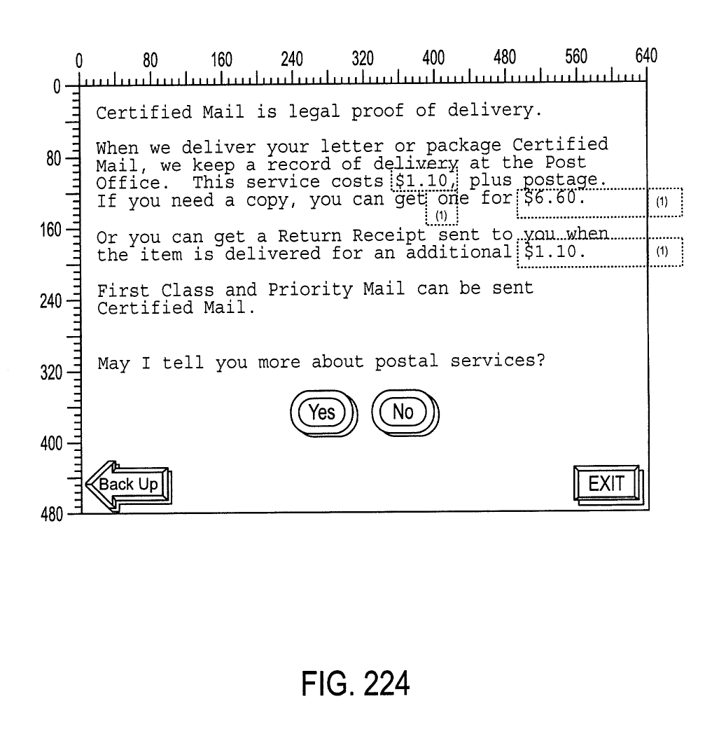

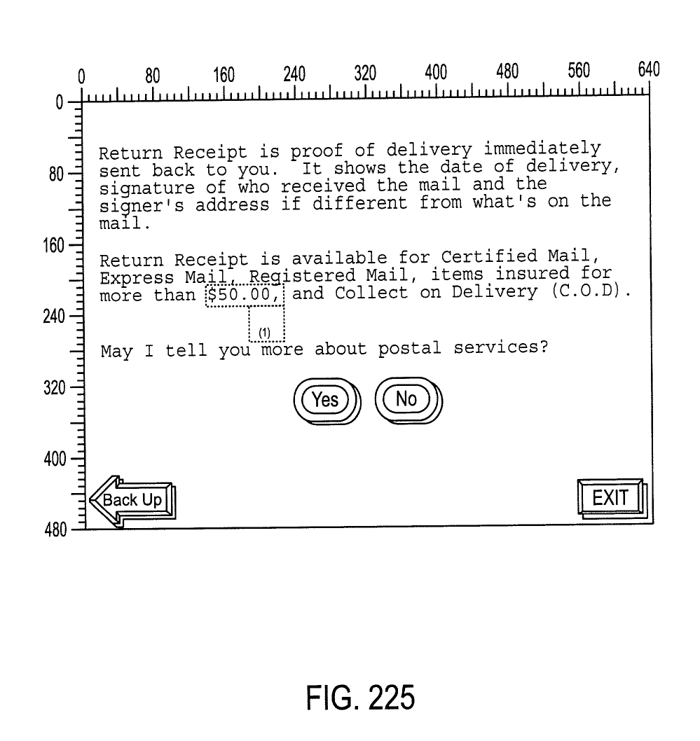

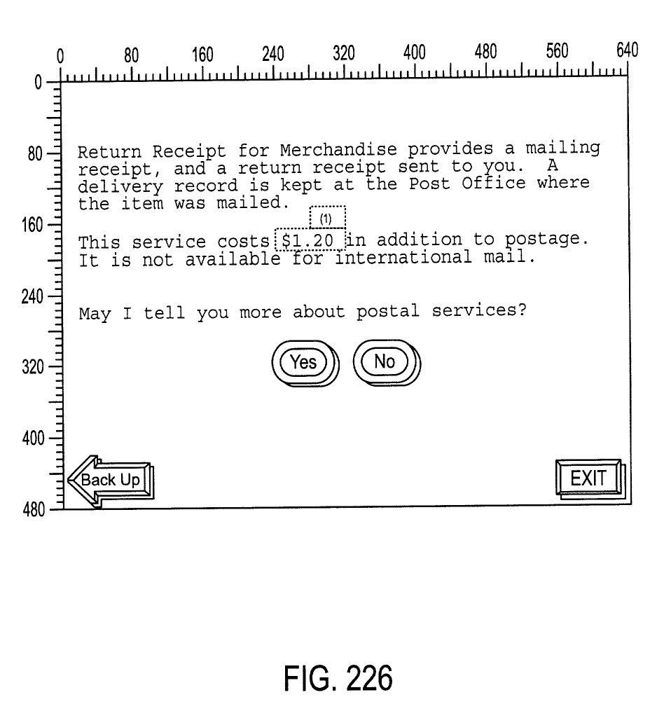

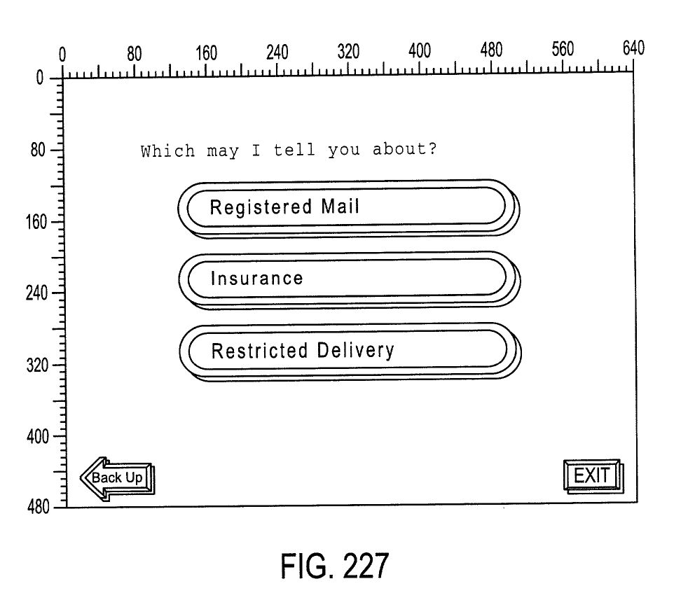

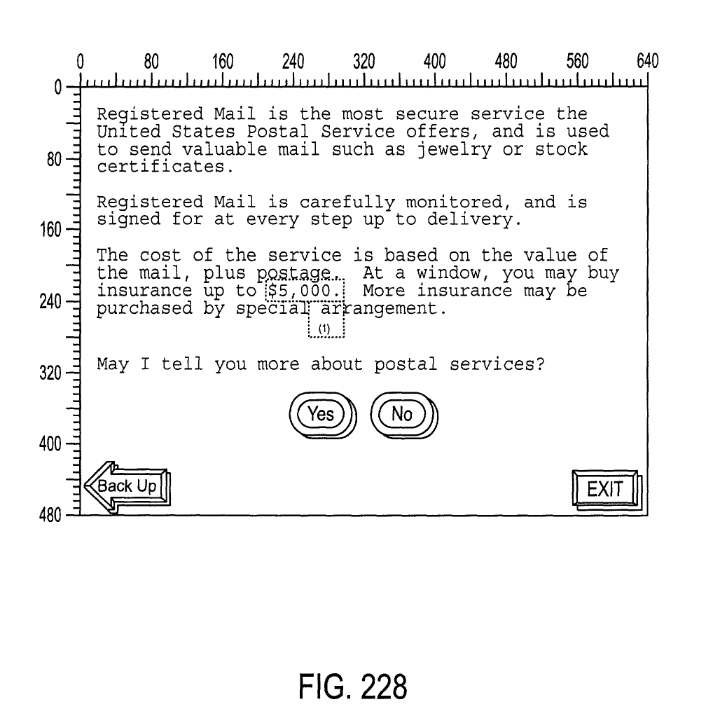

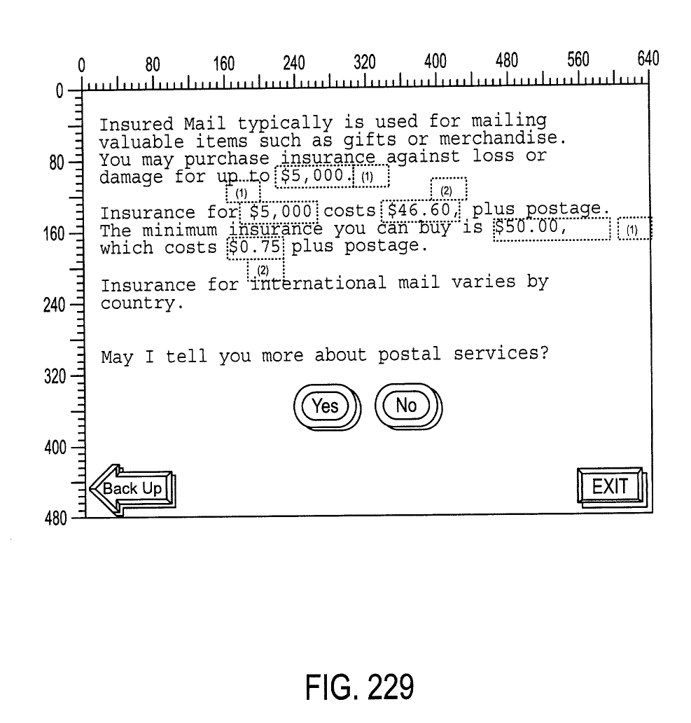

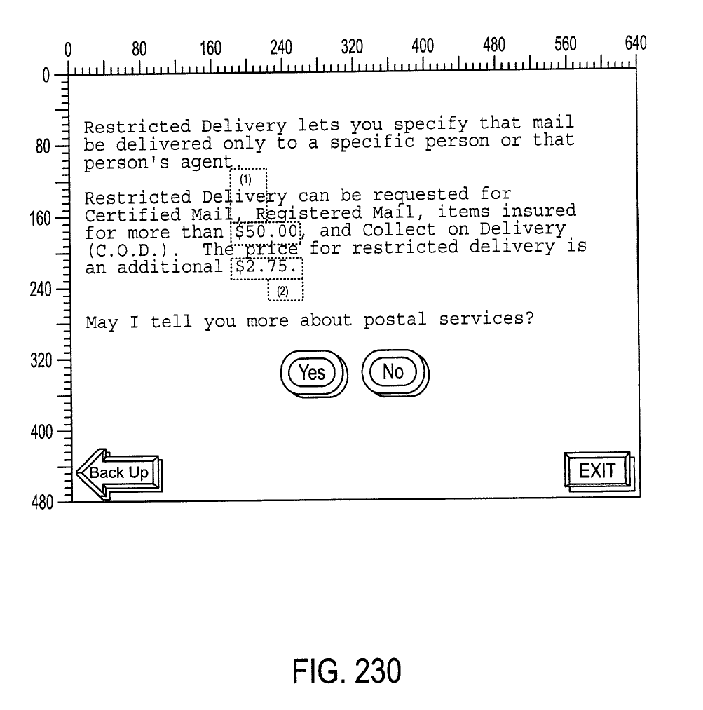

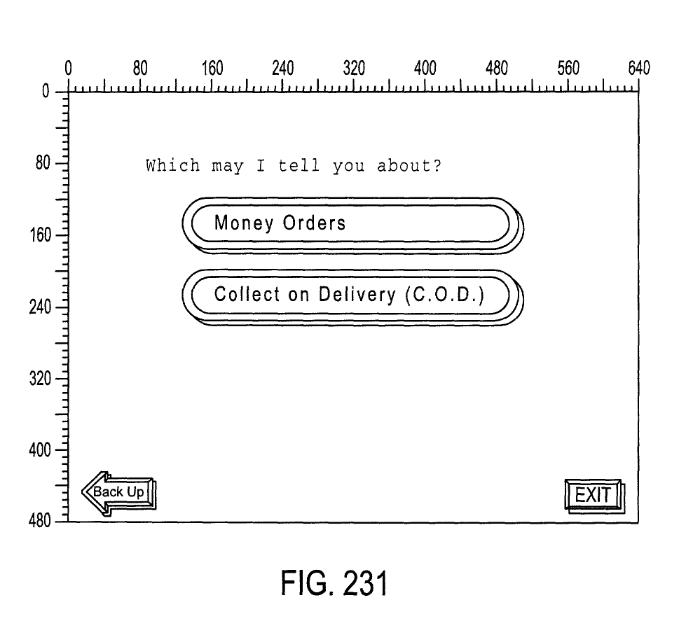

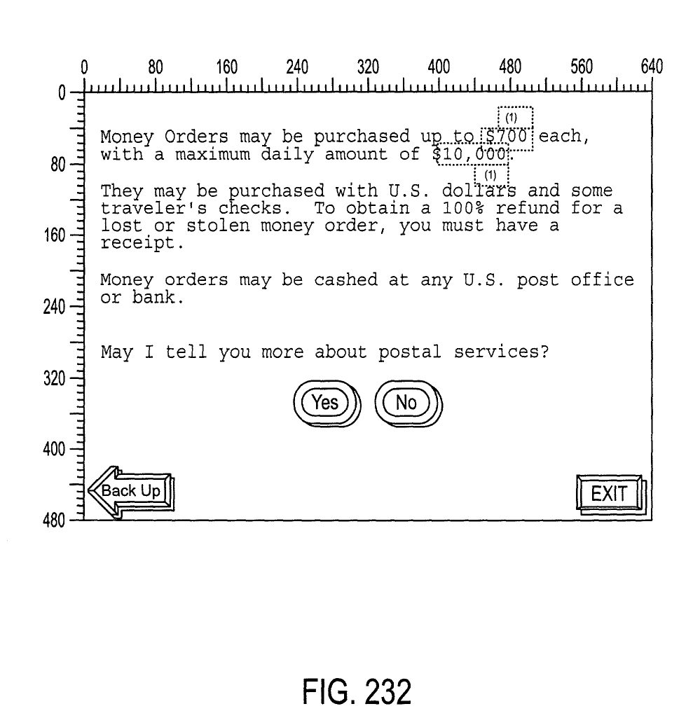

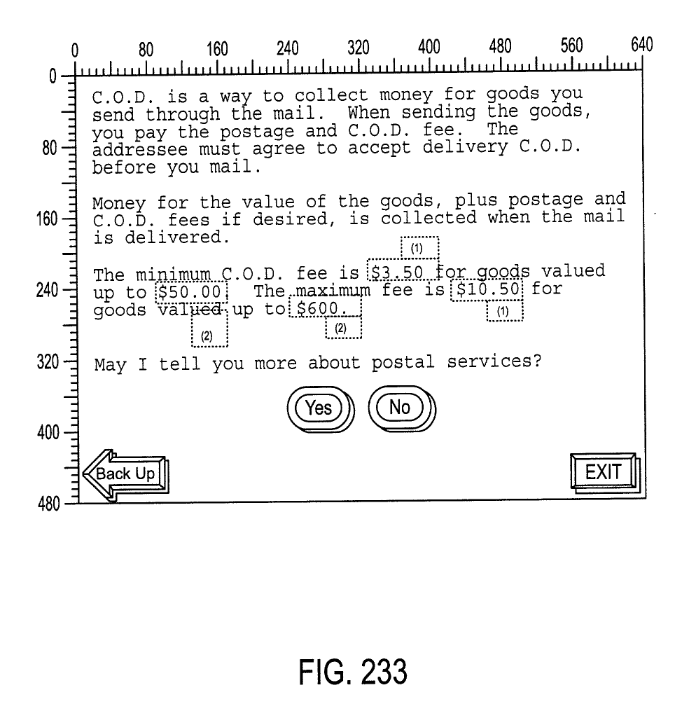

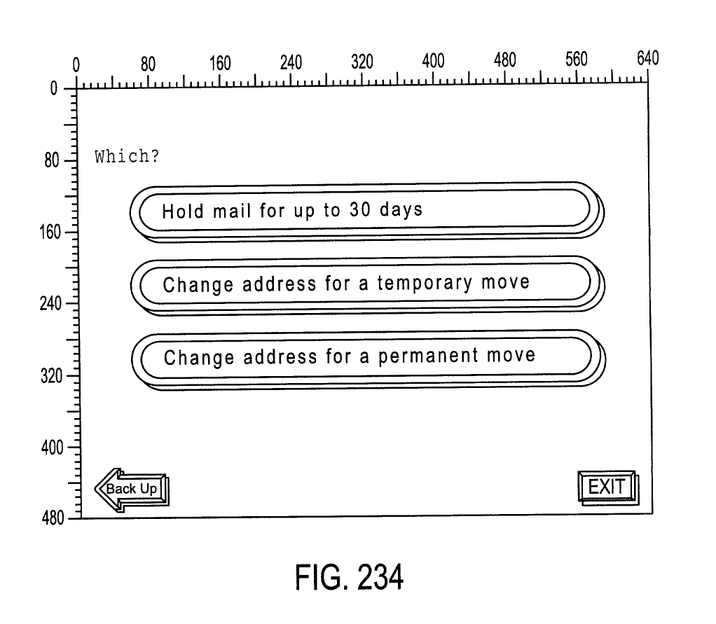

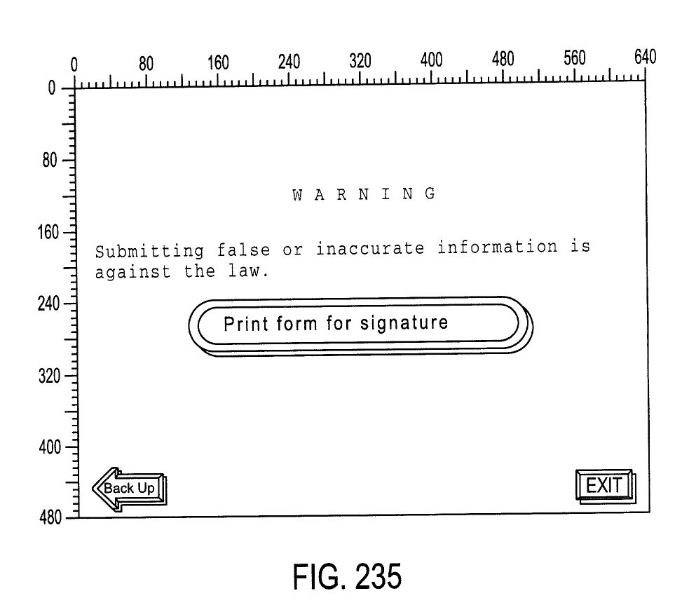

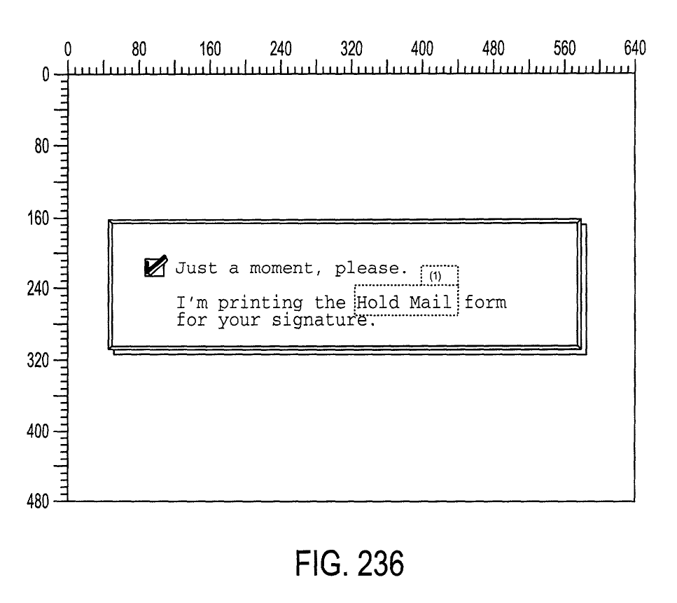

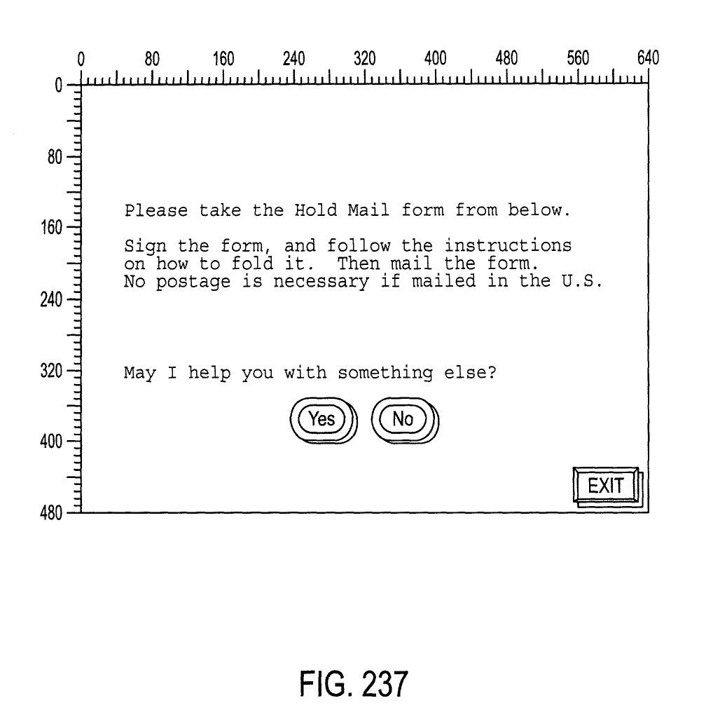

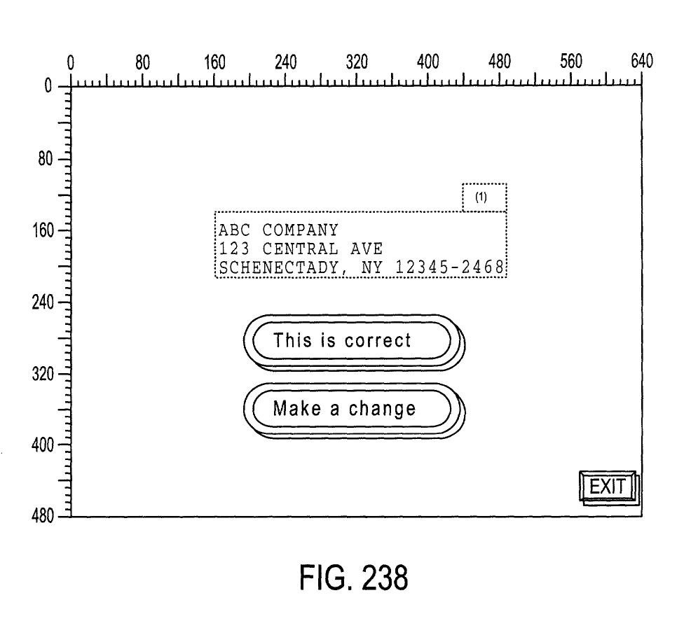

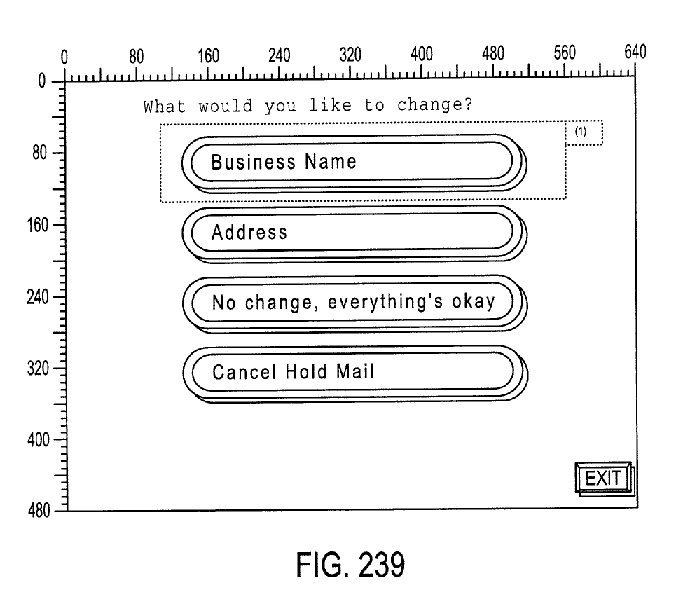

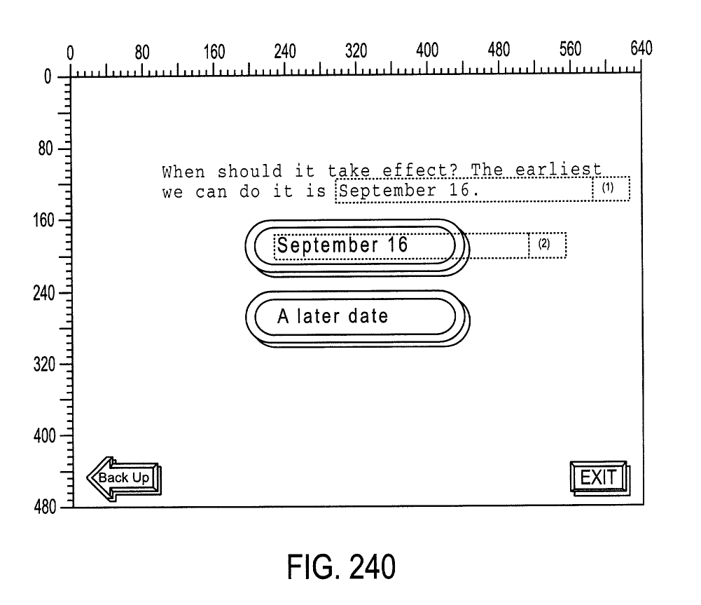

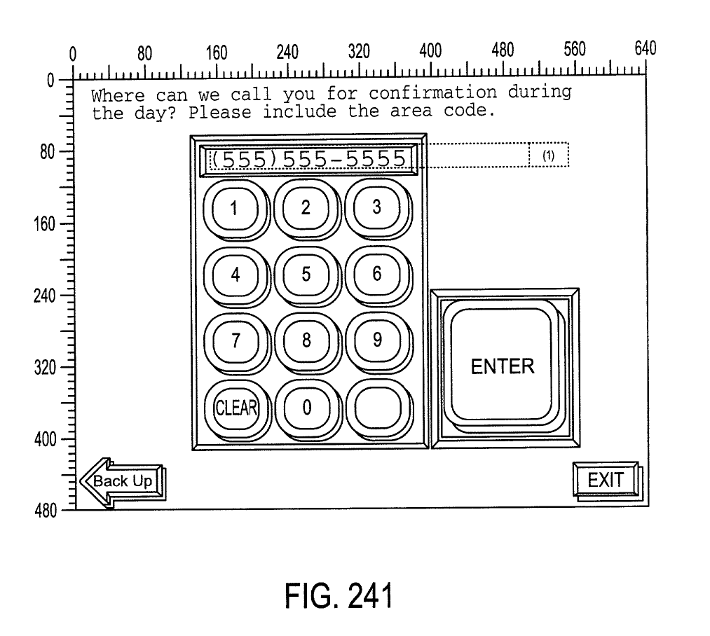

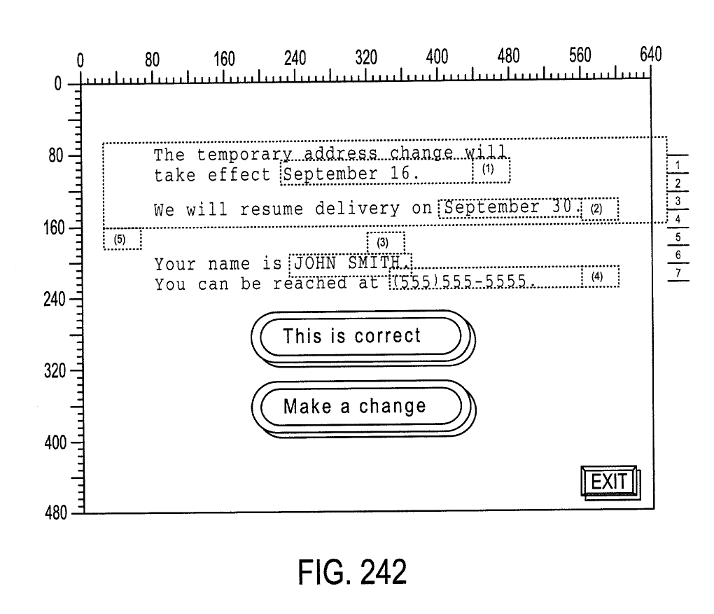

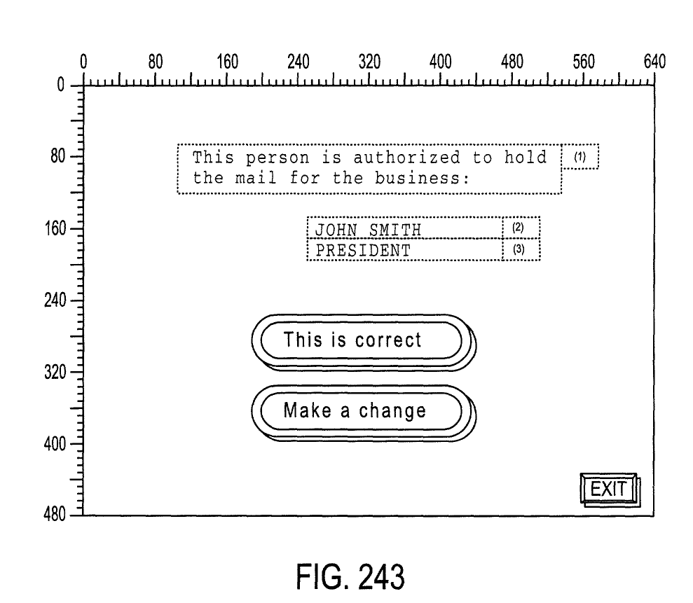

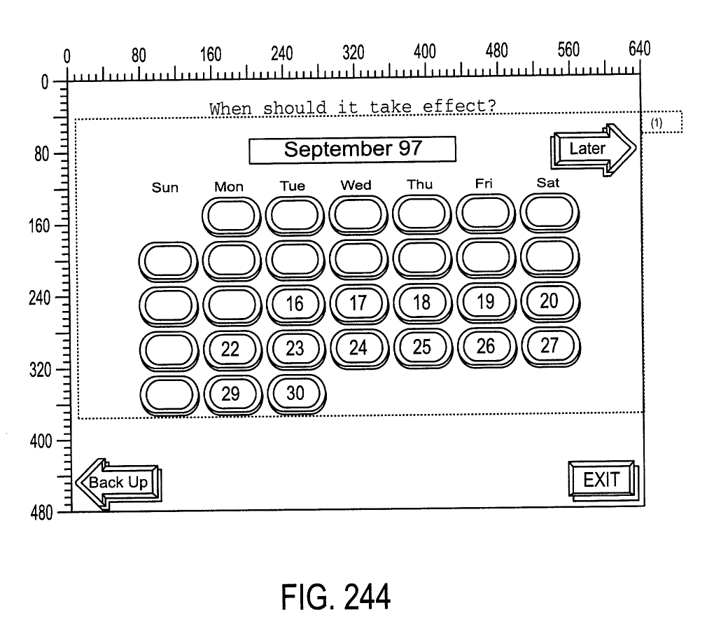

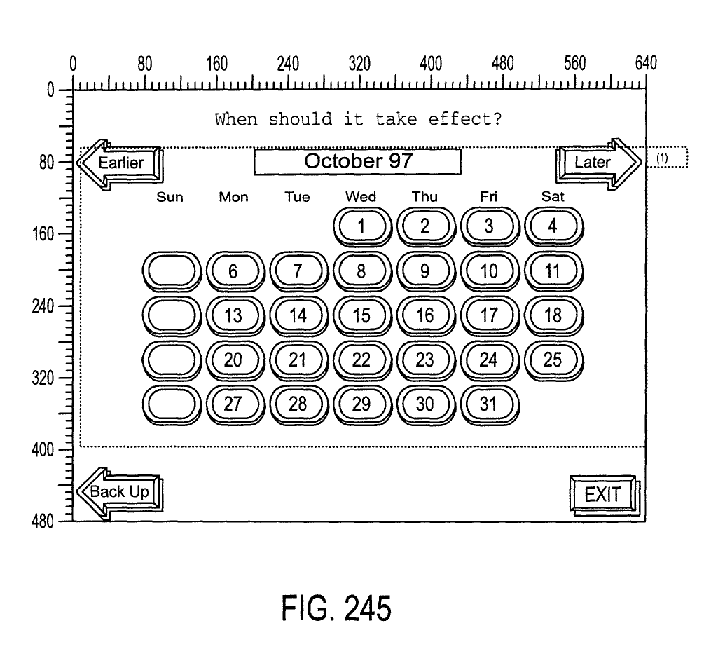

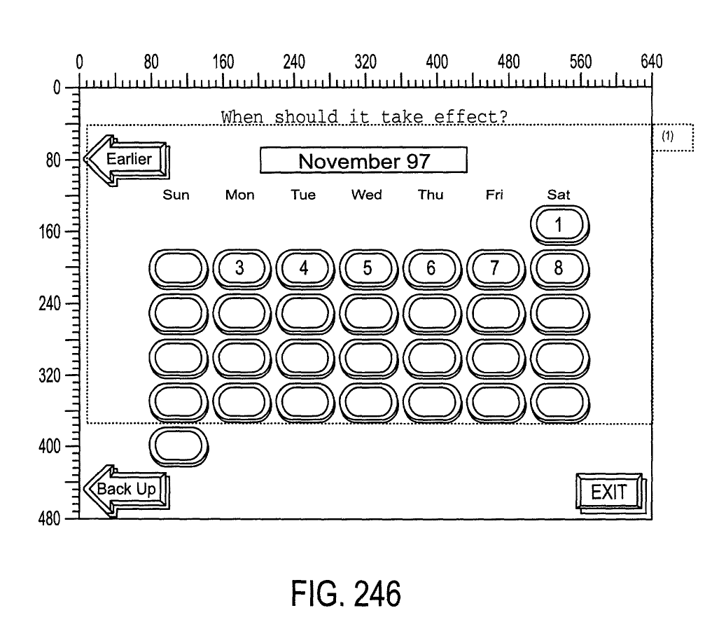

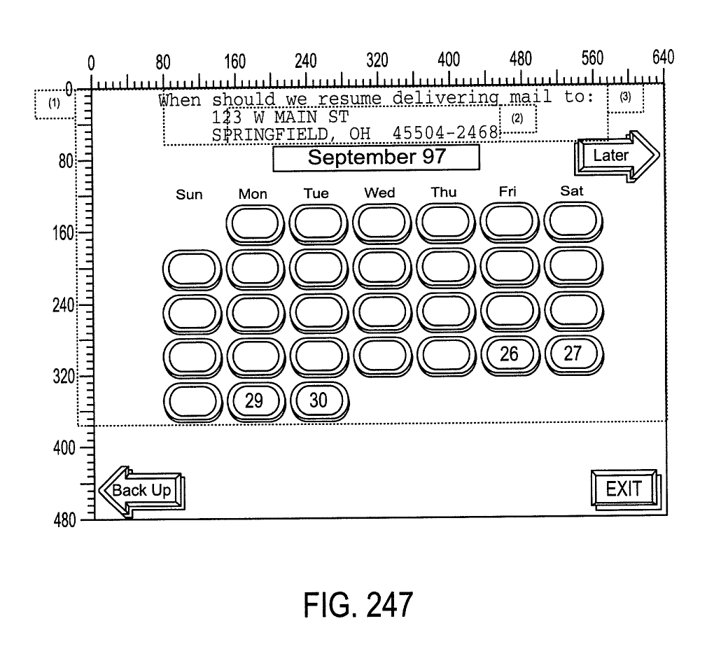

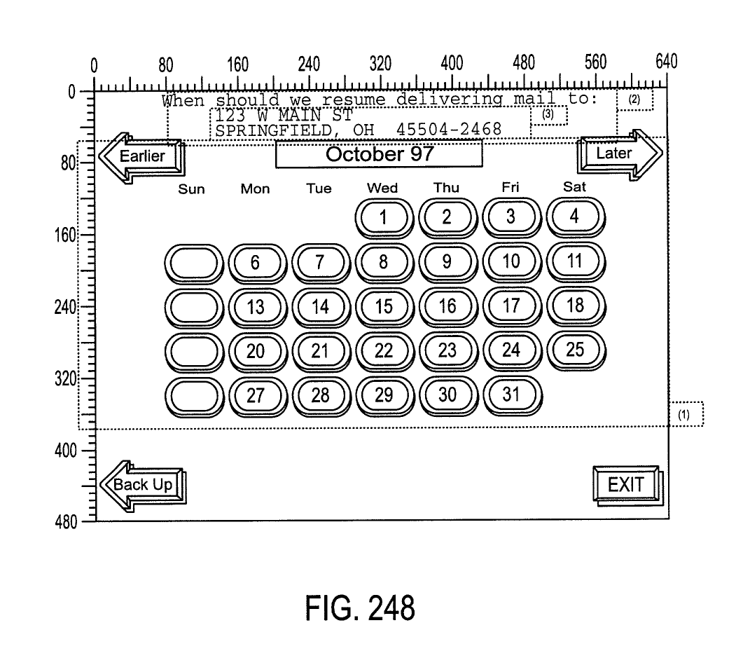

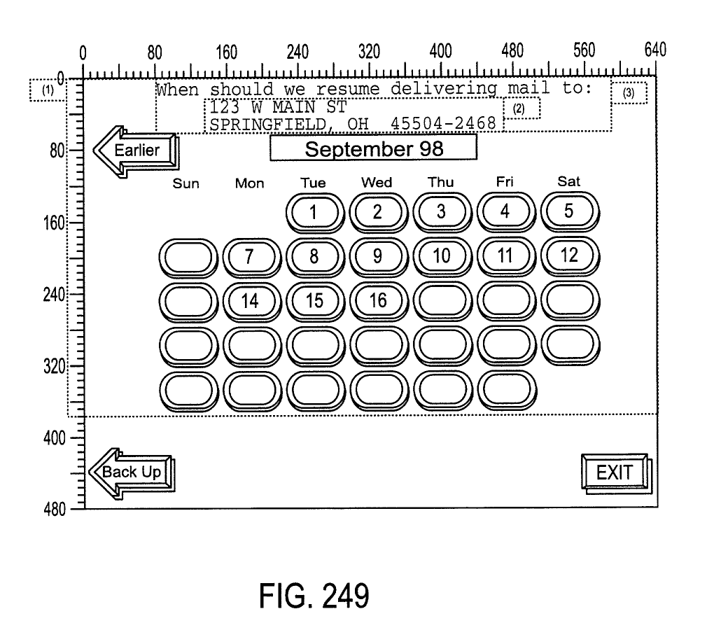

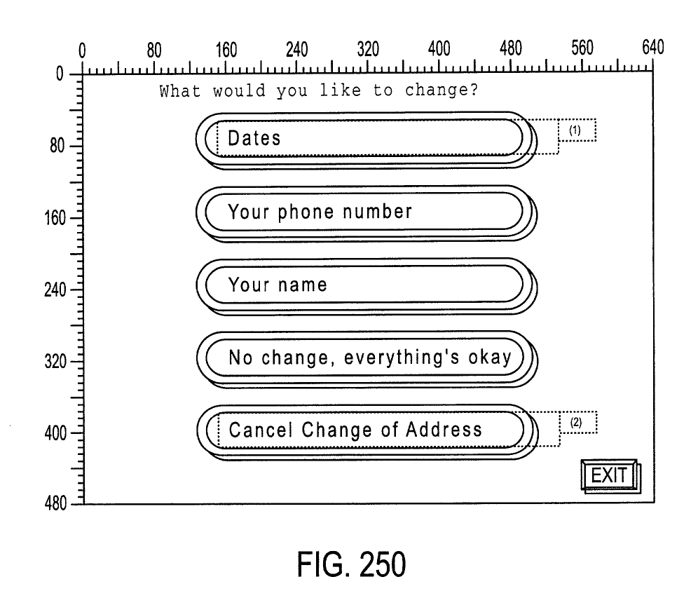

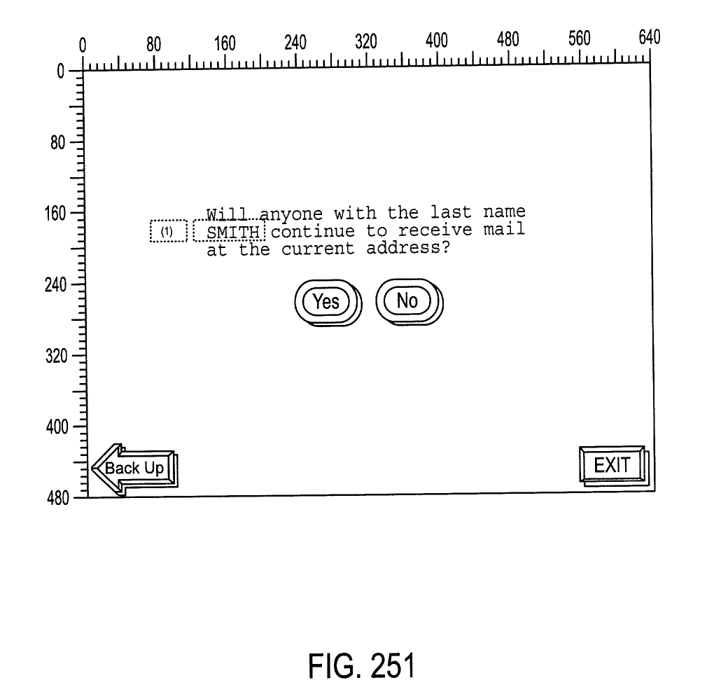

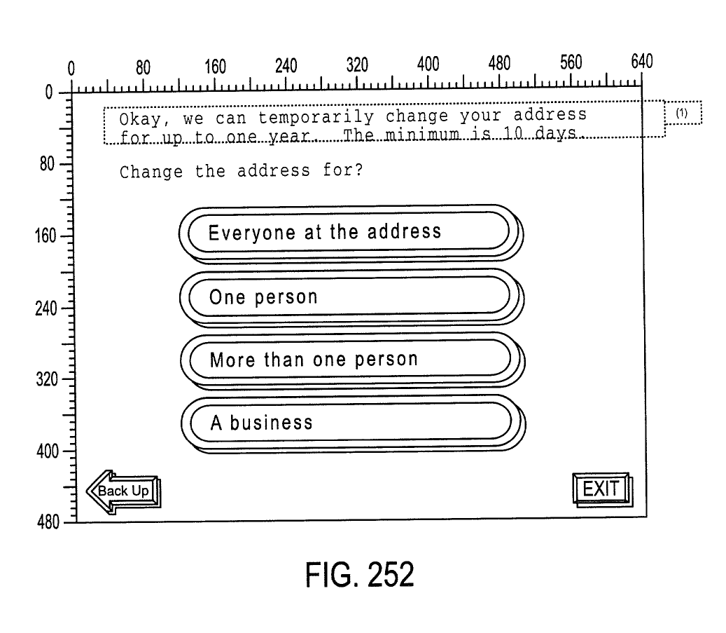

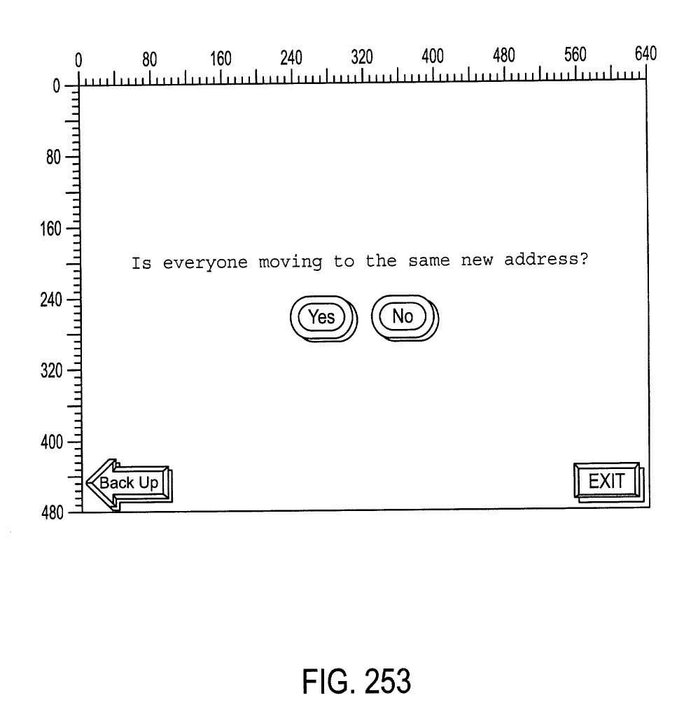

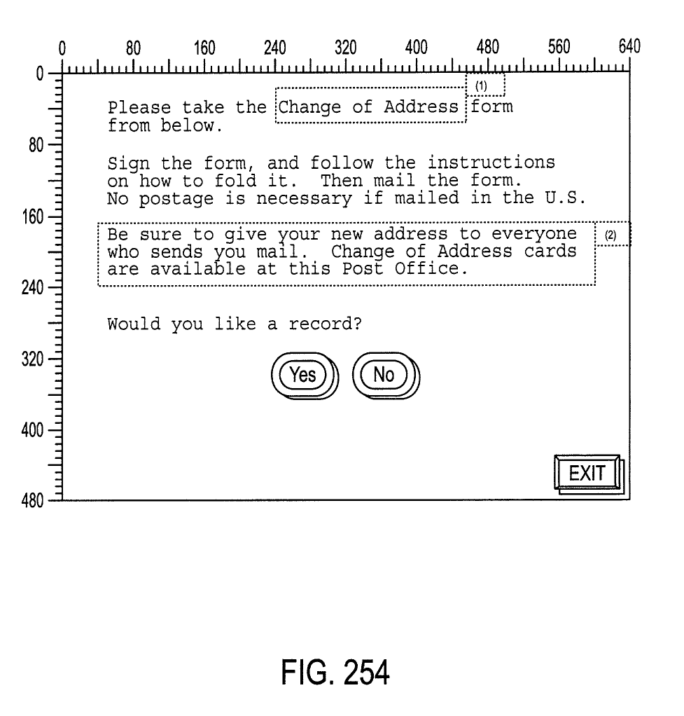

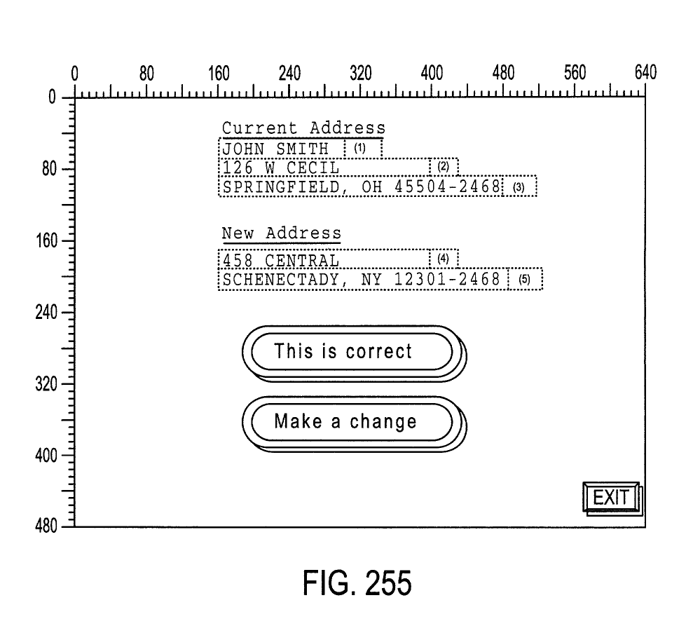

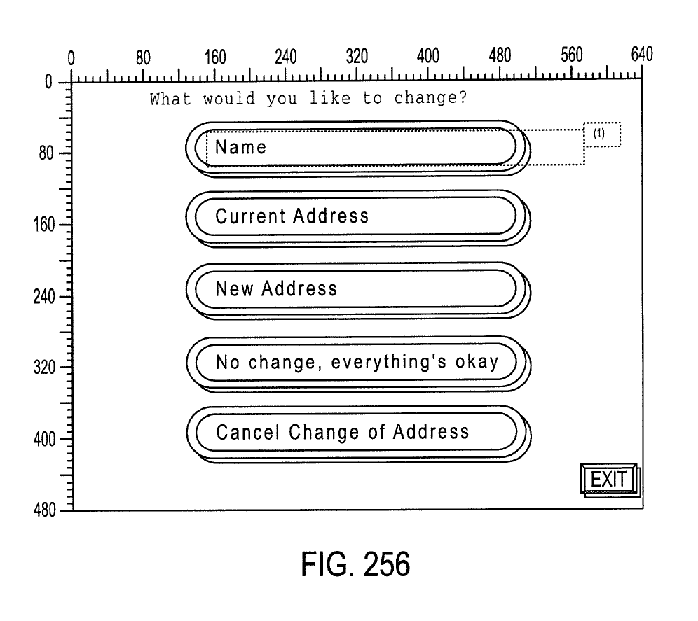

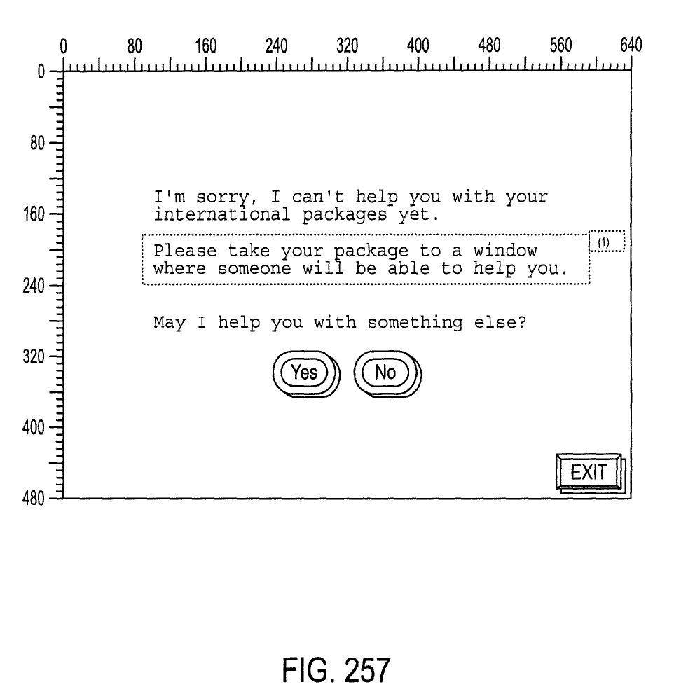

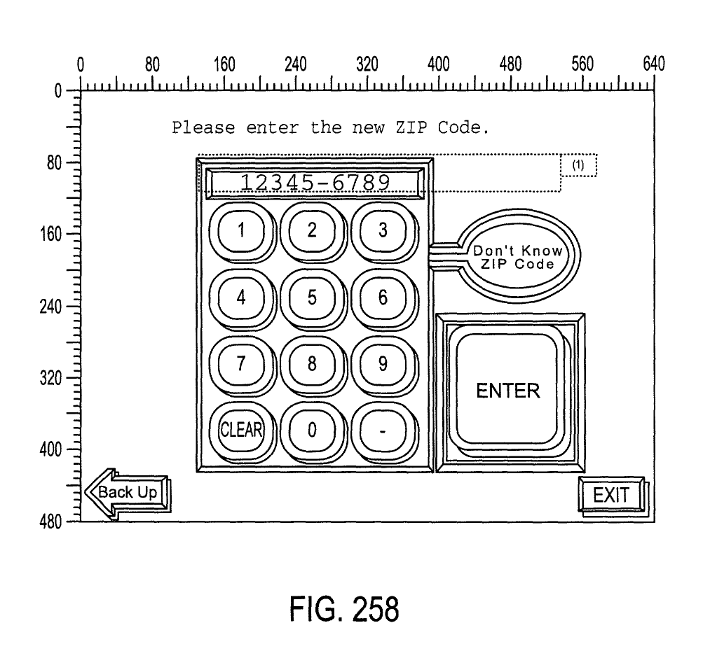

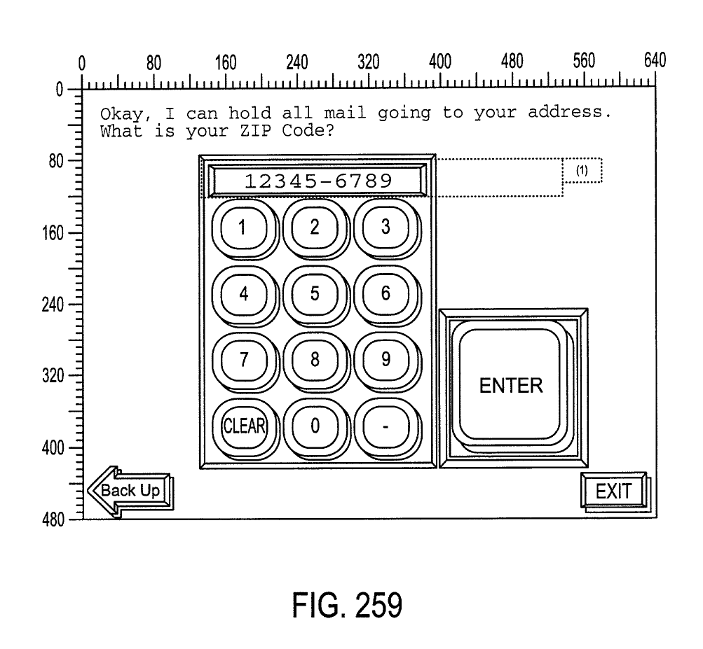

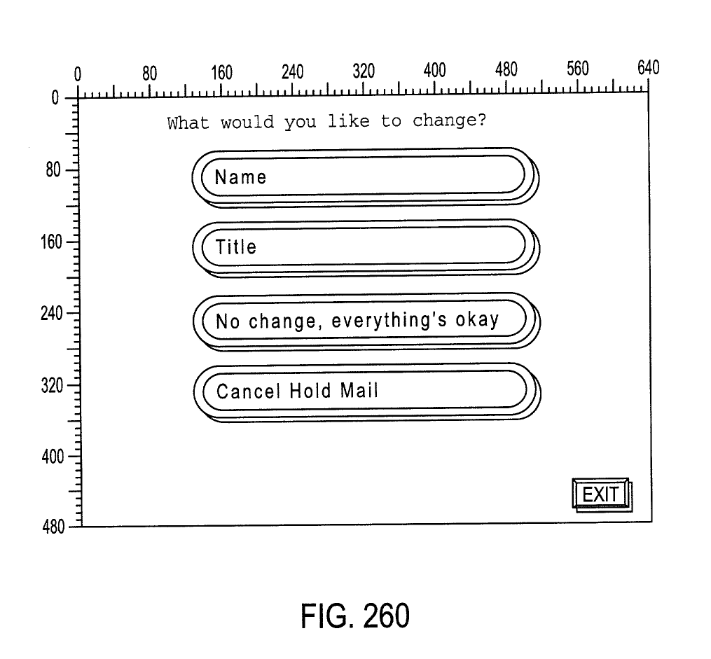

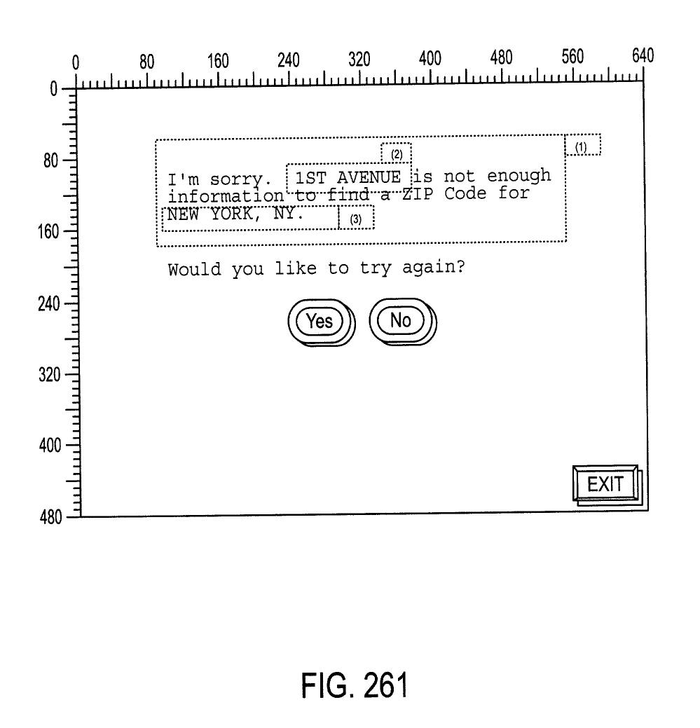

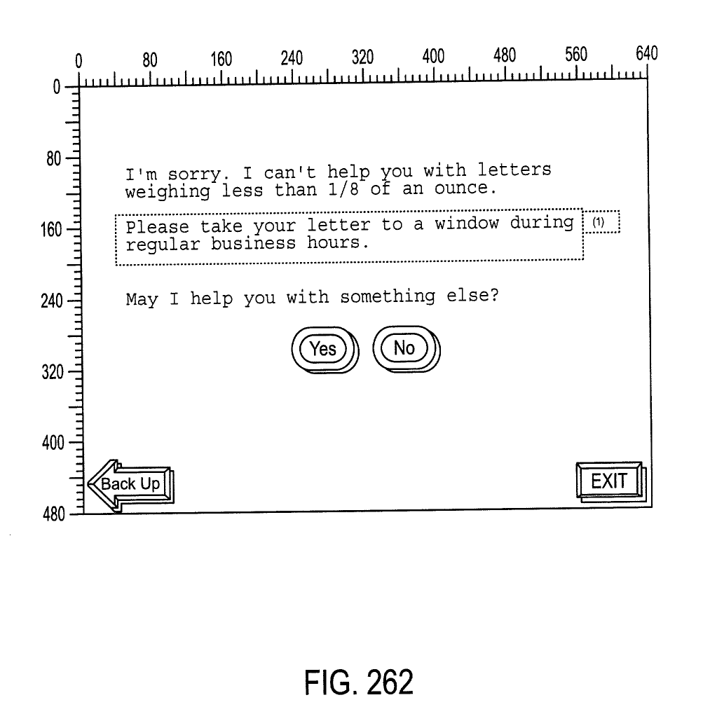

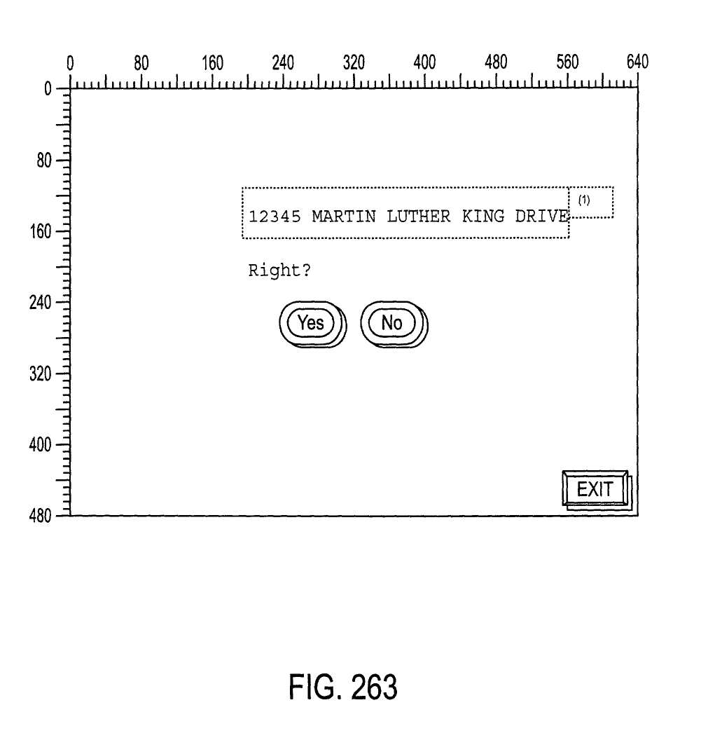

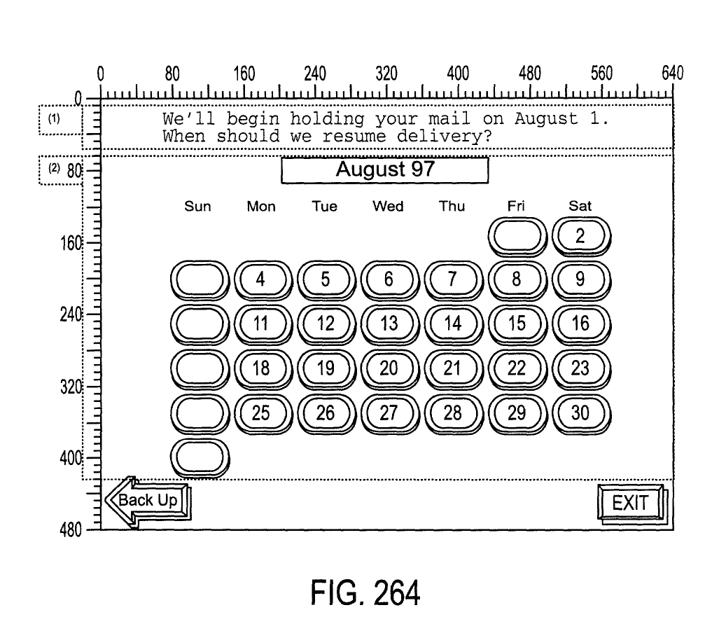

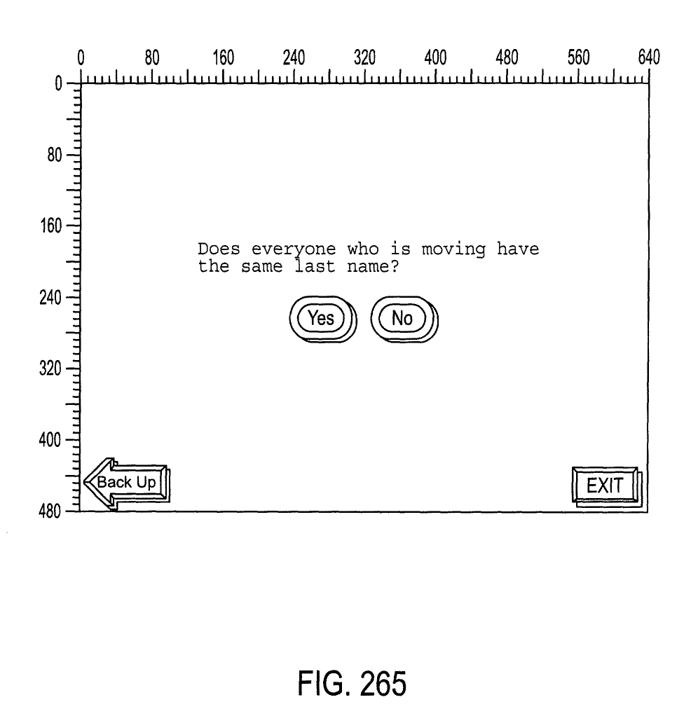

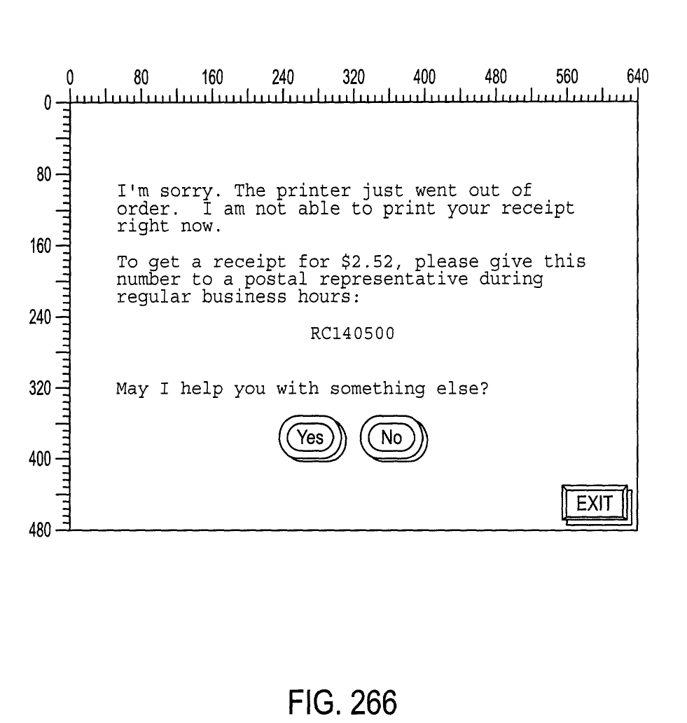

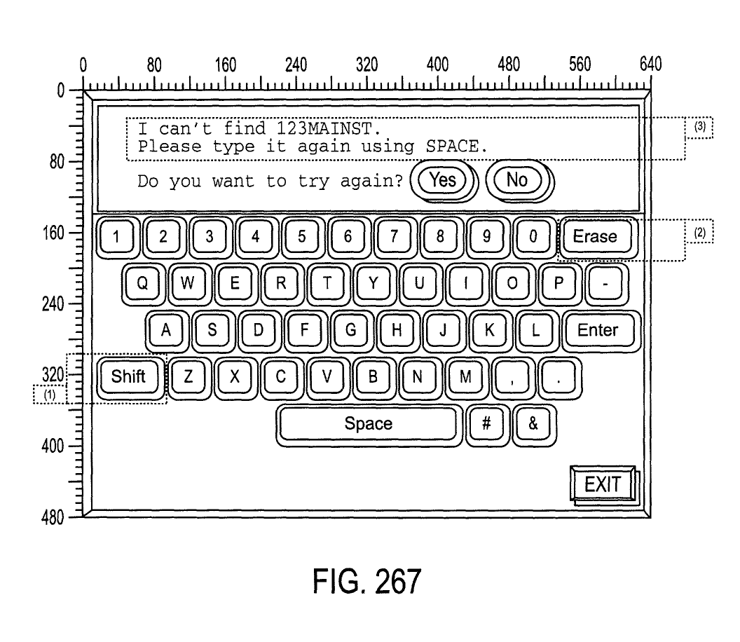

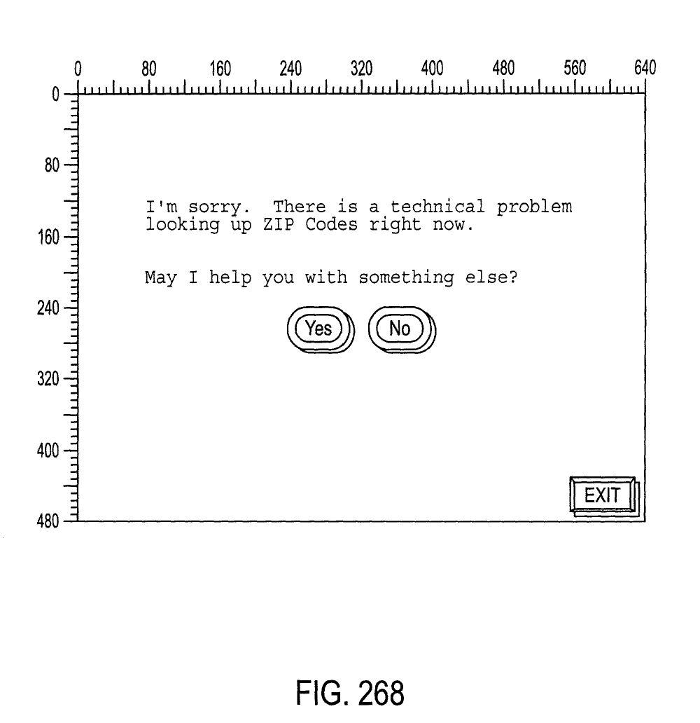

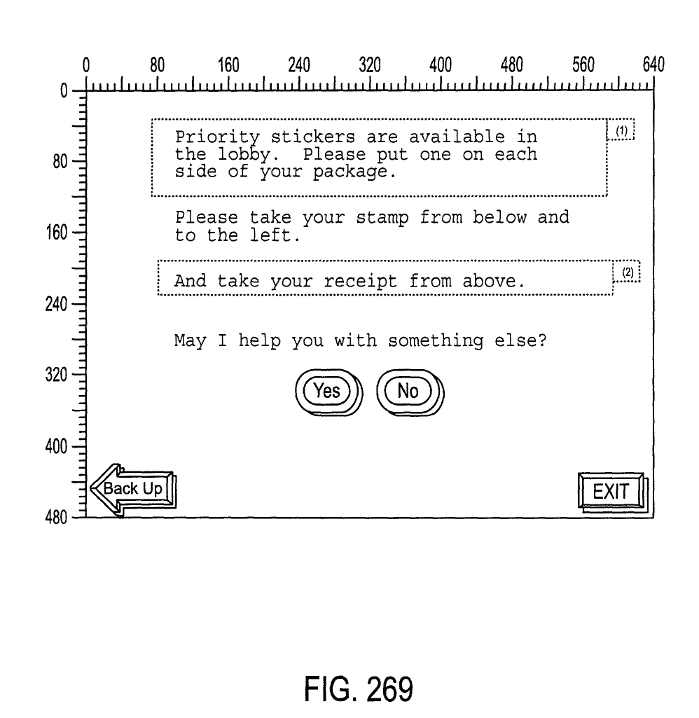

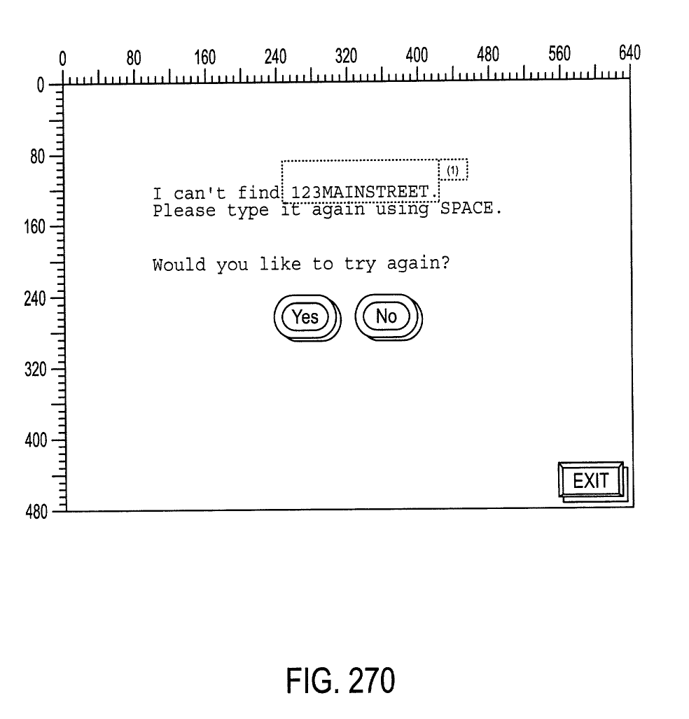

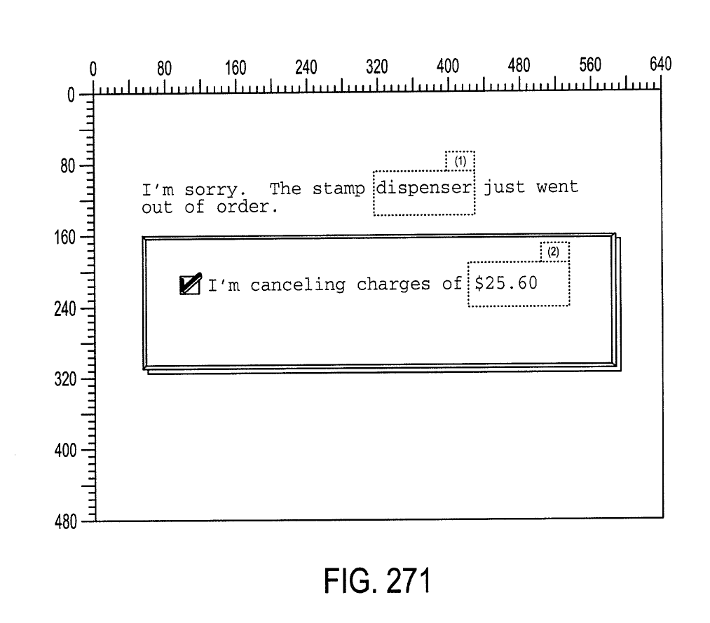

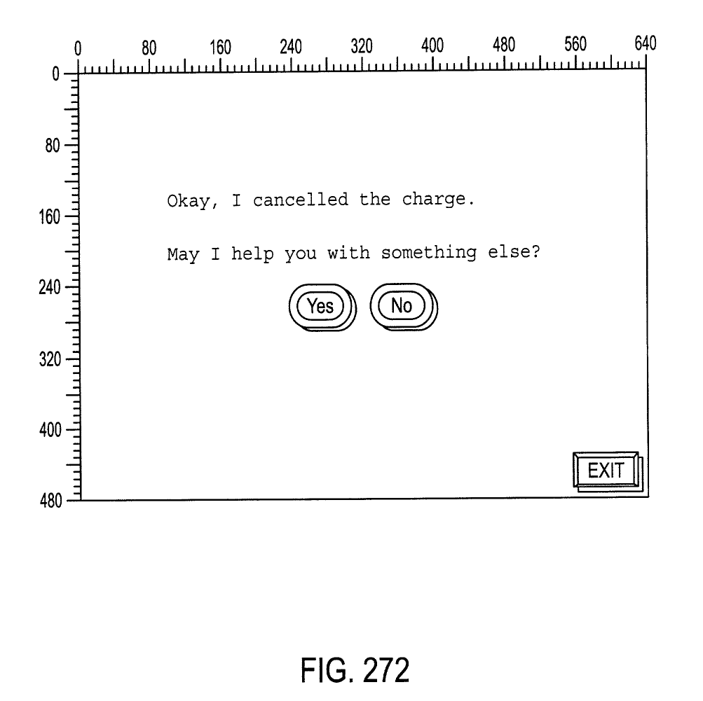

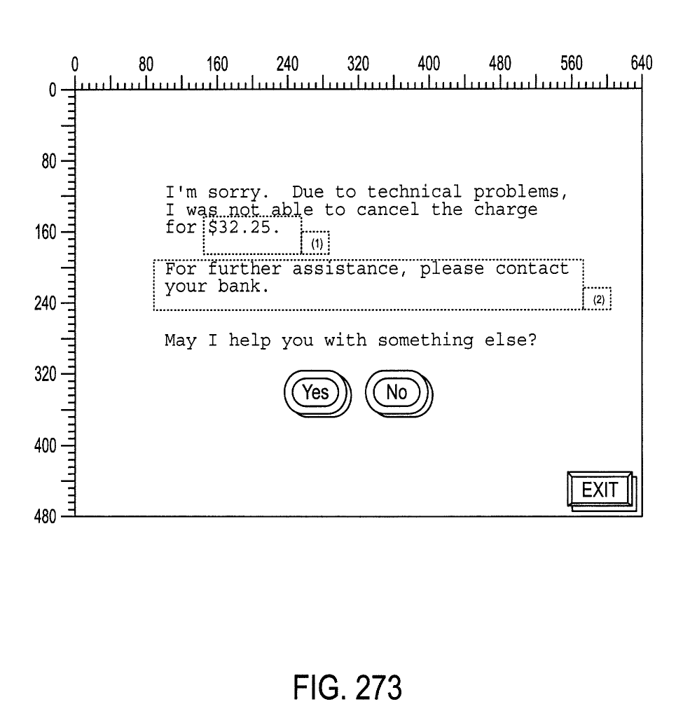

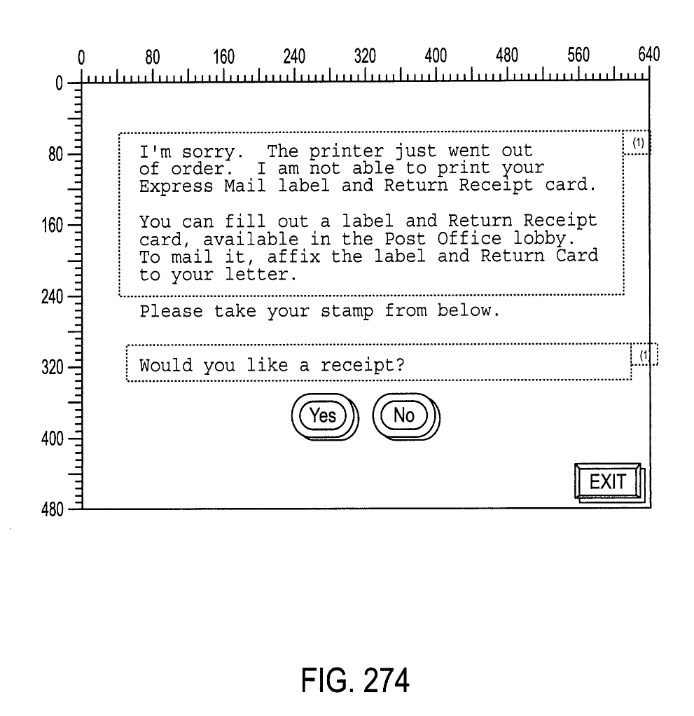

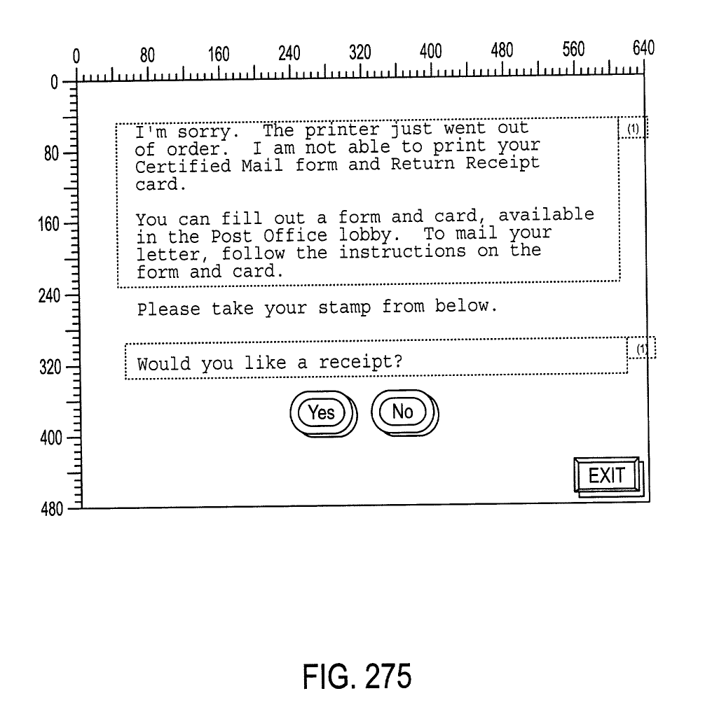

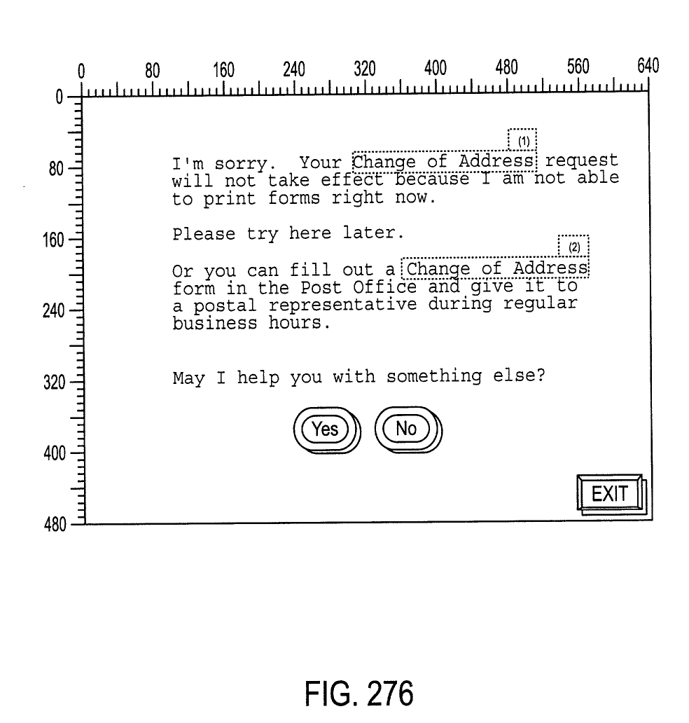

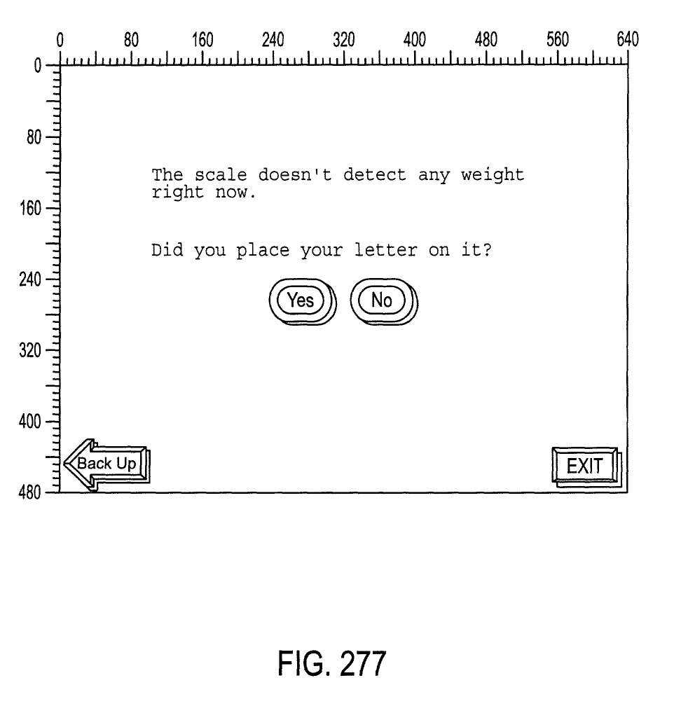

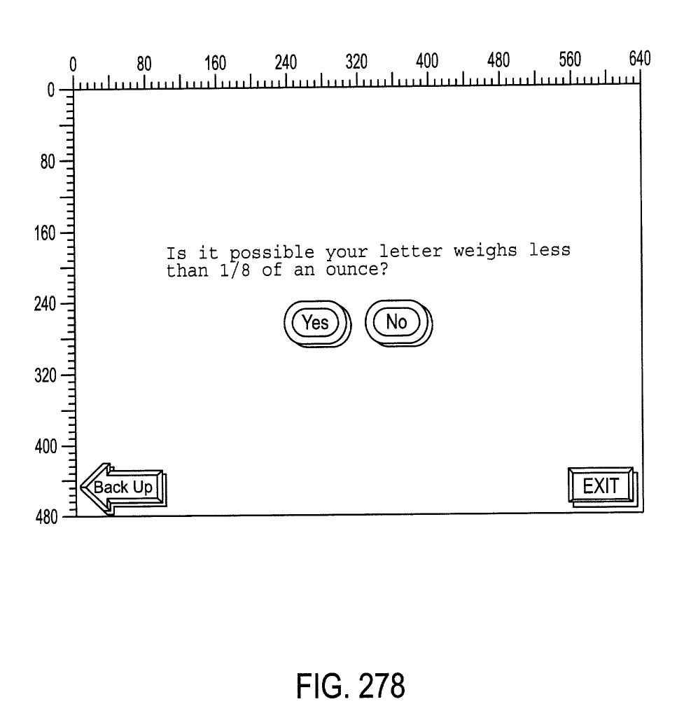

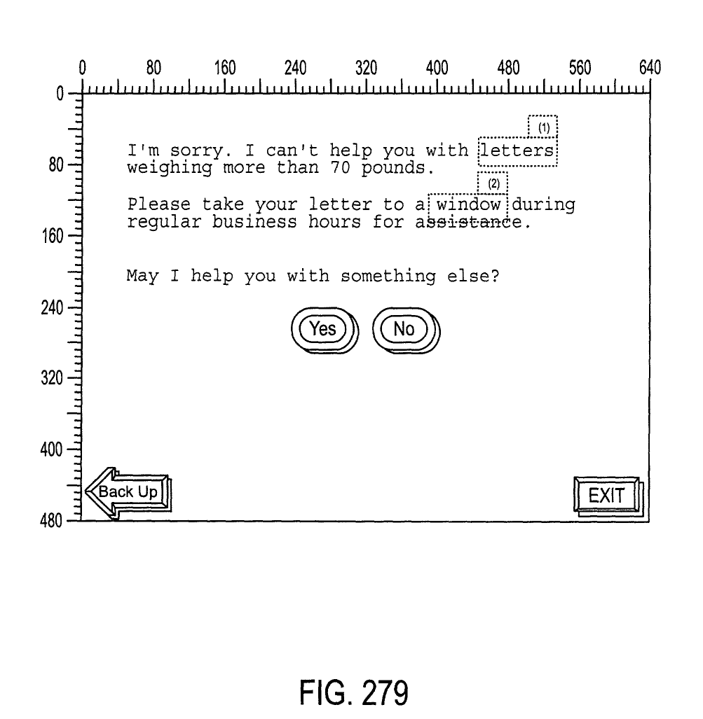

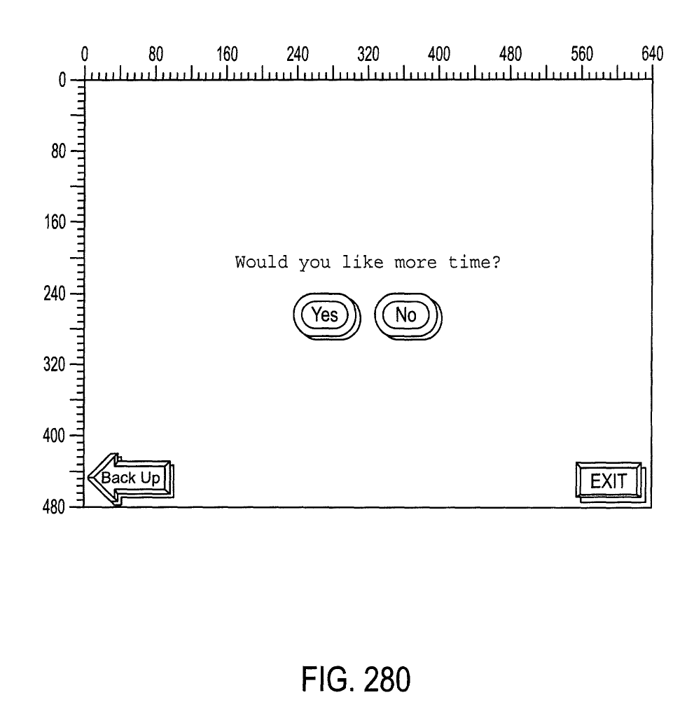

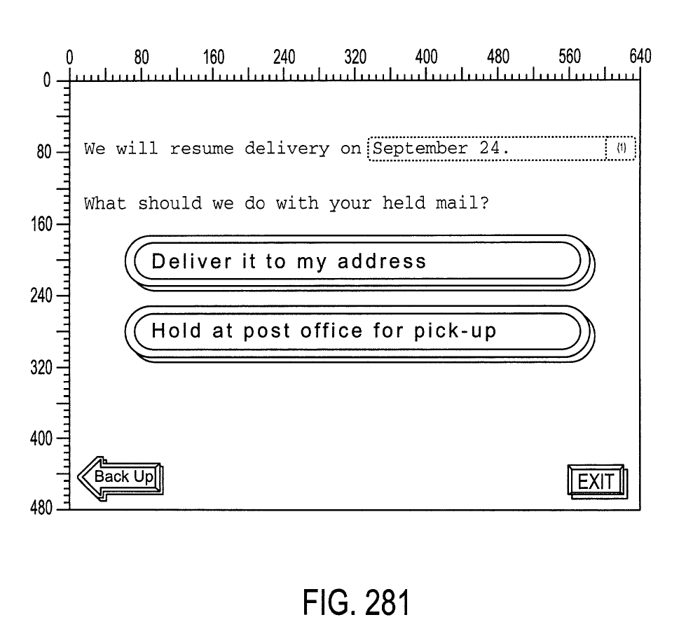

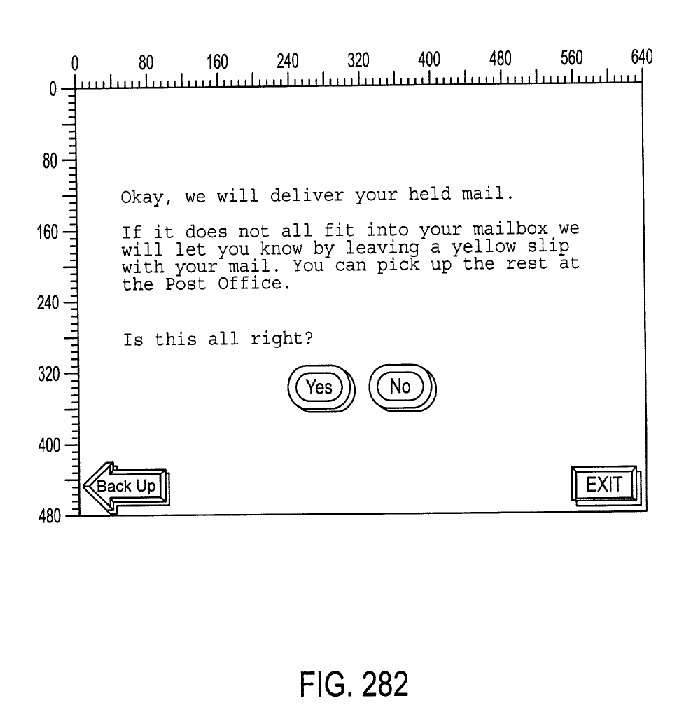

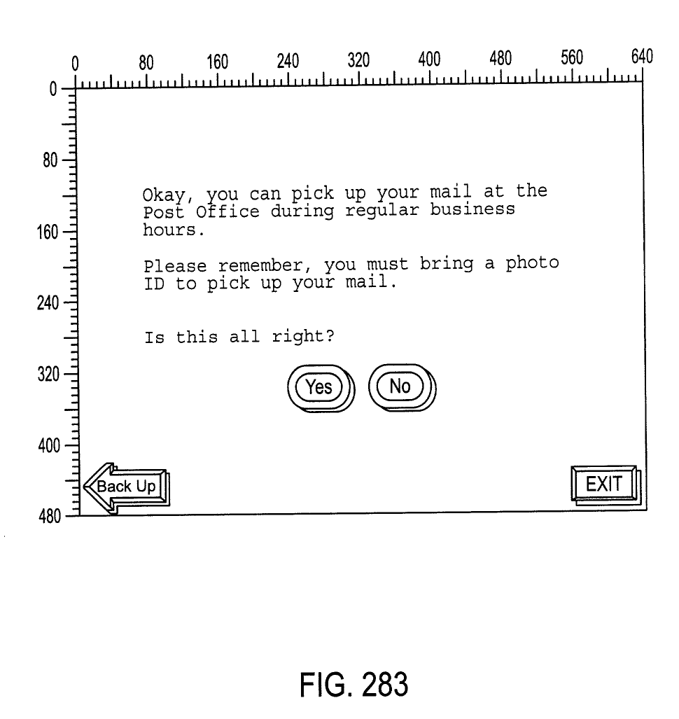

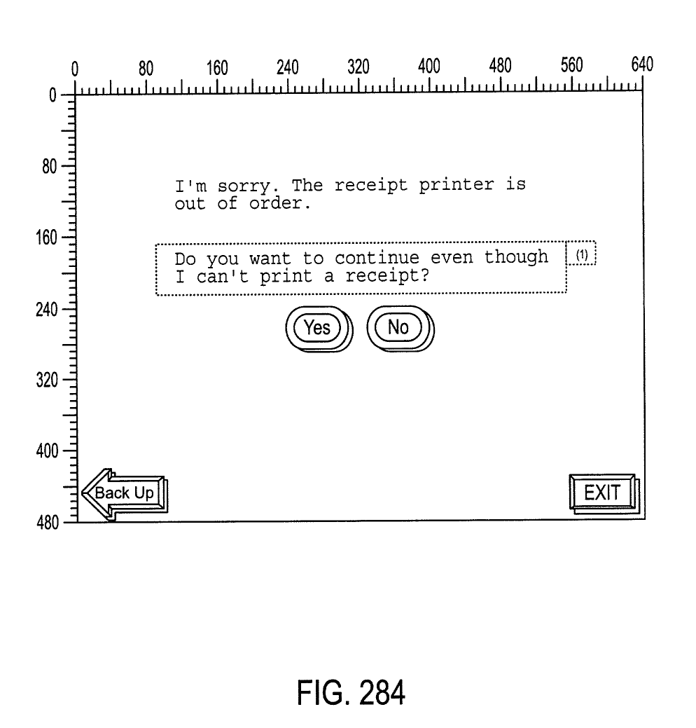

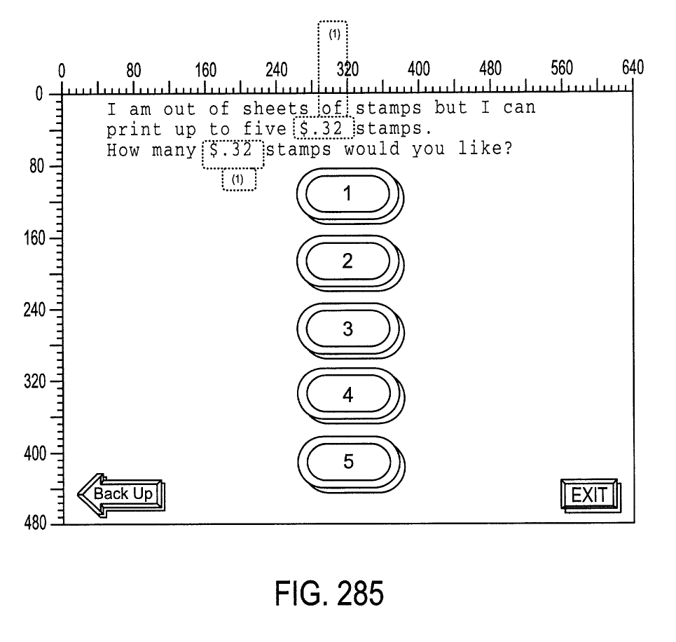

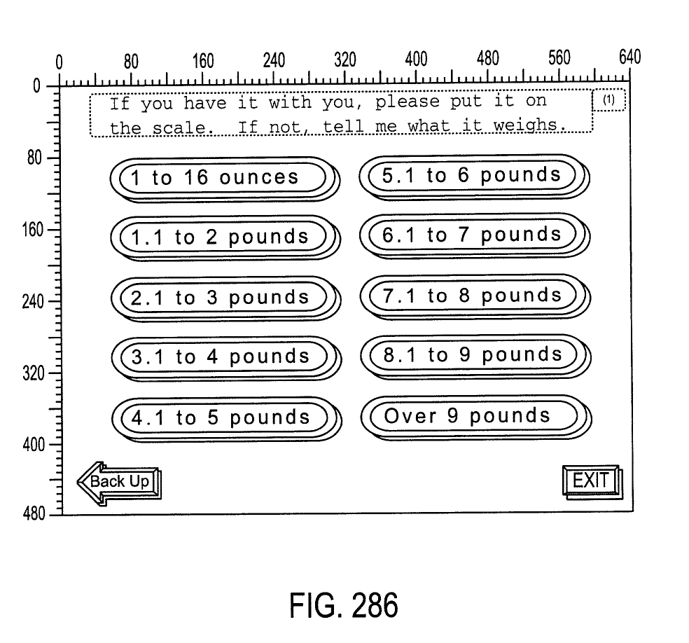

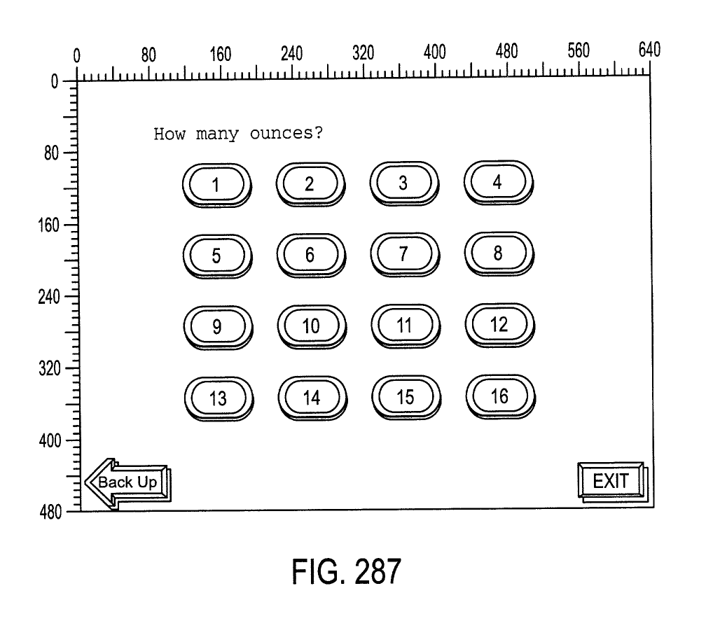

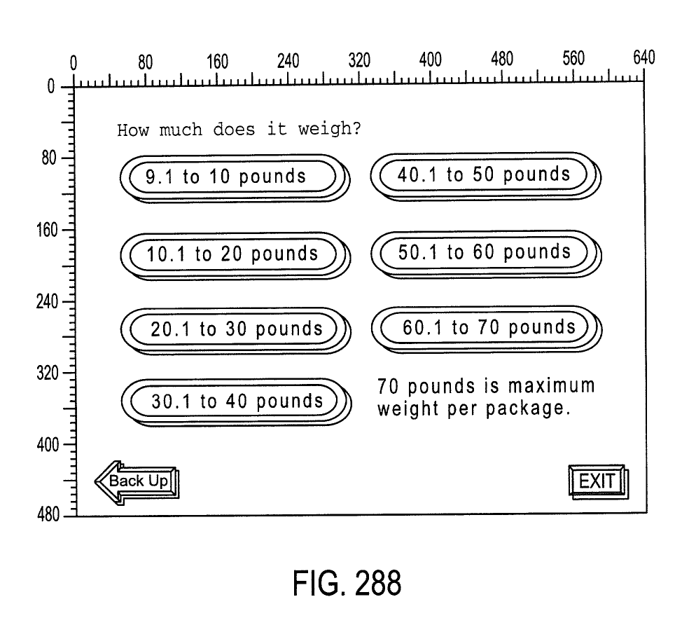

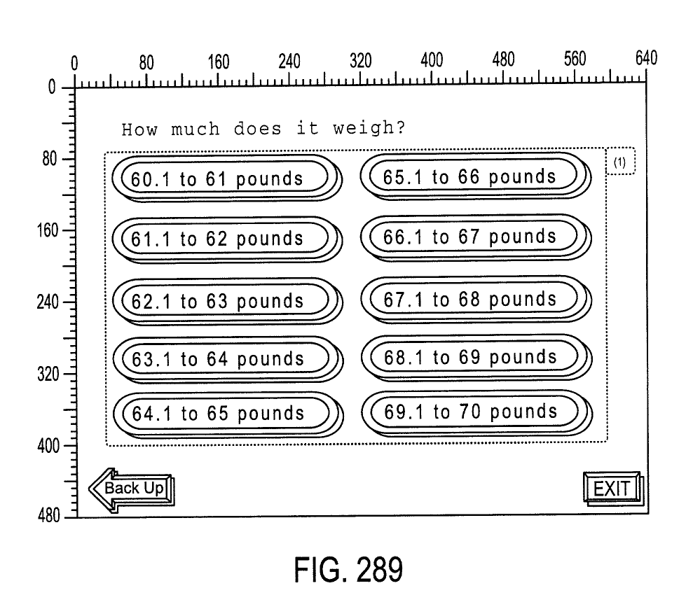

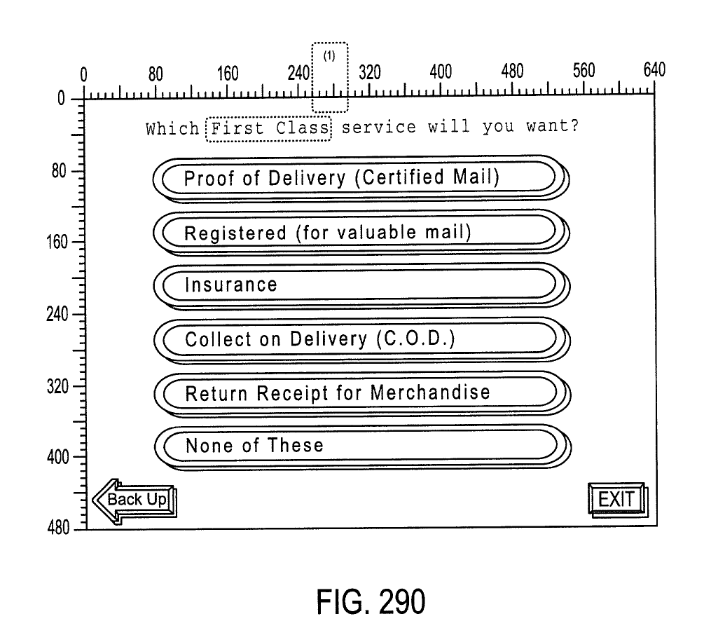

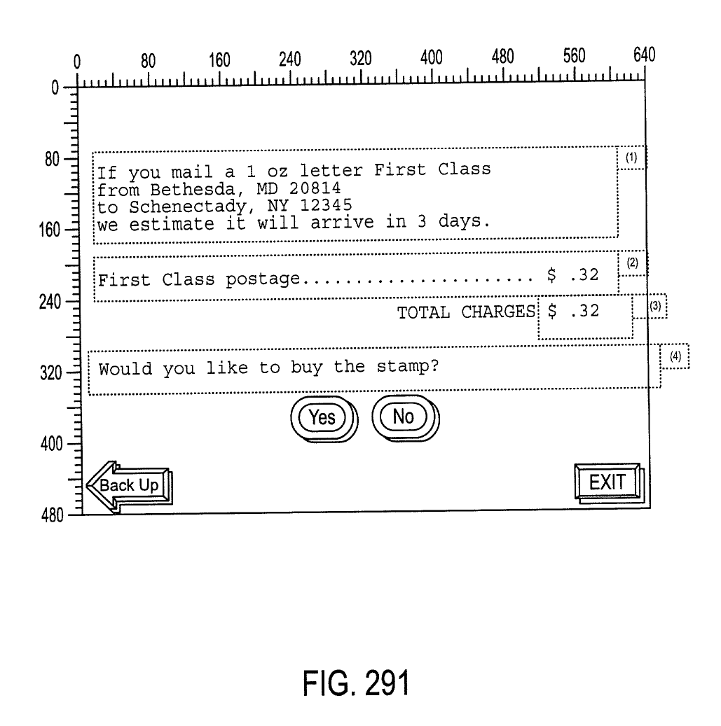

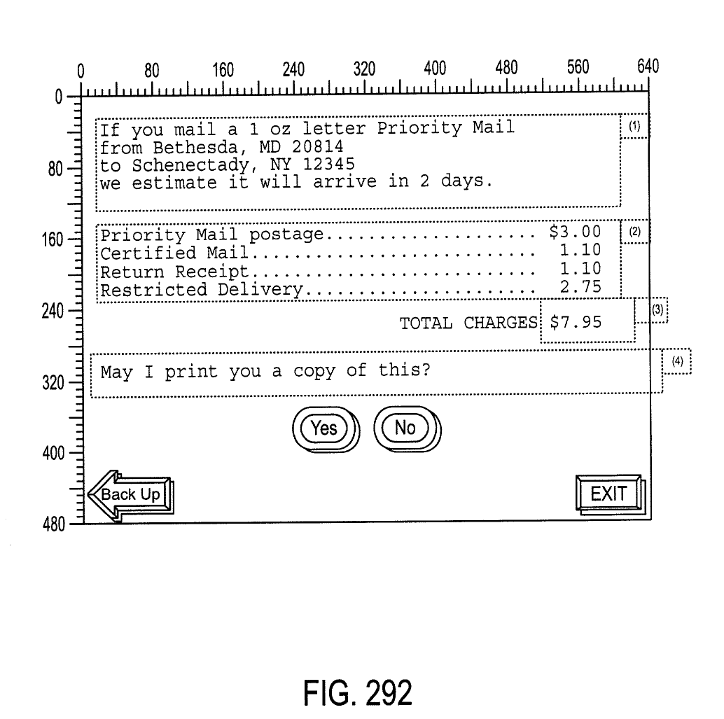

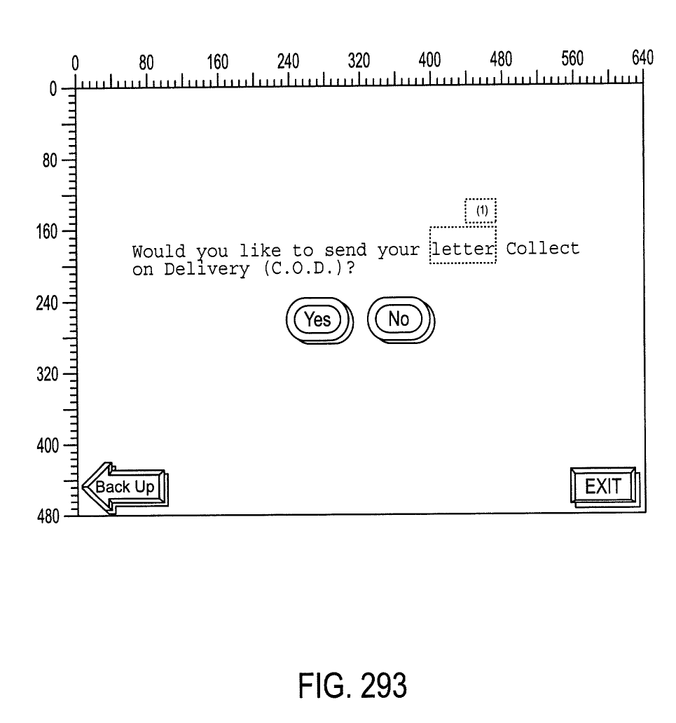

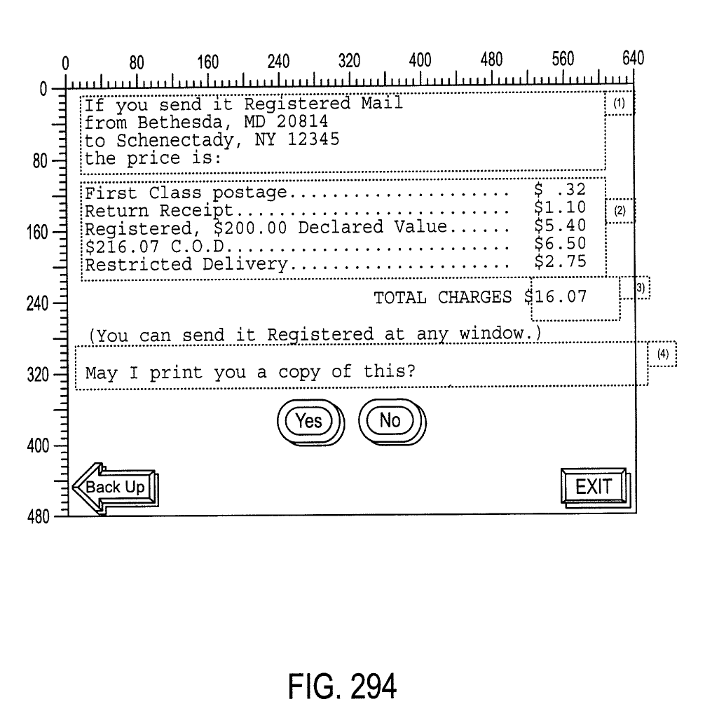

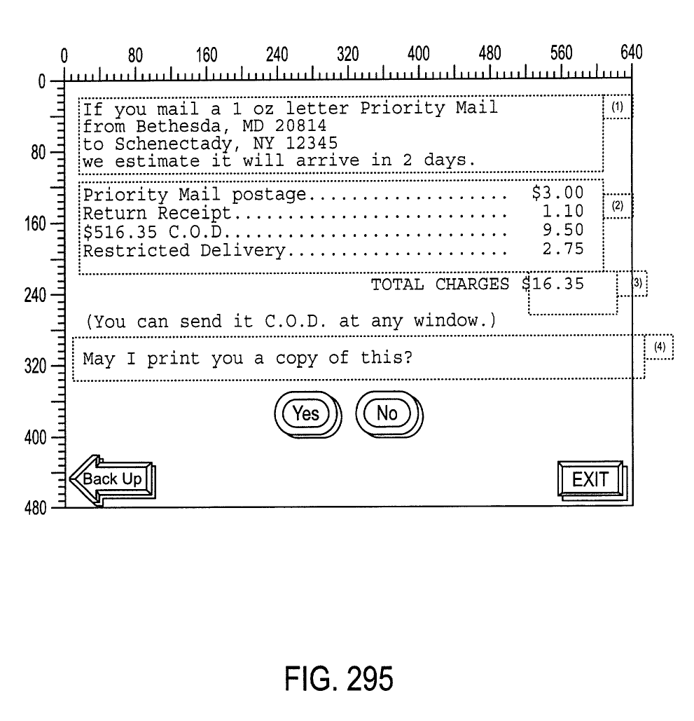

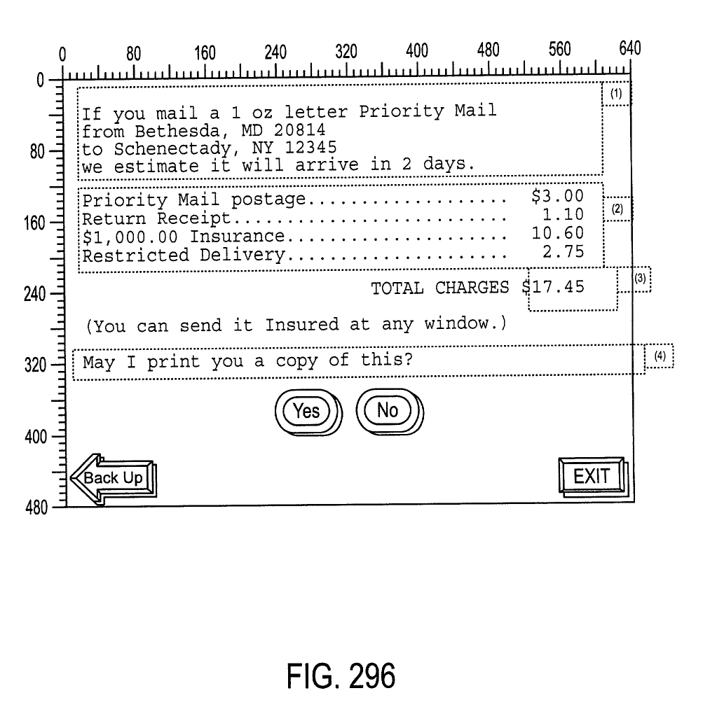

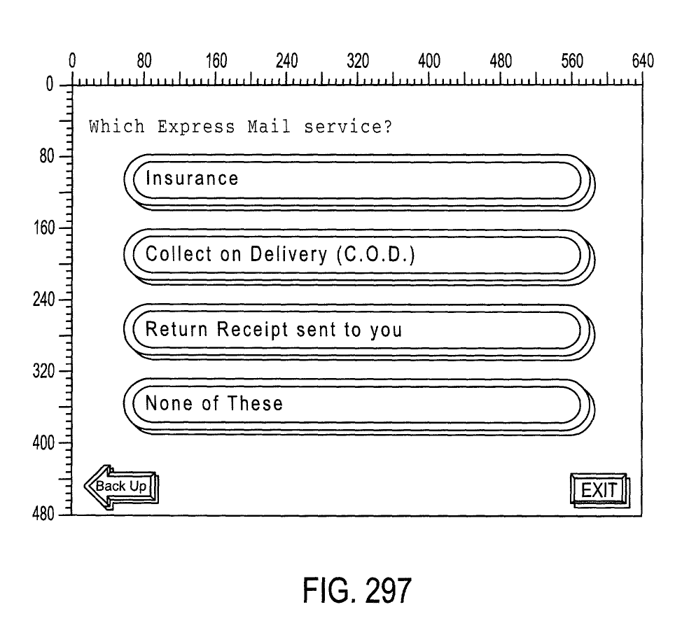

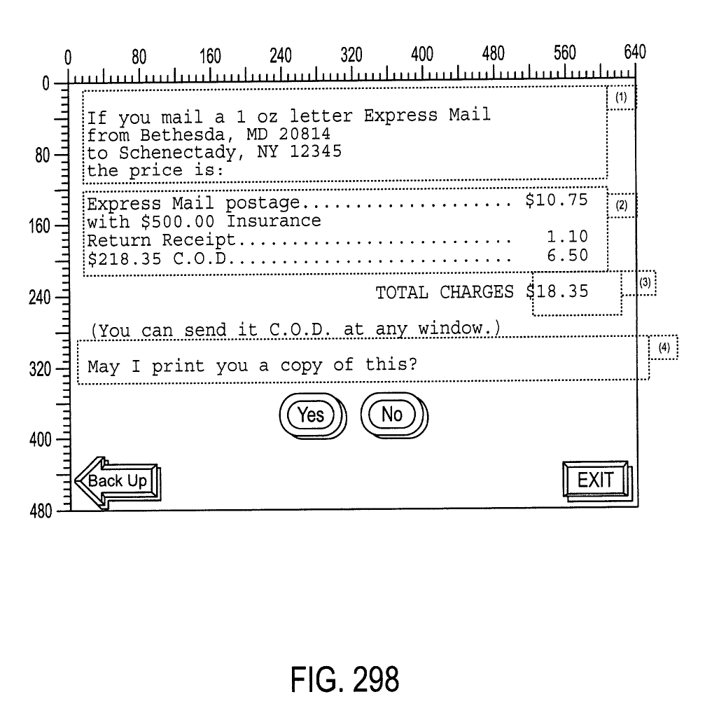

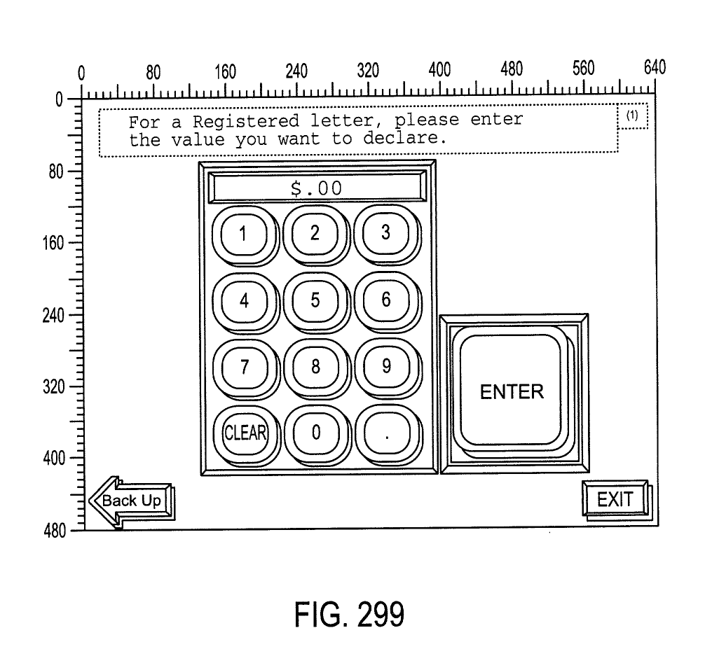

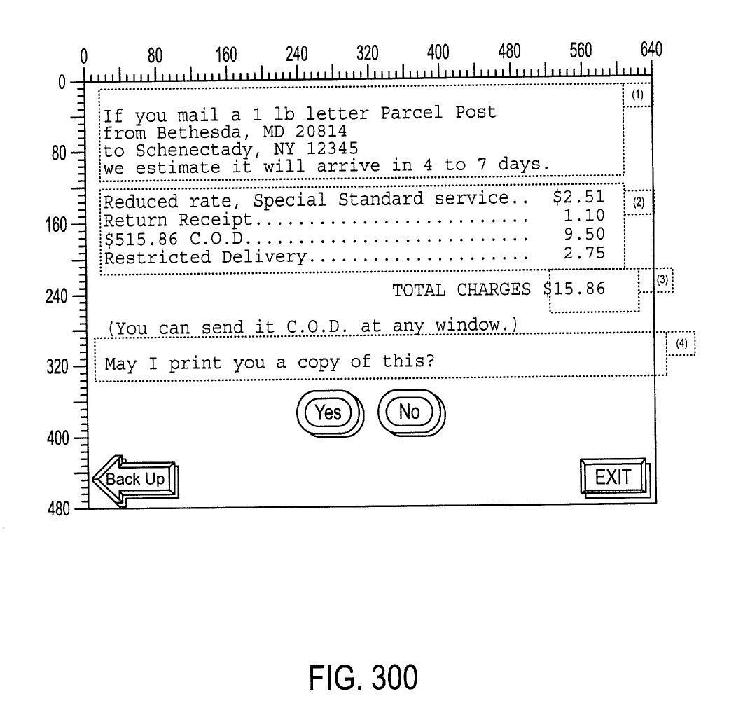

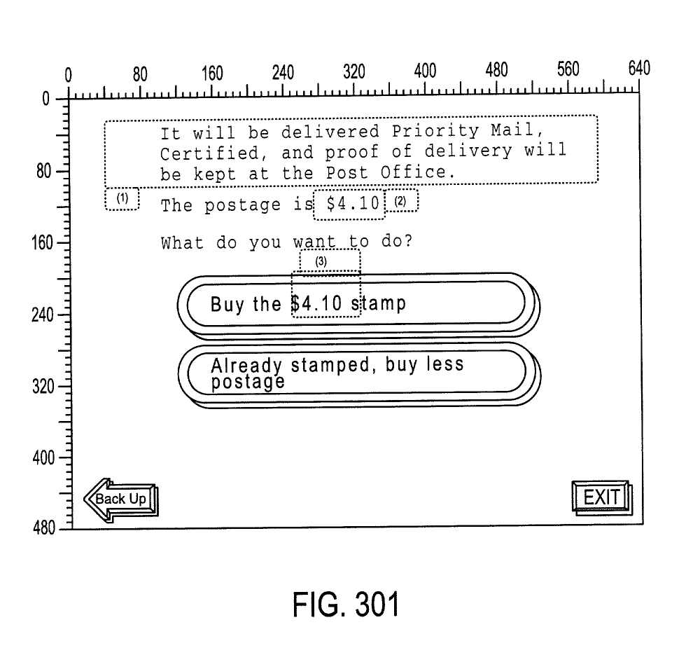

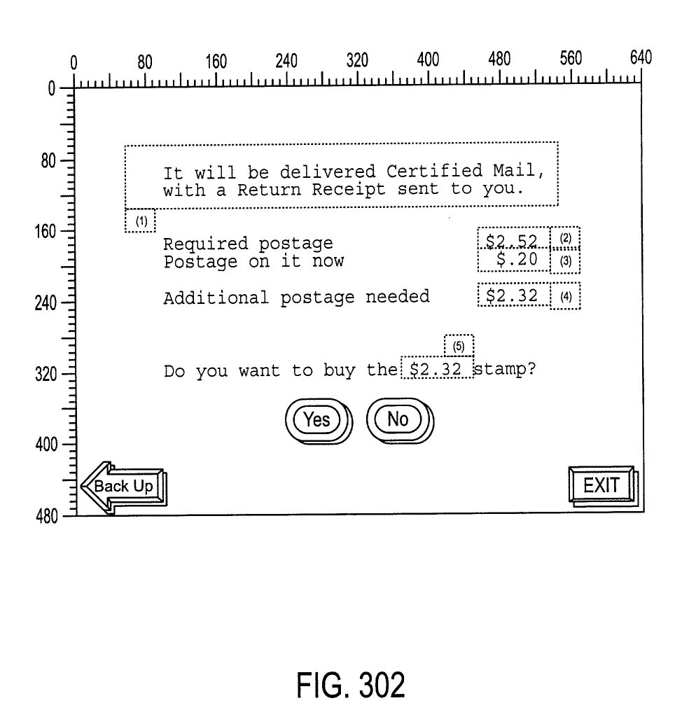

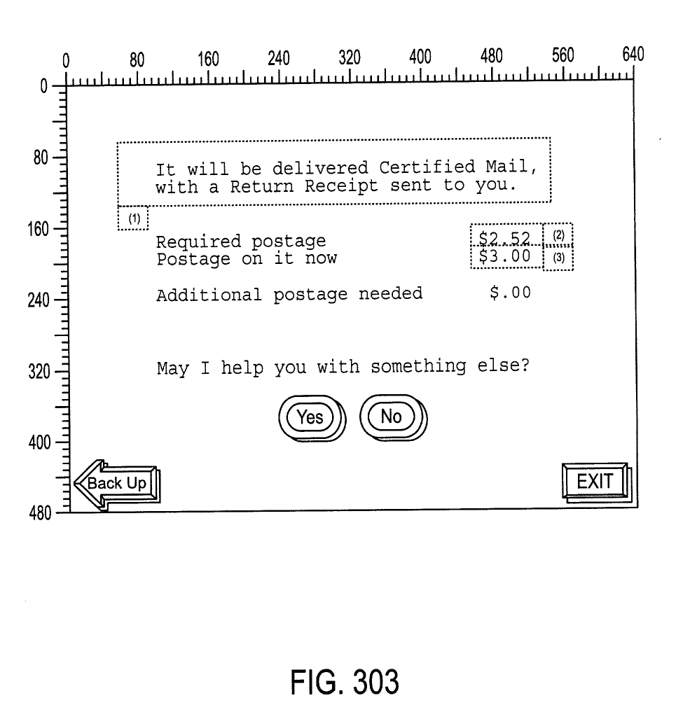

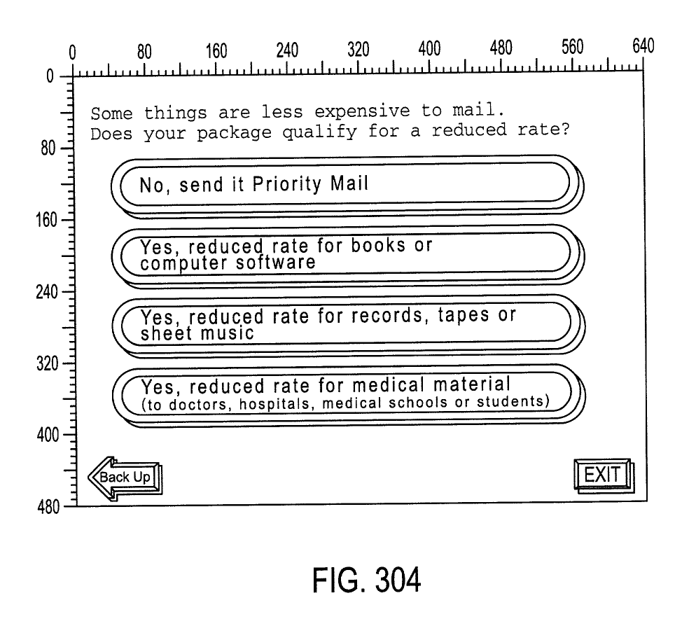

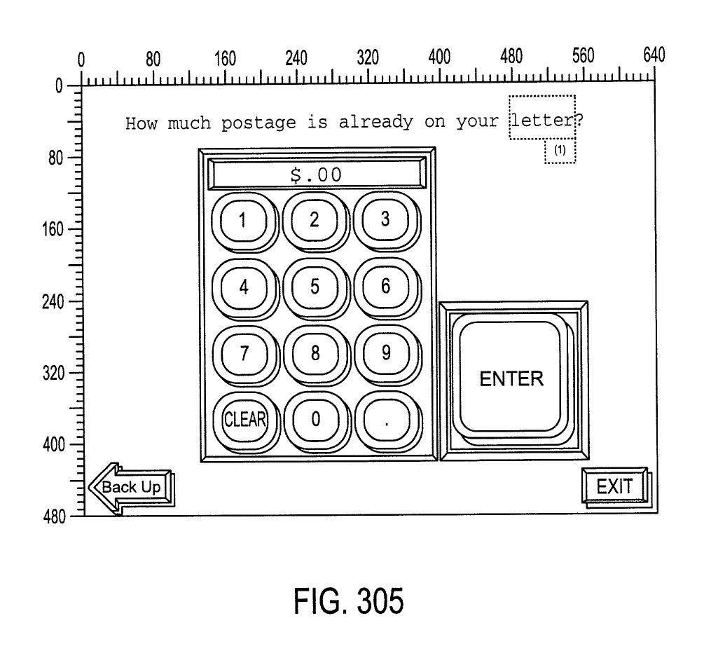

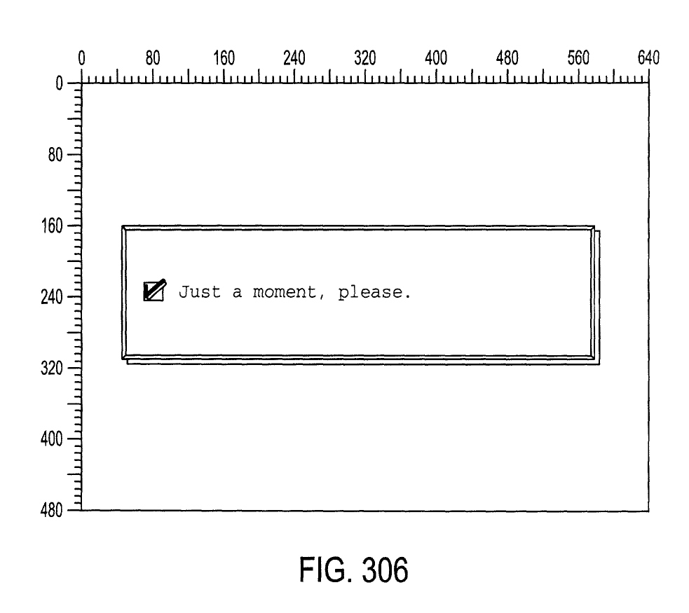

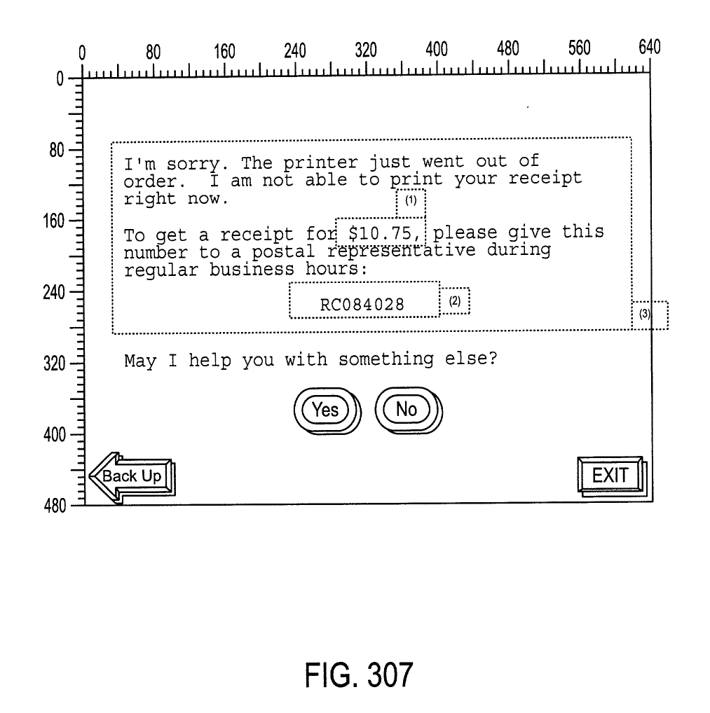

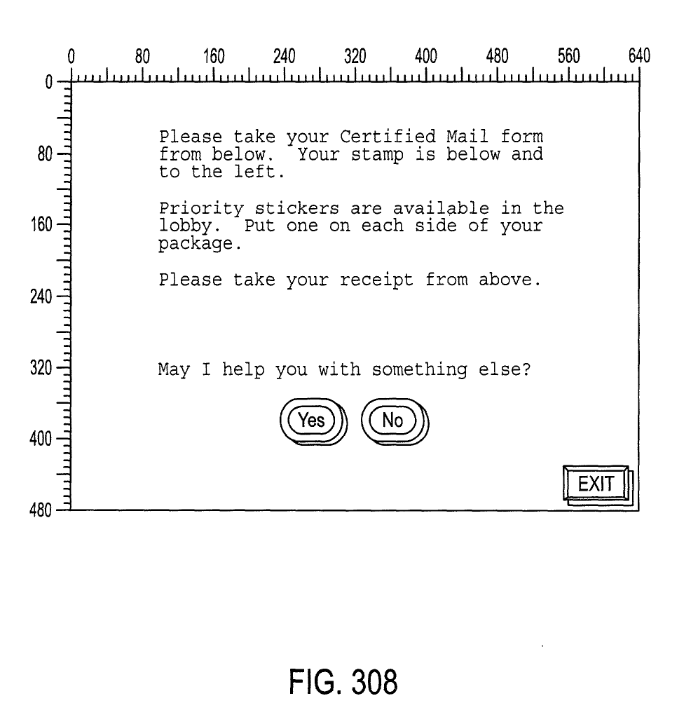

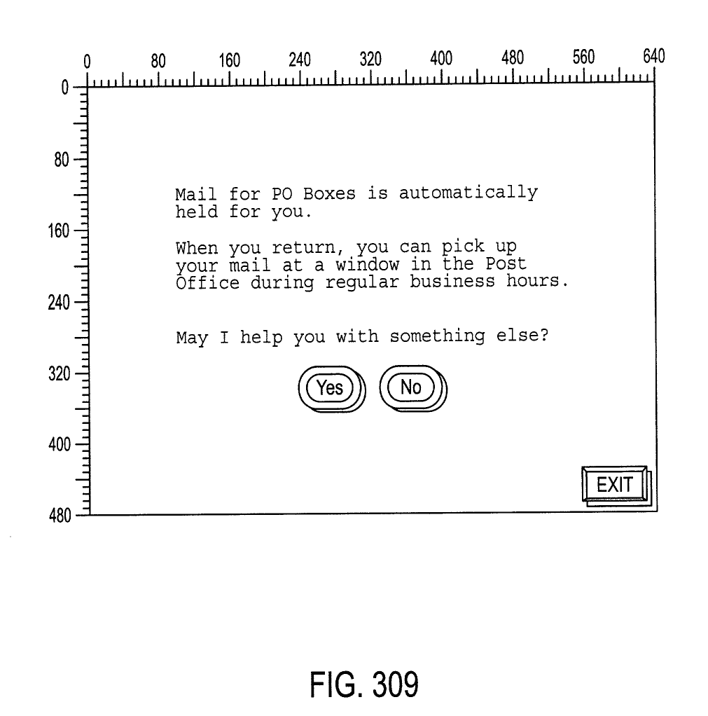

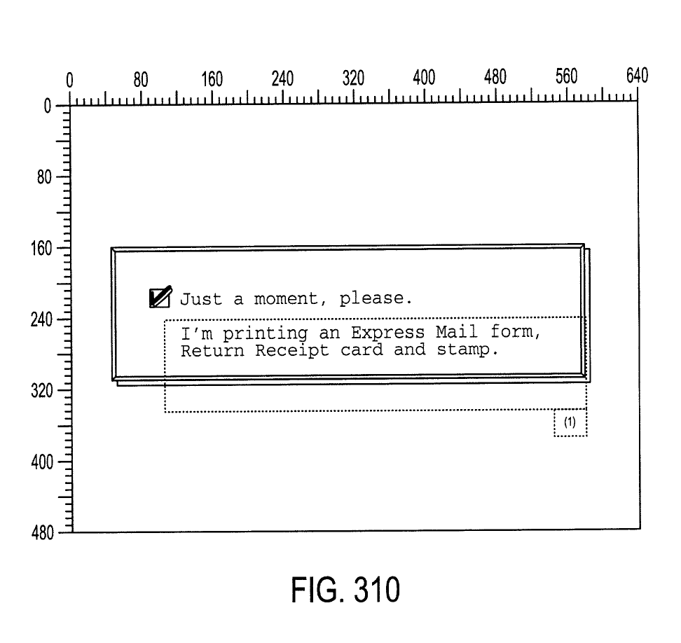

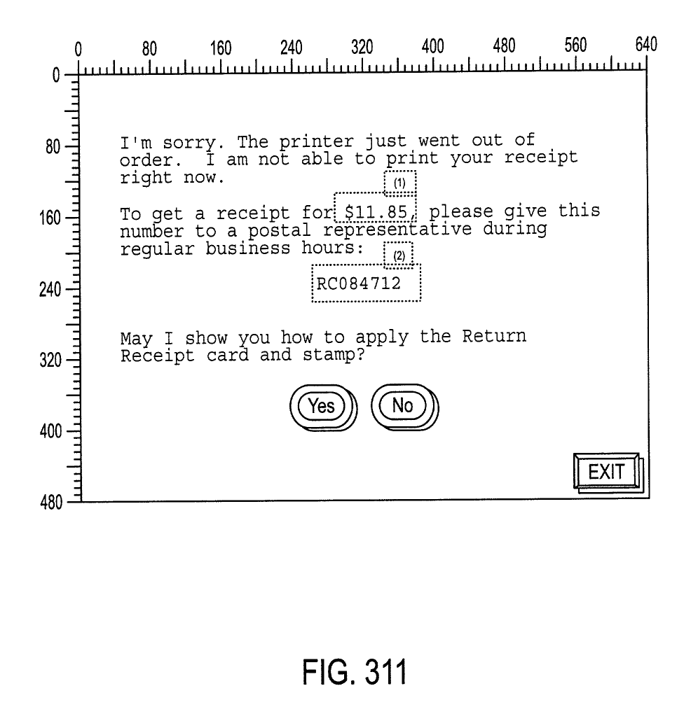

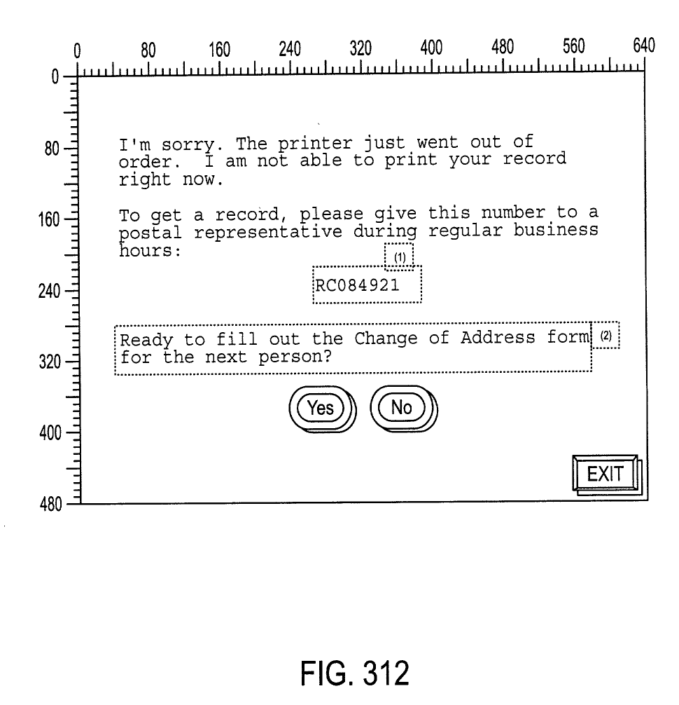

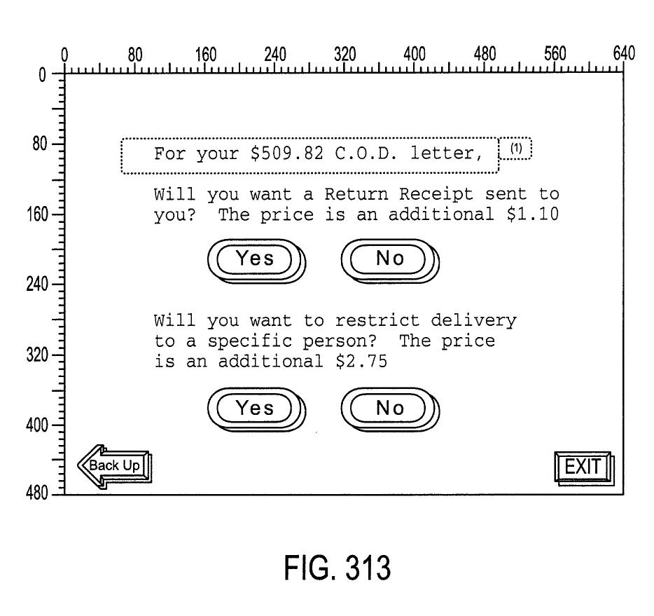

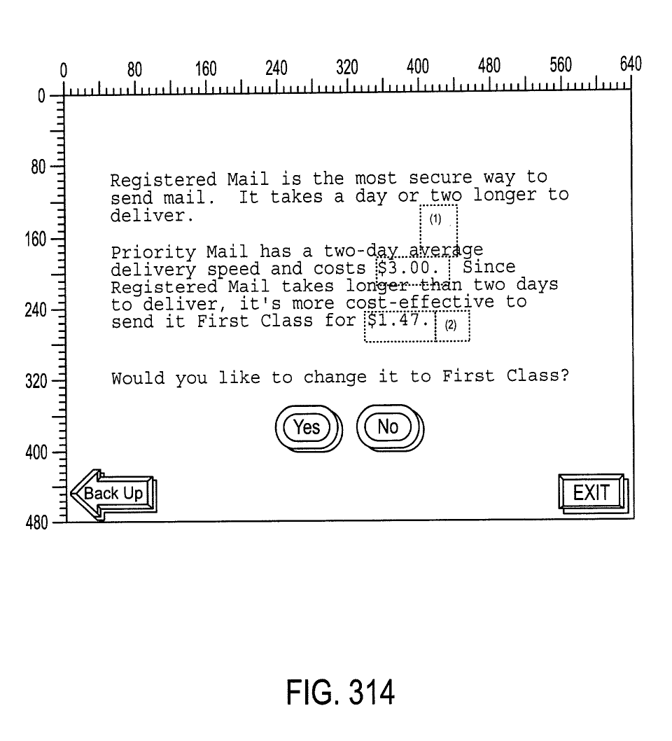

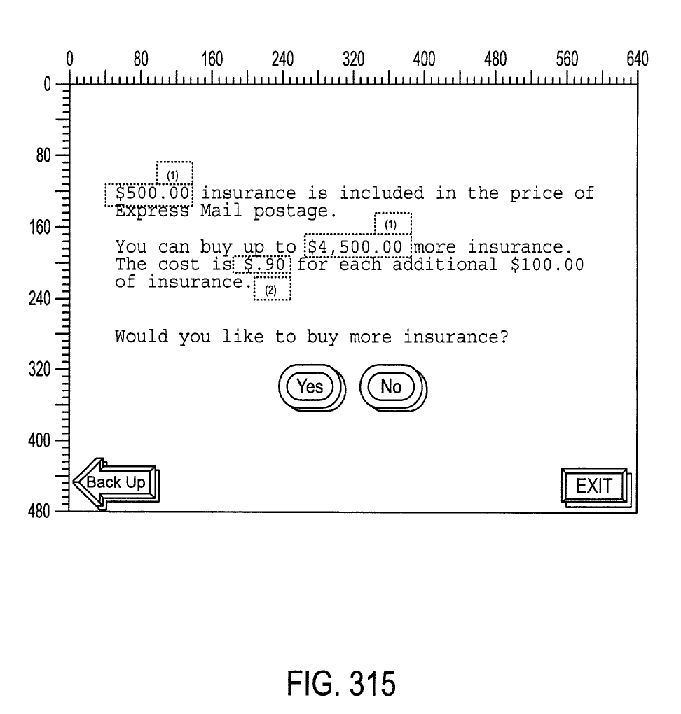

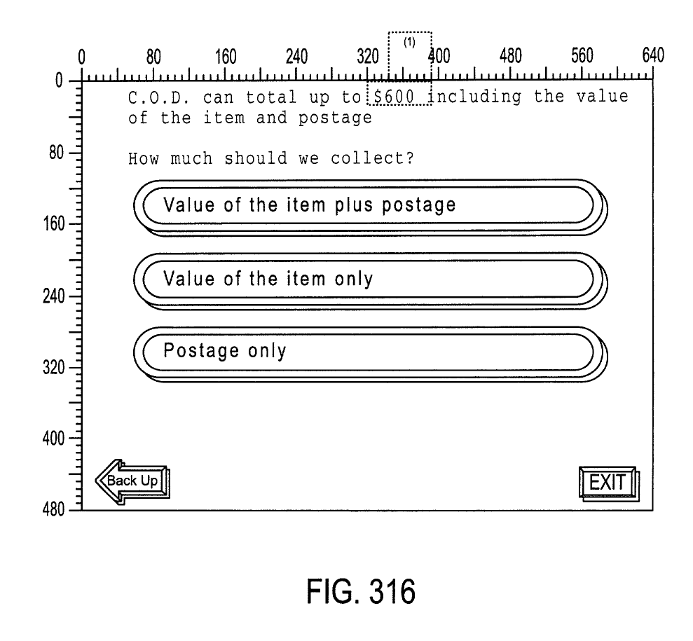

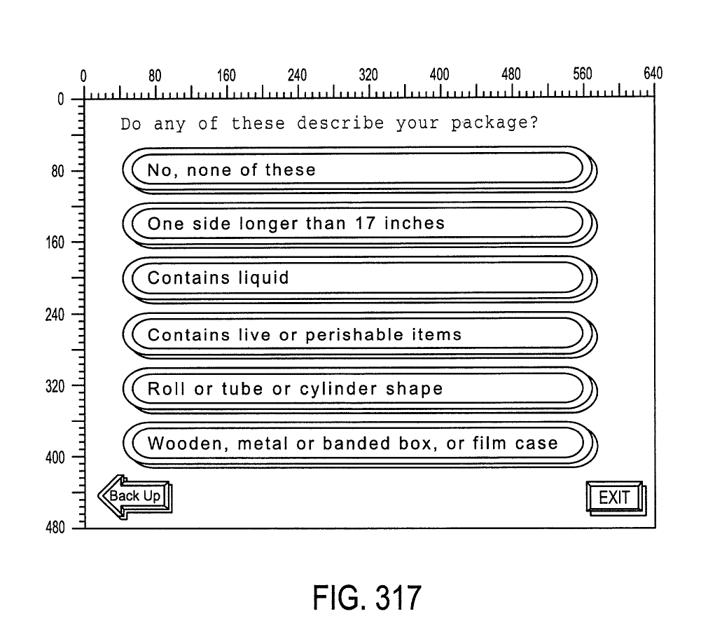

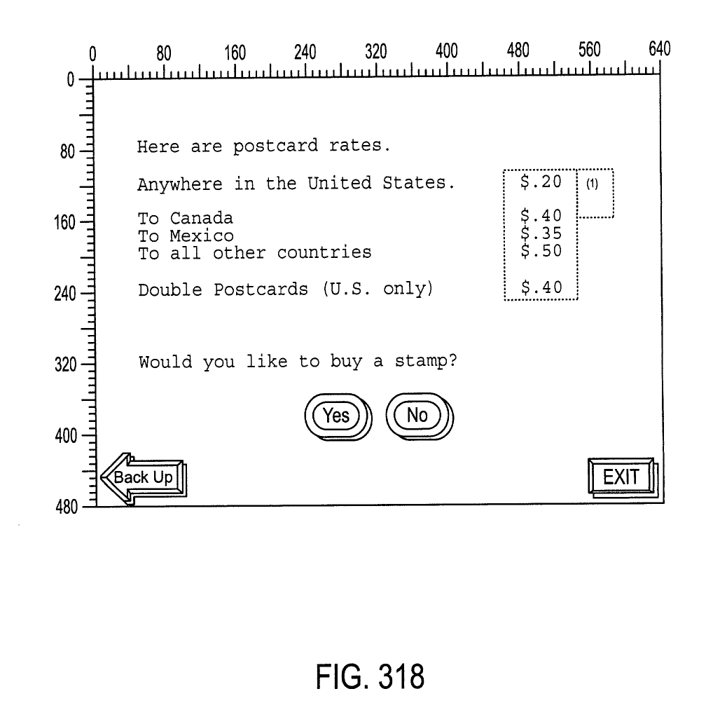

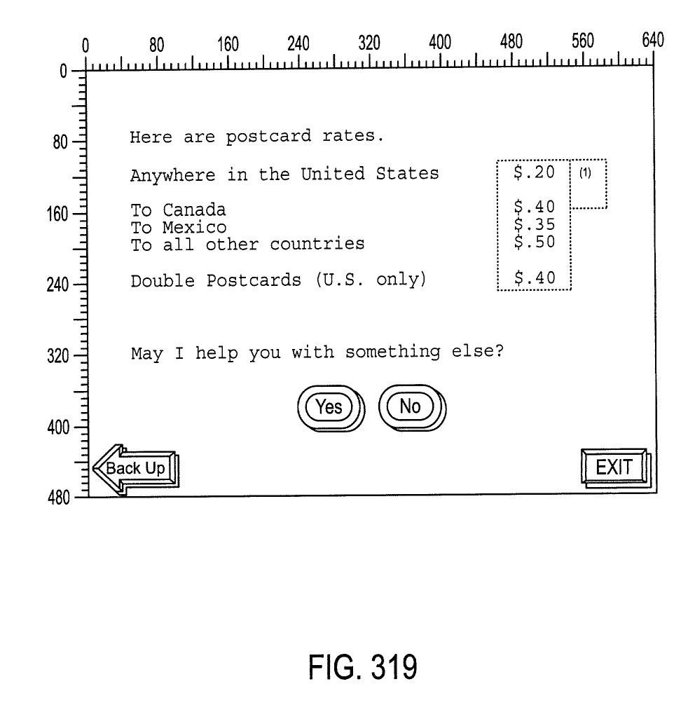

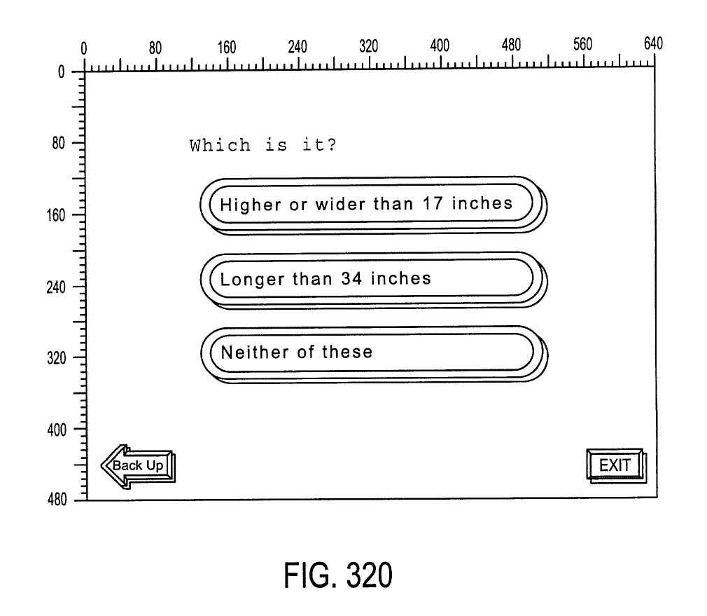

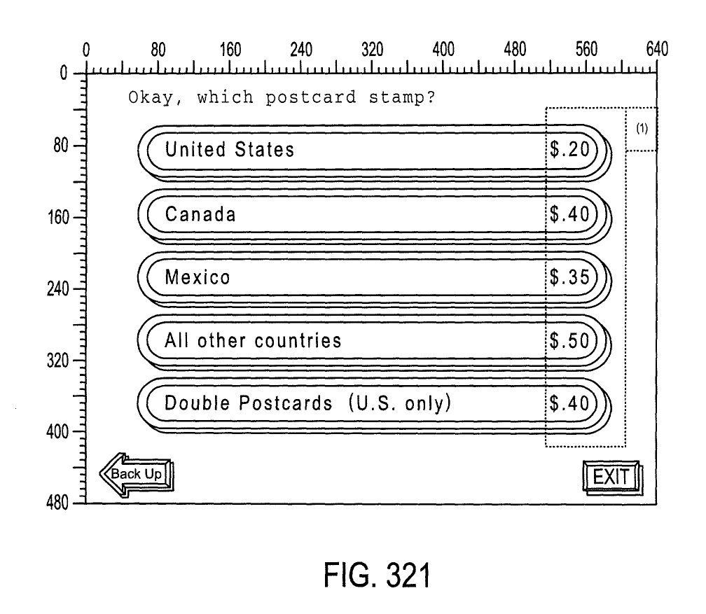

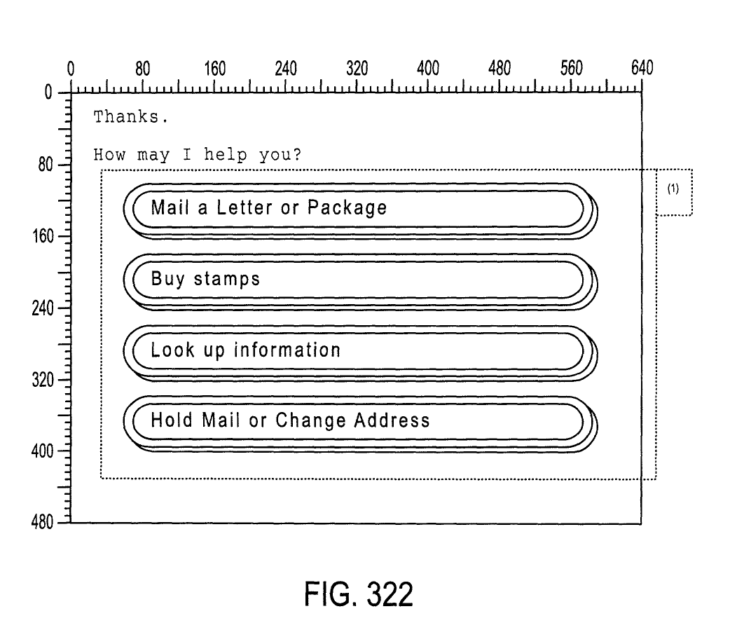

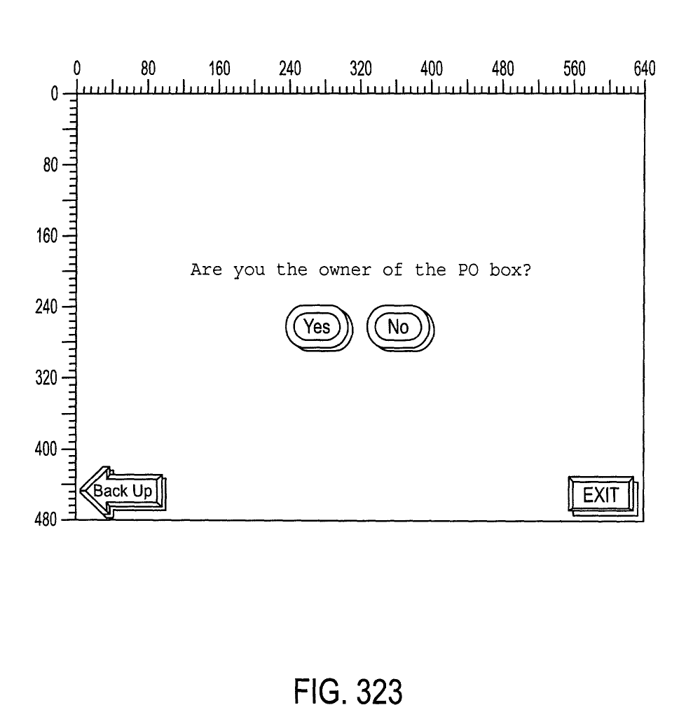

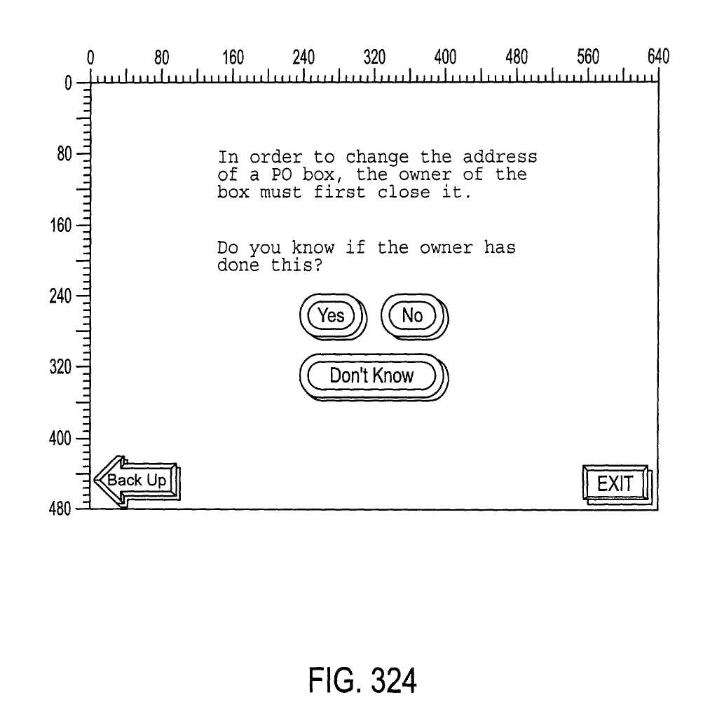

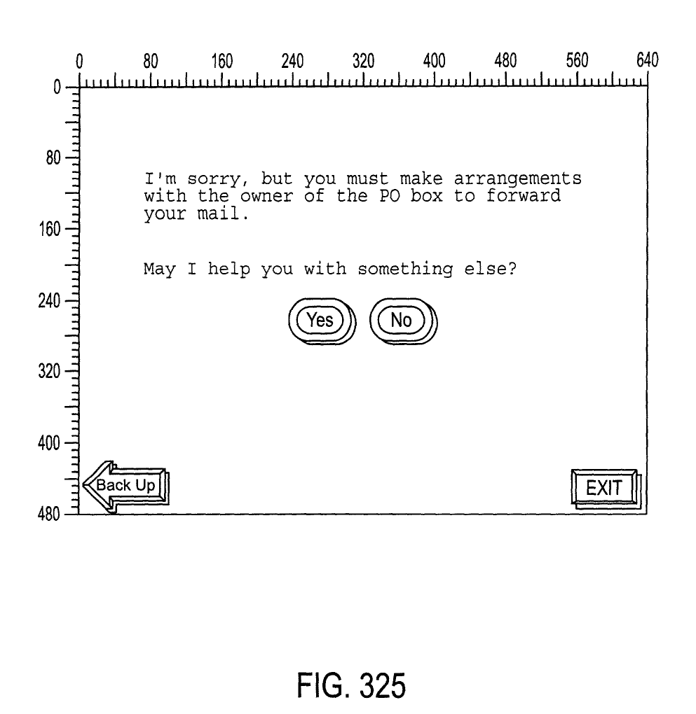

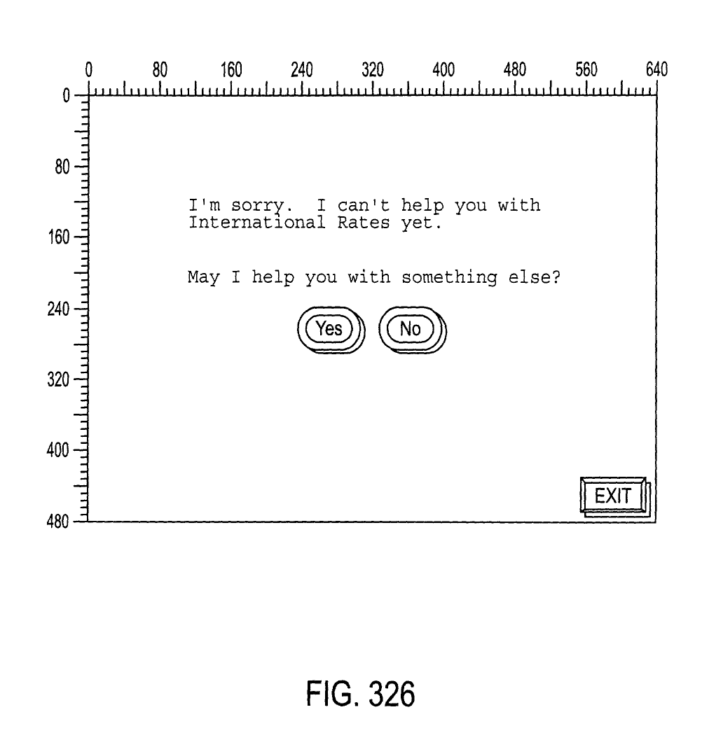

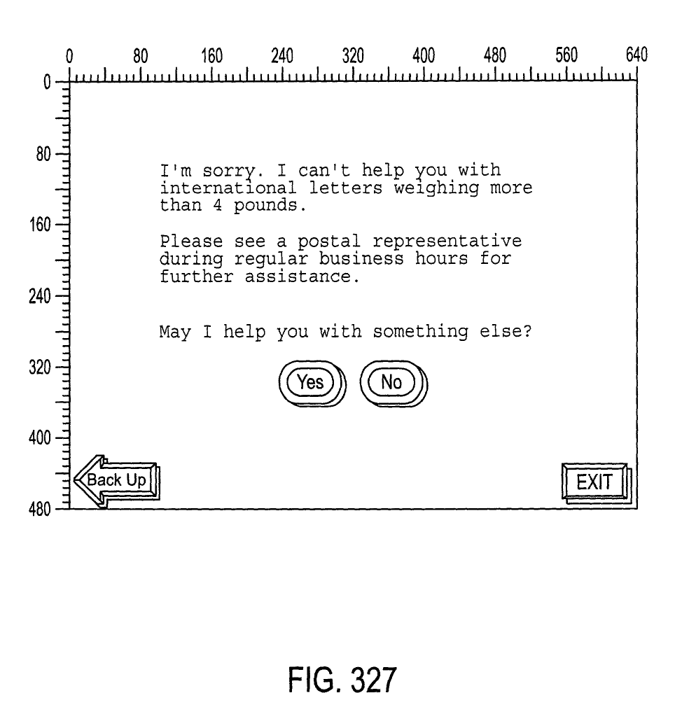

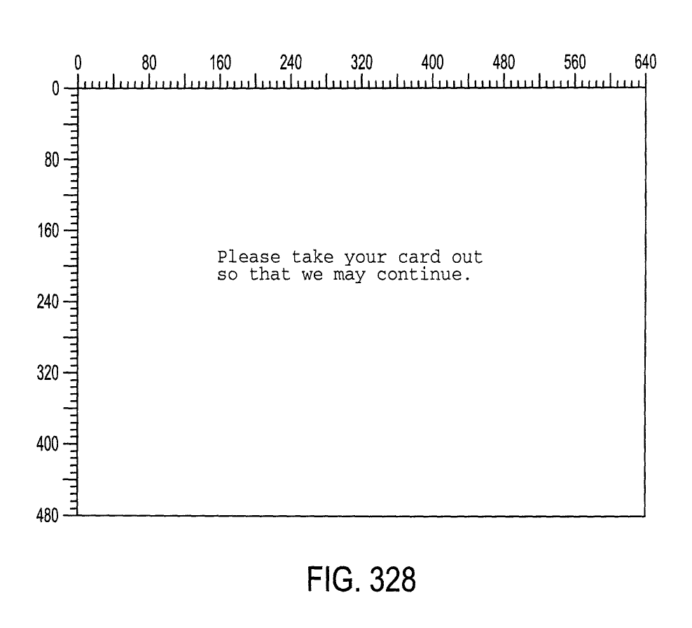

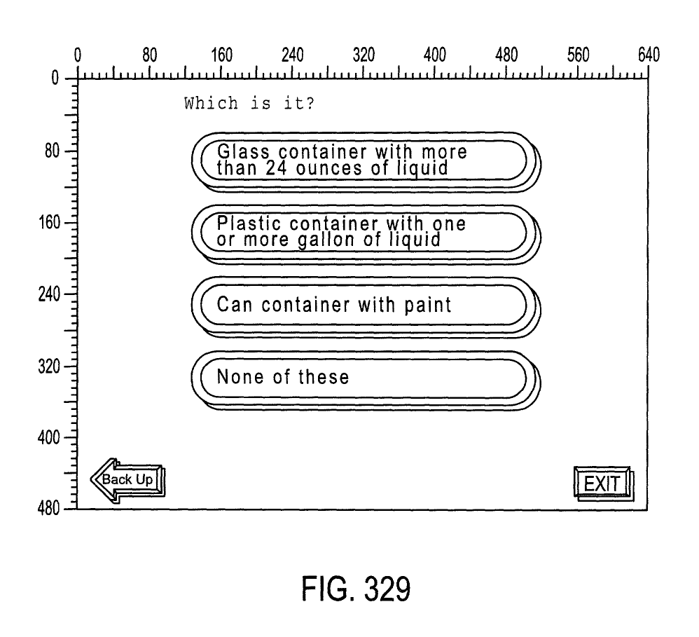

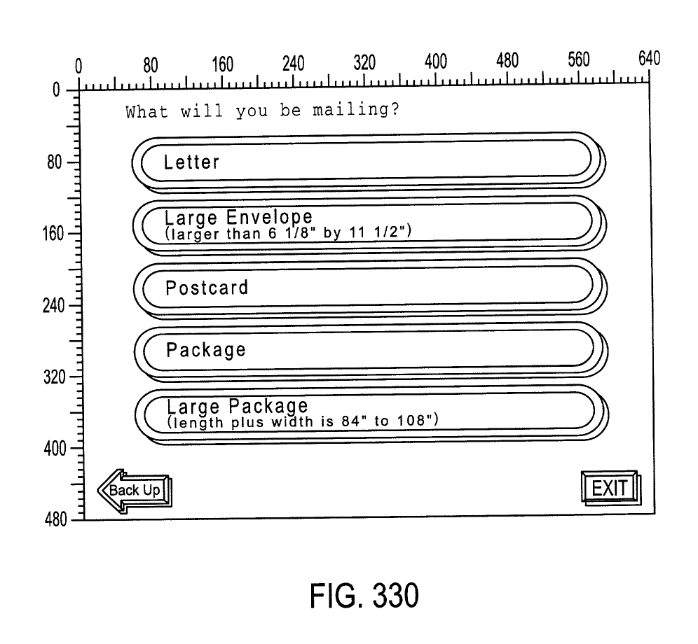

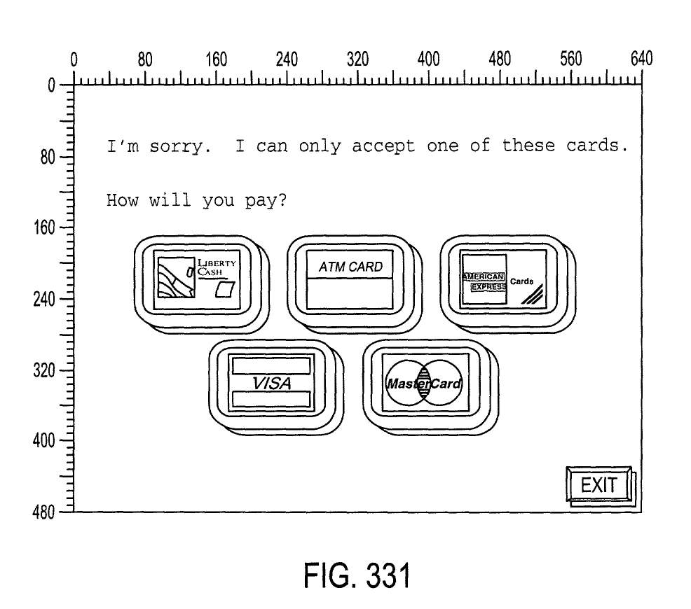

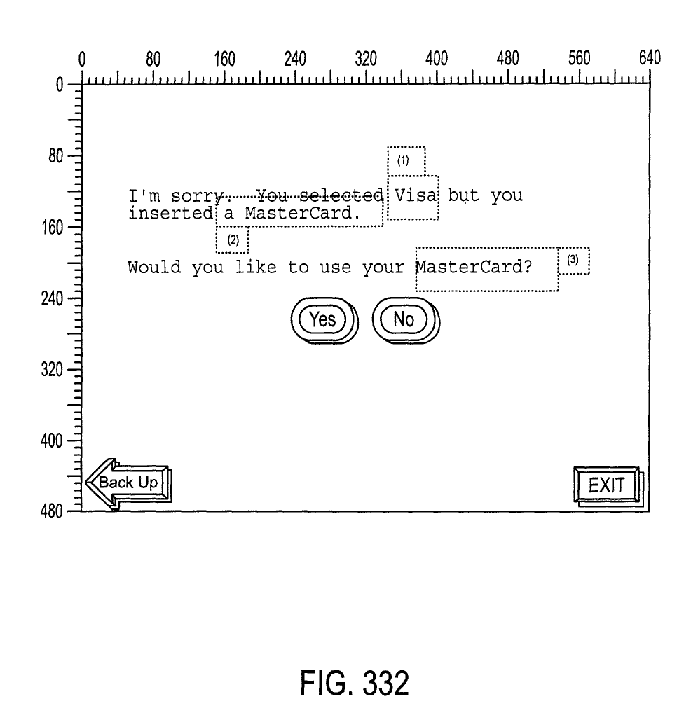

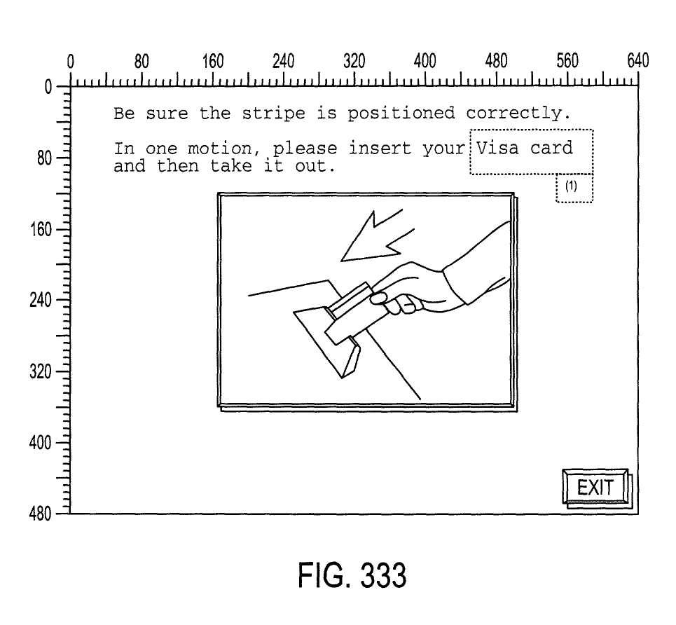

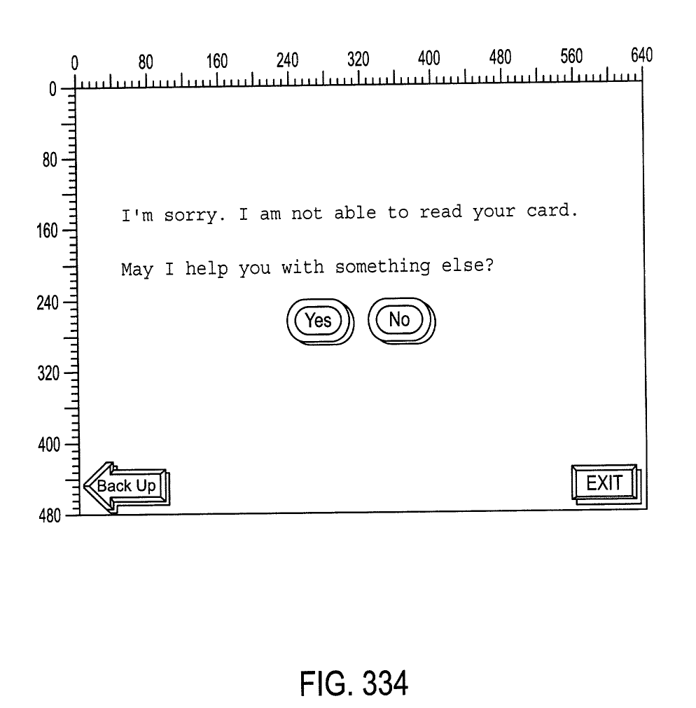

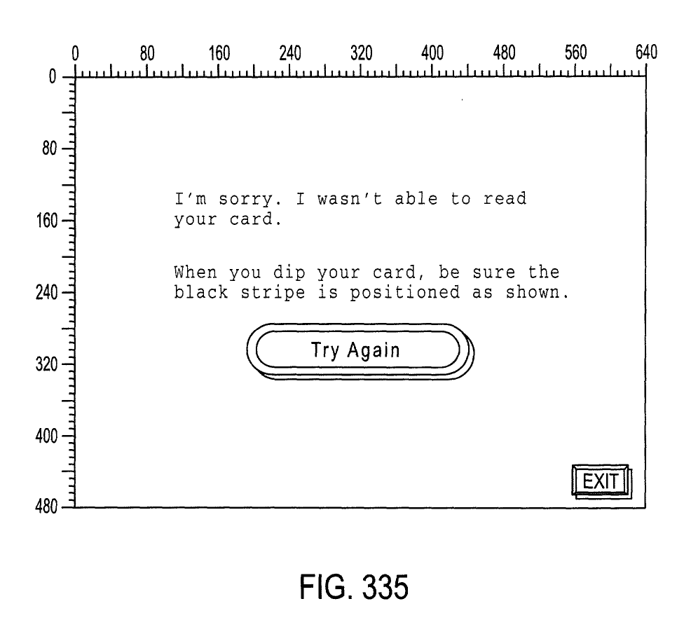

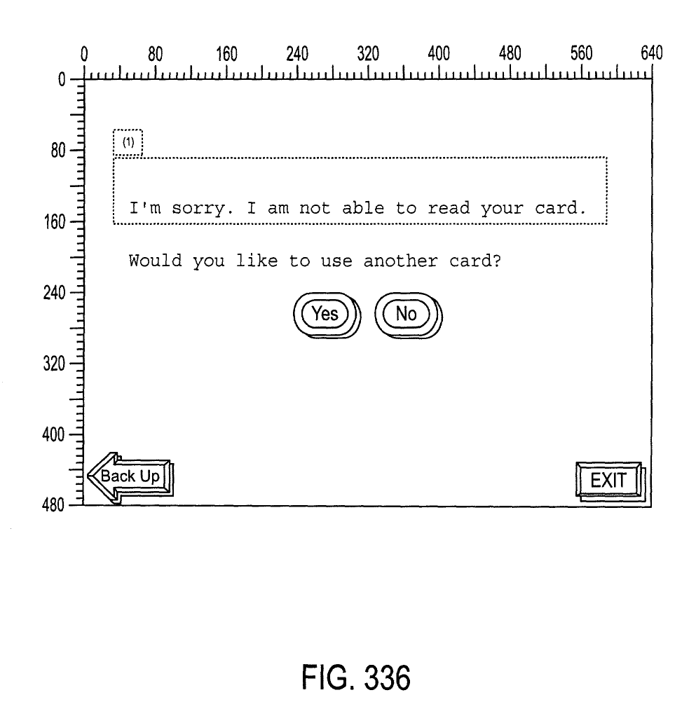

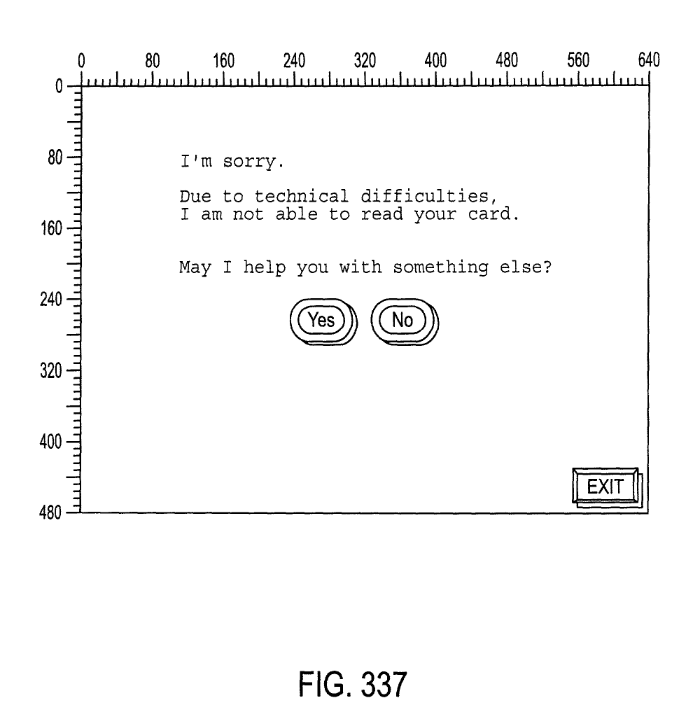

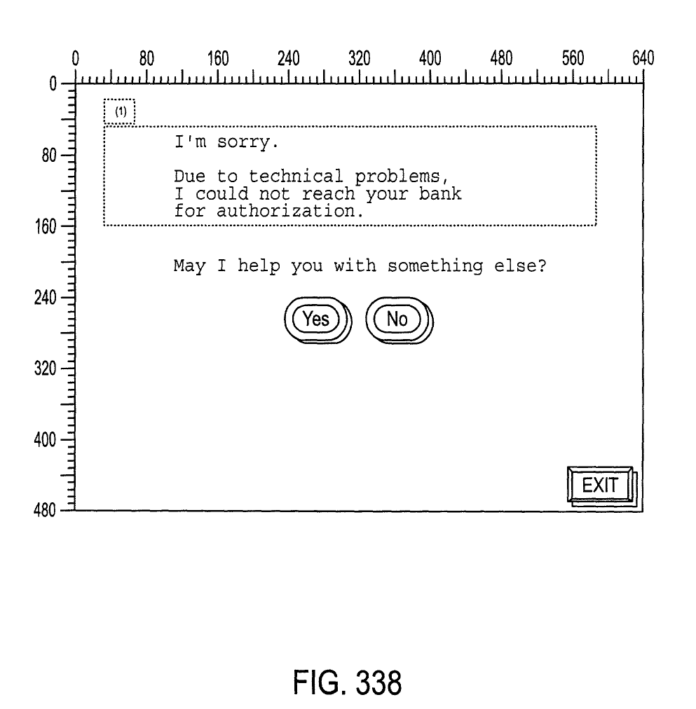

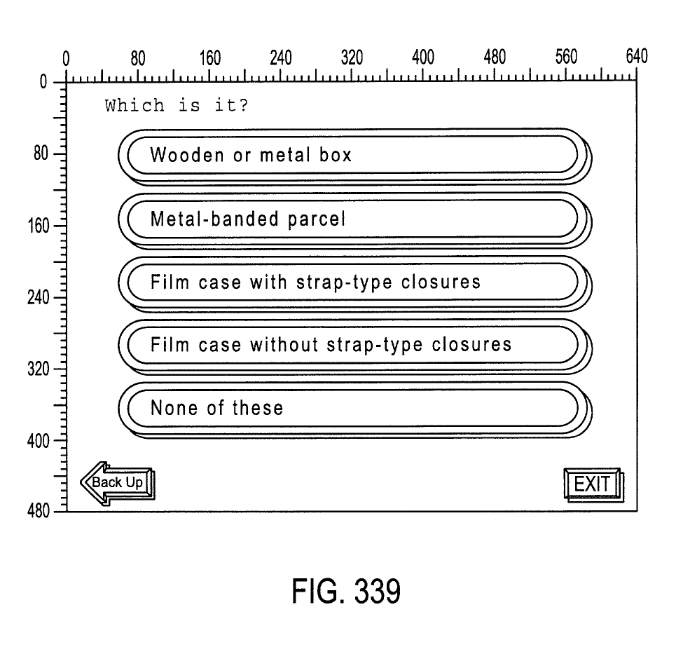

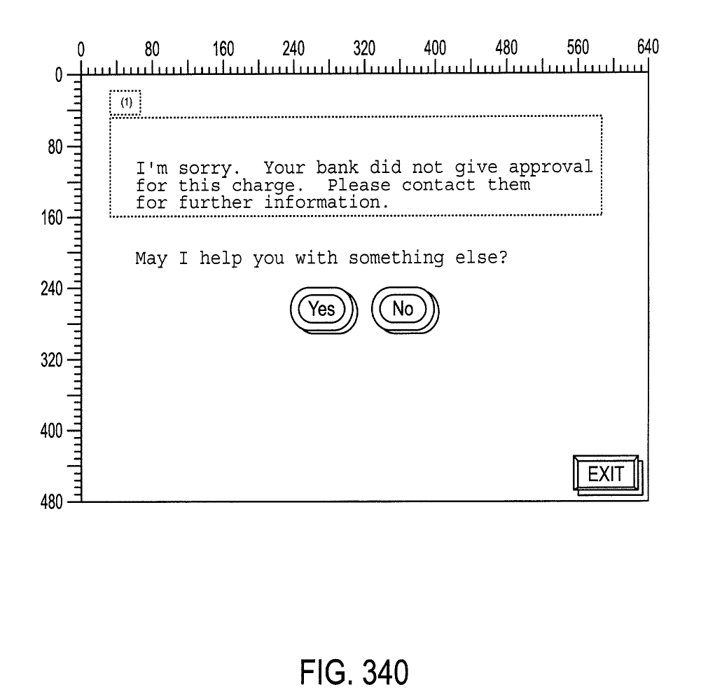

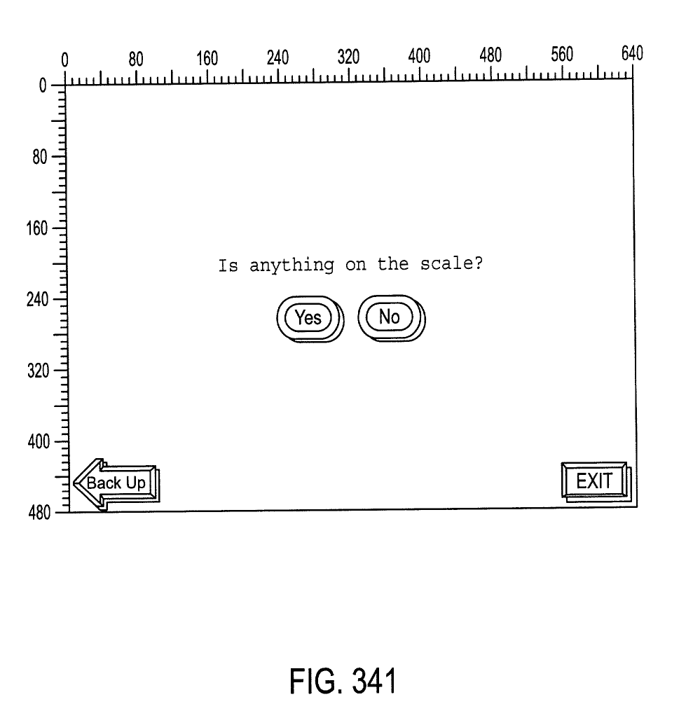

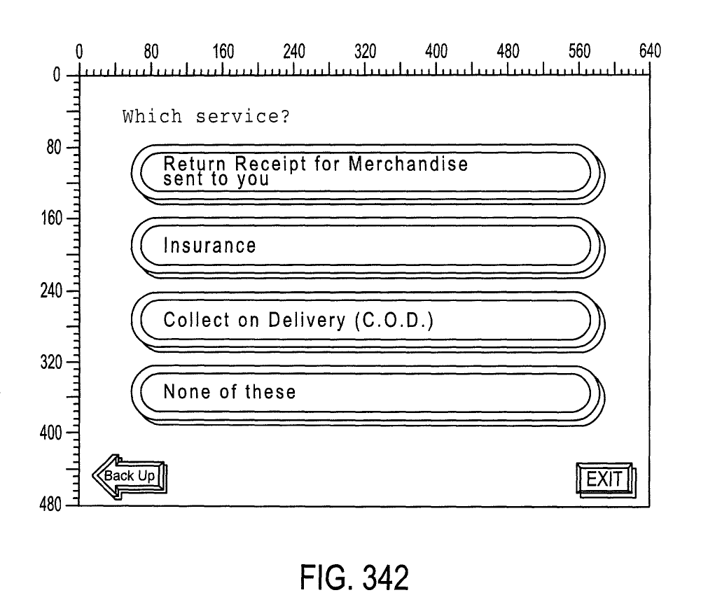

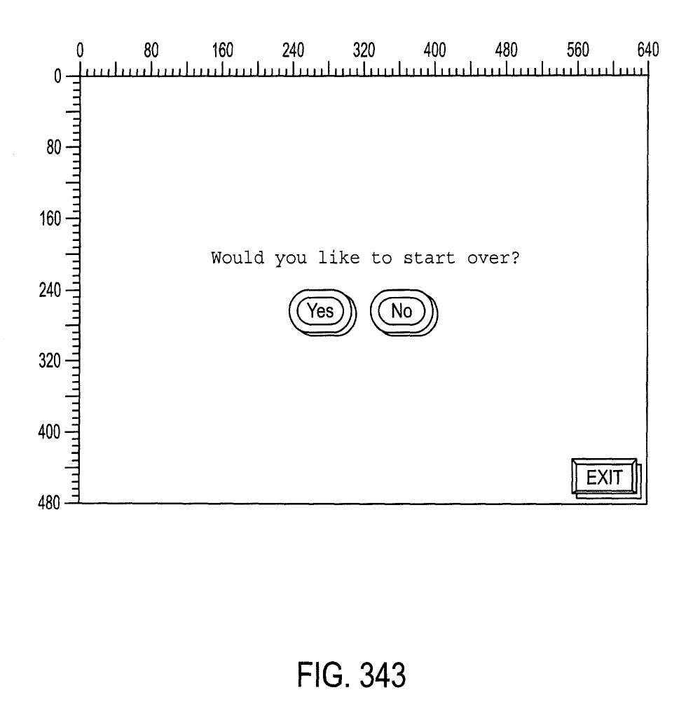

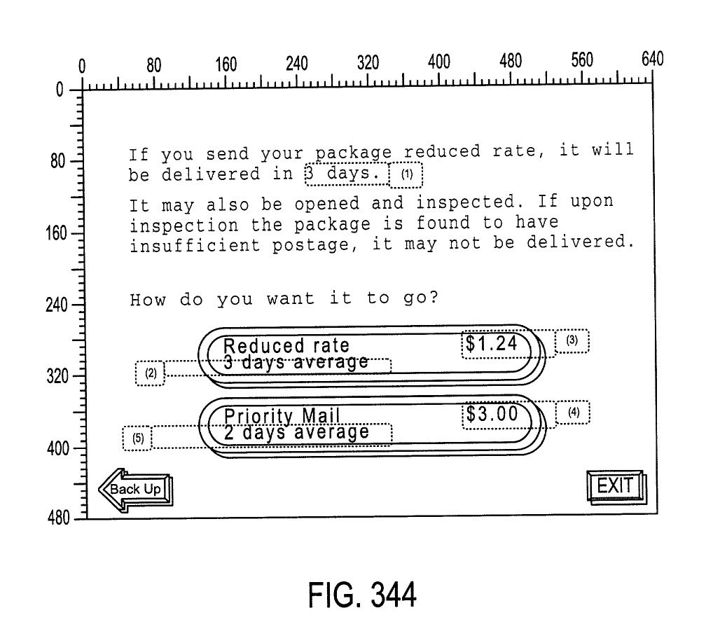

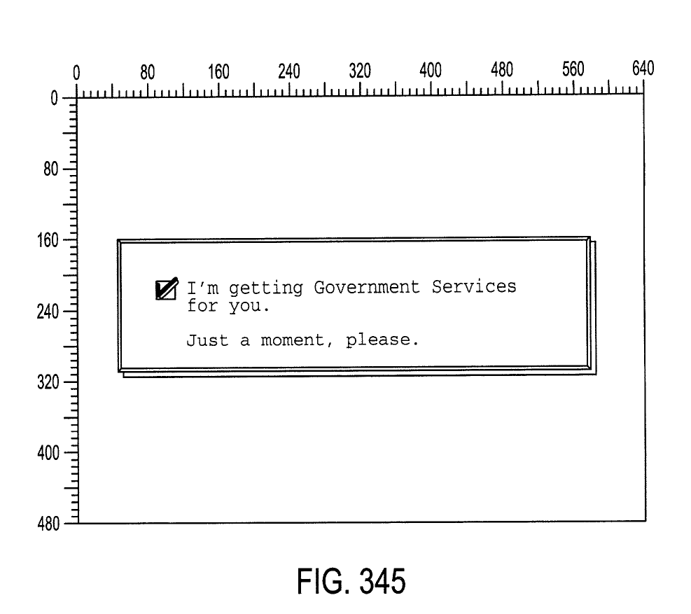

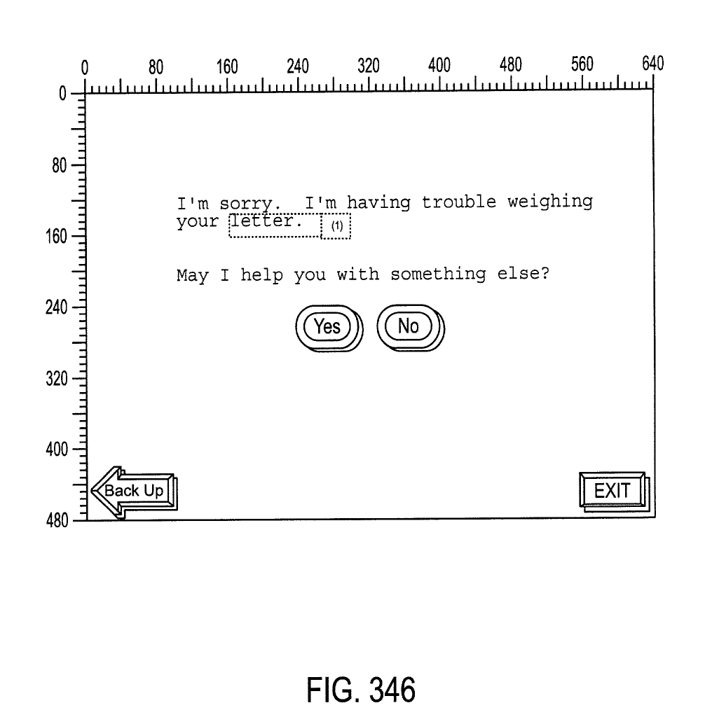

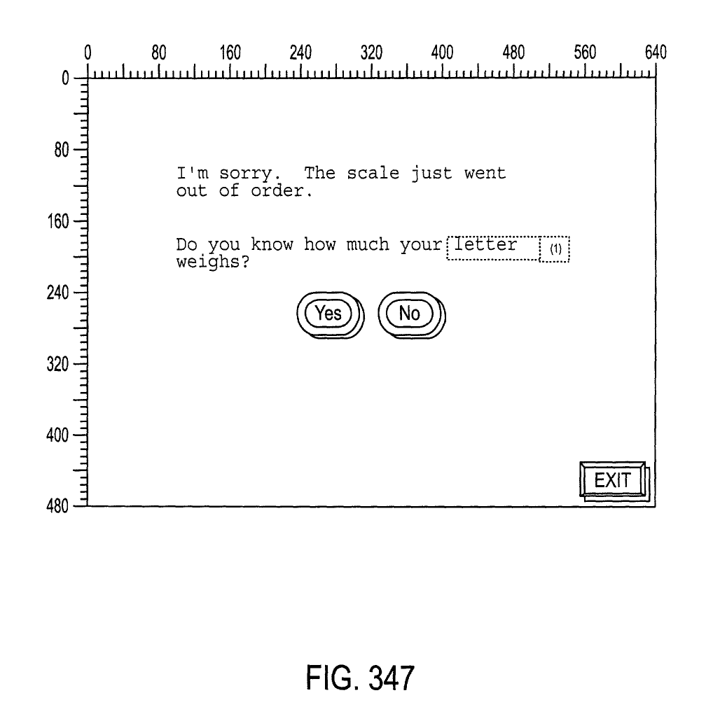

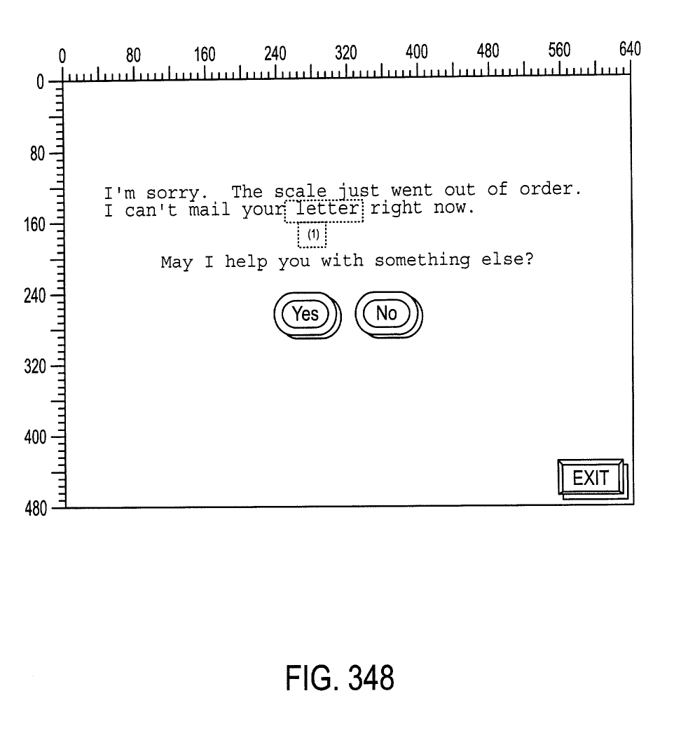

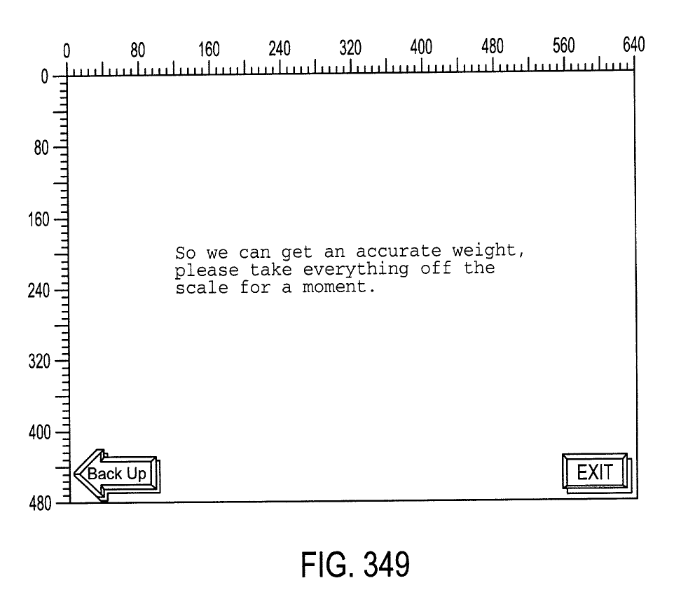

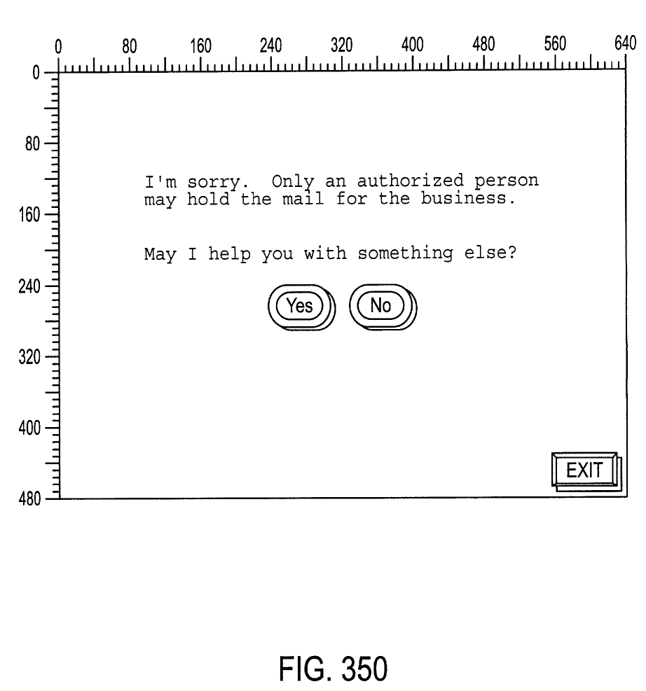

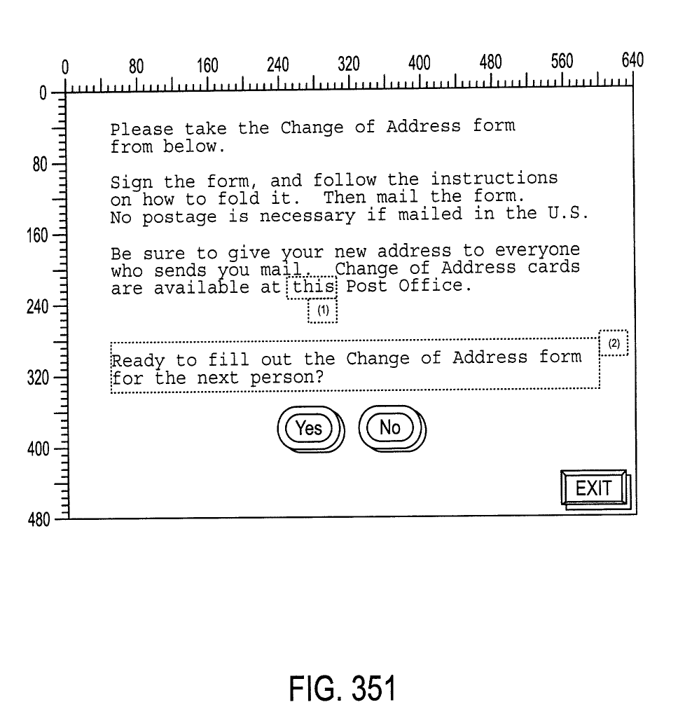

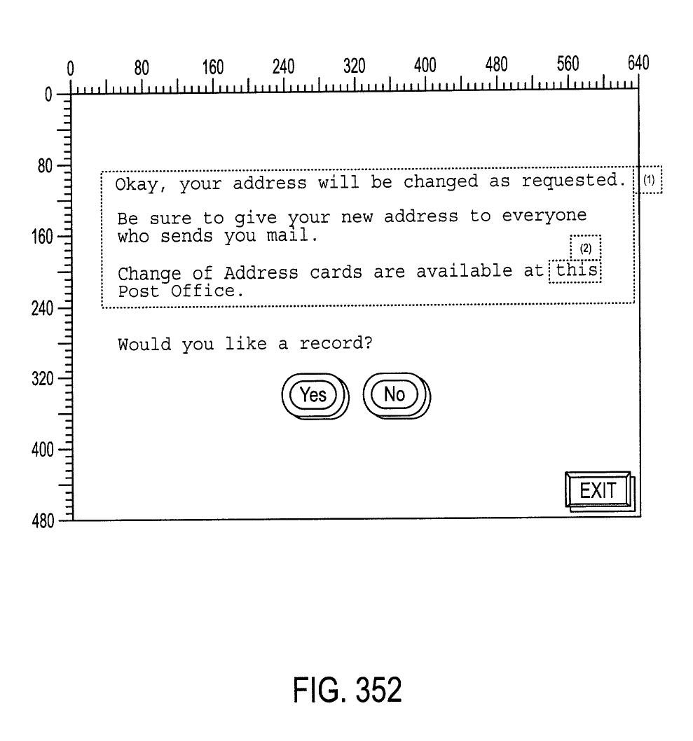

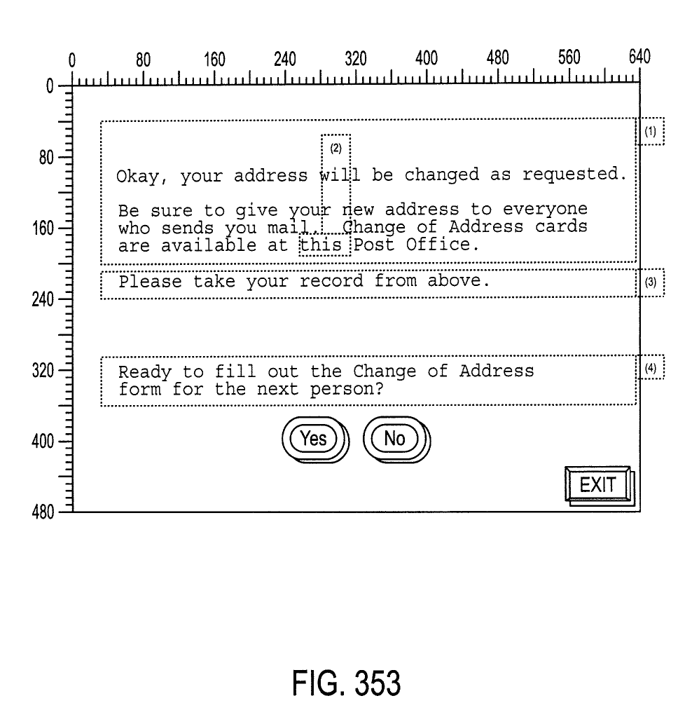

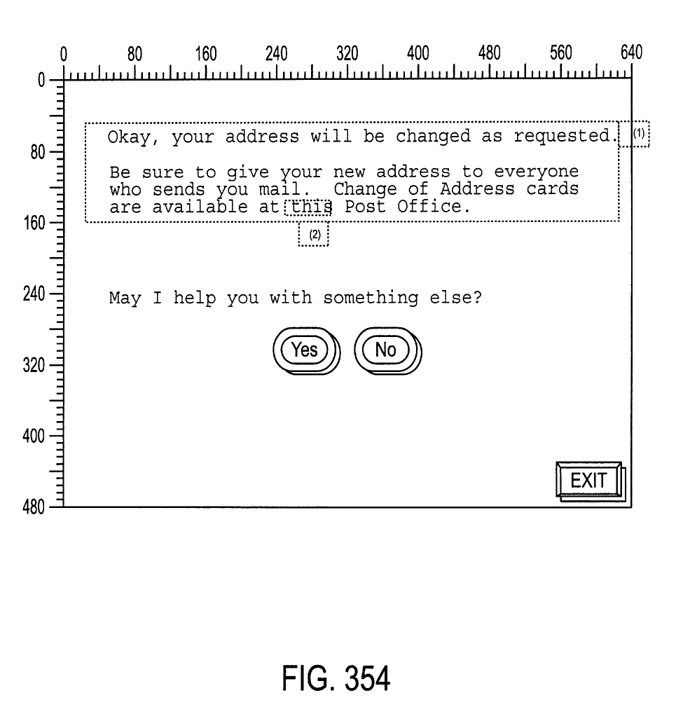

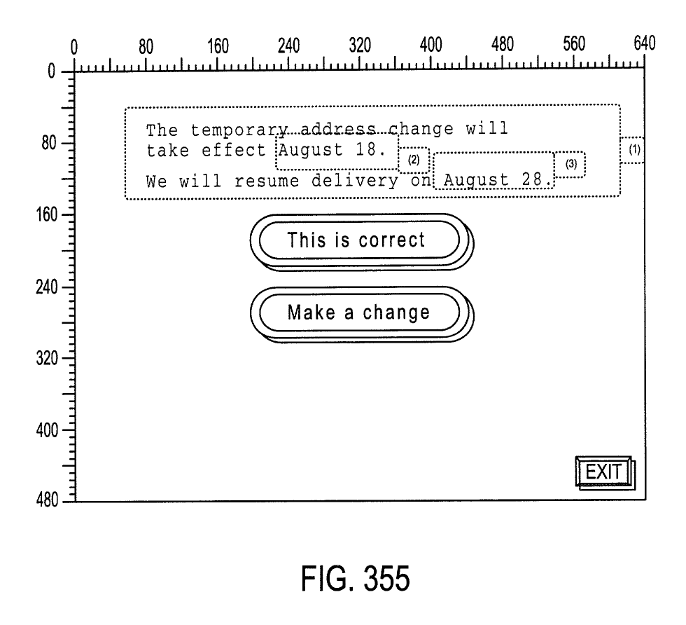

FIGS. 128-371 show detailed user screens for the postal embodiment of the present invention.

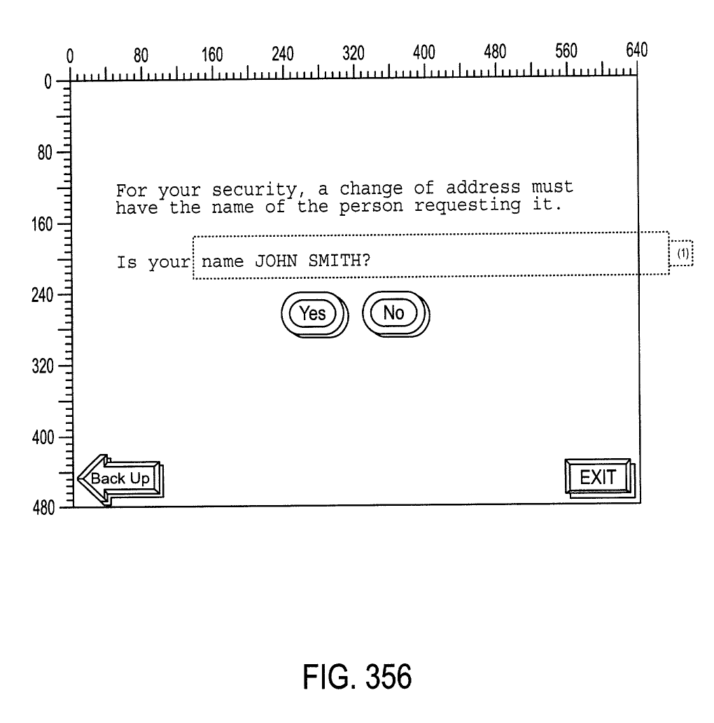

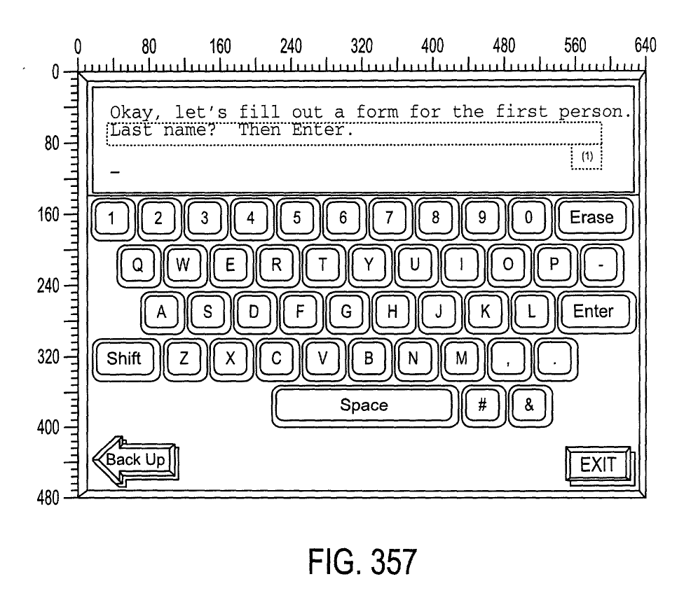

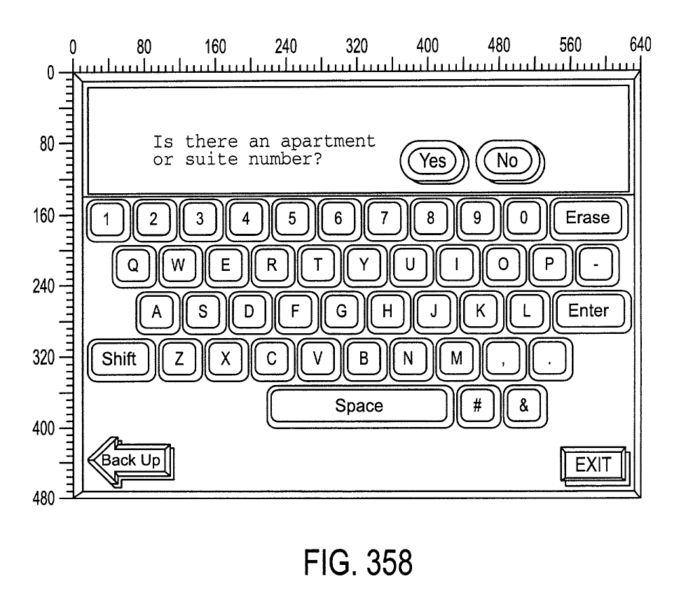

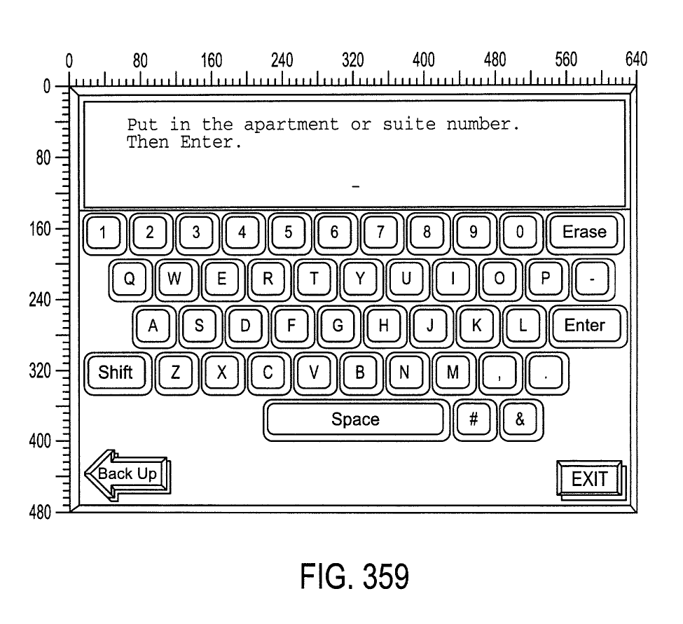

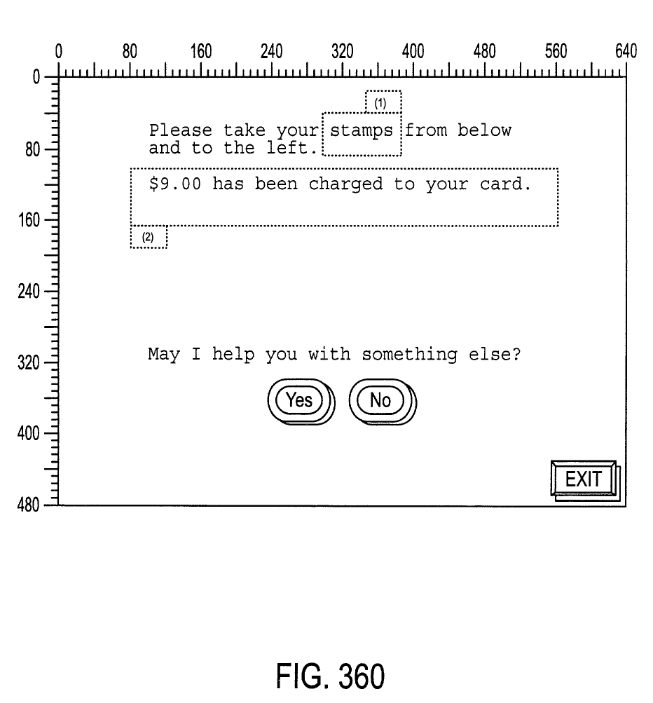

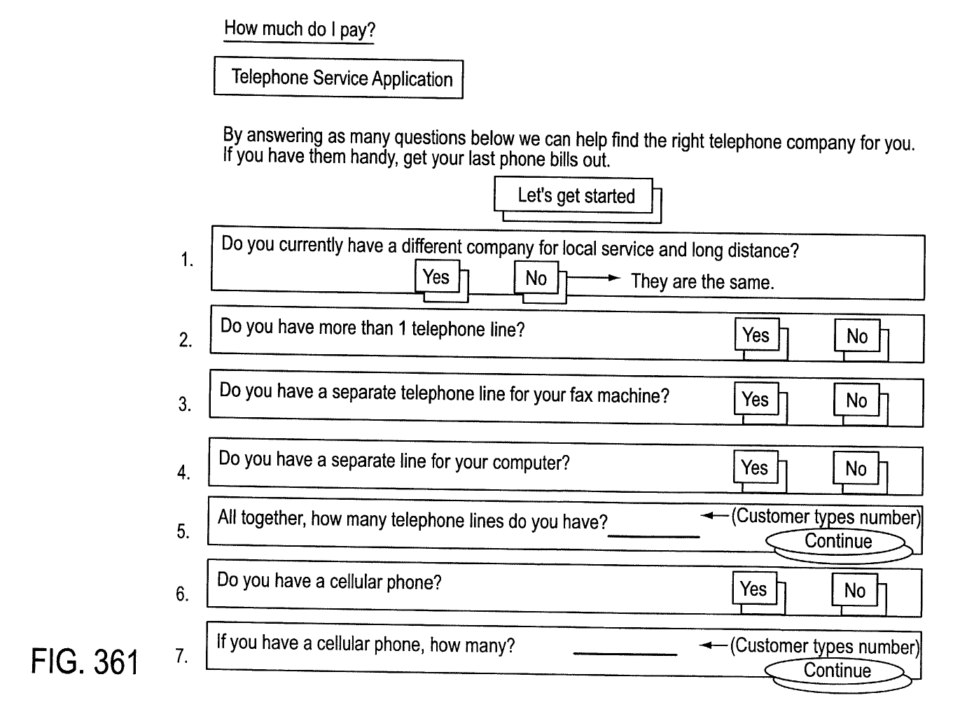

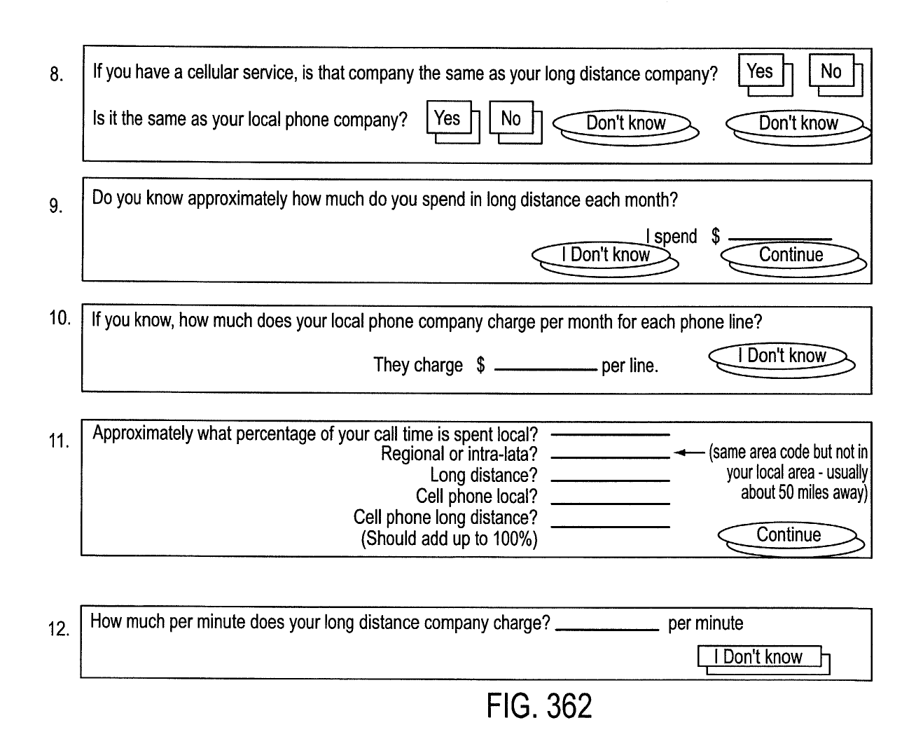

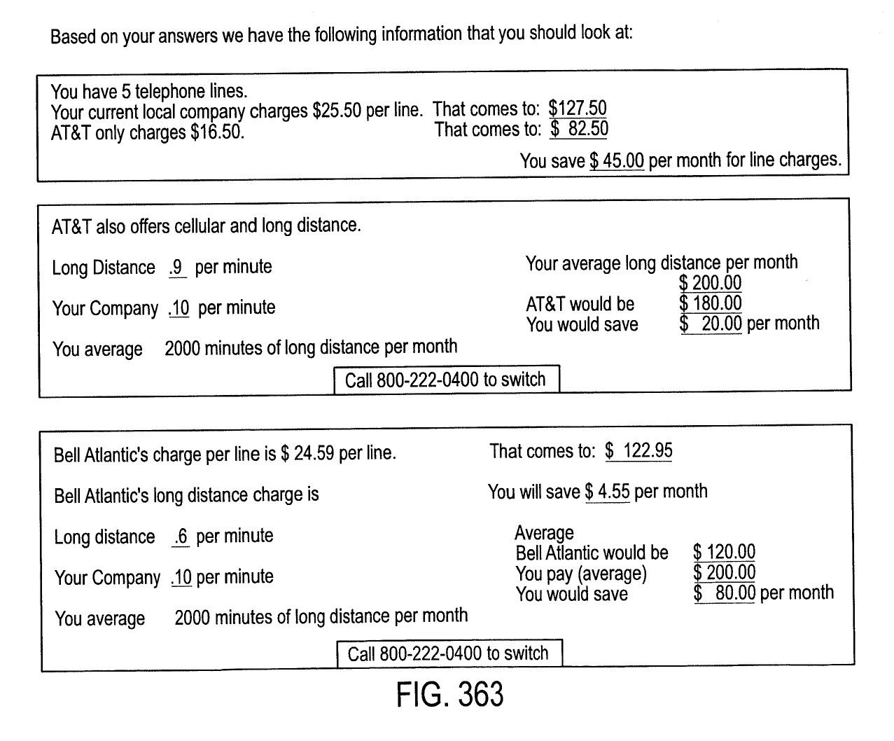

FIGS. 372-374 show an example of the telephone service application of the system of the present invention.

### DETAILED DESCRIPTION OF INVENTION

This invention relates to a system and method for advising consumers how much to pay for goods and services by matching consumers' specific objective needs for product or service characteristics as well as subjective needs, such as certainty, closure, security, style or brand. In particular, this system and method provides an interactive method of providing this advice, information, referral and transaction capability in a step-by-step intuitive manner over an on-line network.

The system of the invention can be used for the purchase of any good or service. In one aspect of the system, the system through a terminal, such as a personal computer, kiosk, telephone, telephone/computer combination, postal meter/computer combination, or other electronic device, guides the consumer thorough a needs analysis by presenting simple questions about the consumer's purchasing needs on a step-by-step basis. It is further appreciated that the system can be deployed as a two-terminal system whereby the staff member of the service provider and the consumer each have their own terminal. In such an embodiment, either the staff member or the user can input the information, and both can view the menu-driven system to identify which services or goods the consumer should select and what price to pay. See U.S. Pat. No. 5,245,535.

The system guides the consumer through a simple step-by-step interactive process to determine both the consumer's needs for particular product characteristics and the consumer's needs for particular subjective criteria such as immediate availability or certainty of specific features. The consumer, in turn, inputs the answers to these simple questions. It is appreciated that the system can interact with the consumer by means of data transmission of screen displays or by interactive voice response. It is further appreciated that the system can be deployed as a two-terminal system whereby the staff member of the service provider and the consumer each have their own terminal. In such an embodiment, either the staff member or the user can input the information, and both can view the menu-driven system to identify which services or goods the consumer should select and what price to pay.

For example, the system simply asks the consumer as a first question whether he or she knows exactly what he or she wants to buy. If the consumer answers yes, then the system immediately suggests the range of purchase prices for the particular good or service, notes the trade-offs at each range of purchase price, and asks if the consumer wants to bid in an “auction” or purchase outright from an available inventory. In a preferred embodiment, the system then hotlinks or transfers the consumer directly to the provider's or auction merchant's site. If the consumer does not know what he or she wants exactly, then the system walks the consumer through a series of questions to narrow down the field of goods or services, plus identify the consumer's own purchasing criteria. Based on an analysis of the consumer's needs and access to available data on the goods and services, the system generates options, recommendations, and referrals to providers of the goods and services.

One embodiment for advising a consumer how much to pay for goods and services is one in which a user terminal accesses a host computer via an online network. The host computer has a resident program to display purchasing choices to the user. The algorithm powering the program is established to respond to subjective choices for the purchase of goods and services. It in effect mimics the consumers' decision making process. The decision making process is intuitive and interactive. The consumer is queried and responds. A decision tree leads the consumer to a logical conclusion.

The kinds of decisions that are prompted are price, delivery time, quality, brand preference, and the like. After helping the consumer quantify his buying criteria the system then generates at least one option, or recommendation, or referral to a source of supply. It also gives pricing information. The resulting information is presented to the user for their reference or action such as connecting to a supplier of the goods or services.

The types of goods and services that can be bought using this system are limitless. Examples in clued groceries, office products, computers, financial service products, insurance, cars and household items.

Another level of analysis is need based. Part of selling is assisting customers to determine their needs. The interactive consumer process elicits information on a subject matter to help the consumer in his decision making. An example is the purchase of a car. It may be an impulse purchase but the range of option can be narrowed by identifying price range, on-road versus off-road usage, truck versus passenger car, highway versus city use, normal occupant load, annual mileage, etc. In time, all personal data collected creates a profile that can include annual income, age demographics, family size and spending habits to profile the consumer and aid him in his decision making. In effect, we are modeling the personality of the consumer to best advise him on his purchases.

After the customer has responded and his profile reviewed the system can then offer selections. The consumer will then be connected with sources of supply to fulfill their purchasing decision.

The invention provides a system for advising a consumer how much to pay for goods and services comprising:
a user interface for allowing a customer to access a host computer via an on-line network,
a host computer which solicits a consumer's objective and subjective criteria for the purchase of goods or services in an interactive, intuitive manner,
wherein based on the consumer's needs and access to available data on goods or services, the system generates at least one of options, recommendations, referrals to providers of goods or services, and prices of goods or services,
presenting information to the customer.

In the system according to the invention, the goods to be purchased may be selected from groceries, office products, computers, financial services products, insurance, mailing services, travel services, cars, and household items.

The invention also provides a system for advising a consumer how much to pay for goods and services comprising:
a user interface for allowing a customer to access a host computer via an on-line network,
a device for collecting information from the customer regarding desires related to the purchase of goods or services,
a device for receiving the customer selection of at least one component regarding the purchase of goods or services, a device for performing a needs analysis based on information collected,
recommending at least one of the available options, recommendations, referrals to providers of goods or services, and prices of goods or services based on the needs analysis, and
presenting information concerning goods or services information to the customer.

Alternatively, the invention provides an integrated system for determining how much a customer should pay for goods or services comprising:
assembling a personal profile that includes means for collecting salient data,
building an integrated customer account relating to the purchase of goods or services including customer data relating to the purchase of goods or services;
receiving a customer selection of at least one component of the integrated customer account;
performing a needs analysis based on information collected;
recommending goods or services based on the needs analysis;
presenting information concerning the selected component of the integrated customer account relating to the purchase of goods or services to the customer; and
allowing data collected to flow to all other points where the data is required so that data need not be entered more than once.

In one embodiment the system, the system includes means for generating multiple prompts for certain pieces of data such that the user may exercise personal judgment concerning the appropriate time to collect such data. The system may include a pending file means for storing information that is collected, but not immediately needed. Each component of the integrated customer account relating to the purchase of goods or services includes data fields and the system further comprises the ability to transfer data between the data fields and the ability to enter data fields in different components that are related such that data entered in one data field can be copied into other related data fields.

The system may optionally include means for building the integrated customer account relating to the purchase of goods or services which comprises means for building a credit card account component, a line of credit account component, or a secured credit account component.

The system of the invention may incorporate a device or means for displaying a representation of a statement or invoice connected to the software for building the customer account relating to the purchase of goods or services, whereby as the account is built the representation of the statement or invoice is updated.

The invention also provides a method of providing an integrated system for determining how much a customer should pay for goods or services, comprising:
opening a customer account that permits a customer to establish a plurality of components relating to the purchase of goods or services, the customer account having a time of opening;
creating a personal profile including substantially all demographic and financial data about the customer at the time of opening;
accessing the profile so that only unknown data is requested from the customer in the establishment of each of the plurality of components relating to the purchase of goods or services;
receiving a customer selection of at least one component relating to the purchase of goods or services of the customer account;
performing a needs analysis based on the personal profile;
recommending a goods or services based on the needs analysis; and
presenting information concerning at least one component relating to the purchase of goods or services of the customer account to the customer. Based on the consumer's needs and access to available data on goods or services, the system may generate at least one of options, recommendations, referrals to providers of goods or services, and prices of goods or services.

In another embodiment the invention provides for a method of opening a customer account advising a consumer how much to pay for goods and services, comprising:
building a database containing a customer profile that includes demographic information and information relating to the purchase of goods or services;
performing a needs analysis based on information collected;
receiving a customer selection of at least one component relating to the purchase of goods or services;
recommending goods or services based on the needs analysis;
presenting information concerning at least one selected component relating to the purchase of goods or services to the customer;
updating the database to reflect the customer's selection of at least one customer account component; and
displaying an image of a representation of a statement, wherein the image reflects the customer's selection of at least one good or service.

The system of the invention may include means for updating the database to reflect the customer's selection of at least one product or service; and the ability to displayn image of a representation of a statement, wherein the reflects the customer's selection of at least one product or service.

Purchase of Goods

In one preferred embodiment of the system, the system includes a host terminal, a network system and an array of consumer terminals that can range from a personal computer, telephone, kiosk, screen telephone or any other information device. (FIGS. 1-3). The consumer terminal may also be configured as a two-terminal system, to be used at the point of sale. In this configuration, the sales person and the consumer may each have a display screen, whereby the system may or may not display a subset of the menus of the sales person's screen to the consumer's screen. This configuration enables the sales person to have additional sales instructions which the consumer need not see. In this configuration the sales person may input the data for the consumer. The host terminal solicits the consumer's objective and subjective criteria for the purchase of a good or service in an interactive, intuitive and step-by-step fashion. The system asks the consumer if the consumer knows what he is interested in buying (FIG. 5). If the consumer does not know, the system (FIG. 6) provides the consumer with an array of options including various goods and services. If, for example, the consumer knows that he wants to purchase a lawn mower, (FIG. 5), the system identifies the available lawn mowers. (FIG. 7). If the consumer wants more detail, the system presents more detail on the lawn mower that the consumer selects. (FIGS. 8-12). If the consumer wants to get help to identify the one he needs, the system helps the consumer identify his objective and subjective criteria for a lawn mower on an interactive step-by-step basis (FIG. 13). Based on the customer's input, the system displays options that meet the consumer's needs. (FIG. 14).

Airline Goods or Services

For example, in one aspect of the system, the consumer knows that he or she wants to travel to London. After ascertaining the consumer's choice of air travel to London, the system asks the following types of questions in a user friendly, step-by-step basis to help the consumer make his or her purchasing decision:
When does the consumer want to go.
How important it is for the consumer to go at that time or at all.
How important is it for the consumer to arrive at a specific airport in London.
Are there a range of dates that the consumer would consider.
What price range the consumer would consider.
What is the class of travel that the consumer would consider.

Based on the consumer's answers to these questions, and the access to the data bases of information on flights that the system is connected to, the system makes a recommendation of flights available, the price range of tickets, and the trade-offs associated with the various options. In addition, the system refers or transfers the consumer by hotlink, telephone forwarding, or otherwise to the recommended providers of the goods or services.

If the consumer wants to participate in an auction, then the system analyzes the data and gives the consumer a recommendation on what to bid, depending on the criteria that are important to the consumer. The system translates this complex array of information into a simple risk analysis with a numerical or other easy to comprehend system to guide the consumer in his or her purchase decision. For example, to advise a consumer on what price to bid on tickets to London, the system after analyzing the consumer's criteria and the data from the airlines, presents an array of options, such as the following:
If you bid $200, it is highly unlikely that your bid will be accepted.
If you bid $400, then there is a 50% chance that your bid will be accepted.
If you bid $600, then there is a 75% chance that your bid will be accepted.
If you bid $900, then there is a 90% chance that your bid will be accepted.
   In addition, in one aspect, the system generates advice, such as:
Given your absolute need to arrive in London Heathrow between 10 and 10:15 AM, my recommendation is to buy direct from British Airways at full posted price, because no other option has the certainty and precision to match your criteria. May I transfer you to British Airways now?

Furthermore, the system, for the convenience of the consumer, provides the ability to save the consumer's needs and criteria to facilitate completion of purchase at a later time. If the consumer elects to save personal needs and criteria, the system assures the privacy of the consumer's information. For example, in one aspect, the system would save the information on the consumer's terminal to ensure the consumer's privacy. If the consumer wants to be transferred to the service provider's site and to have his information transferred as well to avoid inputting the information a second time, the system asks the consumer for permission before transferring the data.

FIGS. 1-3 describe one embodiment of the system. It shows how consumers may access the “How Much Should I Pay?” service through a communications network through a variety of terminals such as a conventional telephone, screen telephone, kiosk or personal computer. The “How Much Should I Pay?” computers interact with the consumer by means of data transmission of screens or interactive voice response. The “How Much Should I Pay?” system collects information from the consumer and other databases that are also connected to a network, processes this information and makes recommendations to the consumer. If the consumer wants to act on the information, the “How Much Should I Pay?” system automatically transfers the consumer to the website or telephone service system of the providers. It is appreciated by those skilled in the art that there are many alternate embodiments of the invention.

Postal Goods and Services

Another embodiment of the invention is a system for helping users (both Postal Workers and Consumers) decide what postal service is appropriate based on the consumers objective and subjective criteria for mailing a letter or package. The electronic interactive system helps users identify which postal services meet their objective needs, such as size of package, and the subjective needs of speed, ability to mail outside a post office, certainty and closure. See FIGS. 16-371.

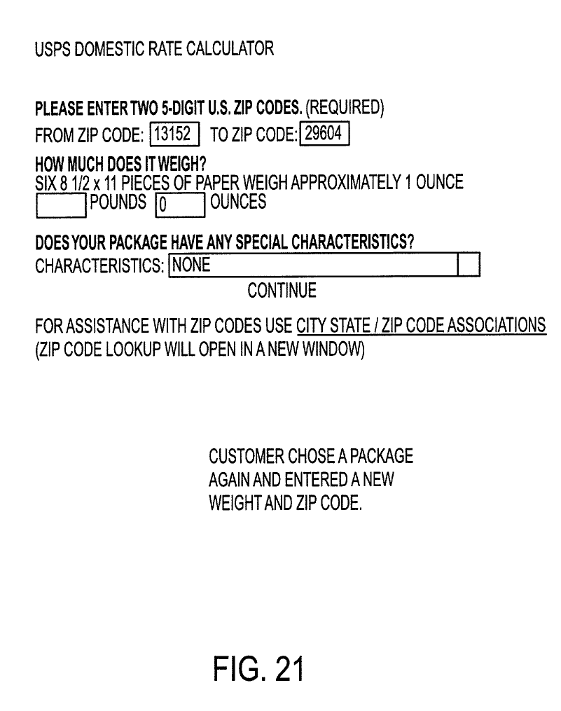

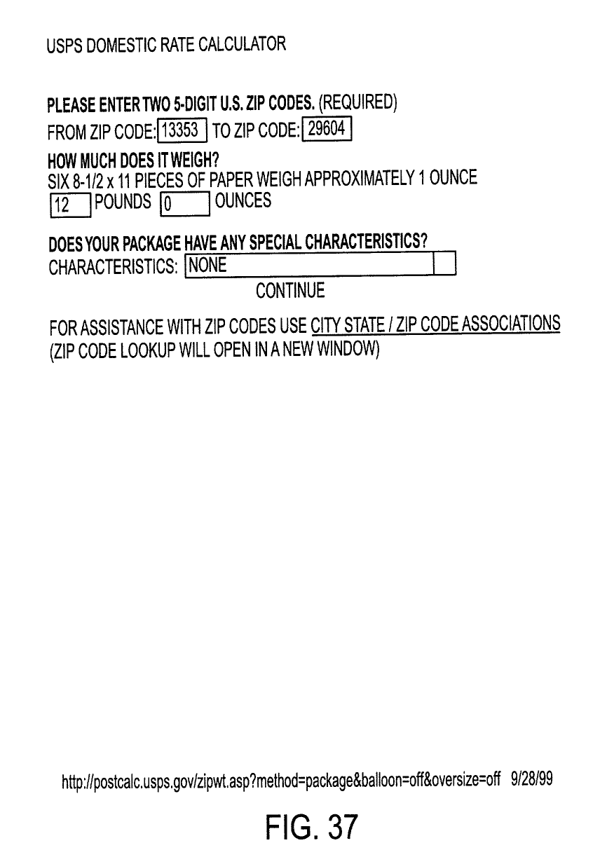

Postal Services presented on a personal terminal such as a PC, kiosk, and screen phone (FIGS. 16-20; FIGS. 21-36; and FIGS. 37-41).

The postal rate calculator walks a customer through the process of determining how much to pay for postage on a step-by-step interactive basis. The screens are displayed on a postal staff terminal, stand-alone kiosk or personal home or office terminal, such as a PC, screen telephone, personal digital assistant or other information appliance.

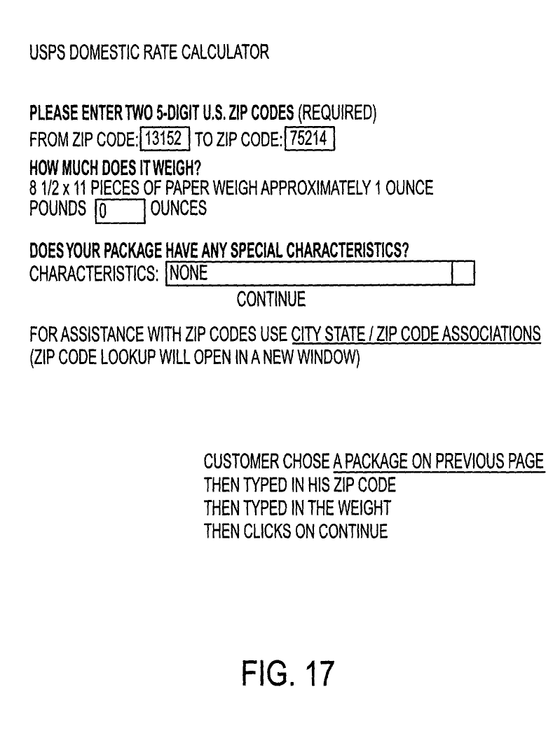

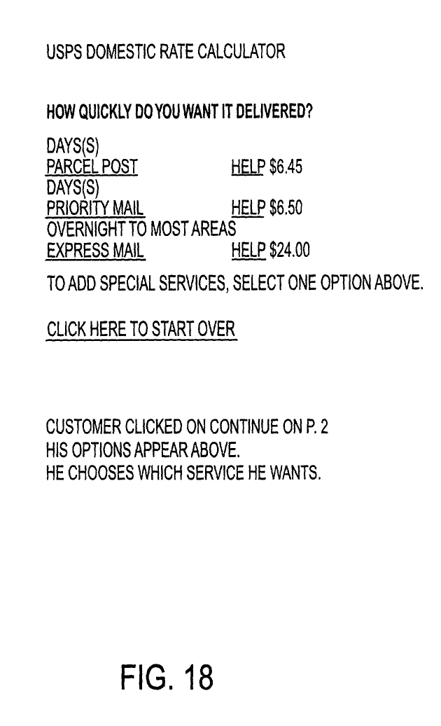

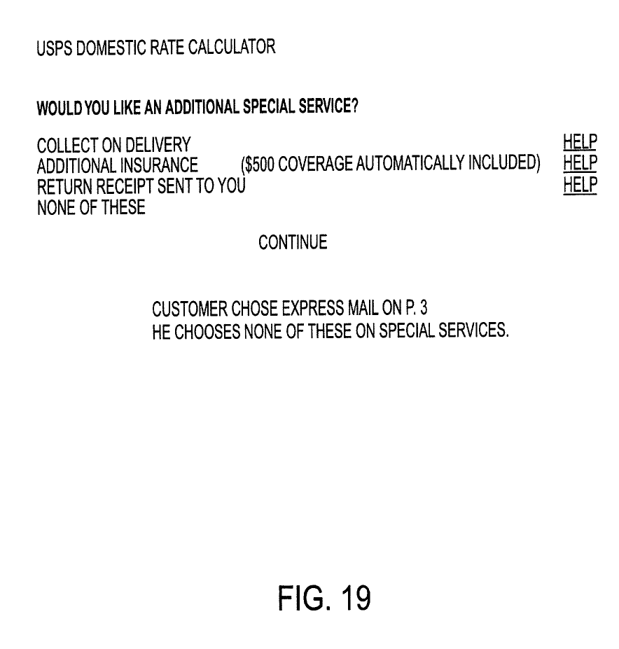

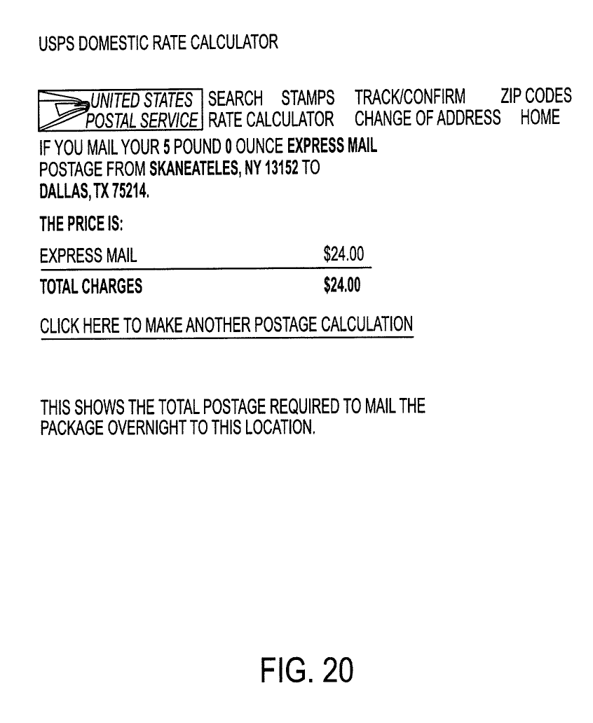

In FIG. 16, the system asks the user what the user wants to mail and provides the user with the entire universe of options. The user selects his or her option, which, in this example, is a package. In FIG. 17, The System asks the user for key objective criteria, such as the zip codes of the sending and receiving location, the weight of the package, and whether the package has any special characteristics. In the example, the user inputs the zip codes and weight. In FIG. 18, the system asks the user for his subjective criteria of how quickly the user wants the package to arrive. The user selects “overnight”, which the system identifies as express mail for $24.00. In FIG. 19, the system asks the user whether he or she wants an additional Special Service. In the example, the customer does not choose any of the Special Services. In FIG. 20, the system succinctly recaps the information that the user has input [the price, weight, mailing location and destination for the package] and provides the user with the advice for how much to pay and which service to select to meet the user's objective and subjective criteria. The system can be deployed with a scale that can be connected to the system so that the weight of the letter or package can be automatically determined and input into the system.

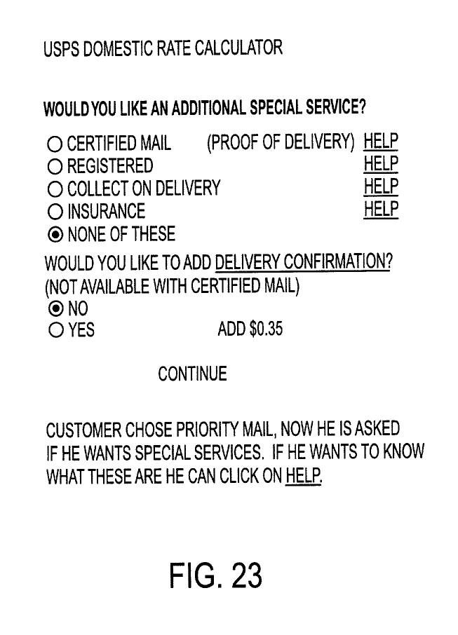

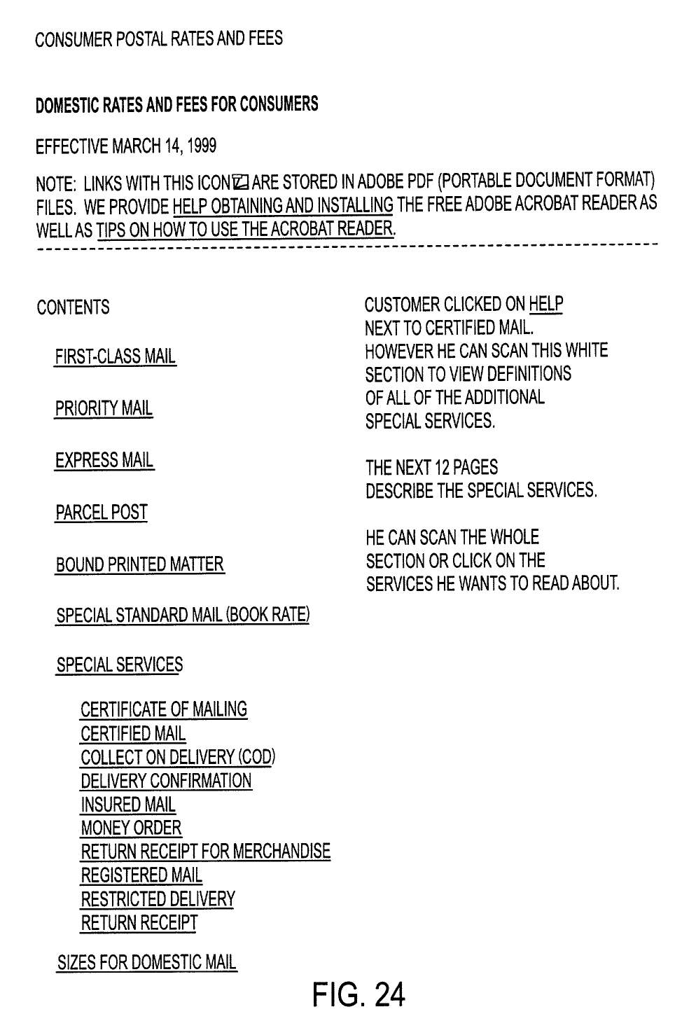

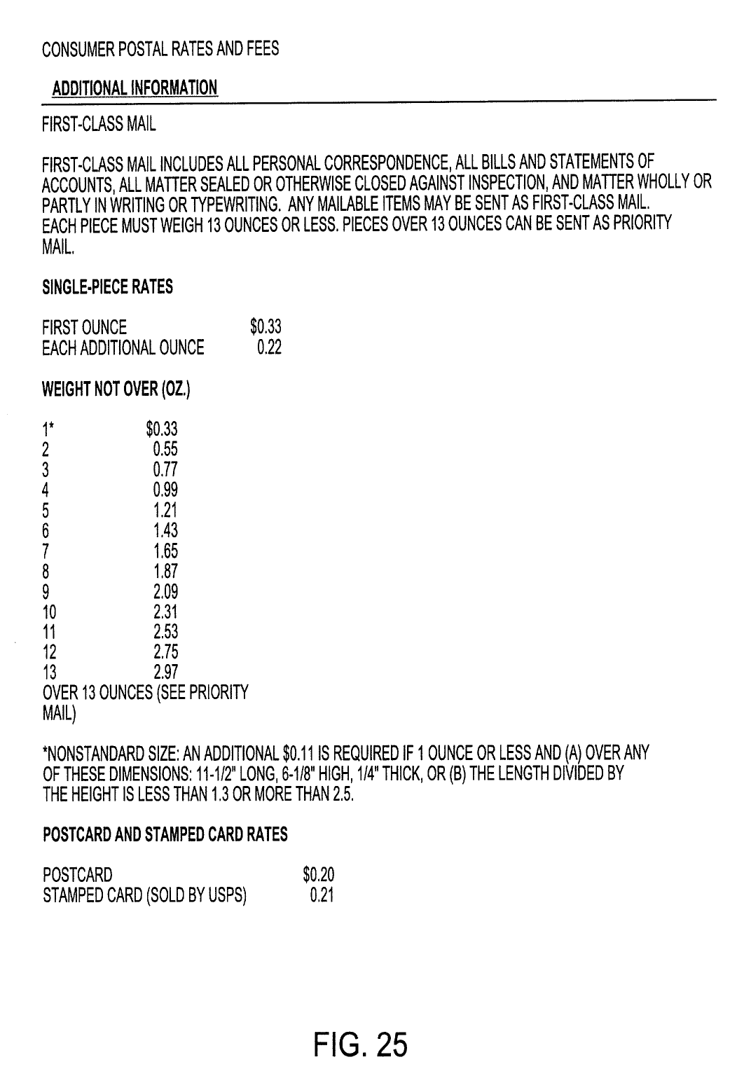

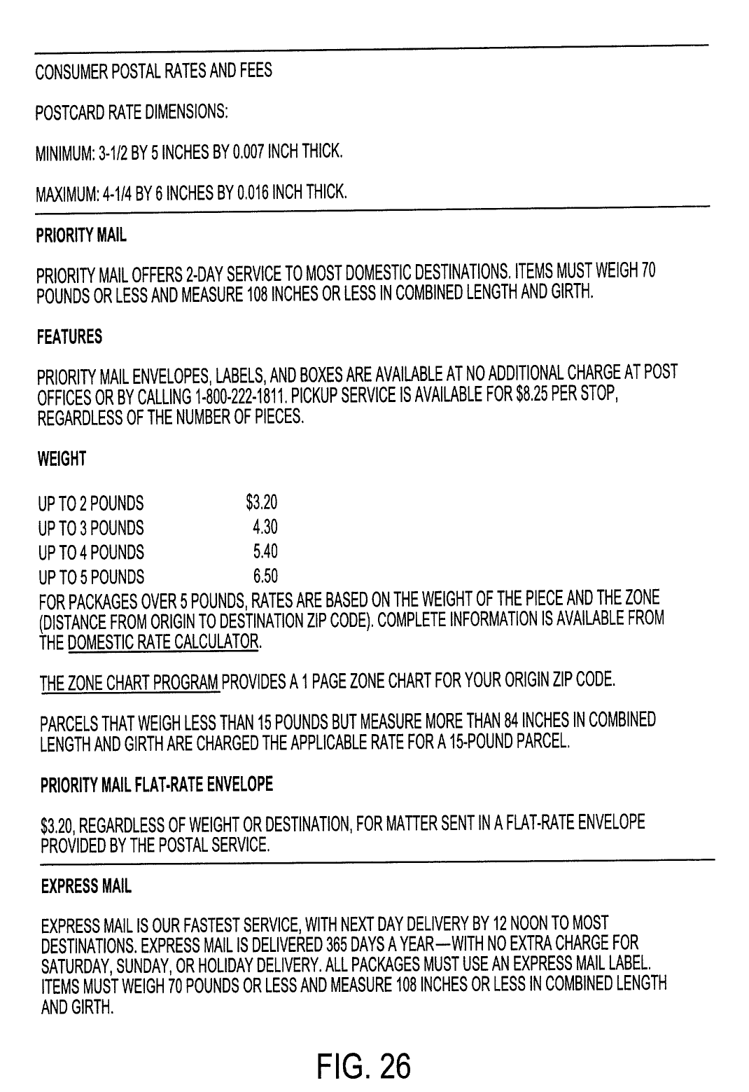

In FIG. 21, the system helps the user understand the types of service options for mailing a package that are available to the user. As with the prior example, in FIG. 21, the system asks the user the zip code for the mailing site and destination for the package that the user wants to mail. As with the prior example, in FIG. 2, the system asks the user how quickly the user want to have the package delivered. The user selects two days, and the system, in FIG. 23, asks the user if he or she would like an additional Special Service. In FIG. 23, the system offers the user the ability to obtain help about any of the special services. If the user selects help, in FIG. 24, the system lists all of the special services and offers the user the ability to get information any one of them. FIGS. 25 through 26 give the user the information about the special service that the user selects. Thus the system provides the user with the information that he or she needs when she needs it most—at the time of making the purchase decision or transaction.

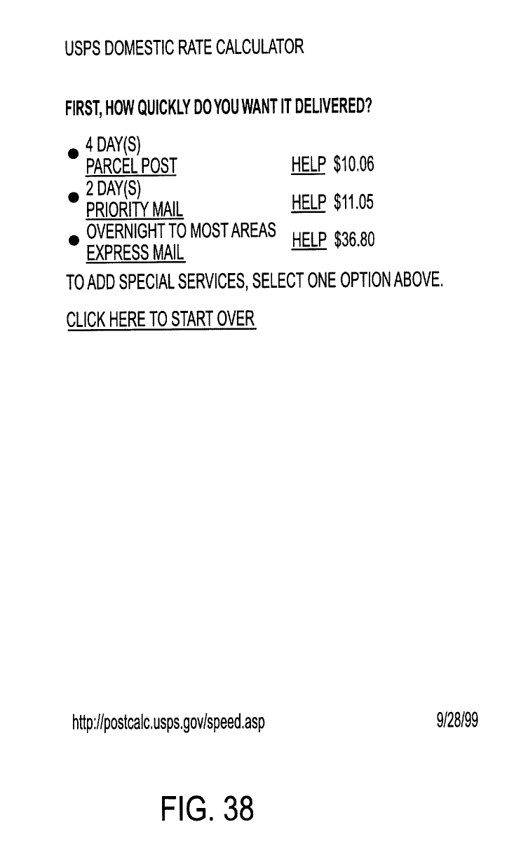

In FIG. 37, the system, helps the user understand in an interactive step-by-step basis what mailing services to select based on the available options, postal service rules and the customer's subjective needs for certainty and closure. In FIG. 37, the system, as in the other examples, asks the customer for the objective criteria of the zip codes of the mailing location and destination. After the user inputs the zip codes and the weight, the system calculates and presents the various rates that are available based on how long it would take the package to be delivered in FIG. 38. In this screen the system asks the user for his subjective criteria of how quickly the user wants the package to be delivered.

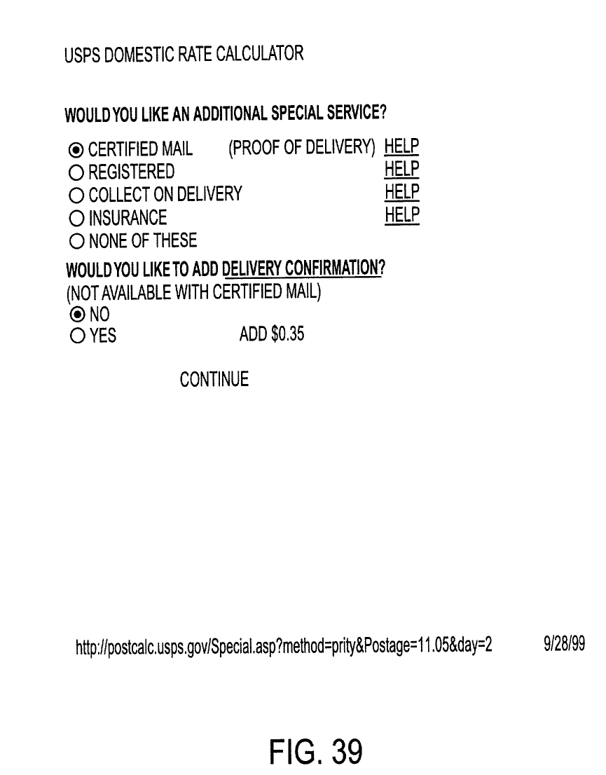

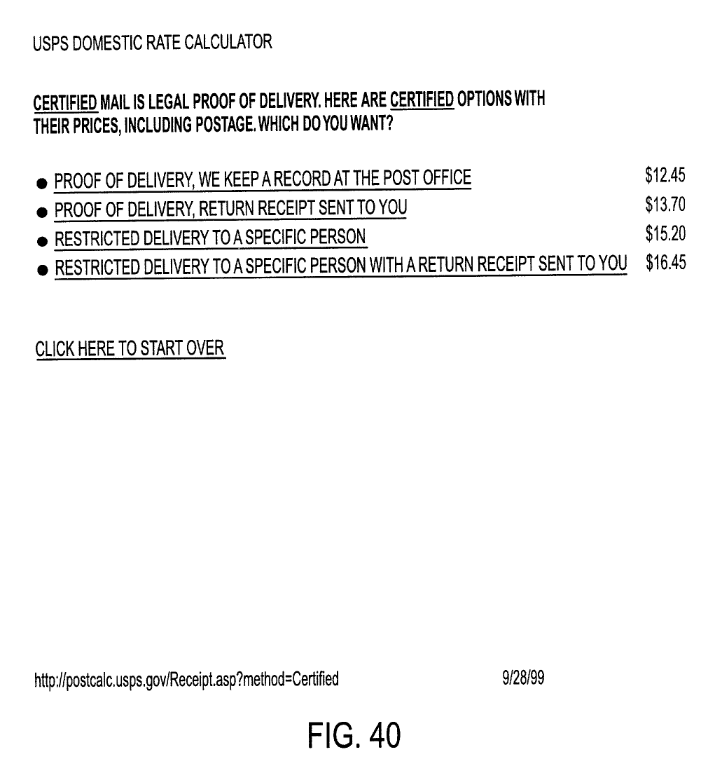

In FIG. 39, the system asks the user if he or she would like a special service. In the example, the user selects “Certified Mail” and “help” to find out what Certified Mail includes. In FIG. 40, the system defines certified mail and certified mail options, and includes the prices for the service including postage for this user's package.

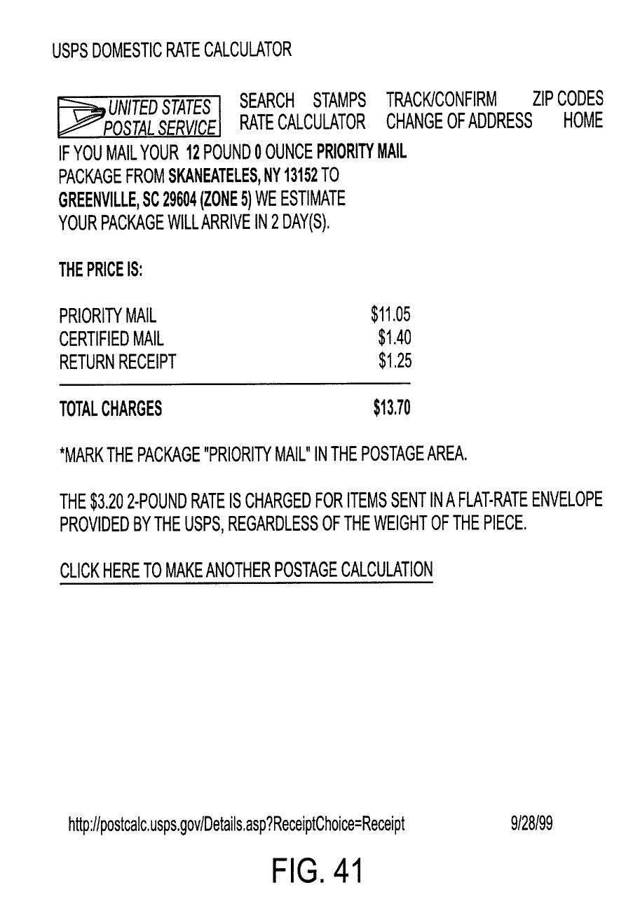

After the user selects the option that best meets his or her needs, in FIG. 41, the system processes the user's input with a very complex set of rules to help the user identify which mailing services meet the user's objective needs for mailing a package (weight, destination) plus the user's subjective need for speed and certainty.

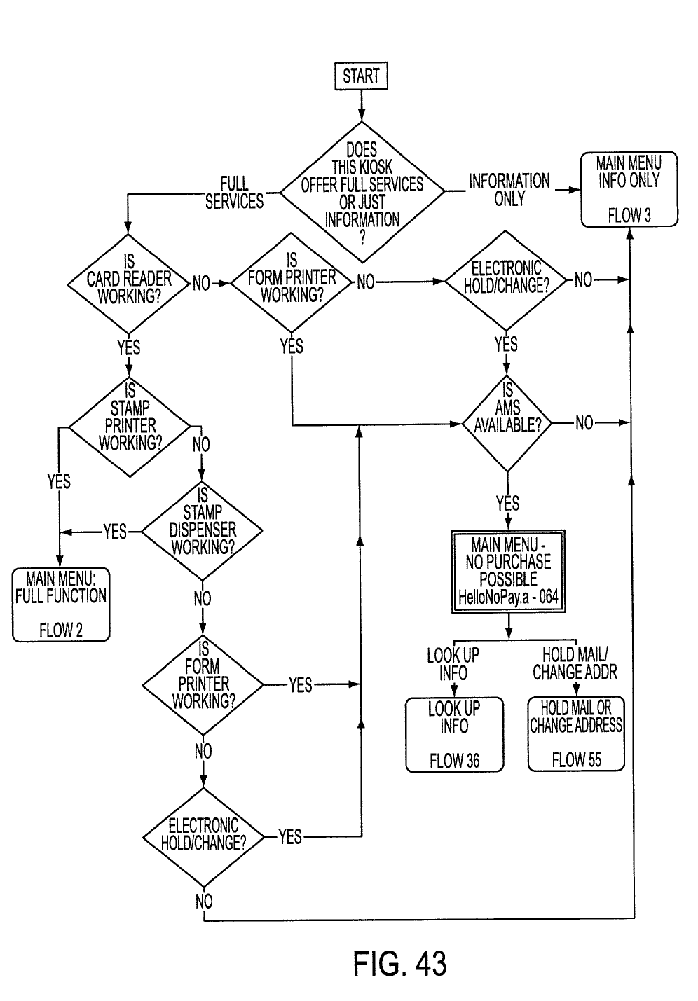

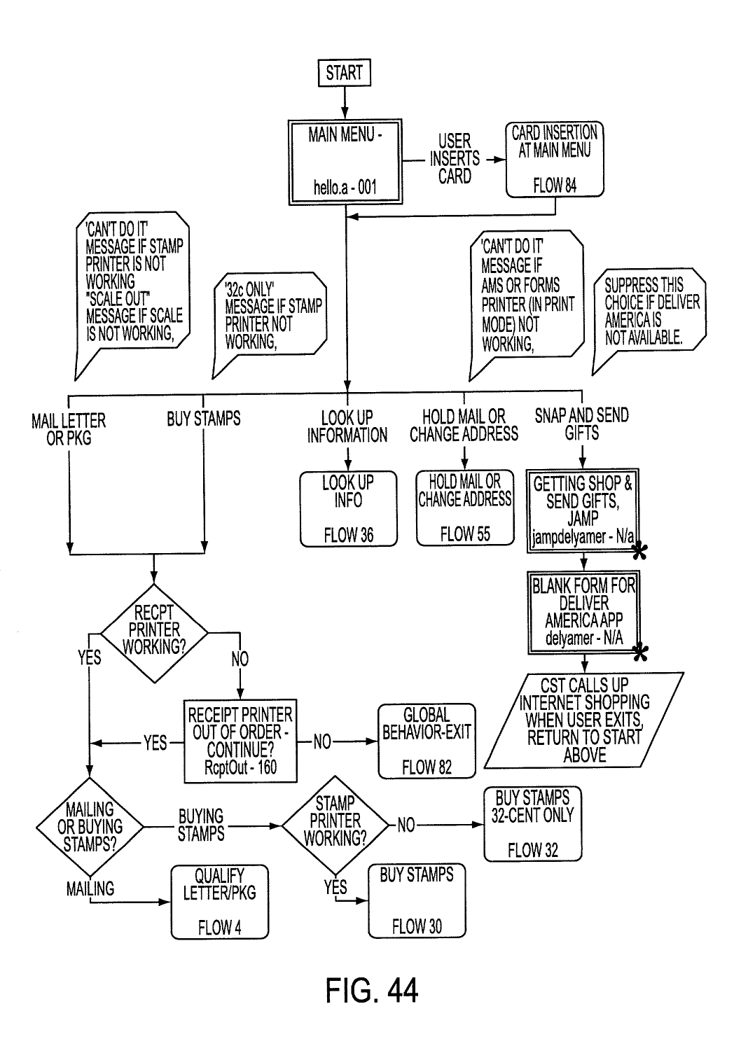

Referring to FIG. 43 ‘shown as a Main menu configuration displaying the flows of the postal transaction system. There are two main paths depending on whether a kiosk is full service or information only. As a result there are two different main menus. The figure demonstrates the internal logic regarding whether such functions as the card reader, form printer, stamp printer, and stamp dispenser are working in order to offer the customer the full array of services. Referring to FIG. 44, shown as a demonstration of the main menu with its full function. The customer is given the choices of mailing a letter or package, buying stamps, looking up information’ holding mail or changing one's mailing address, and shopping for and sending gifts. This figure also demonstrates the internal logic that the system 4ses and the resulting flow path if one or more functions is not working properly.

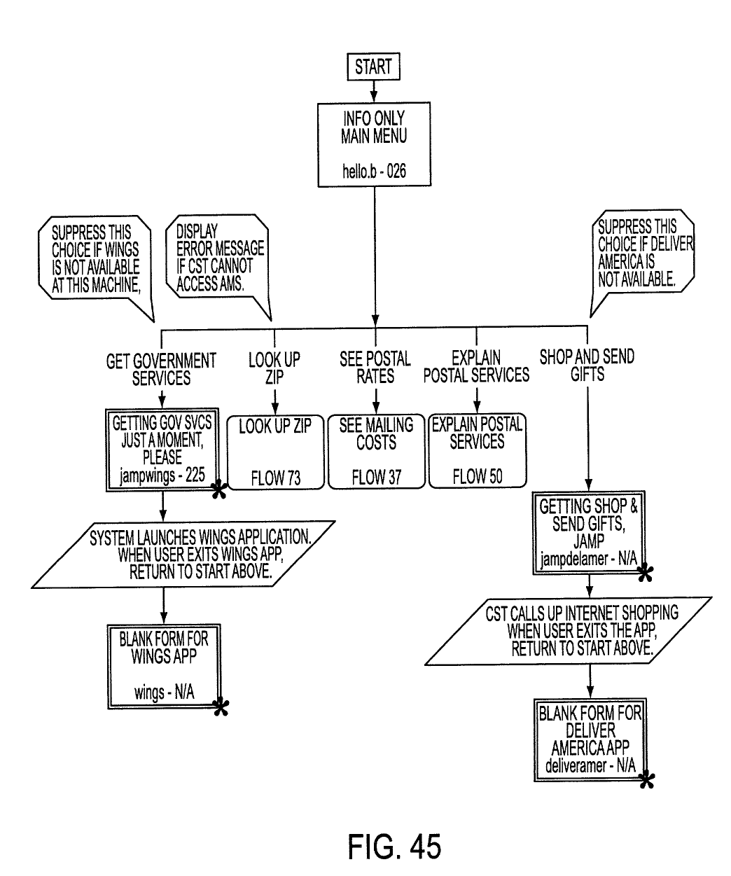

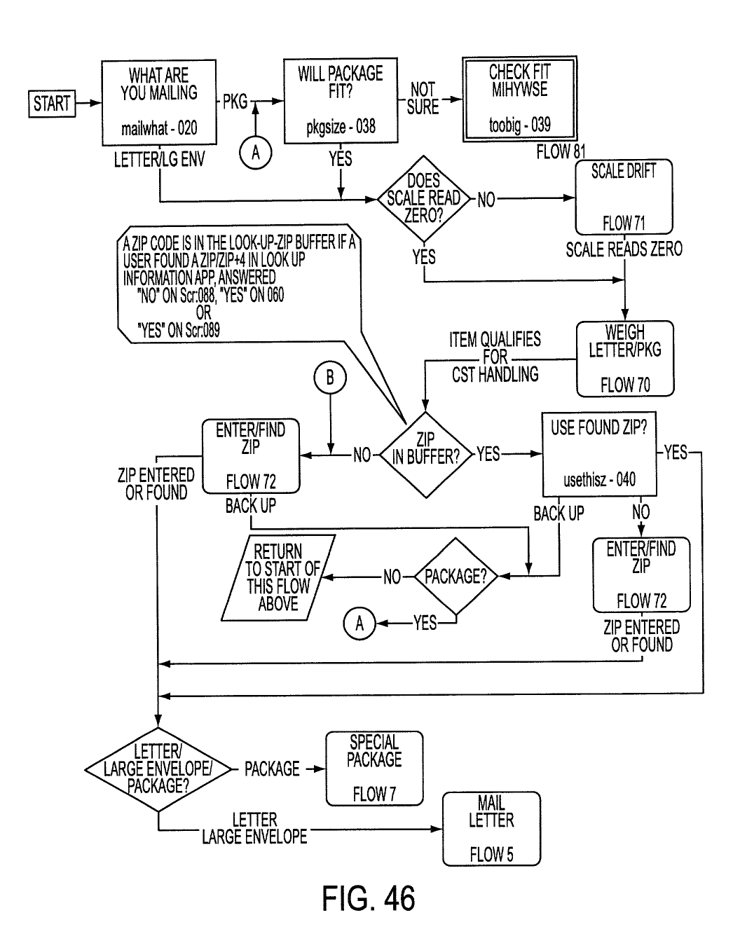

Referring to FIG. 45, shown as a system for displaying the main menu if information is the only service provided at that particular kiosk. The customer is given the options of: getting government services, looking up zip codes, see postal rates, explaining postal services, and shopping for and sending gifts. If Deliver America is not available then the option for shopping and sending gifts is suppressed. Referring to FIG. 46, shown as a system for displaying the steps which a customer goes through in order to mail a letter or package. The primary step shown in this figure is qualifying the letter or package to see if it complies with postal regulations. Once the letter or package is qualified it is weighed and the zip code is entered. Once all of the required information is entered the letter or package is mailed and the customer is guided through the appropriate flow.

Referring to FIG. 47, shown as a flow chart of how to mail a letter, the system identifies mailing options for the customer based on the customer's objective and subjective criteria. The system provides viable options based on the customer's criteria and enables customers to purchase the correct postage to meet the customer's need for speed.

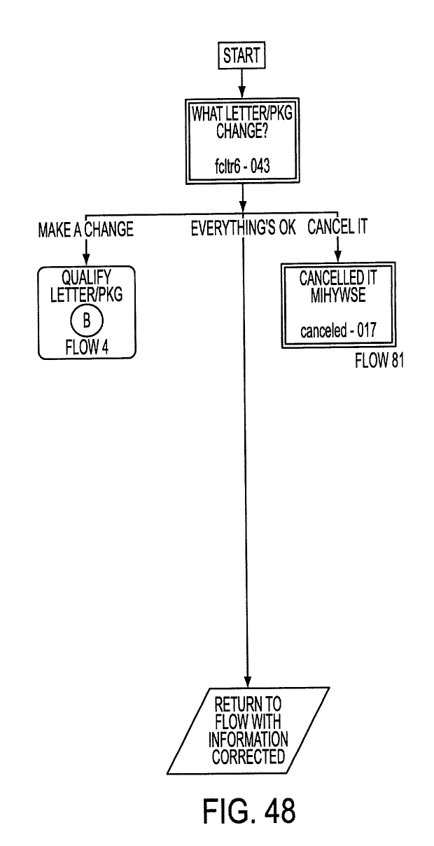

Referring to FIG. 48, shown as a system for enabling the user to change a mailing option, the system walks the user through the process of making a change in a previously selected option on a step-by-step basis. It asks whether a change is necessary, whether the transaction is correct or whether the transaction should be cancelled. Based on the user's response the system provides the list of variables.

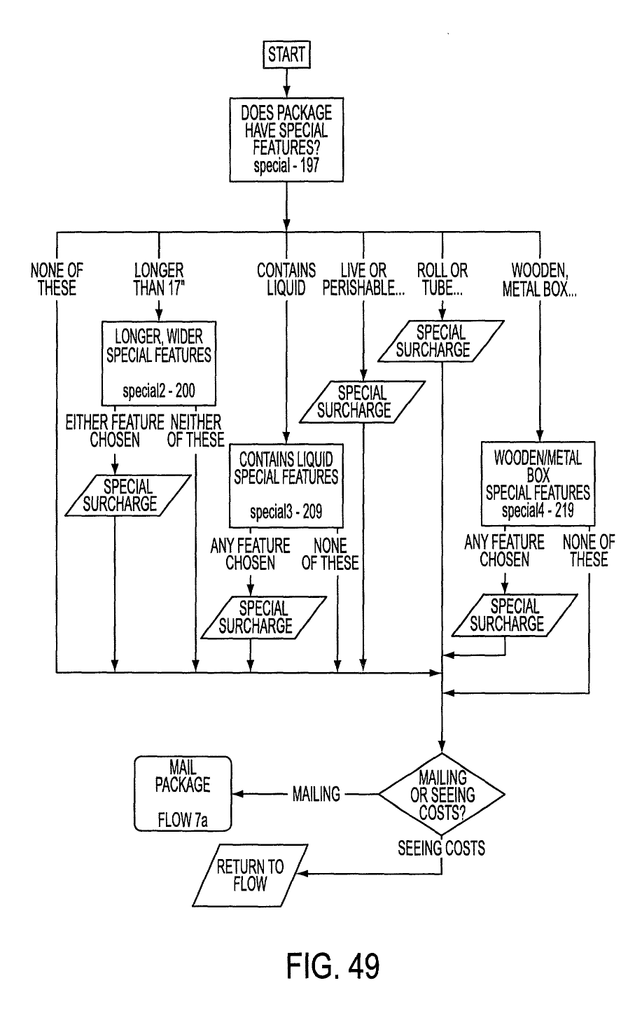

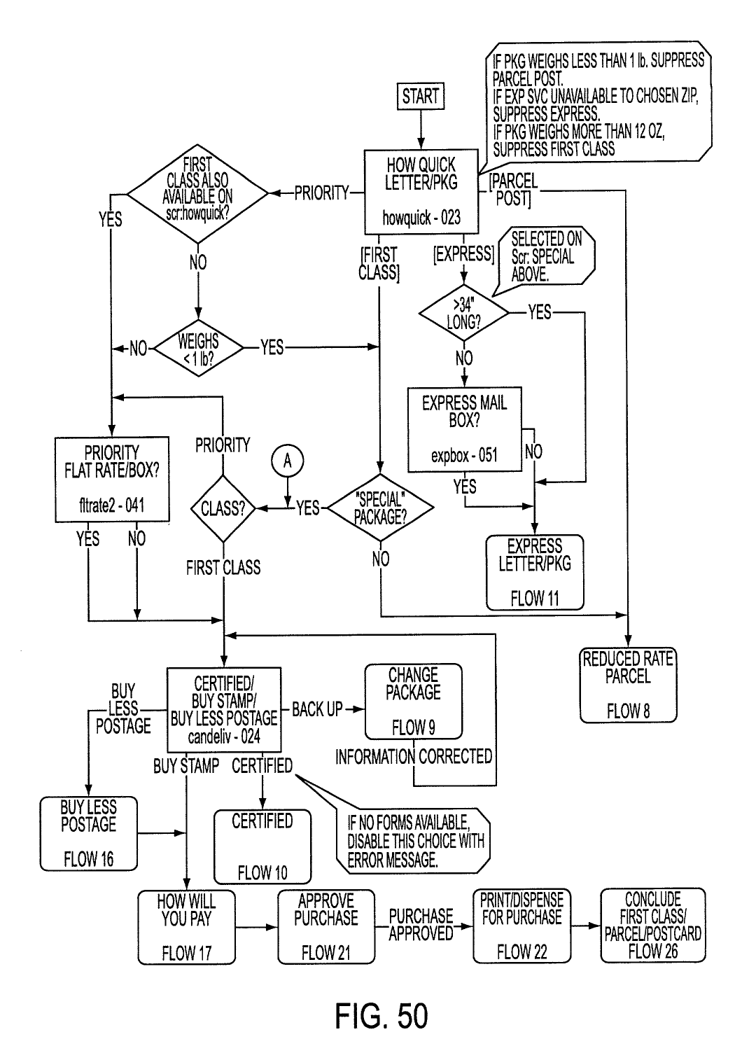

Referring to FIG. 49, shown as a system for understanding how much to pay for postal services for a package with special features, the system walks the user through the various options on a step-by-step basis. It first asks whether the user's package has any special features. It then lists the various special features that are available. Based on the user's response the system asks more specific questions, such as how large the box is over 17″ or whether the box is made of wood or metal. If the customer says that the package has any of these features, the system advises the customer of the appropriate surcharge. After the system has solicited all the necessary information to assess the user's objective criteria about the physical features of the package, the system advises the user of the various costs to mail the package based on the user's subjective criteria of the need for speedy delivery of the package and need for certainty in FIG. 50.

Referring to FIG. 50, shown as a system for advising a user how much to pay for postal services for mailing a package based on the user's criteria, the system walks the user through the process of determining the optimal mailing service and cost based on the user's subjective criteria of how quickly the user wants his mail delivered and the user's objective criteria of weight and special features. As the user inputs his criteria, the system automatically suppresses options that do not apply to the user's circumstances. For example, if the package weighs less than 1 pound, the system automatically suppresses the Parcel Post option because it is not available for packages under one pound. Similarly, if the package weighs more than 12 oz., the systems does not show the user the First Class options, since they are not available for such packages. It can be appreciated by this example, that postal rules are quite complex. Postal workers need a great deal of training to understand them and apply them. Indeed the Postal Service manual is quite lengthy and difficult to apply to the many variables in each user's mailing transactions. The instant invention alleviates confusion for users about the options for which postal services to buy.

Referring to FIG. 51, shown as a system for understanding how much to pay for postal services for a package eligible for reduced rates, the system walks the user through the various options on a step-by-step basis. The system advises the user whether his package is eligible for reduced rates and compares the other options to find the best price for the user's criteria.

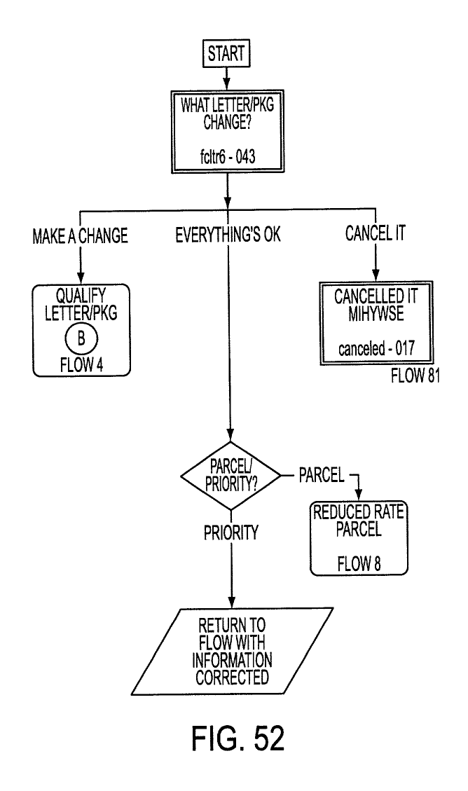

Referring to FIG. 52, shown as a system for enabling the user to change a mailing option, the system walks the user through the process of making a change in a previously selected option on a step-by-step basis. It asks whether a change is necessary, whether the transaction is correct or whether the transaction should be cancelled. Based on the user's response the system provides the list of variables.

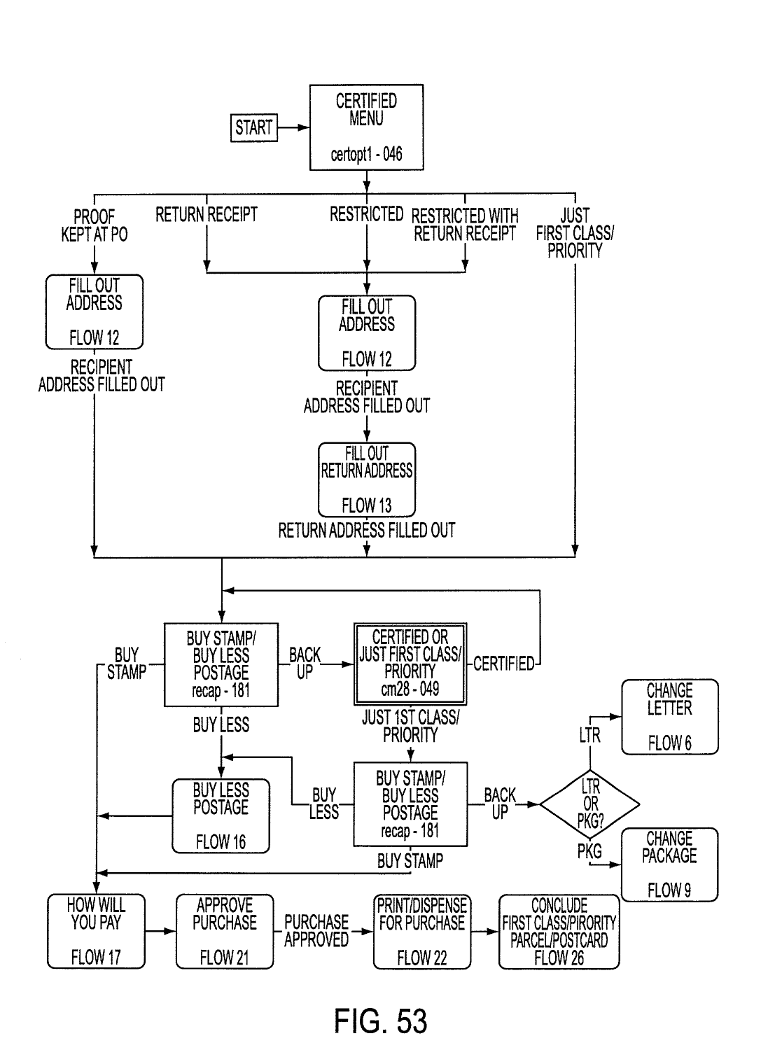

Referring to FIG. 53, shown as a system for enabling the user to mail a package by certified mail, the system advises the user which certified mail option to buy based on the user's subjective need for certainty and closure. Based on the user's response the system provides the list of viable objective criteria of weight and special features. As the user inputs his criteria, the system automatically suppresses options that do not apply to the user's circumstances. For example, if the package weighs less than 1 pound, the system automatically suppresses the Parcel Post option because it is not available for packages under one pound. Similarly, if the package weighs more than 12 oz., the systems does not show the user the First Class options, since they are not available for such packages. It can be appreciated by this example, that postal rules are quite complex. Postal workers need a great deal of training to understand them and apply them. Indeed the Postal Service manual is quite lengthy and difficult to apply to the many variables in each user's mailing transactions. The instant invention alleviates confusion for users about the options for which postal services to buy.

Referring to FIG. 51, shown as a system for understanding how much to pay for postal services for a package eligible for reduced rates, the system walks the user through the various options on a step-by-step basis. The system advises the user whether his package is eligible for reduced rates and compares the other options to find the best price for the user's criteria.

Referring to FIG. 52, shown as a system for enabling the user to change a mailing option, the system walks the user through the process of making a change in a previously selected option on a step-by-step basis. It asks whether a change is necessary, whether the transaction is correct or whether the transaction should be cancelled. Based on the user's response the system provides the list of variables.

Referring to FIG. 53, shown as a system for enabling the user to mail a package by certified mail, the system advises the user which certified mail option to buy based on the user's subjective need for certainty and closure. Based on the user's response the system provides the list of viable options. It also enables the user to execute the transaction by completing the correct forms and purchasing the correct postage for the option selected.

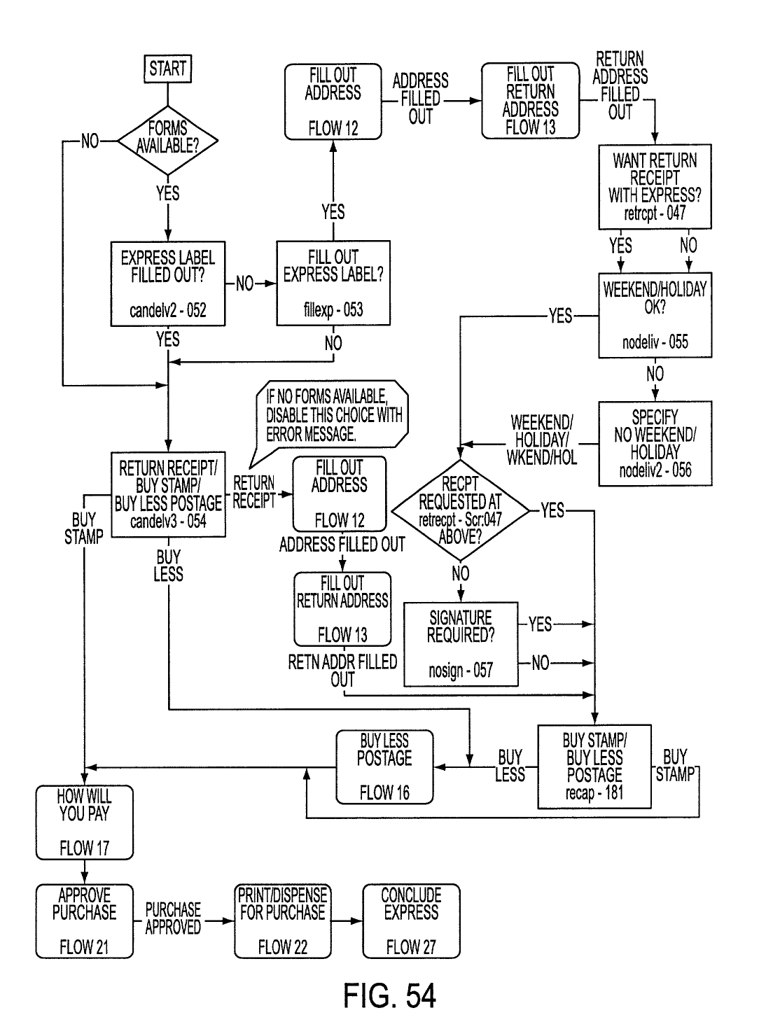

Referring to FIG. 54, shown as a system for enabling the user to select and execute a express letter package transaction, the system walks the user through the process of completing the correct forms and determining how much to pay for the express mail option. It also enables the user to execute the transaction by completing the correct forms and purchasing the correct postage for the option selected.

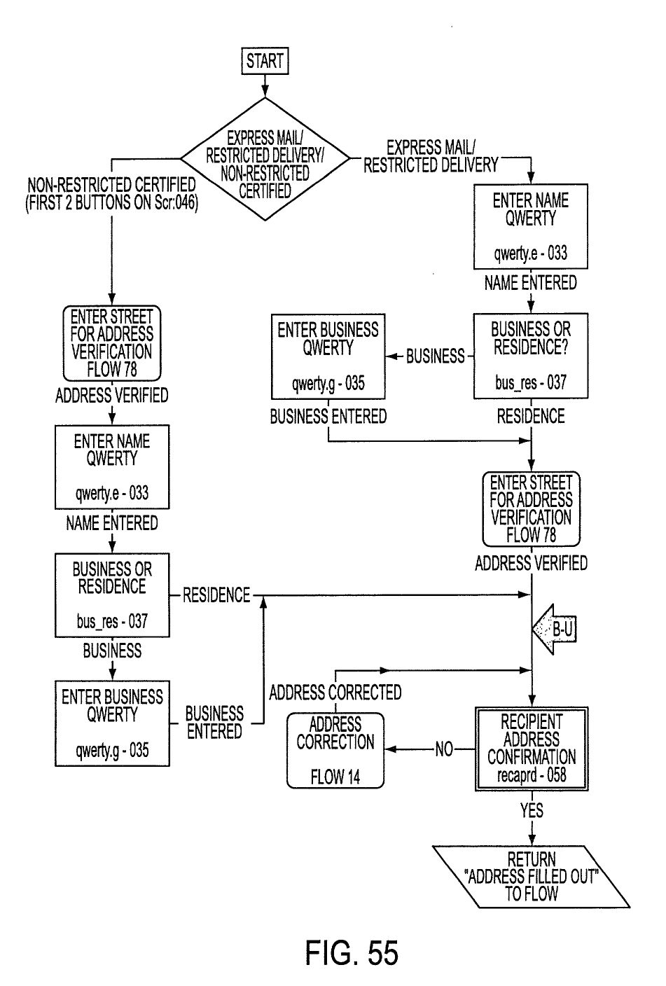

Referring to FIG. 55, shown as a system for enabling the user to execute an express mail and certified mail transaction, the system walks the user through the process of completing the correct forms and determining how much to pay for the express mail and certified mail option. The system deploys a QWERTY keyboard on a touch screen or a screen with mouse to simplify the process of inputting the relevant data.

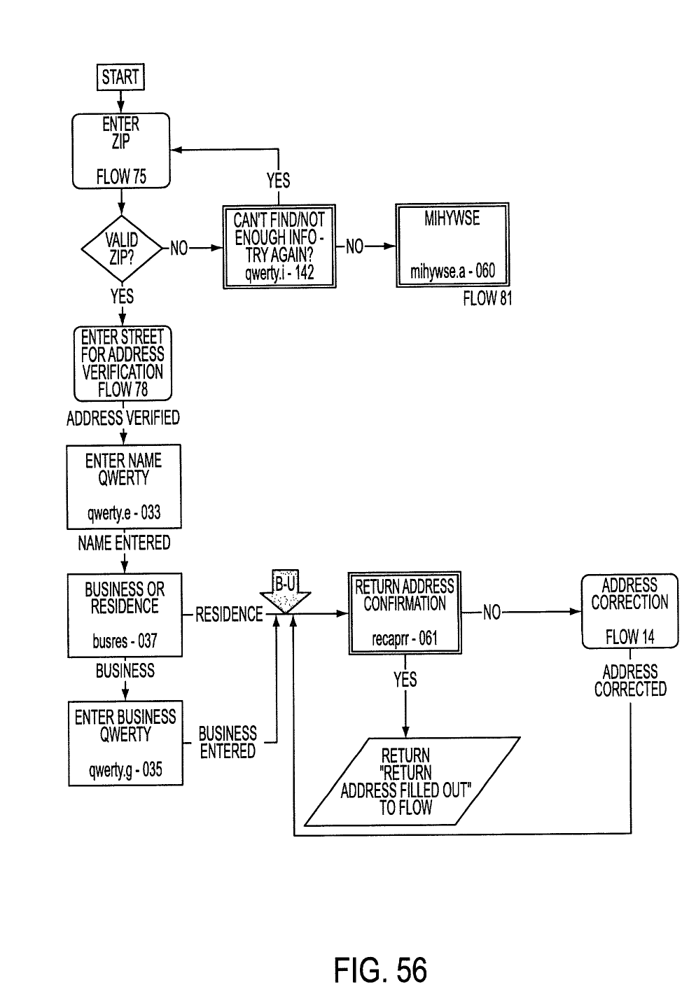

Referring to FIG. 56, shown as a system for enabling the user to complete the return address forms to execute a express letter or certified mail transaction, the system walks the user through the process of completing the correct forms. The system deploys a QWERTY keyboard on a touch screen or a screen with mouse to simplify the process of inputting the relevant data.

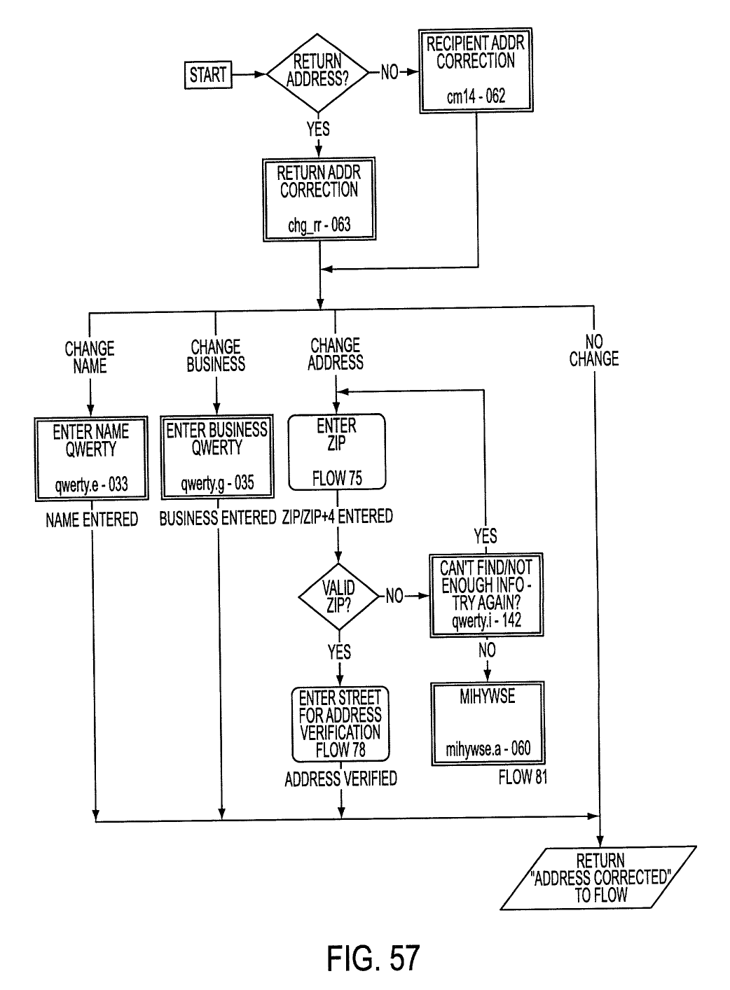

Referring to FIG. 57, shown as a system for enabling the user to correct the return address or recipient address input in FIGS. 55 and 56.

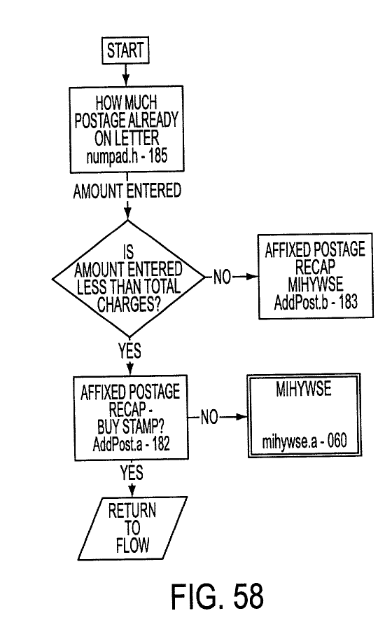

Referring to FIG. 58, shown as a system for enabling the user to calculate how much postage is required to mail a letter which already has some postage on it, the system enables the user to systematically calculate the postage due on a step-by-step basis.

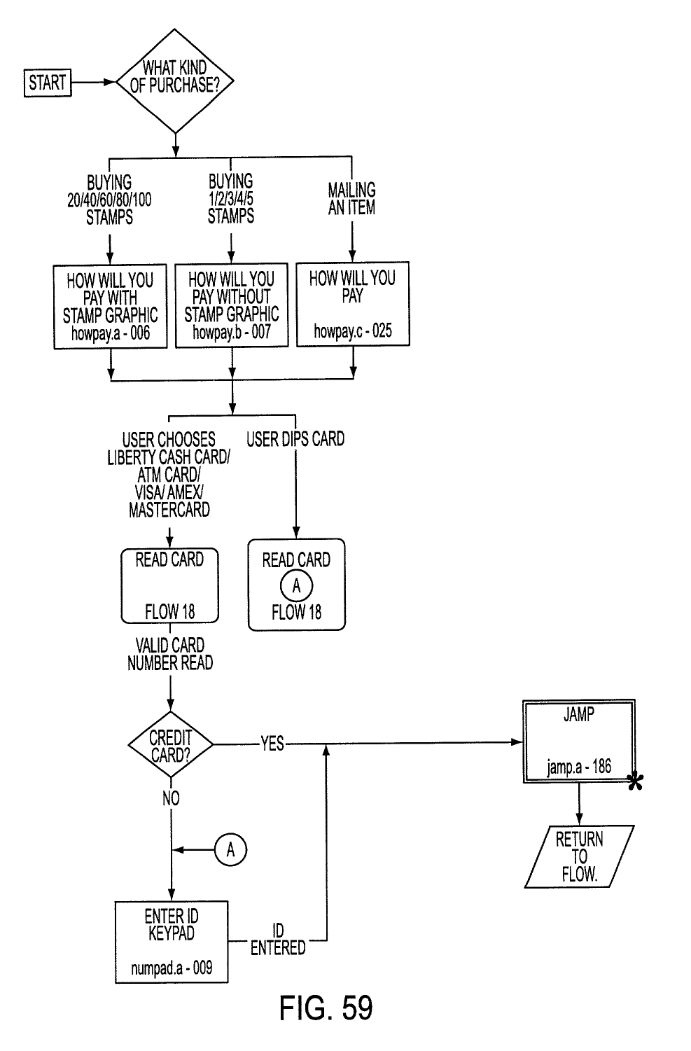

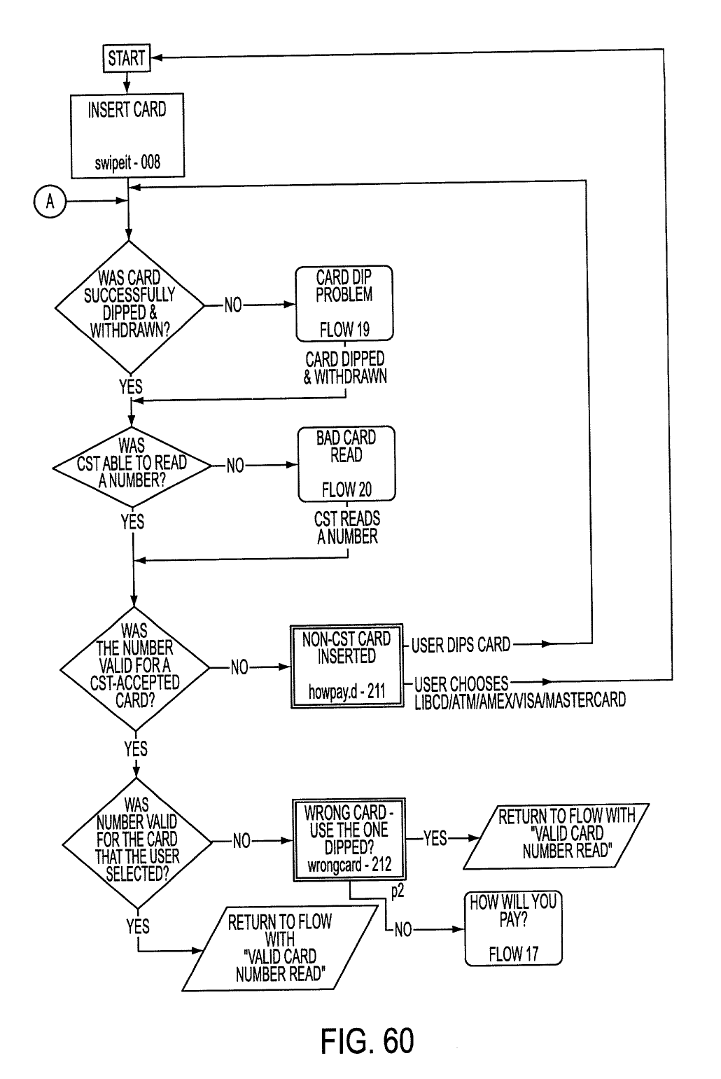

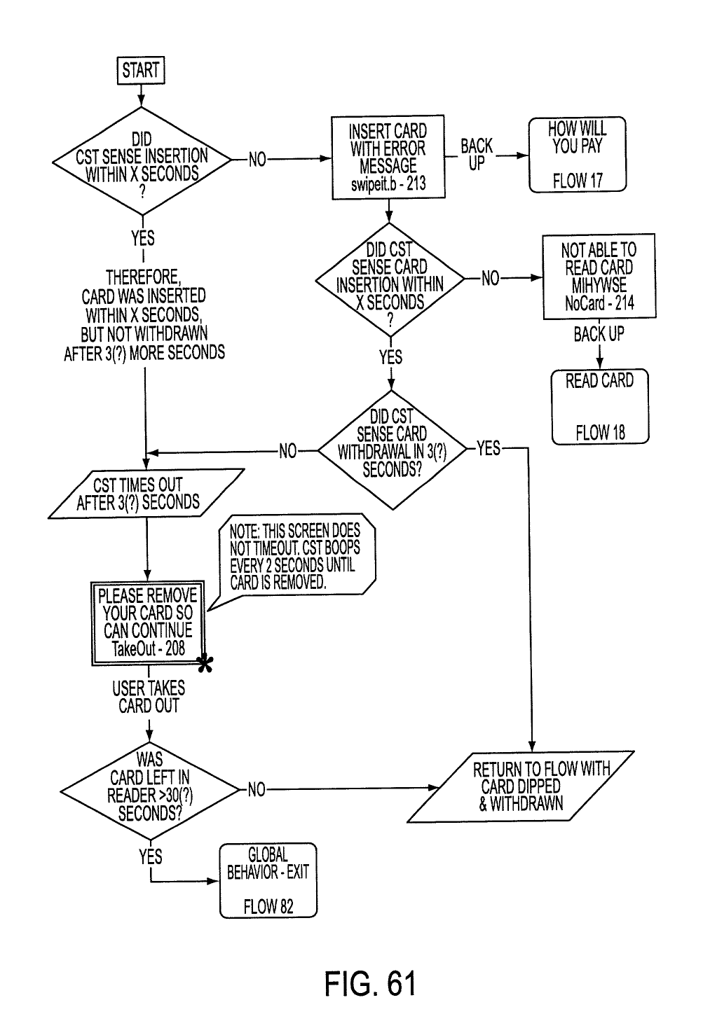

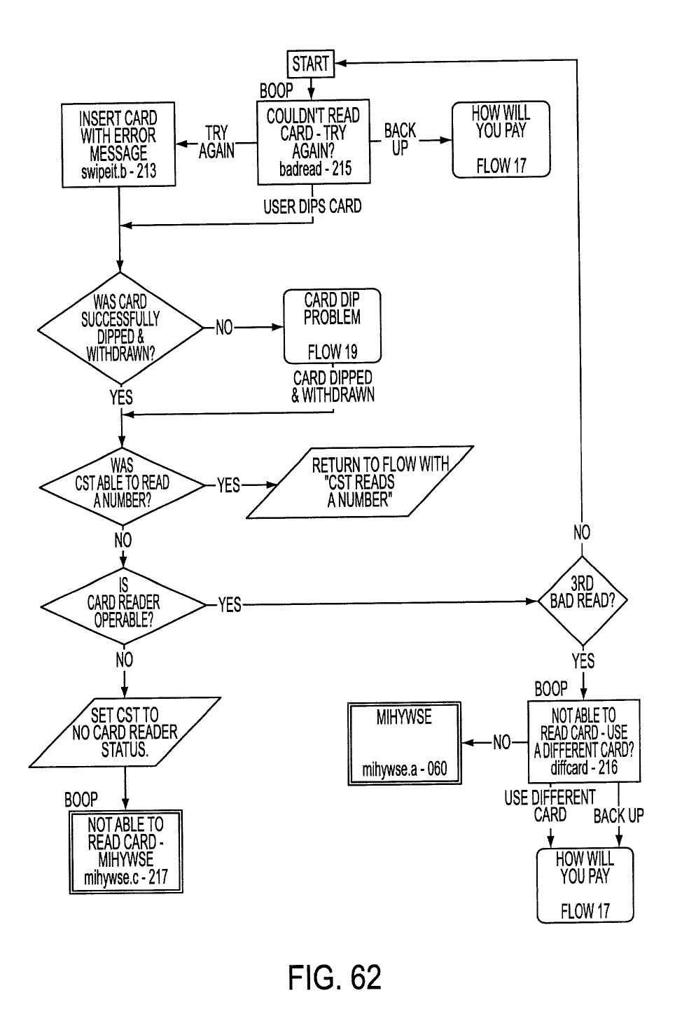

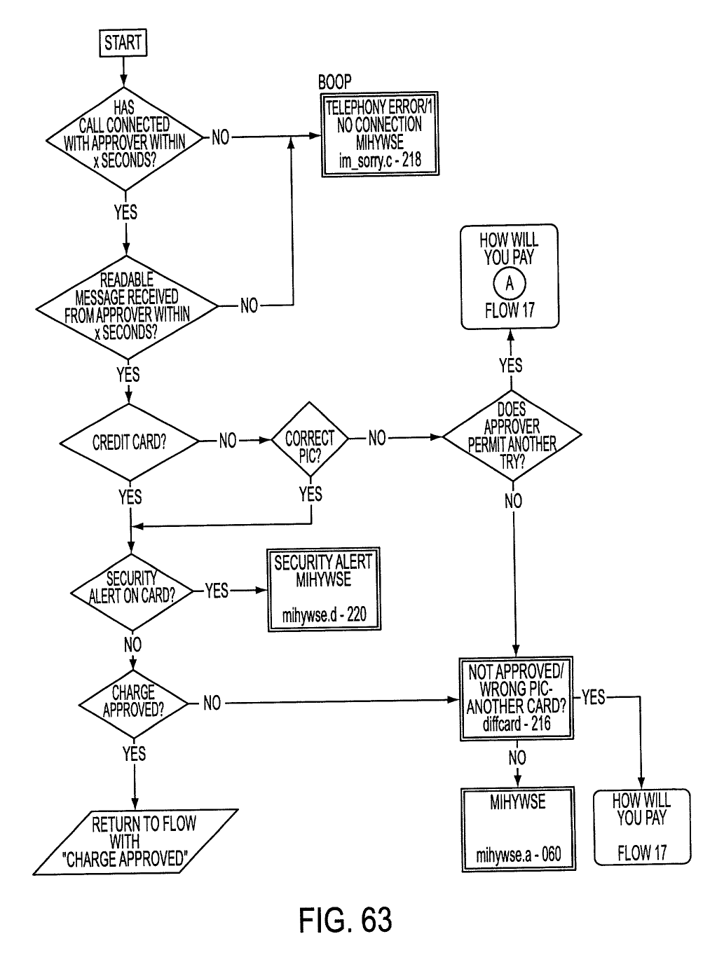

Referring to FIGS. 59 through 63, shown as a system for enabling the user to purchase postage, the system helps the user buy stamps or mail an item by using a variety of financial devices such as a credit card, debit card or smart card. The system walks the user through the process on a step-by-step basis. The simple system reduces training time for staff and eliminates frustration on the part of the consumer. The system clarifies the procedures for processing the various payment methods and the individual steps involved for card dip problems and authorization.

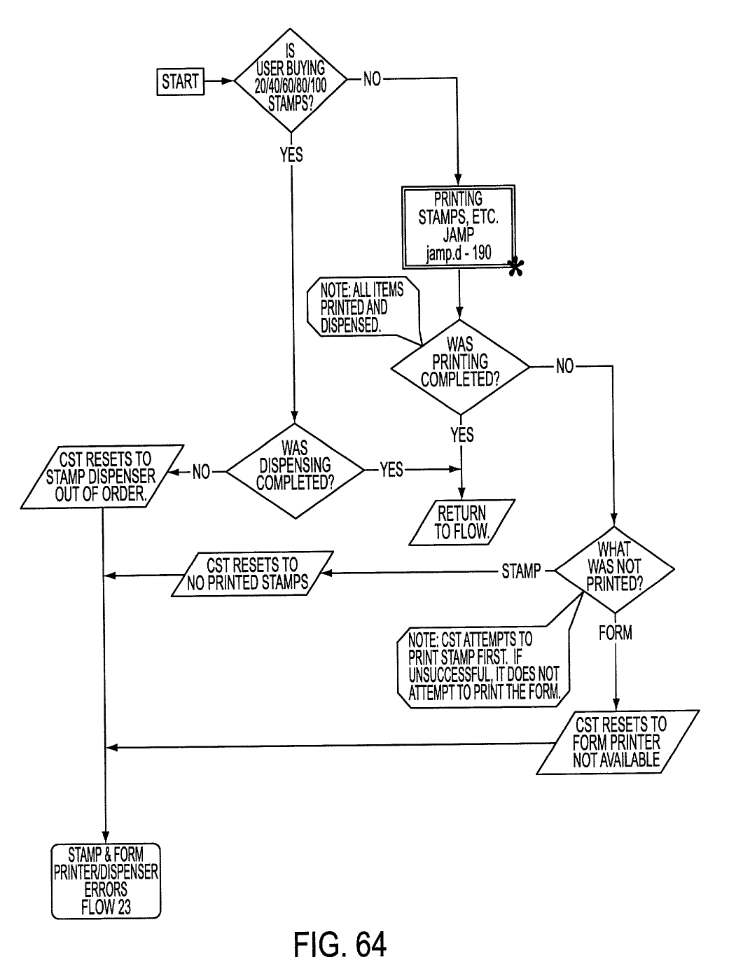

Referring to FIG. 64, shown as a system for enabling the user to print and dispense stamps for purchase, the system helps the user print stamps that meet its needs.

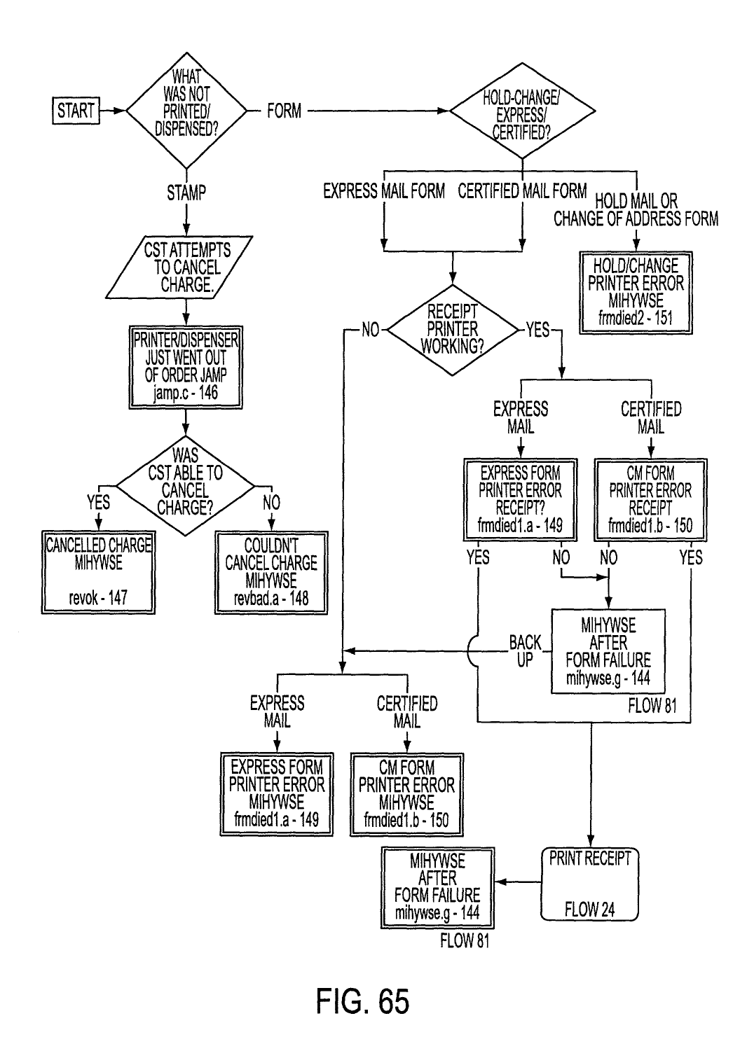

Referring to FIG. 65, shown as a system for correcting errors in an automated system for completing mailing forms and dispensing stamps, this embodiment walks the user thorough the process of identifying and correcting errors on a step-by-step basis.

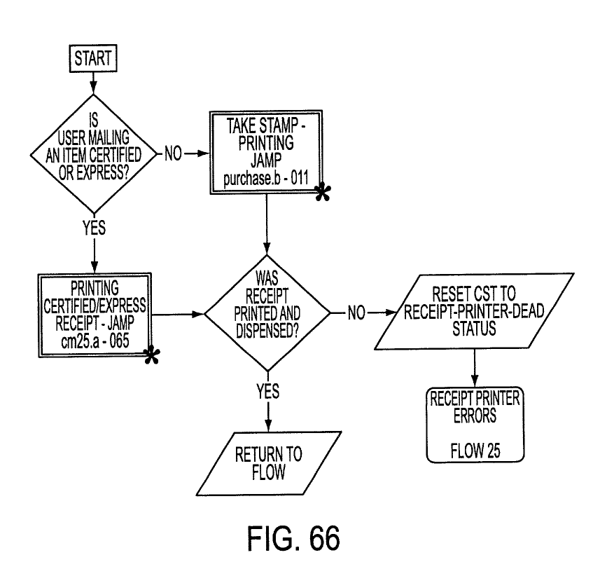

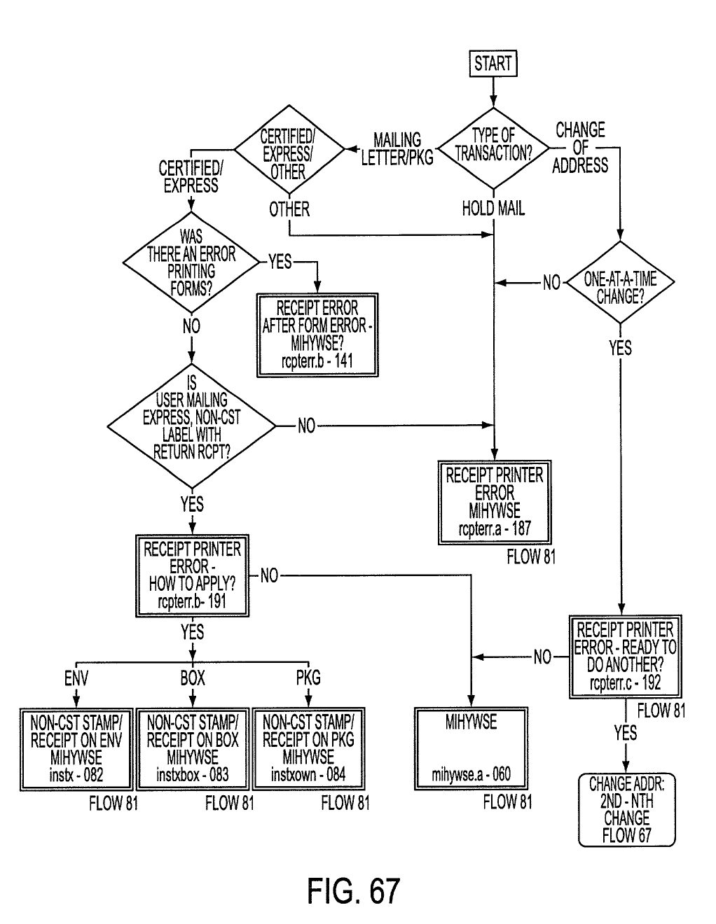

Referring to FIGS. 66 and 67, shown as a system for printing a receipt and correcting errors, the system walks the user though the options for printing a receipt and what to do if there is an error.

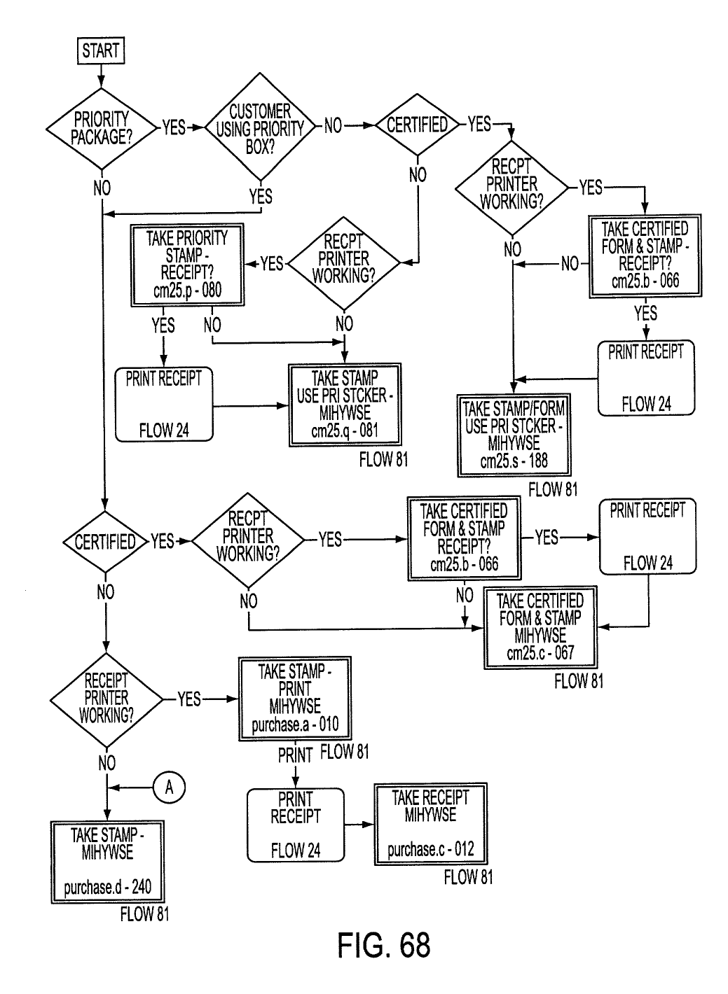

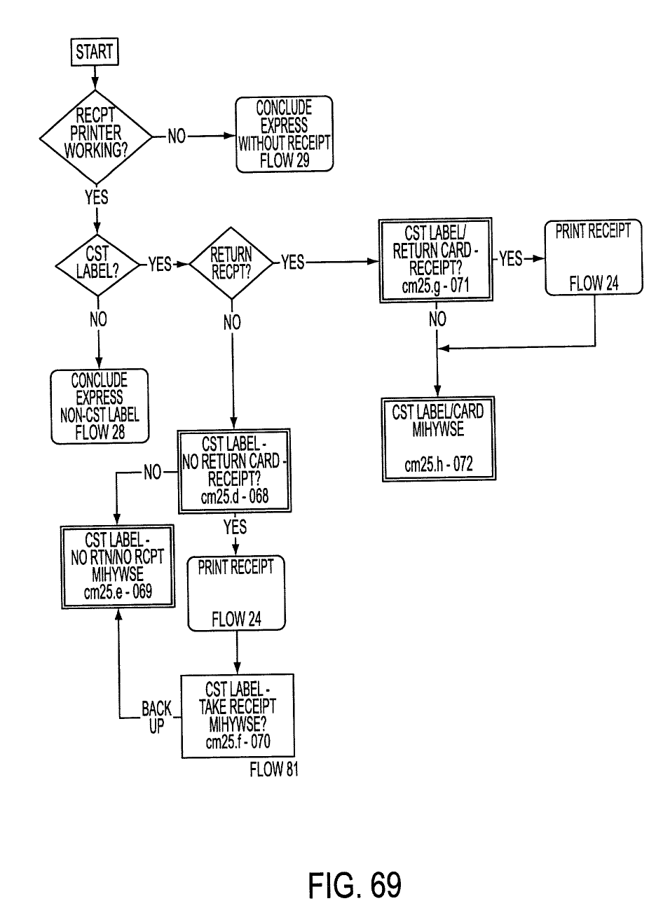

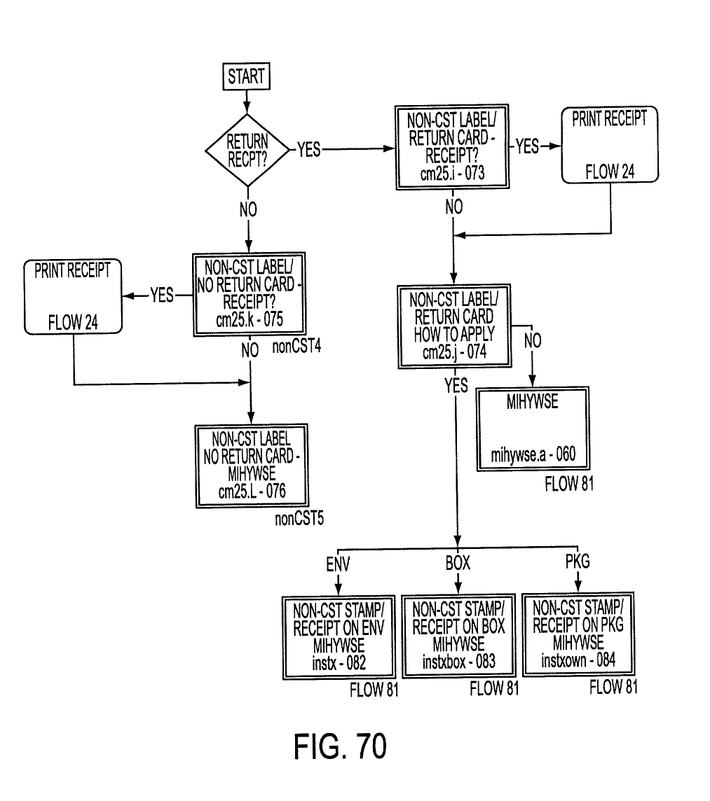

Referring to FIGS. 68 through 70, shown as a system for concluding first class, priority, Parcel Post, postcard and Express transactions, the system walks the user through the requirements for executing various mailing transactions. The system asks the user what type of transaction he wants to complete. It asks the user whether it has the necessary forms and postage for the transaction. It prints the receipt for the transaction.

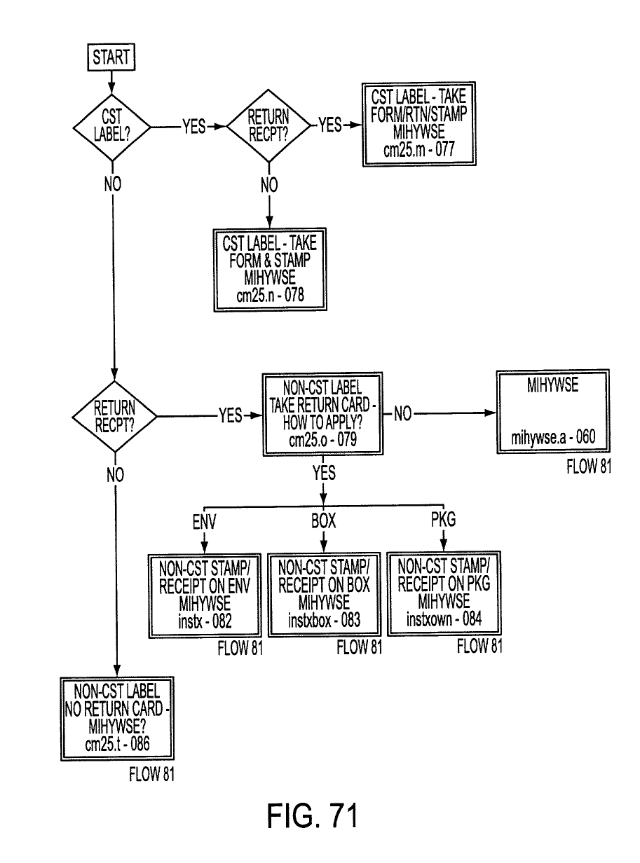

Referring to FIG. 71, shown as a system for concluding an express mail transaction without a receipt, it instructs a user how to complete an Express Mail transaction without a receipt.

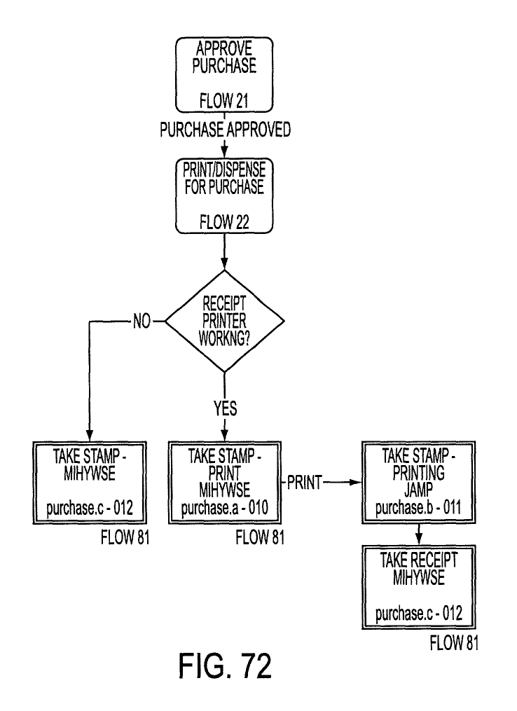

Referring to FIG. 72, shown as a system for concluding a stamp purchase, the system walks a user through the process of approving the purchase of stamps, printing or dispensing the stamps for purchase, and issuing a receipt.

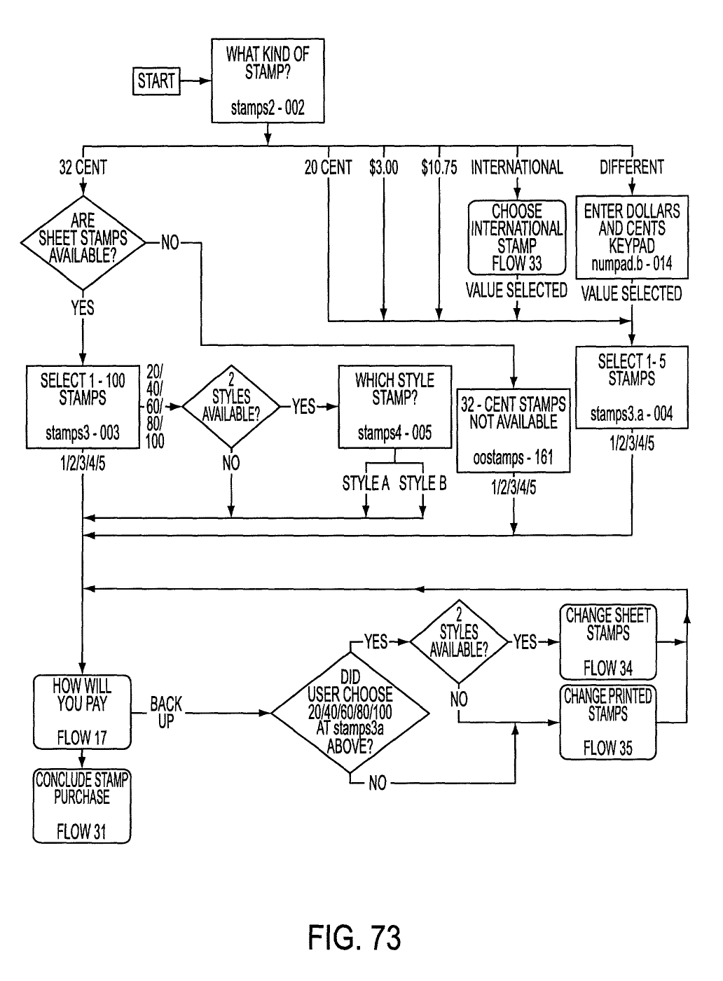

Referring to FIG. 73, shown as a system for purchasing stamps, the system walks the user through the process of buying stamps. The system displays the various options for stamps available and aids the user in the execution of the stamp purchase.

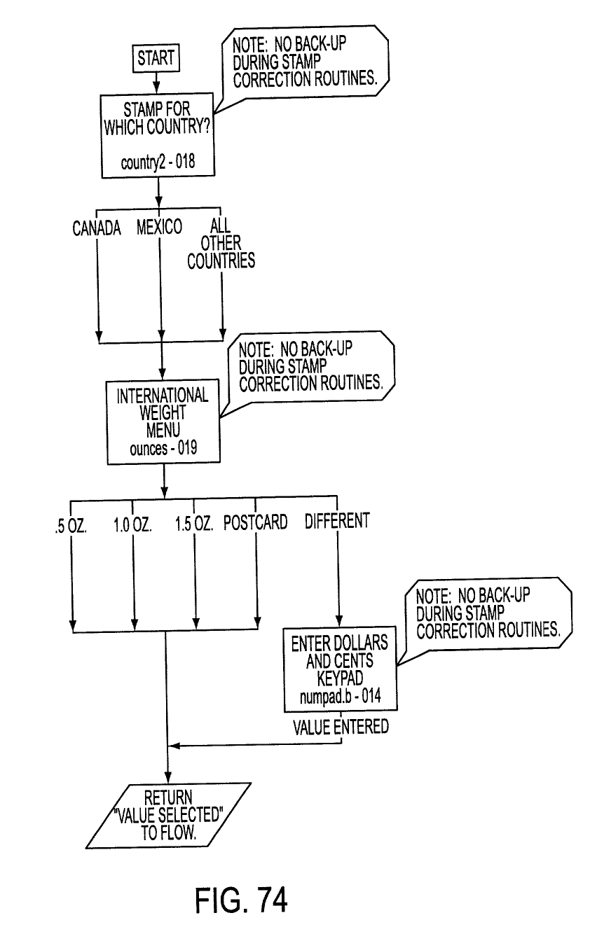

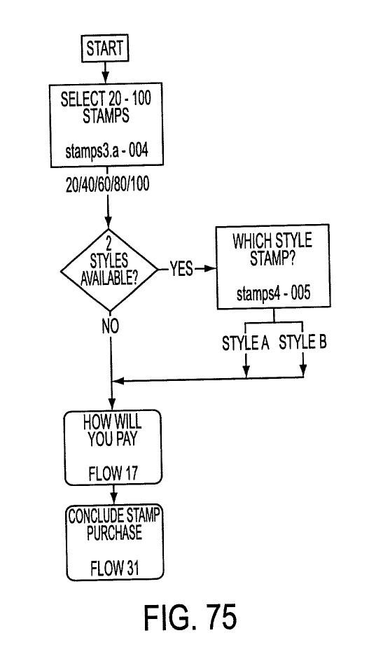

Referring to FIG. 74, shown as a system for facilitating the purchase of international stamps, the system helps users determine how much to pay for postage for international mailing transactions. First the system asks the user to identify the country for the stamp. Then the system lists the options. After the user has selected the country, the systems ask the user the weight of the item. In certain embodiments the scale is attached to the system and the system automatically calculates the weight. Then the system identifies the amount the user must pay based on the objective criteria of weight and mailing destination.

Referring to FIG. 74, shown as a system for facilitating the purchase of a 32-cent stamp, the system walks the user through the simple transaction of purchasing 32-cent stamps. It displays the numbers and styles that are available. It allows the user to input his criteria for the stamp purchase. It enables the user to purchase the stamp.

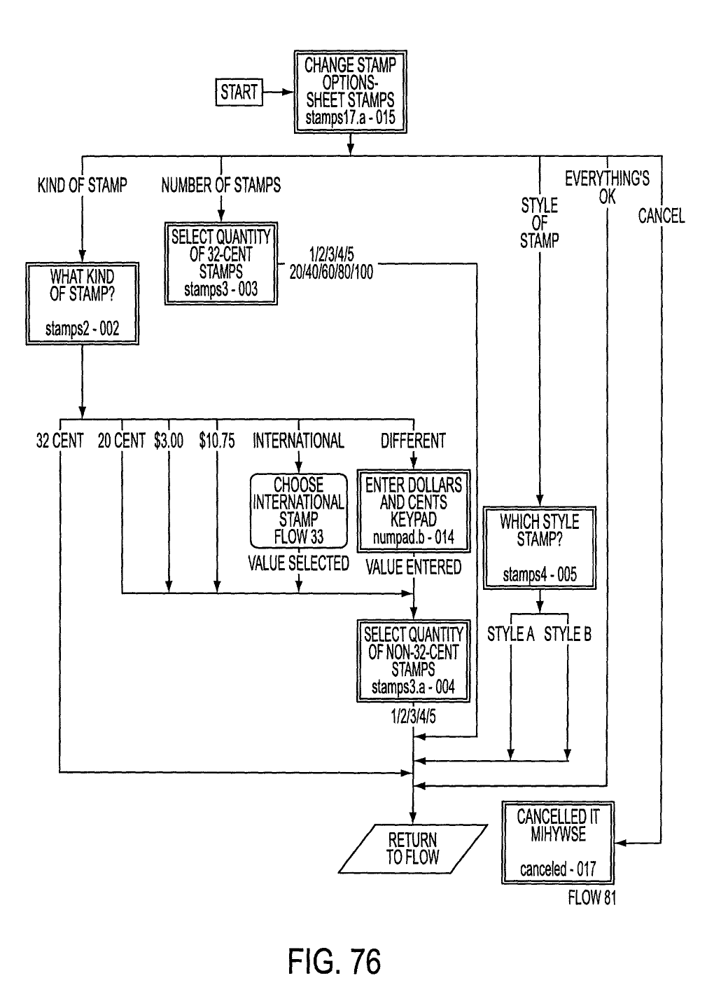

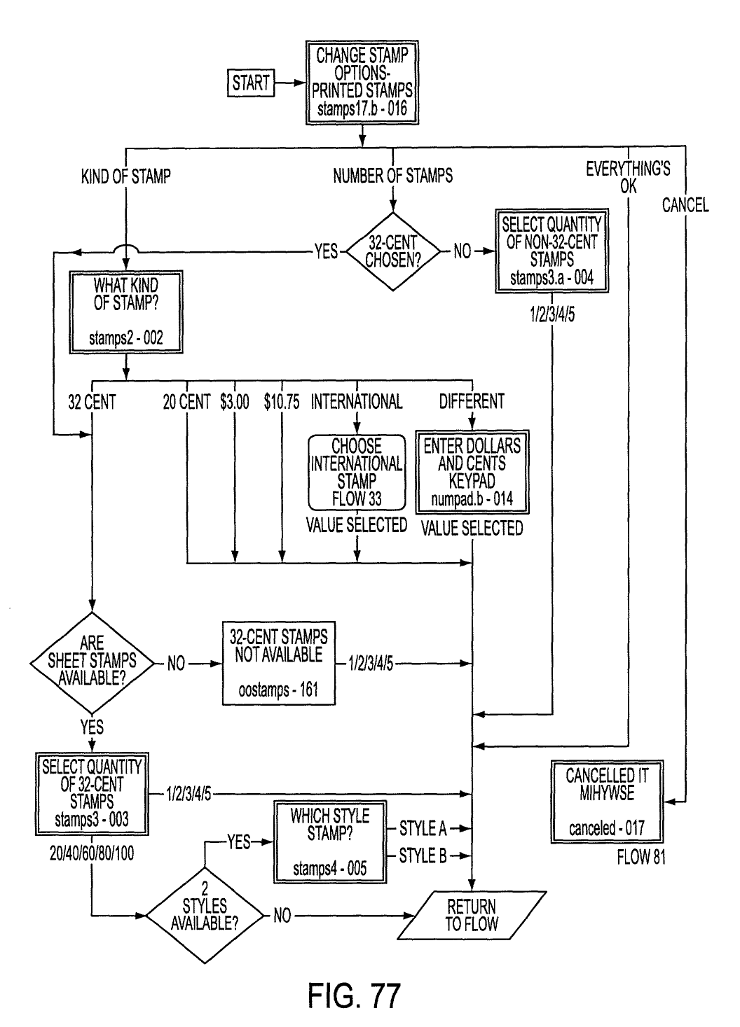

Referring to FIGS. 76 and 77, shown as a system for changing the stamp options selected in FIG. 73, the system allows the user to change the kind, number, or style of stamp that the user had previously selected. It also provides the option of canceling the transaction.

Referring to FIG. 78, shown as a system for looking up information, the system enables users as a part of the invention to access various types of postal information, including looking up zip codes, seeing postal rates and getting information on postal services. The system further provides access to information available publicly from other government agencies.

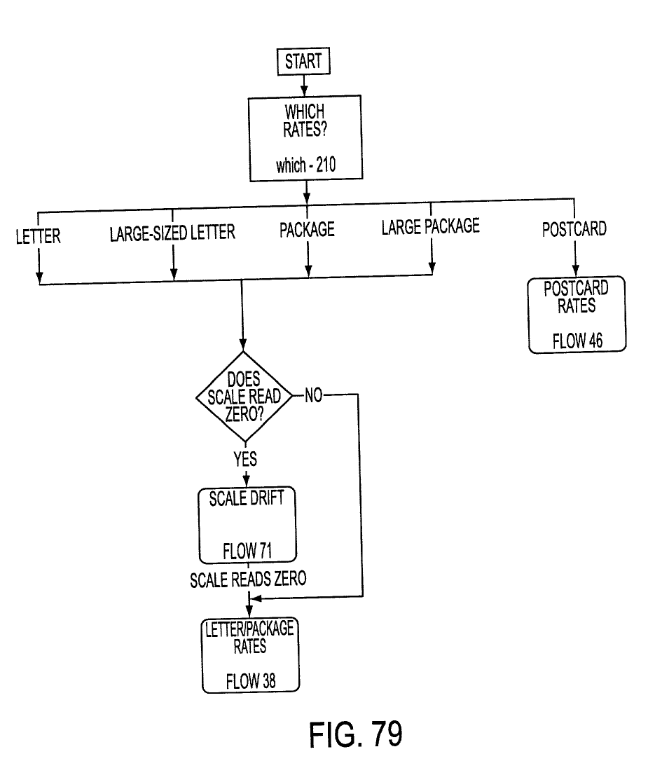

Referring to FIGS. 79 through 91, shown as flow charts of see mailing costs, this is an embodiment of the present invention of an interactive method of advising customers how much to pay for mailing services based on the customer's objective criteria, such as weight or size of package and subjective criteria, such as how quickly the package would arrive and the customer's need for certainty and closure (certified mail, insurance, return receipt requested.)

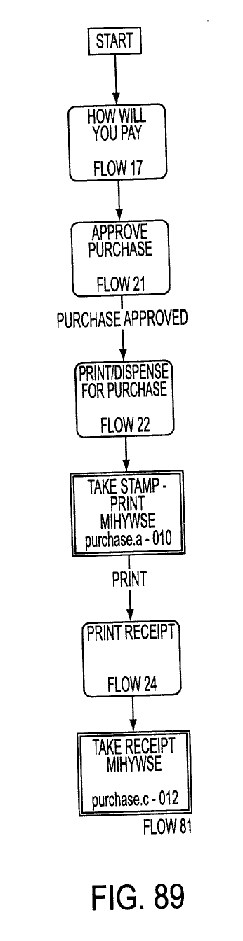

Referring to FIG. 89, shown as a system for determining how a customer will pay for the postage transaction after viewing the mailing costs. The opportunity to approve the purchase is also provided. The system also provides a means for physically obtaining postage and a printed receipt.

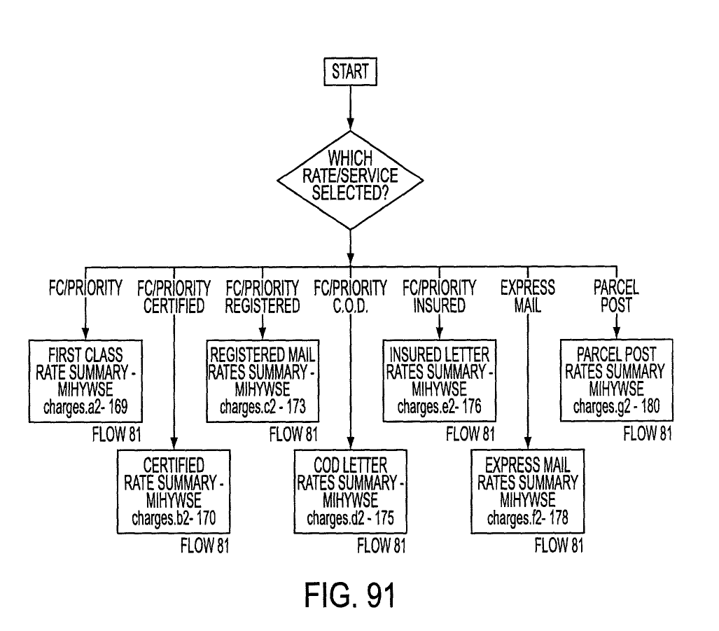

Referring to FIG. 91, shown as a system for displaying different postal rates and services available along with a summary of each rate and service that the customer can choose. The system facilitates a customer's ability to make informed decisions quickly.

Referring to FIG. 92, shown as a system for displaying broadly the services that are provided. Those include speed and cost of mailing, proof of delivery, security, and money services. The system facilitates a customer's ability to quickly understand the services that are available.

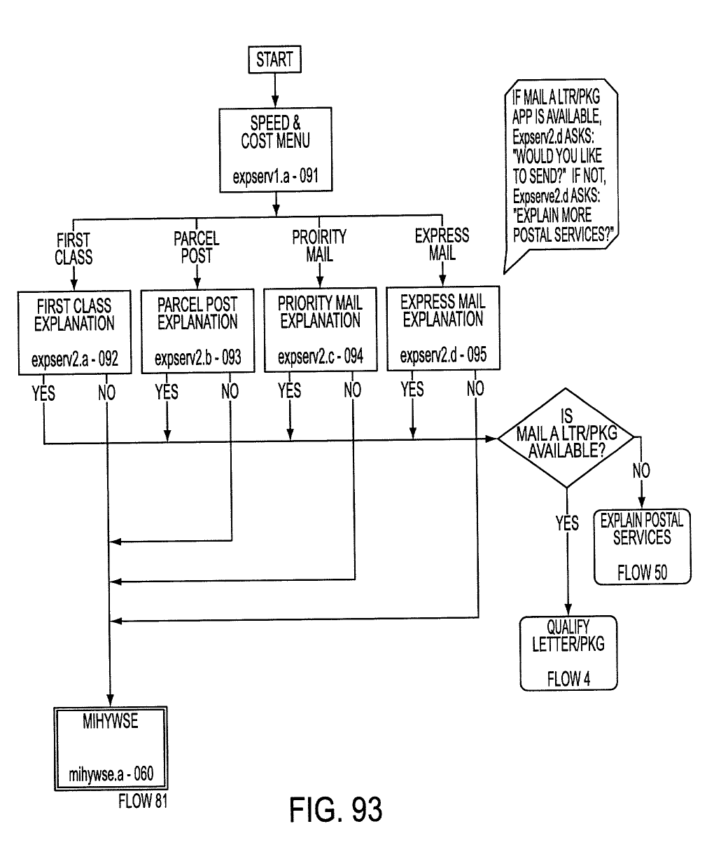

Referring to FIG. 93, shown as a system for viewing and explaining options such as First Class mail, Parcel Post, Priority Mail, and Express Mail. The system also provides a means of further explaining postal services, and whether an item intended for mailing qualifies as a letter or a package.

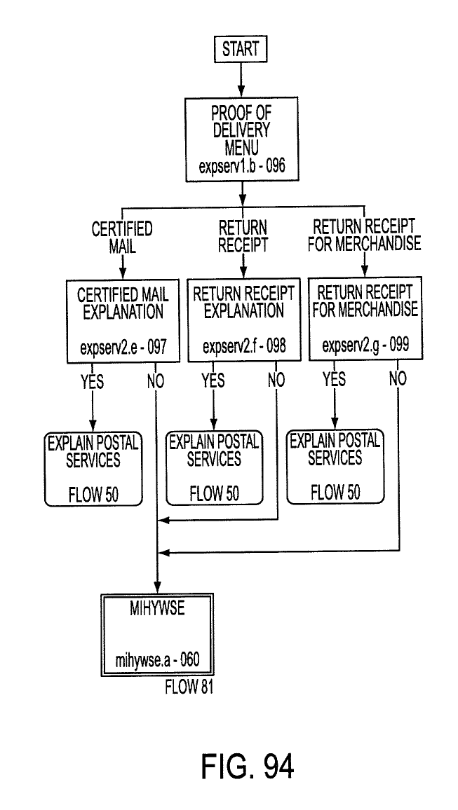

Referring to FIG. 94, shown as a flow chart offering and explaining Proof of Delivery and the options that are available including Certified Mail, Return Receipt, and Return Receipt for Merchandise. Following each choice is an explanation of postal services.

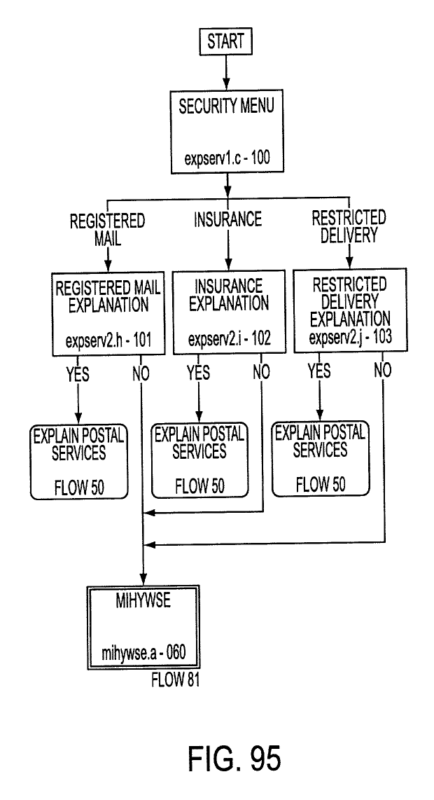

Referring to FIG. 95, shown as a system for explaining and offering the different security options available for mailing. These include Registered Mail, Insurance, and restricted Delivery. Following each choice is an explanation of postal services.

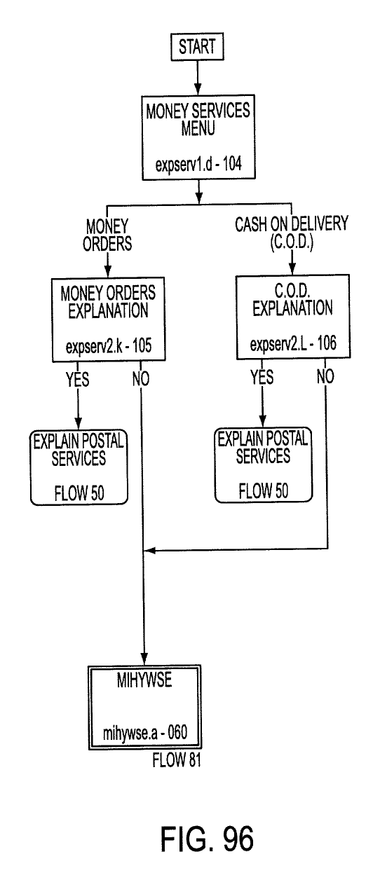

Referring to FIG. 96, shown as a system for offering and explaining the different money services available to a customer. These include Money Orders and Cash on Delivery. Following each choice is an explanation of postal services.

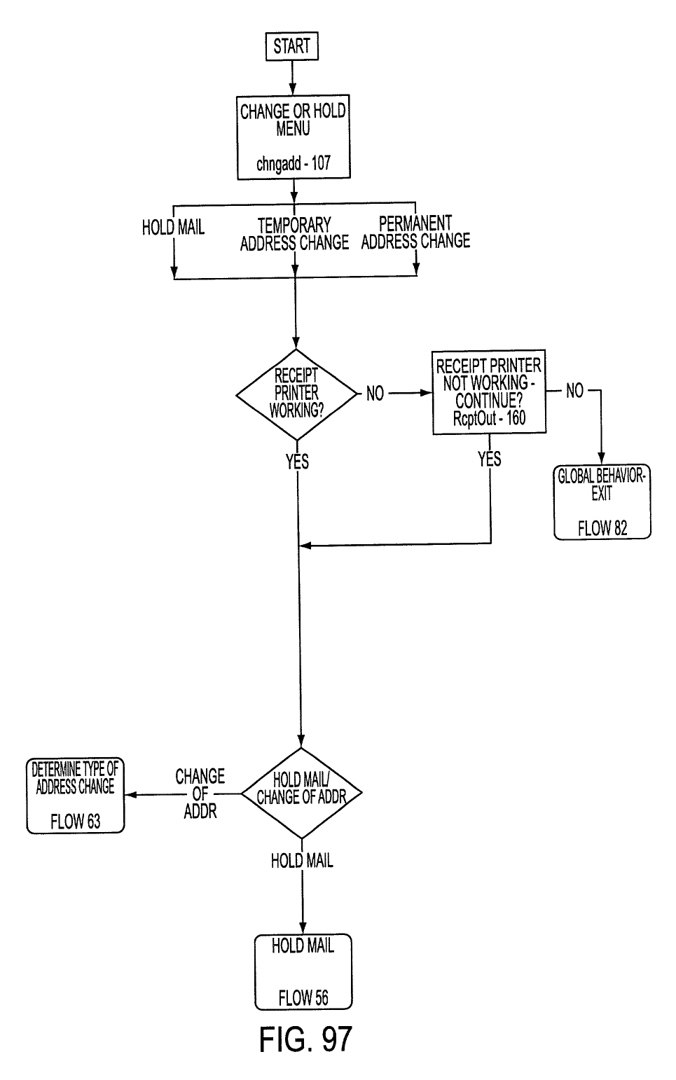

Referring to FIG. 97, shown as a flow chart for providing a customer with the means for changing a customer's address or holding a customer's mail. The system asks the customer if the change is temporary or permanent. The system then provides a receipt of the transaction.

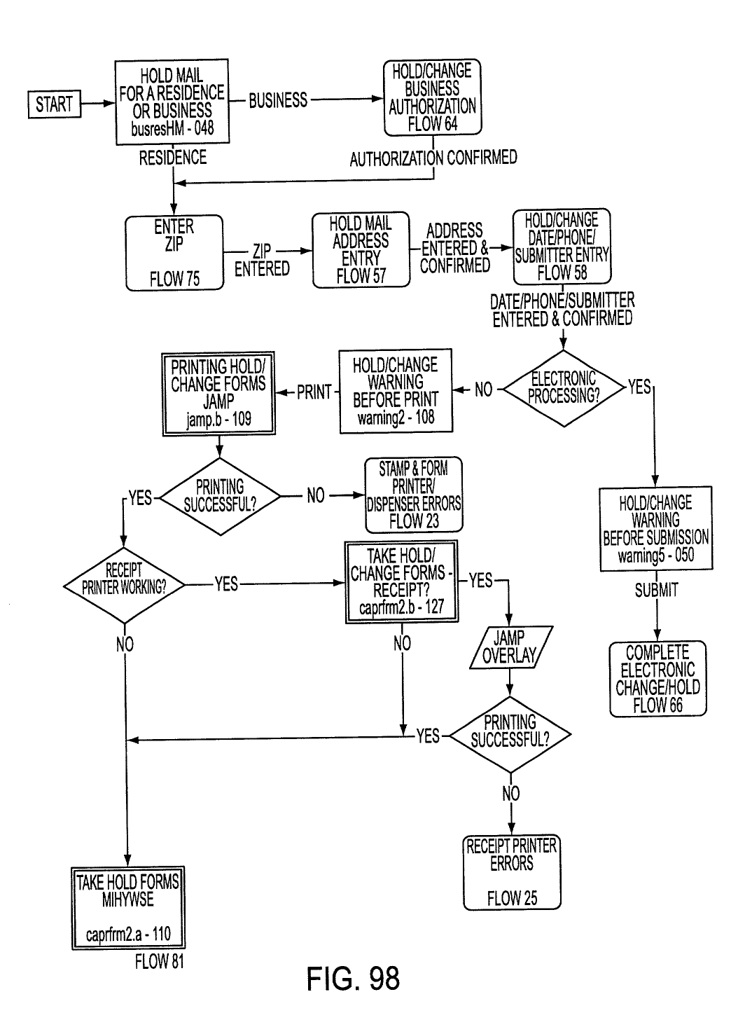

Referring to FIG. 98, shown as a flow chart for providing a customer with the means for changing an address or holding mail. The system requests information from the customer pertaining to their address, zip code, and the date for hold or change. After the customer confirms the address a receipt is provided.

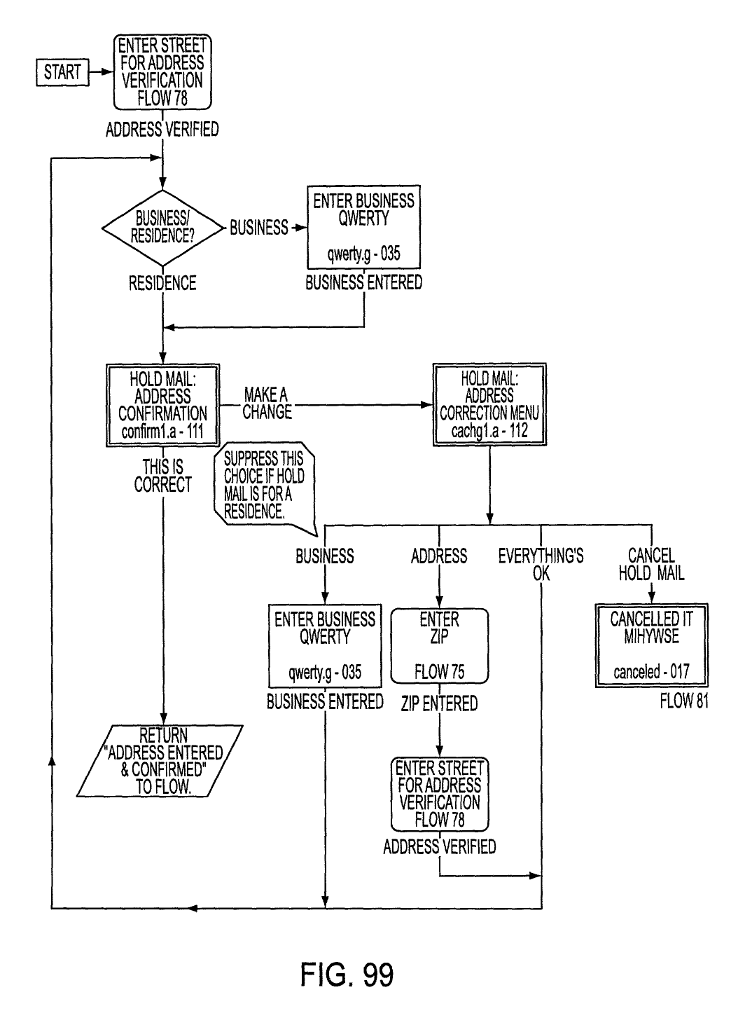

Referring to FIG. 99, shown as a system for providing a customer with the means for holding their mail and canceling the hold request. The system asks the customer if the hold is for a business or residence.

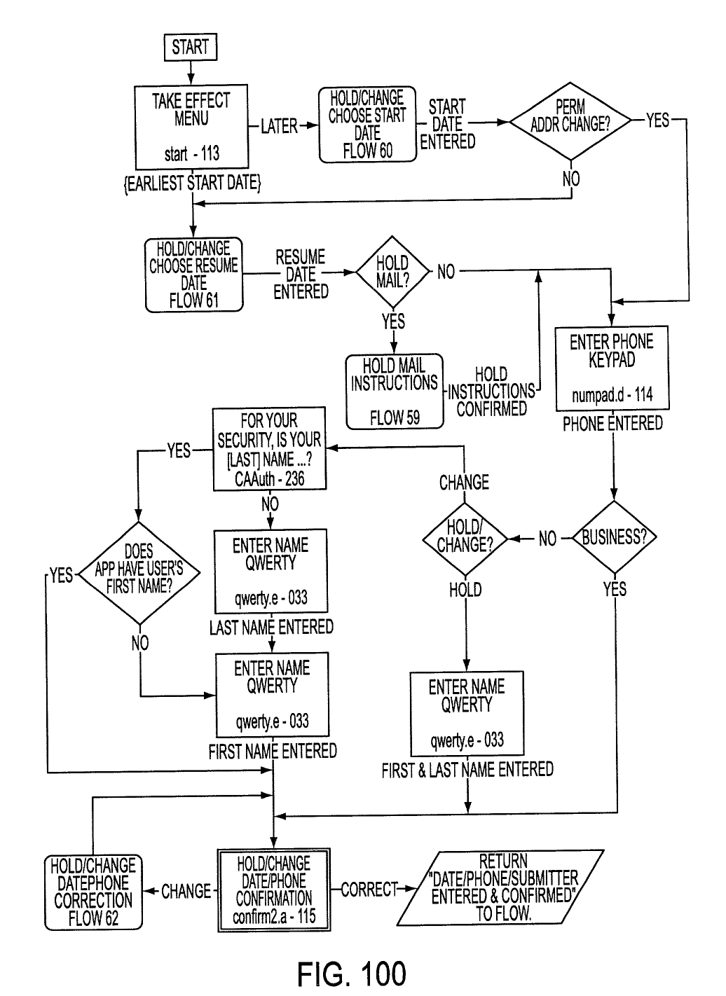

Referring to FIG. 100, shown as a system that enables a customer to choose a start date and resume date for holding their mail, including hold instructions, changing an address, and entering proper data to insure security for the customer.

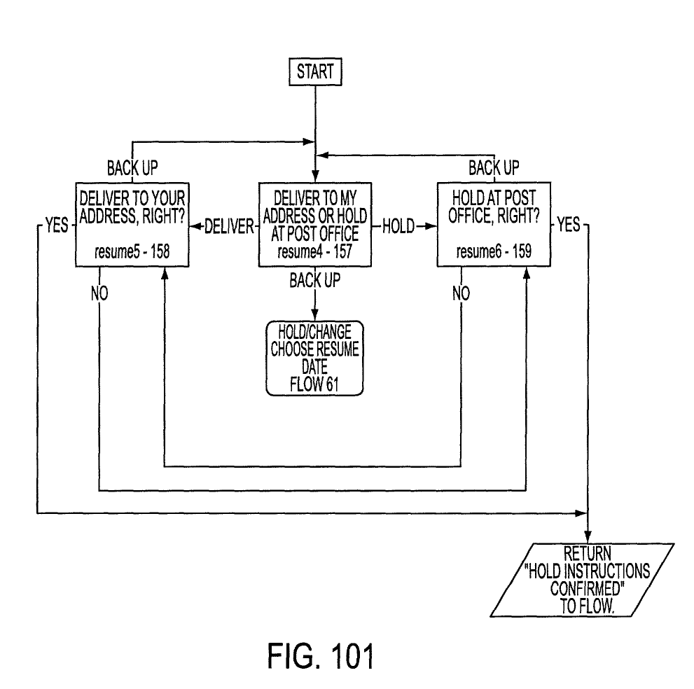

Referring to FIG. 101, shown as a system providing Hold Mail instructions. The customer is given the option to hold mail at the post office and to resume delivery to their address on a specified date.

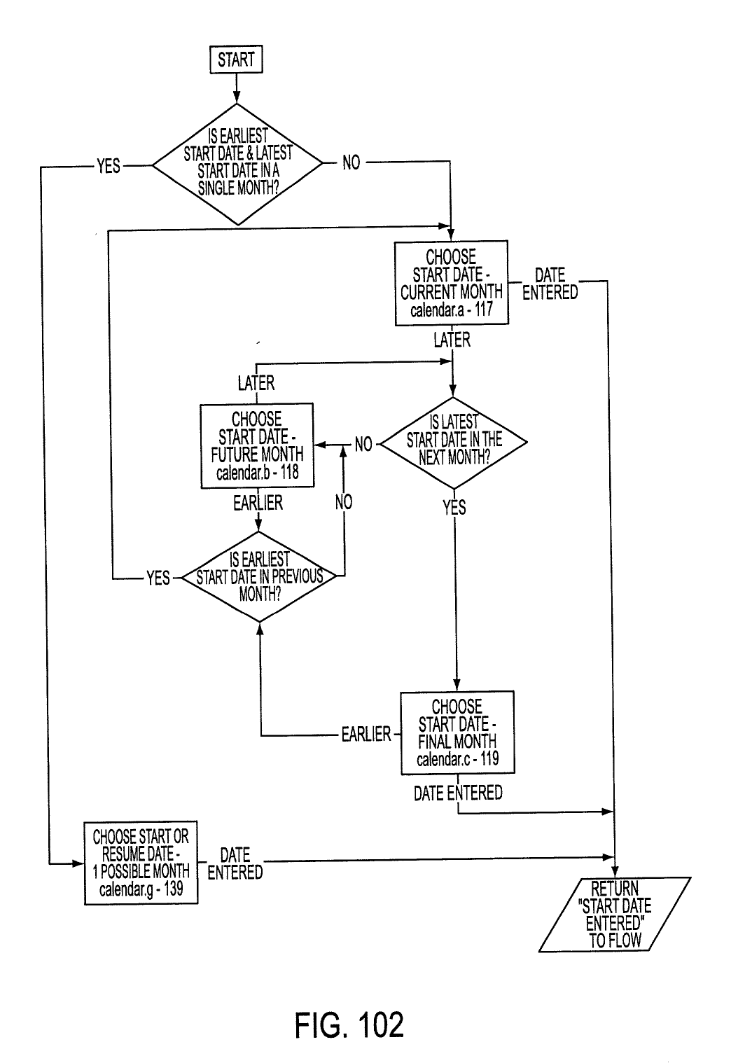

Referring to FIG. 102, shown as a flow chart that enables a customer to choose his start date to hold mail.

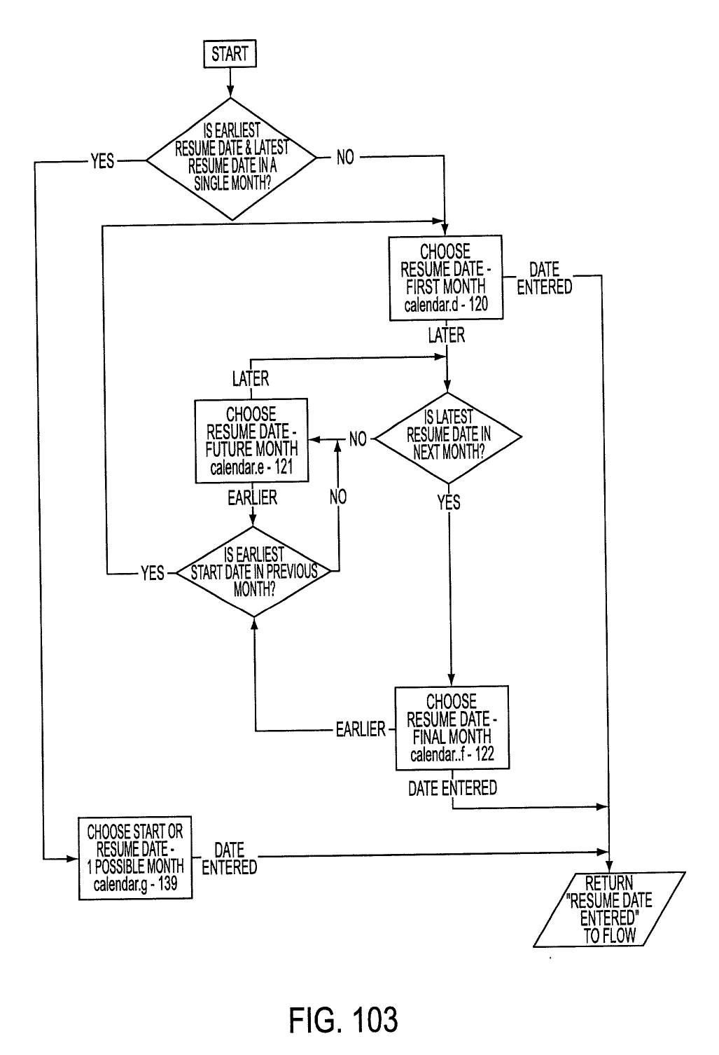

Referring to FIG. 103, shown as a flow chart that enables a customer to choose the date to resume mail delivery to the customer's address.

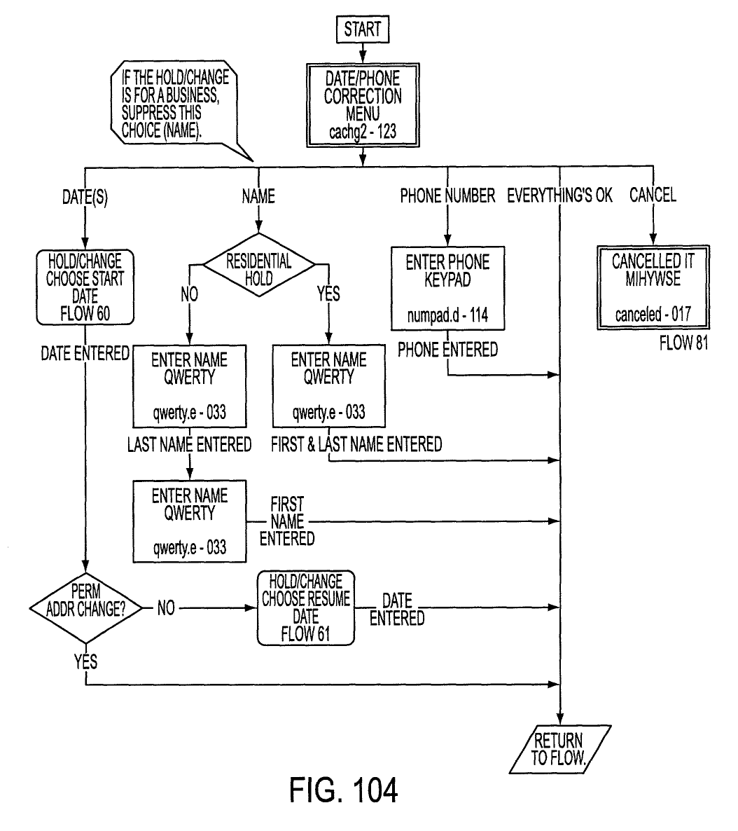

Referring to FIG. 104, shown as a system that enables a customer to correct the contact telephone number given by the customer to the postal service in relation to an address change or Hold Mail request. In this system the customer also enters his name.

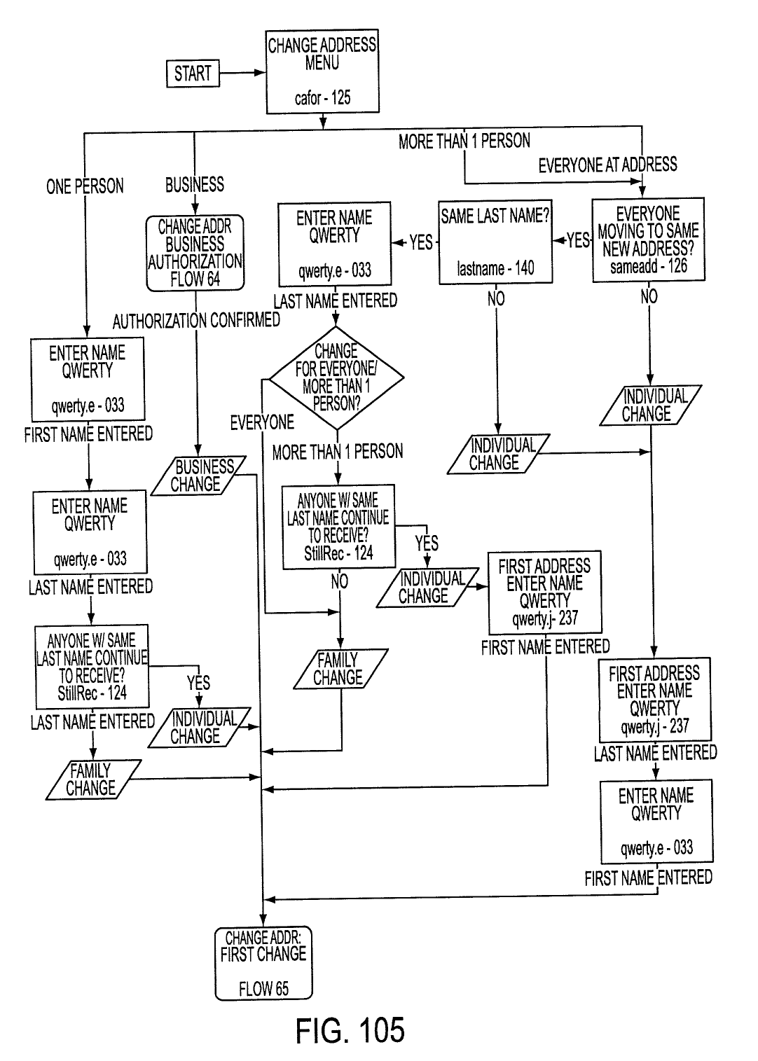

Referring to FIG. 105, shown as a system for determining whether an address change pertains to an entire family, an individual, a business, or anyone with the same last name.

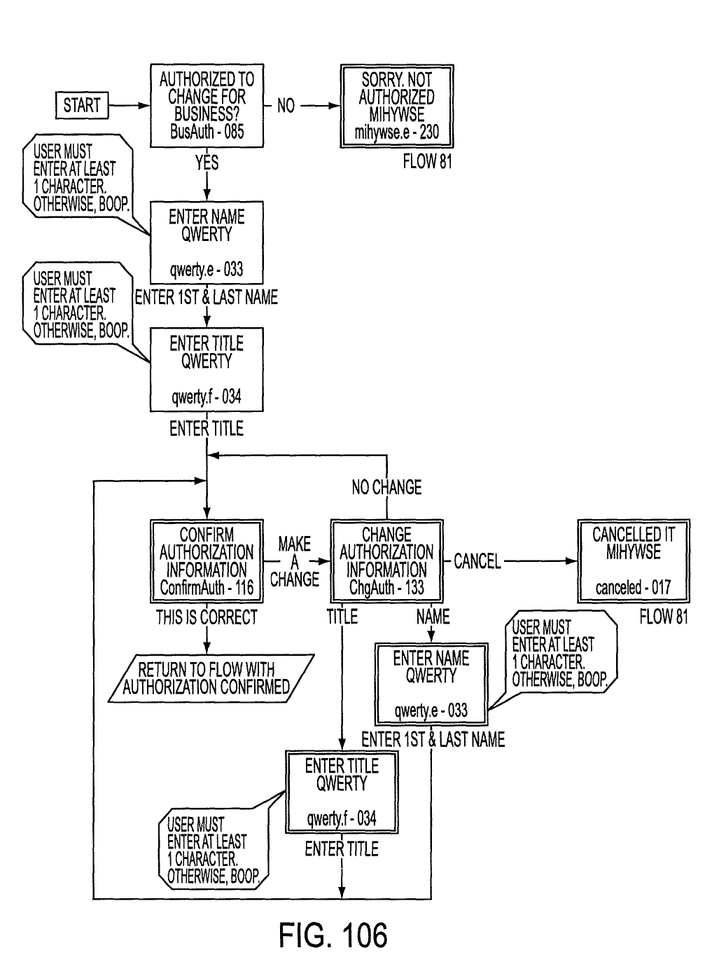

Referring to FIG. 106, shown as a system for determining whether a particular user is authorized to initiate a change or Hold Mail request for a particular business.

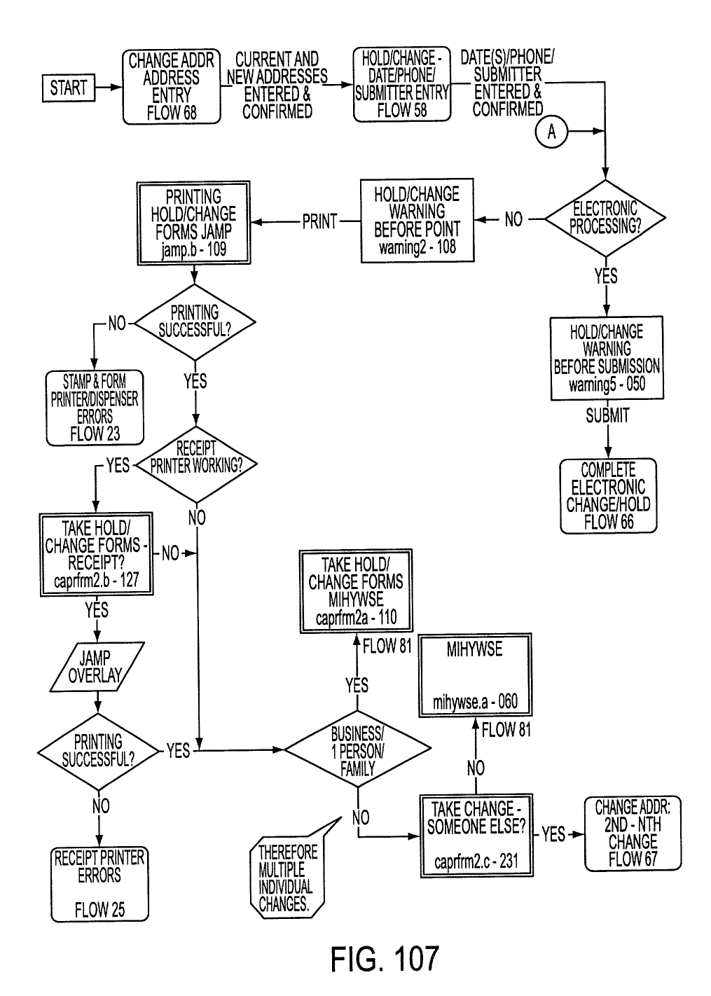

Referring to FIG. 107, shown as a system for entering a hold or address change. The date of change and telephone number of the customer is also requested. A receipt is provided.

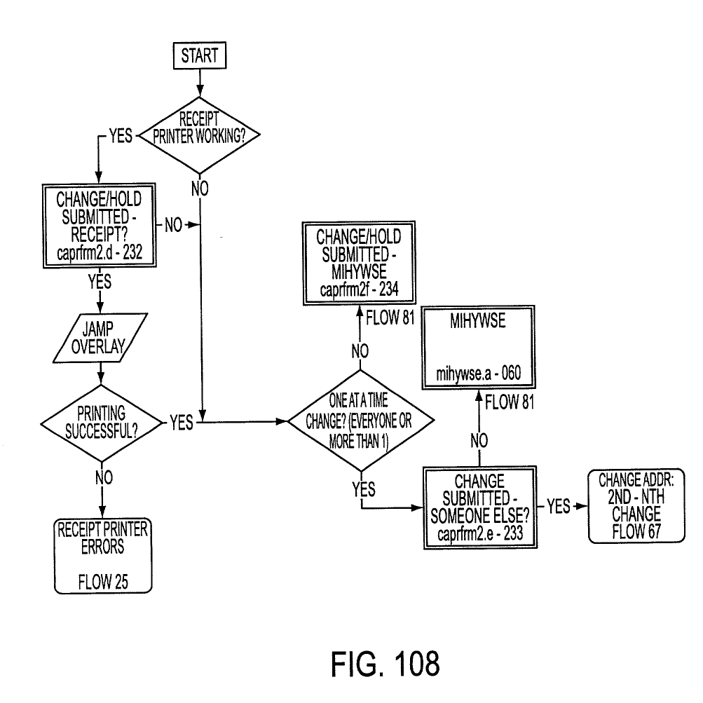

Referring to FIG. 108, shown as a flow chart that portrays the completion of then change or hold request. After a receipt is provided the system asks the customer if he would like to initiate another change or hold.

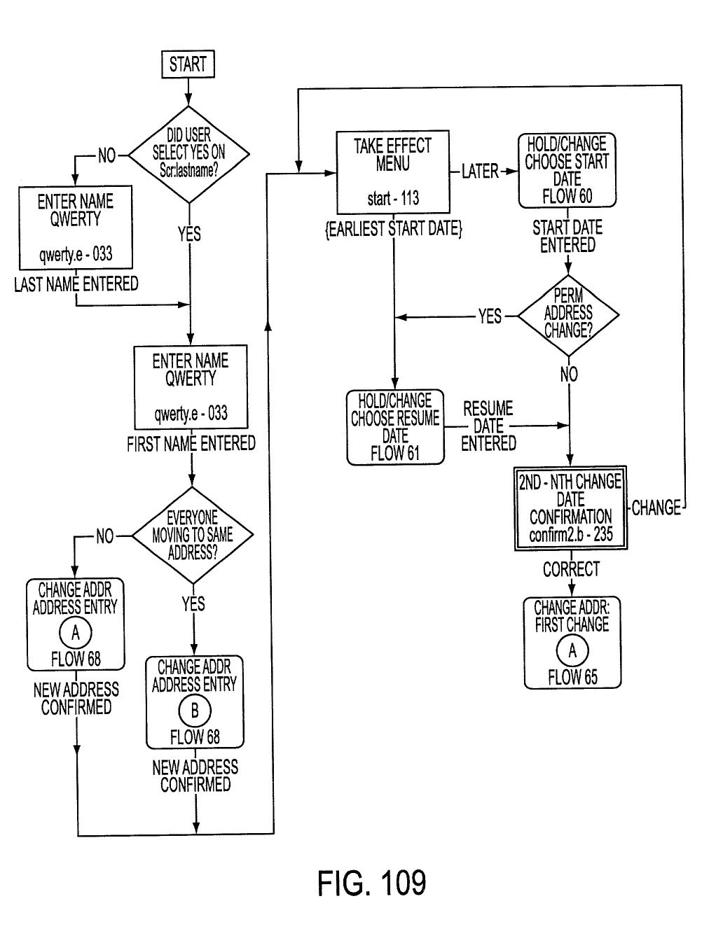

Referring to FIG. 109, shown as a system for implementing a second hold or change of address request. The flow is similar to the first change or hold request in that it requests information from the user pertaining to the user's name, the effective date of the change or hold, and whether everyone at the current address is moving to the same address.

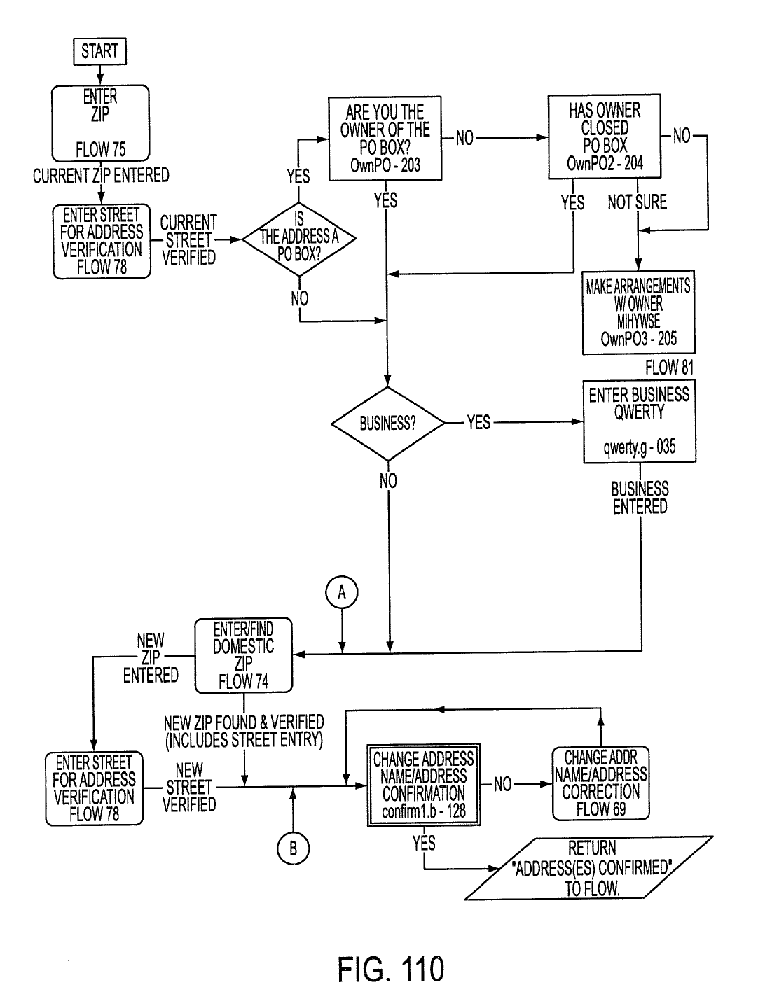

Referring to FIG. 110, shown as a system for entering an address change when the current address is a post office box.

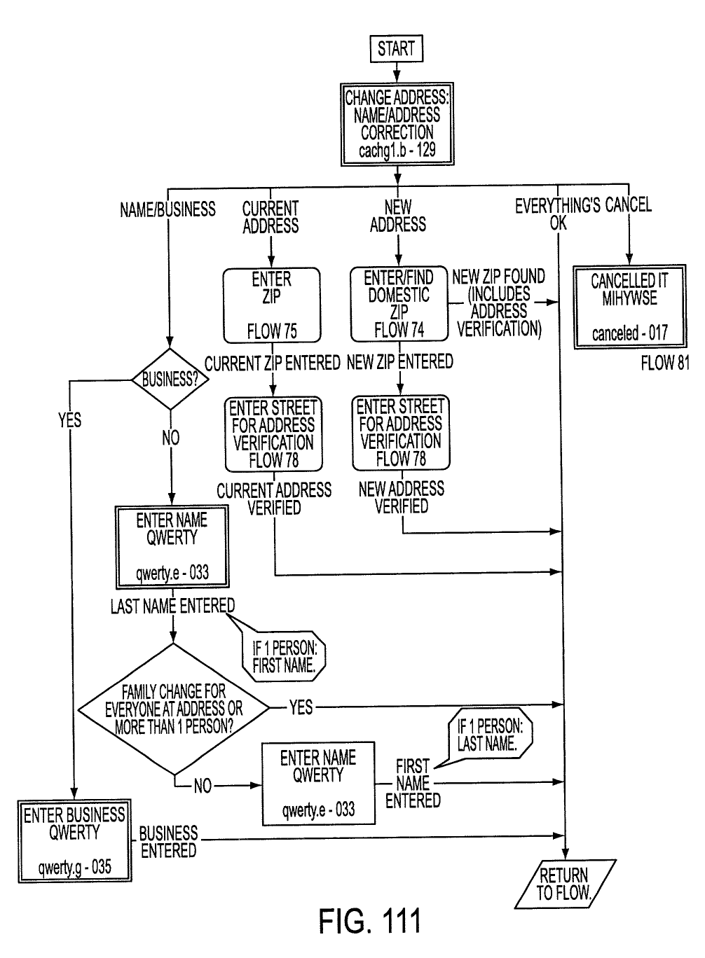

Referring to FIG. 111, shown as a system for correcting a name or address given in an earlier change address request. The system asks whether the change is for an individual, a family, more than one person, or everyone at the address.

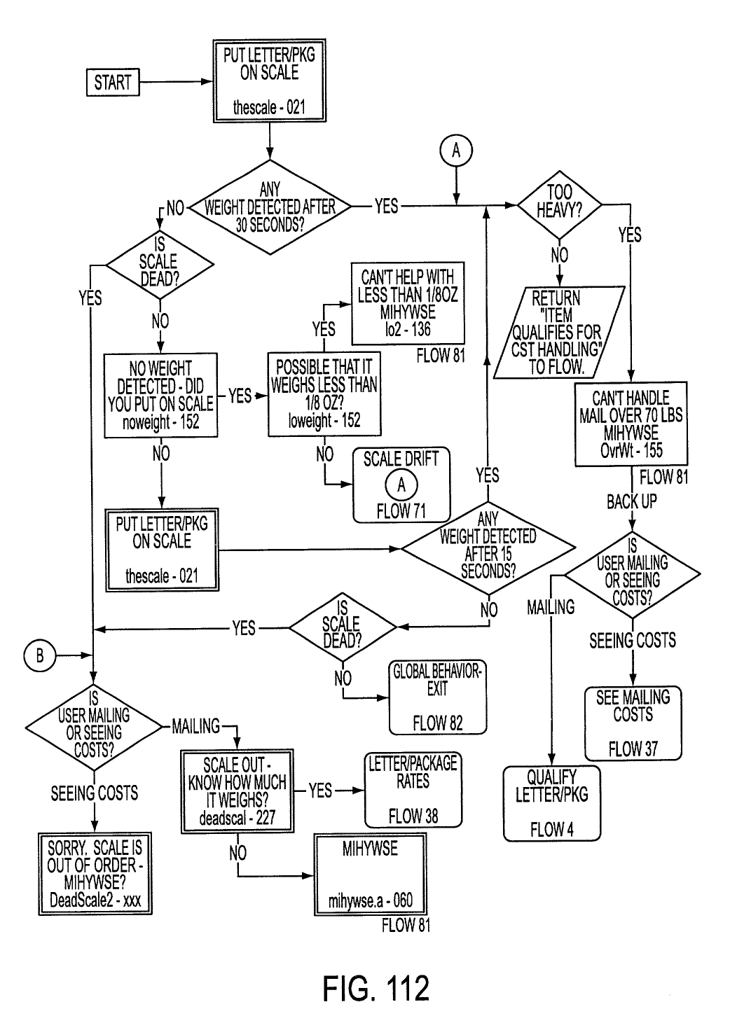

Referring to FIG. 112, shown as a system enabling a customer to weigh a letter or package and to view mailing costs. The system also demonstrates the prompts that appear if the scale is not functioning properly or if the item being weighed is less than ⅛ of an ounce or heavier than 70 pounds.

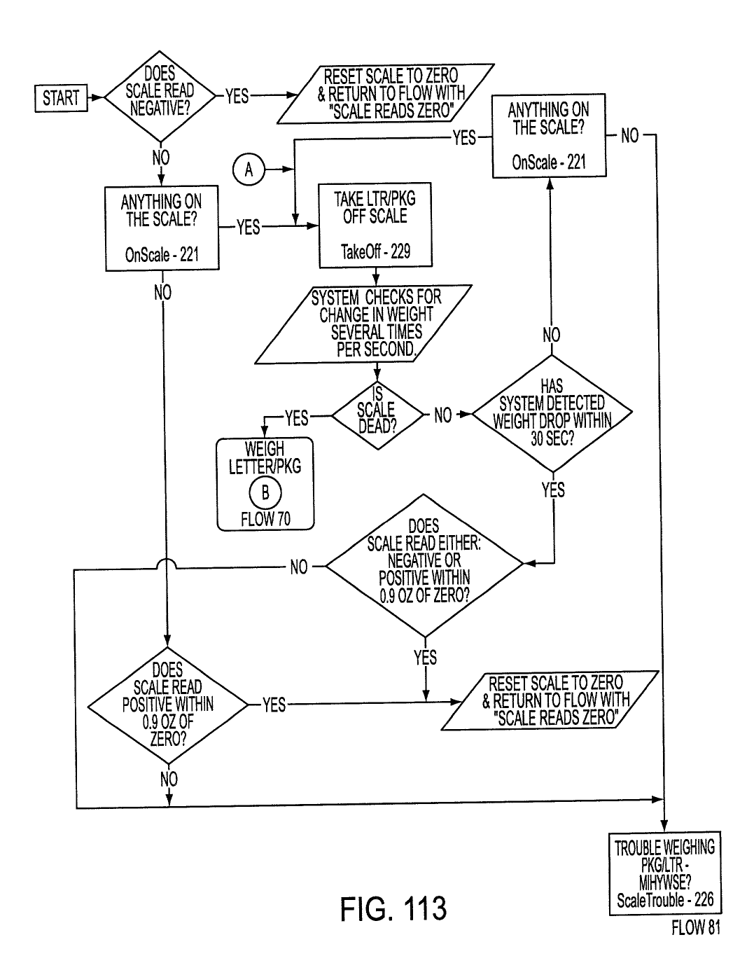

Referring to FIG. 113, shown as a flow chart demonstrating the internal checks and tests that the scale performs if the scale is not functioning properly.

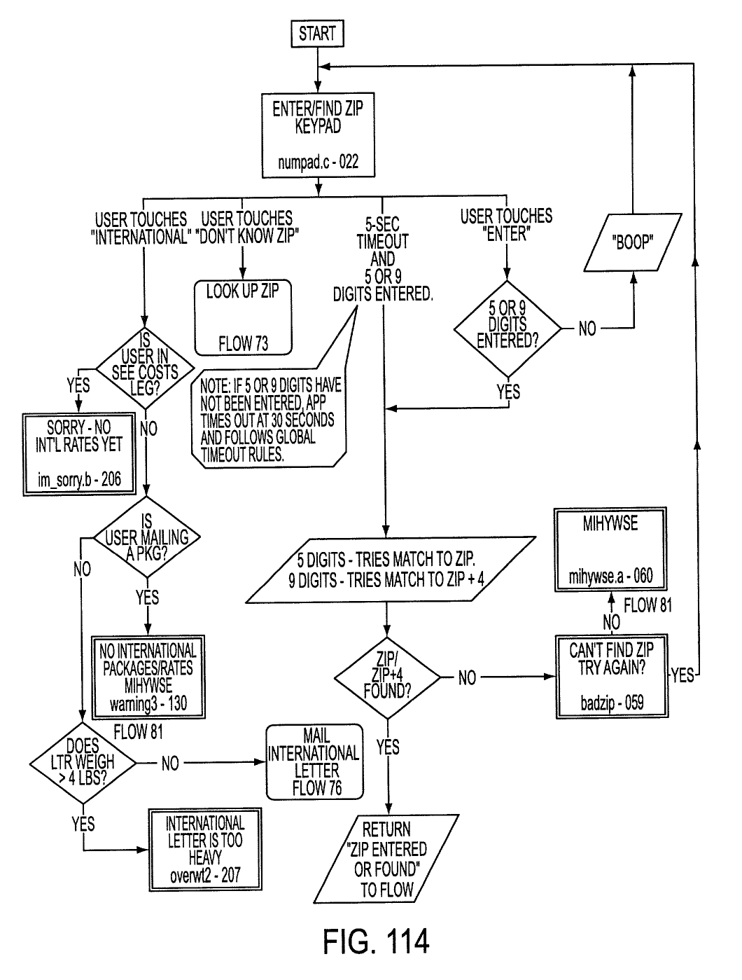

Referring to FIG. 114, shown as a flow chart demonstrating a system to find and enter the correct zip code. The system also provides assistance in mailing an international letter.

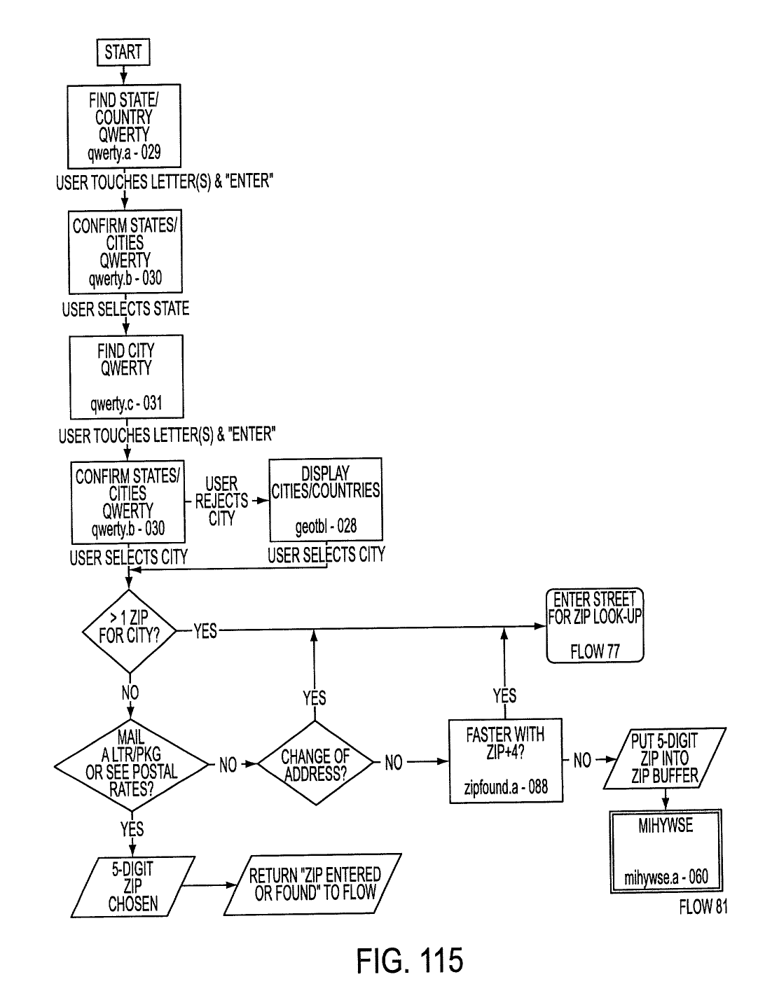

Referring to FIG. 115, shown as a flow chart demonstrating a system that enables a customer to find a zip code by entering a city, state, and street name. The system also provides the customer with the choice of mailing a letter or package, or viewing postal rates.

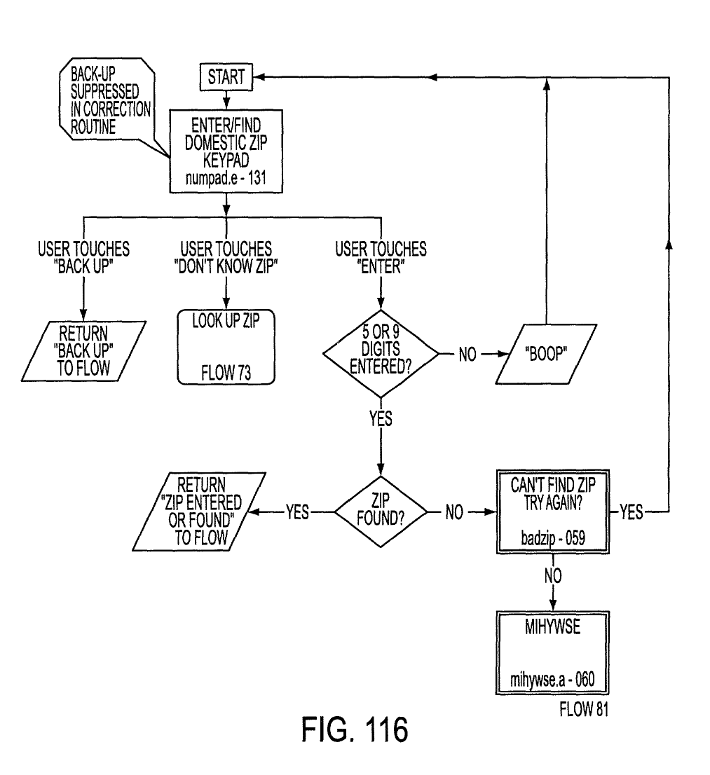

Referring to FIG. 116, shown as a system enabling a customer to find and enter the appropriate zip code.

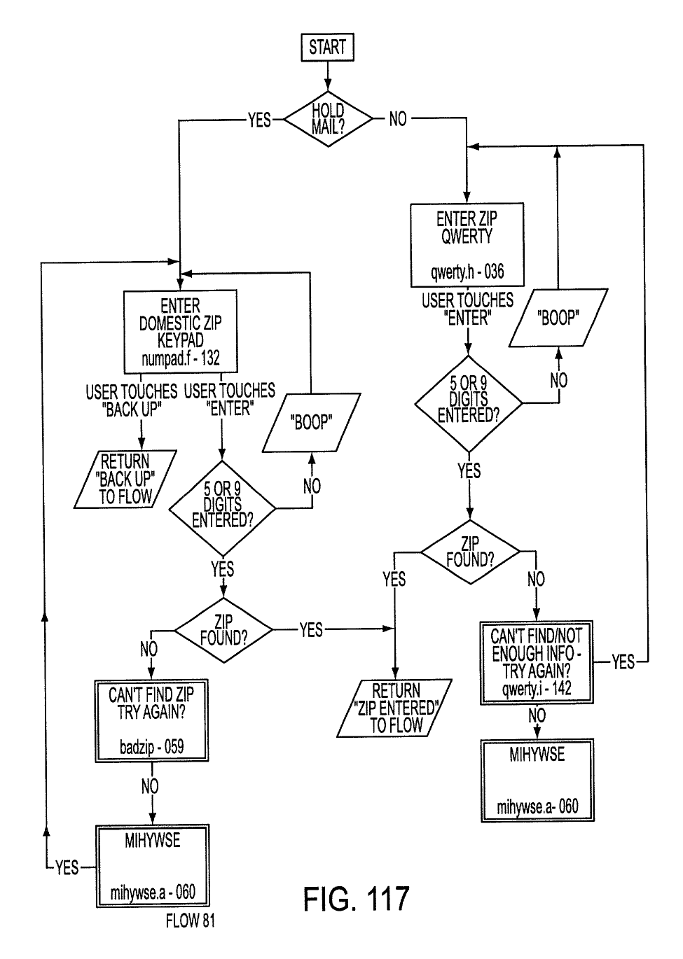

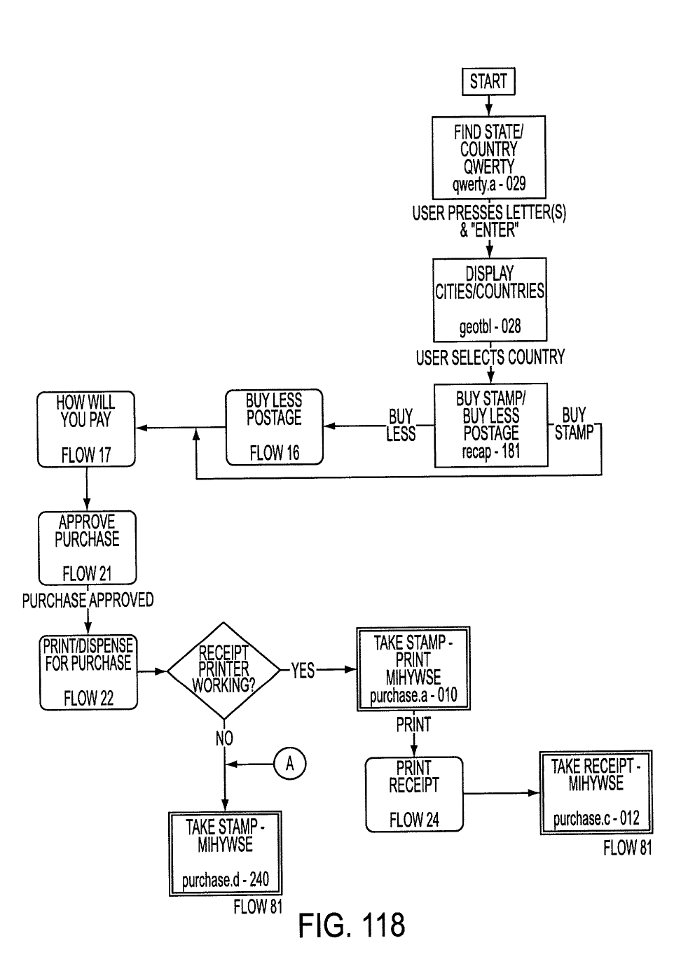

Referring to FIG. 117, shown as a system for entering a zip code for a Hold Mail request or for mailing a letter or package.

Referring to FIG. 118, shown as a flow chart demonstrating a system for mailing an international letter including buying the required postage, asking the customer how he will pay, approving the purchase, printing a receipt, and taking the stamp.

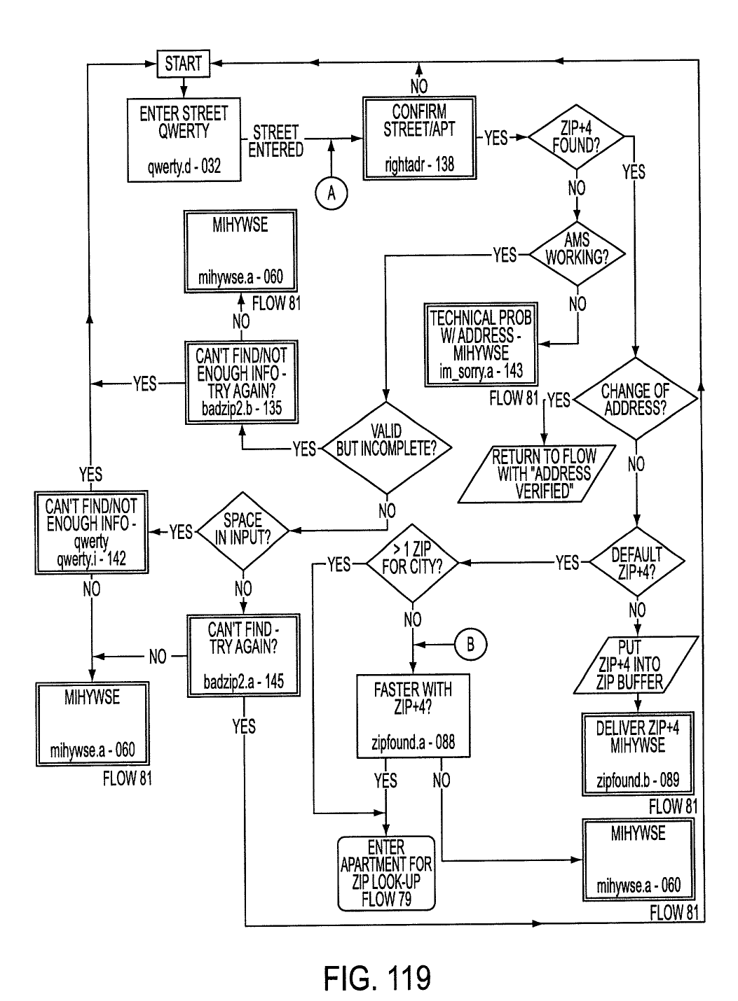

Referring to FIG. 119, shown as a flow chart demonstrating a system for looking up a zip code by street address.

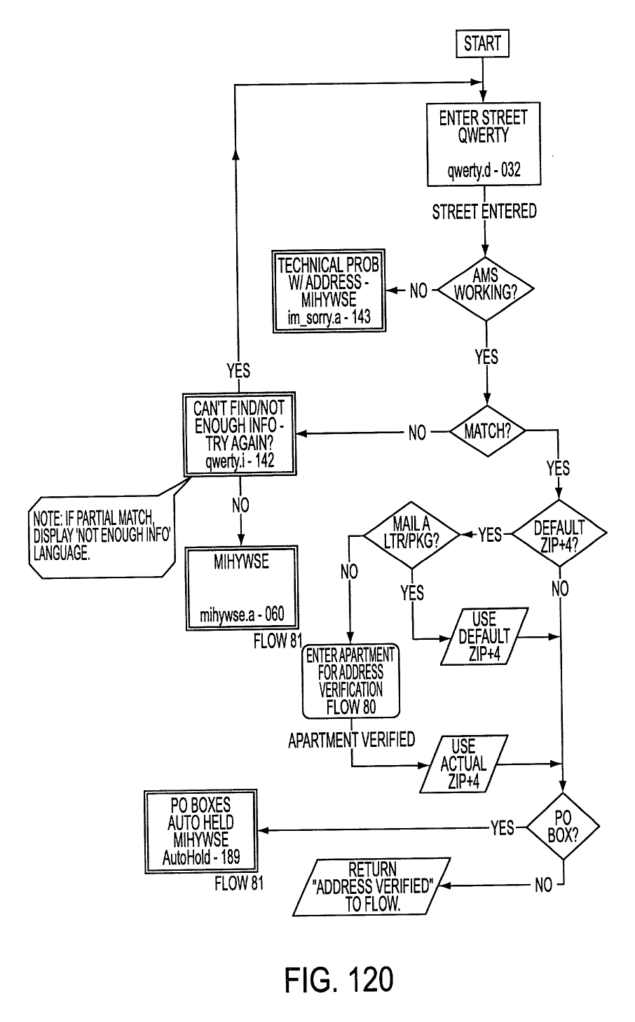

Referring to FIG. 120, shown as a system for entering a street for address verification.

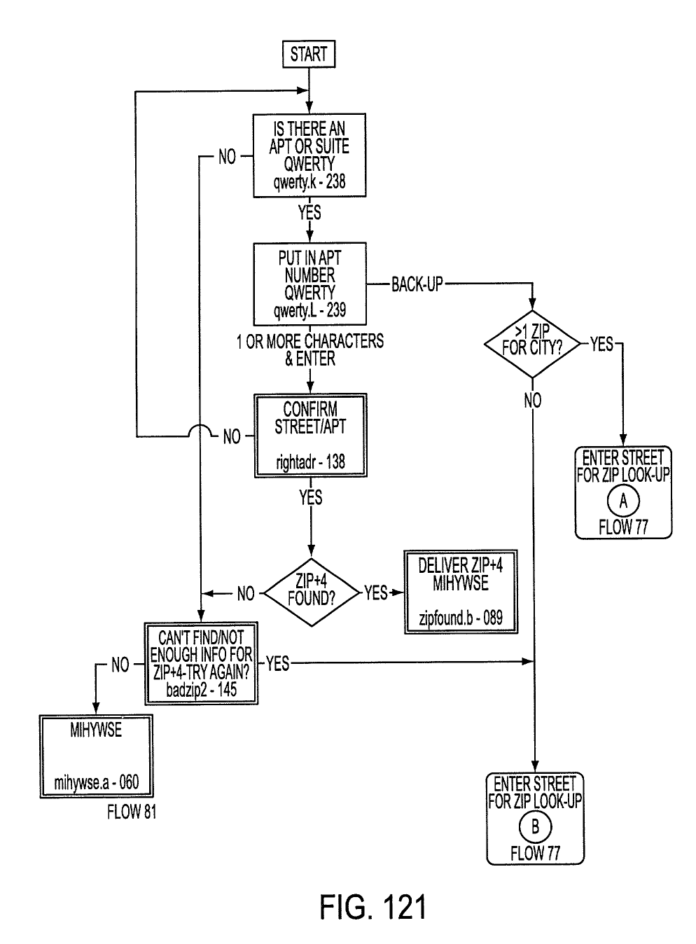

Referring to FIG. 121, shown as a system for looking up a zip code by entering an apartment number and street address.

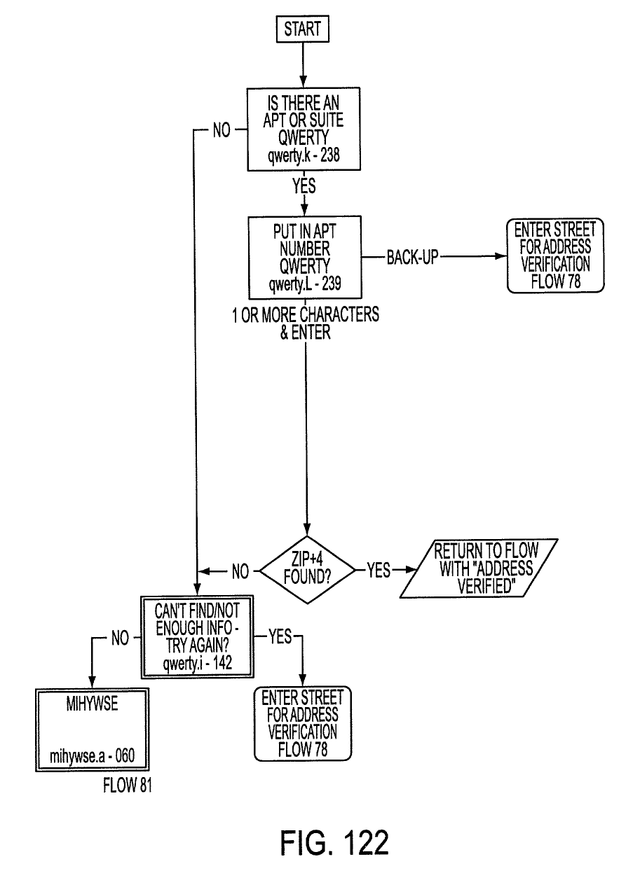

Referring to FIG. 122, shown as a system for verification of an address provided by entering an apartment number. Once a zip plus 4 is found the customer is returned to flow with address verified.

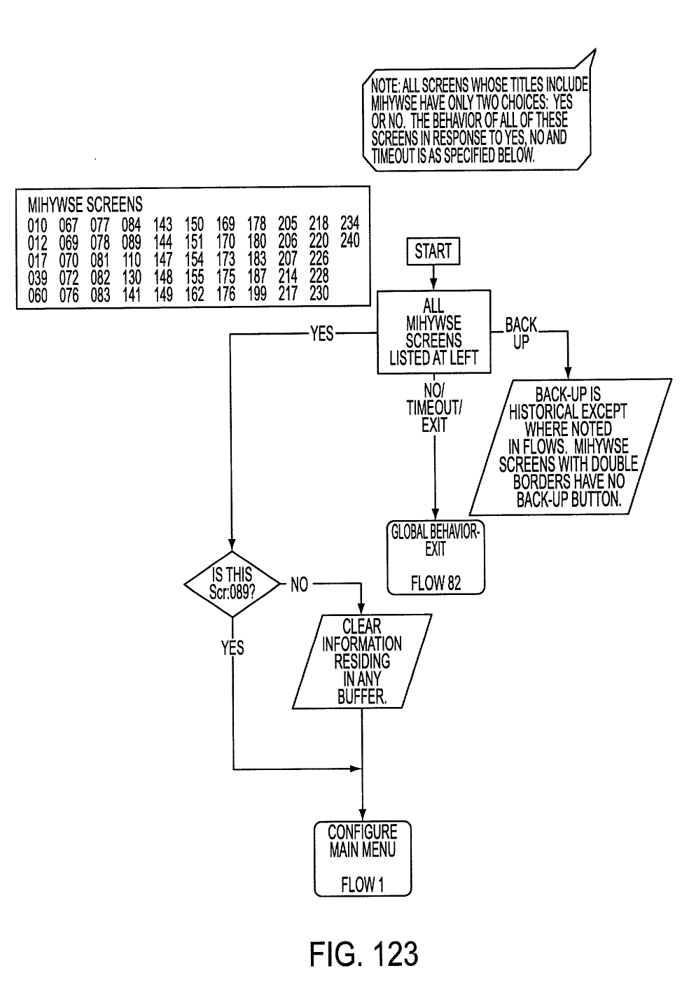

Referring to FIG. 123, shown as a flow chart demonstrating the global behavior source flows. All of the MIHYWSE (May I help you with something else) screens are listed in numerical order. There are 52 MIHYWSE screens. The flow chart demonstrates what appears on the screen if a customer answers No or time runs out.

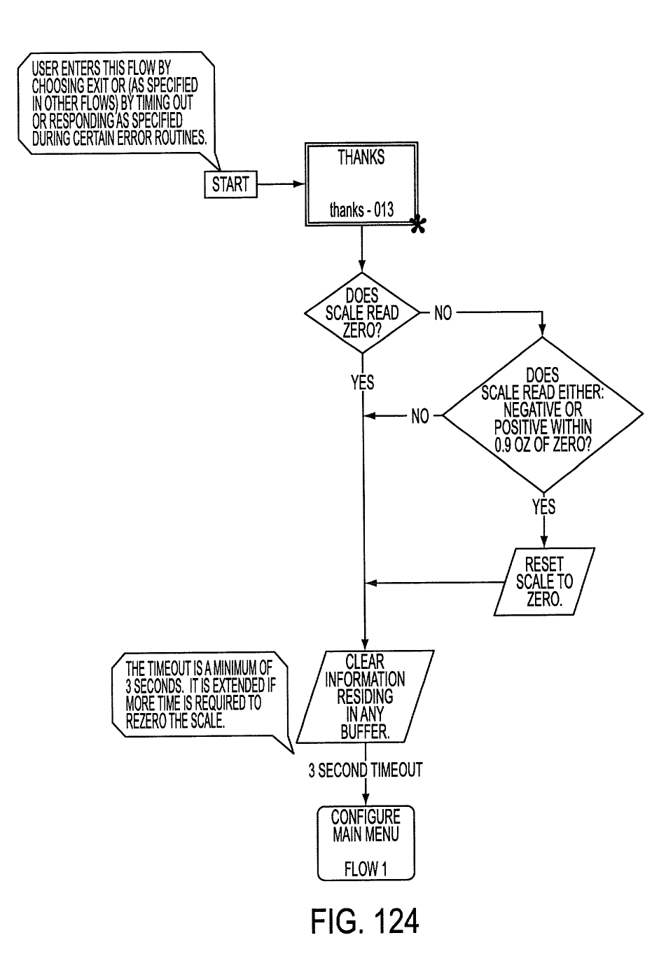

Referring to FIG. 124, shown as a flow chart demonstrating the global behavior flows and the exit flow. The chart demonstrates the flow to the main menu if the customer exits or time runs out in incremental periods. The flow chart also demonstrates what occurs if the scale does not read zero when it should.

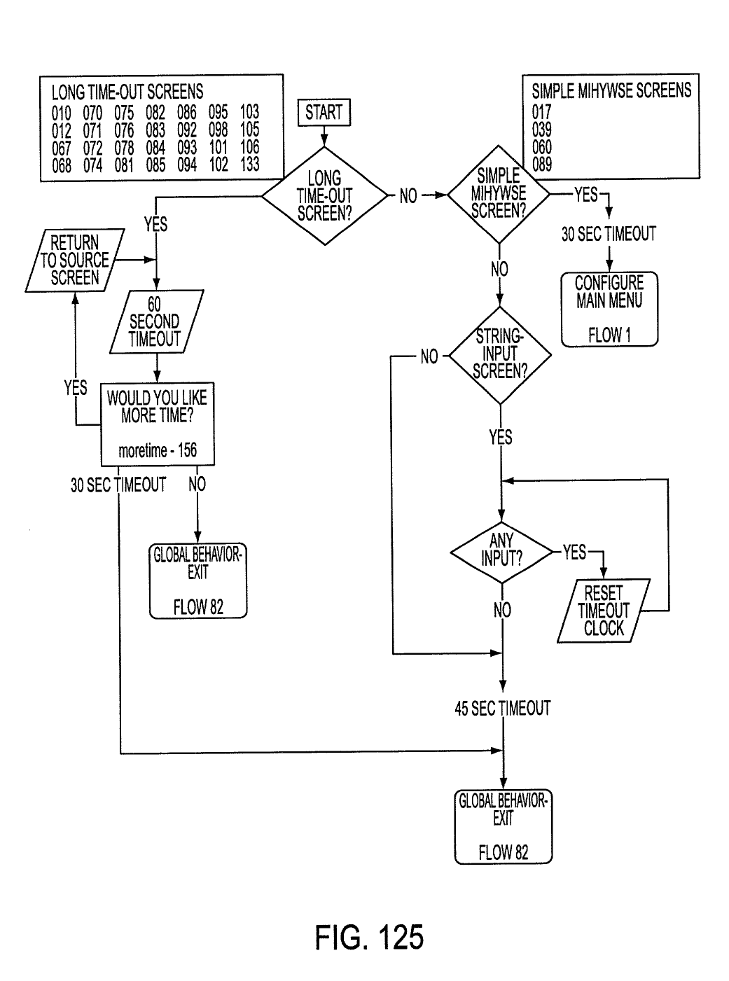

Referring to FIG. 125, shown as a flow chart demonstrating the global behavior for handling time-outs. There are two paths presented. One path is from a long time out screen which results in a global behavior exit after asking the customer if they need more time. This results in a 30 second time-out. The system defaults to a MIHYWSE screen. If the customer answers Yes or waits 30 seconds the main menu configuration appears. If the customer answers No there is a global behavior exit after 45 seconds.

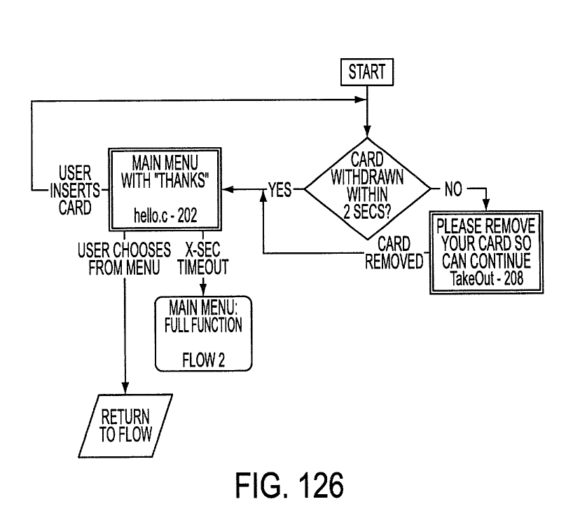

Referring to FIG. 126, shown as a flow chart demonstrating what appears when a customer inserts his card at main menu. The customer returns to flow once the card is inserted and removed.

Referring to FIG. 127, shown as a flow chart demonstrating global behavior back up flows. The system asks the customer if the user want to see mailing costs. If the customer answers No the system asks the user if he would like to start over. If the customer answers Yes the main menu configuration appears.

Telephone or Internet Services

Helping Customer Decide How Much to Pay for Telephone or Internet Services

In another embodiment of the invention, the system helps buyers choose which telephone or Internet service to purchase. As with the other embodiments of the invention, the system walks a customer through the process of determining which telephone service best suits his needs and how much to pay for telephone services on a step-by-step interactive basis. The screens are displayed on a stand-alone kiosk or personal home or office terminal, such as a PC, screen telephone, personal digital assistant or other information appliance.

In the first step, the system asks the buyer to identify the buyer's objective criteria for selecting a phone service from a menu that displays all of the relevant variables. These objective criteria include, but are not limited to, how many calls a month the buyer makes, what time of day he places the calls, whether he needs a calling service, whether he makes international calls, whether he calls one number in particular, whether he needs a tool-free number for incoming calls, whether he needs Internet service.

Based on the buyer's responses, the system displays the various options for telephone calling plans that meet the buyer's criteria. Based on the buyer's responses, the system automatically further refines the list of options.

In sum, the system and method of the present invention, as outlined in the above examples, can be used by customers for the determination of how much to pay for products or services, and/or for obtaining information on product or services. The system and method as outlined herein can be used for example, to determine how much to pay for mortgages, stocks, mutual funds, real estate, consumer products, including cars, tickets for entertainment, auction items, etc.

In one embodiment, for postal services, the invention enables users (both postal workers and consumers) to get ready access to all Postal service rules and services through multiple access devices, with a consistent interface. The system enables users to get personalized systemic advice on which postal services to use to meet user's objective and subjective needs, and enables users to perform virtually all transactions from purchasing stamps to certified mail services and to service their own needs, such as requesting an address change. Detailed examples of this advice and transaction capability, as well as the principal characteristics of the invention listed above, are included in the screens and screen flows, which are attached.

As an example, the postal rate calculator, walks a customer through the process of determining how much to pay for postage on a step-by-step interactive basis. The screens are displayed on a postal staff terminal, stand-alone kiosk or personal home or office terminal, such as a PC, screen telephone, personal digital assistant or other information appliance. The invention systematically identifies what it will cost to meet the user's need for speed and then presents other valid options. In page 1, the system asks the user what the user wants to mail and provides the user with the entire universe of options. The user selects his or her option, which, in this example, is a package. In page 2, The System asks the user for key objective criteria, such as the zip codes of the sending and receiving location, the weight of the package, and whether the package has any special characteristics. In the example, the user inputs the zip codes and weight. On page 3, the system asks the user for his subjective criteria of how quickly the user wants the package to arrive. The user selects “overnight”, which the system identifies as express mail for $24.00. On screen 4, the system asks the user whether he or she wants an additional Special Service. In the example, the customer does not choose any of the Special Services. On page 5, the system succinctly recaps the information that the user has input and provides the user with the advice for how much to pay and which service to select to meet the user's objective and subjective criteria.

In one embodiment, the invention is a business method and system for bringing public postal transactions to the home, office, or other non-public location. In this embodiment, the system provides the integration of advising, selecting and executing the appropriate mailing options based on the user's subjective and objective criteria with a system for managing mailing lists, addressing envelopes, folding mailing material, and “stamping” the mail with the Post Office IBID or the red indicia of a postage meter.

The system is deployed in several different configurations. In one embodiment, the system delivers the postal services and advice through an electronic communications network and an electronic device, such as a PC with a printer. In this embodiment, the user contacts the host computer by means of any communications network. The host computer delivers the systemic advice to the user about all postal transactions, including transmitting the postal indicia IBID for printing on the user's envelopes. This embodiment can be deployed with an attached scale used for weighing letters and packages for determining the correct postage.

In another embodiment, the system delivers the postal services and advice through an electronic communications network and an electronic device, such as a PC with a printer, which is also attached to a postal meter. The postal meter can print indicia of the correct postage on envelopes for mailing with instructions from the host computer.

In another embodiment, the system is deployed through an intelligent postage meter with electronic screen display, modem, and processing capability. The intelligent postage meter has the ability to automatically contact the host computer through the communications network for information updates.

Each of these embodiments can be further connected to a dedicated envelope printer. The envelope printer prints addresses, postal indicia for “stamping” upon instruction from the PC or intelligent postal meter.

In another embodiment, the invention enables airline employees and customers to get ready access to information on all airline services through multiple access devices, with consistent interface, get personalized advice on how much to pay based on customer's subjective and objective criteria, plus ability to perform transactions such as purchase of tickets, making reservations, selecting airline seats. See U.S. Pat. No. 5,886,889 (Integrated full service consumer banking system and method for opening an account, incorporated herein by reference.)

Rule Based Artificial Intelligence System for Enabling User to Complete Transactions and Get Information

Postal Transaction Machine (PTNI)

Airline Fulfillment Systems

The present invention describes a method of reorganizing, marketing, and delivering services for a variety of commercial transactions. It facilitates the electronic marketing and delivery of services in both a more appealing and more cost effective basis. The method is designed to enable at least 90% of the relevant market to use the system with satisfaction without any training. The system provides customers and employees an easy and automatic system and method to access a full range of services, obtain relevant information, and complete purchasing and service transactions using a variety of access points with direct access to the computer systems of the service provider or company. The system enables companies and service providers to reduce their costs, improve reliability, reduce training time, and improve customer satisfaction. The system and method provides a way to present complex information and multiple options to enable users to do what they want and find the information that they want in a step by step, menu driven, intuitive fashion.

Benefits of the invention include: making customers and employees aware of the myriad of services and transactions available in a simple and convenient way.

The system reduces frustration of customers by determining and fulfilling their needs on an expedited basis. It enhances sales opportunities by either allowing customers to service their own needs or by allowing the sales staff to service the customer in an effective way. It is easily updated to accommodate changes, new information and new services. The system enhances sales opportunities by providing customers the information that they need about a product or service at the tune that they need it.

The system provides an improved method for seamlessly accessing the service provider's services and products.

It provides a system and method for making those services available to a customer at every access point in a consistent manner.

Consistent interface promotes quick familiarity with new products and services, it reduces sales training time of the staff, it provides operating.

Efficiencies and cost reduction.

The system also allows companies and service providers to pass cost savings to customers.

The system promotes loyalty and satisfaction. The principle characteristics of the system are:
Permits customers to access transactions and services through a variety of access points, including stand alone public terminals, supported terminals, home terminals, or telephones;
Provides clear view of myriad of complex services when a customer or staff member is interested in them; Facilitates customers' understanding of choices and ability to get information and conduct transactions by using succinct instructions with intuitive navigation techniques; Fully integrated system that connects customer, staff end back office terminals in a seamless way.

System includes a transaction terminal with or without a touch screen that enables a customer to walk through a transaction on a step basis.

Navigation. The options for navigating include having the action button, touch screen buttons or other prompts, a constant location, not all over the screen, as is over, the case in most internet and Microsoft applications.

The system makes it clear how to navigate around one screen, within a specific subset of an application? and throughout the entire application.

Data Input. The system enables users to input extensive alphanumeric data by presenting a standard QWERTY keyboard on the touch screen and allowing users to type their data input by touching the QWERTY keyboard on the touch screen.

Simplicity of screen. The content of any given screen is limited in size, so as not to overwhelm the user with more information than is needed at any even step of the transaction;

Constant order of magnitude. The specificity and generality of questions are always presented within same order of magnitude. For example, opening screens will ask the general question what do you want to do with a list of the broad choices do things or get information. Once an option is selected, such as get information, then the user is presented with the specific list of types of information that the user can obtain. A screen that provides a general choice of what to do would not be mixed with a screen that lists specifically how much does the package you want to mail weigh, or get $100 money order.

Symmetrical Fashions. Questions are either related to getting information or doing transactions, but not mixed.

Exhaustive and Exclusive. The step by step method of presenting options to the user presents questions that are exhaustive and exclusive so that there is no ambiguity.

Limitation on Number of Variables The method of eliciting information and presenting options uses a limited number of variables, so that users will not be confused or overwhelmed by the number of choices.

Rule Based artificial intelligence. All rules products, and service options are integrated into the system, rather than requiring users to team the options.

An example of are embodiment of the invention include a postal transaction system. The system provide information and convenient and automatic access to postal transactions through a variety of access points all with the same customer interface so that the customer only teas to learn a simple method of obtaining the information and can obtain such information and services when, where, and how the customer chooses.

Examples of the access points include: self service automated postal teller machine kiosks, a staff-assisted postal processing system for performing postal transactions using two computer terminals, ‘one for the customer and one for the clerk, at the postal point of sale; a staff-terminal to facilitate the postal clerk's ability to provide information and conduct transactions, an automated voice response system, on-site and remote computer access. This invention comprises the system, software, navigation, and graphic user interface (GVI), which is also referred to as the look and feel.

Another embodiment would include a system with the same access points and features for conducting line transactions.

In one embodiment for postal services, the invention enables users (both postal workers and consumers) to get ready access to all Postal service rules and services through multiple access devices, wit1x a consistent interface. The system enables users to get personalized systemic advice on which postal services to use to meet users objective and subjective needs, and enables users to perform virtually all transactions from purchasing Stamps to certified mail services and to service their own needs, such as requesting an address change. Detailed examples of this advice and transaction capability, as well as the principal characteristics of the invention listed above’ are included in the screens and screen flows.

The purpose of the above description and examples is to illustrate some embodiments of the present invention without implying any limitation. It will be apparent to those of skill in the art that various modifications and variations may be made to the composition and method of the present invention without departing from the spirit or scope of the invention. All patents and publications cited herein are incorporated by reference in their entireties.

1. A system for advising a consumer how much to pay for goods and services comprising:
a user interface for allowing a customer to access a host computer via an on-line network,
a host computer which solicits a consumer's objective and subjective criteria for the purchase of goods or services in an interactive, intuitive manner,
wherein based on the consumer's needs and access to available data on goods or services, the system generates at least one of options, recommendations, referrals to providers of goods or services, and prices of goods or services,
and means for presenting information to the customer.

2. A system according to claim 1 wherein the goods to be purchased are selected from the group consisting of groceries, office products, computers and household items.

3. A system according to claim 1 wherein the services to be purchased are postal services and the goods purchased are postal goods.

4. A system according to claim 1 wherein the services to be purchased are telephone services or airline services.

5. A system according to claim 1 wherein the services to be purchased are

6. A system according to claim 1 wherein the services to be purchased are

7. A system for advising a consumer how much to pay for goods and services comprising:
a user interface for allowing a customer to access a host computer via an on-line network,
means for collecting information from the customer regarding desires related to the purchase of goods or services,
means for receiving the customer selection of at least one component regarding the purchase of goods or services,
means for performing a needs analysis based on information collected,
means for recommending at least one of options, recommendations, referrals to providers of goods or services, and prices of goods or services based on the needs analysis, and
means for presenting information concerning goods or services information to the customer.

8. In an integrated system for determining how much a customer should pay for goods or services comprising:
means for assembling a personal profile that includes means for collecting salient data,
means for building an integrated customer account relating to the purchase of goods or services including customer data relating to the purchase of goods or services;
means for receiving a customer selection of at least one component of the integrated customer account;
means for performing a needs analysis based on information collected;
means for recommending goods or services based on the needs analysis;
means for presenting information concerning the selected component of the integrated customer account relating to the purchase of goods or services to the customer; and
means for allowing data collected to flow to all other points where the data is required so that data need not be entered more than once.

9. The system of claim 8, further comprising means for generating multiple prompts for certain pieces of data such that the user may exercise personal judgment concerning the appropriate time to collect such data.

10. The system of claim 8, further comprising pending file means for storing information that is collected, but not immediately needed.

11. The system of claim 8, wherein each component of the integrated customer account relating to the purchase of goods or services includes data fields and the system further comprises means for transferring data between the data fields and means for entering data fields in different components that are related such that data entered in one data field can be copied into other related data fields.

12. The system of claim 8, wherein the means for building the integrated customer account relating to the purchase of goods or services comprises means for building a credit card account component.

13. The system of claim 8, wherein the means for building the single integrated account relating to the purchase of goods or services comprises means for building a line of credit account component.

14. The system of claim 8, wherein the means for building the integrated customer account relating to the purchase of goods or services comprises means for building a secured credit account component.

15. The system of claim 8, further comprising means for displaying a representation of a statement or invoice connected to the means for building the customer account relating to the purchase of goods or services, whereby as the account is built the representation of the statement or invoice is updated.

16. The method according to claim 8, wherein said information includes demographic information and customer financial information.

17. The method of claim 8, wherein based on the consumer's needs and access to available data on goods or services, the system generates at least one of options, recommendations, referrals to providers of goods or services, and prices of goods or services.

18. A method of providing an integrated system for determining how much a customer should pay for goods or services, comprising:
opening a customer account that permits a customer to establish a plurality of components relating to the purchase of goods or services, the customer account having a time of opening;
creating a personal profile including substantially all demographic and financial data about the customer at the time of opening;
accessing the profile so that only unknown data is requested from the customer in the establishment of each of the plurality of components relating to the purchase of goods or services;
receiving a customer selection of at least one component relating to the purchase of goods or services of the customer account;
performing a needs analysis based on the personal profile;
recommending an account based on the needs analysis; and
presenting information concerning at least one component relating to the purchase of goods or services of the customer account to the customer.

19. The method of claim 18, wherein based on the consumer's needs and access to available data on goods or services, the system generates at least one of options, recommendations, referrals to providers of goods or services, and prices of goods or services.

20. A method of claim 18, wherein said plurality of components relating to the purchase of goods or services comprises at least one of options, recommendations, referrals to providers of goods or services, and prices of goods or services.

21. A method of opening a customer account advising a consumer how much to pay for goods and services, comprising:
building a database containing a customer profile that includes demographic information and information relating to the purchase of goods or services;
performing a needs analysis based on information collected;
receiving a customer selection of at least one component relating to the purchase of goods or services;
recommending goods or services based on the needs analysis;
presenting information concerning at least one selected component relating to the purchase of goods or services to the customer;
updating the database to reflect the customer's selection of at least one single customer account component; and
displaying an image of a representation of a statement, wherein the image reflects the customer's selection of at least one good or service.

22. The method of claim 21, wherein based on the consumer's needs and access to available data on goods or services, the system generates at least one of options, recommendations, referrals to providers of goods or services, and prices of goods or services.

23. The system of claim 21, further comprising:
means for updating the database to reflect the customer's selection of at least one product or service; and
means for displaying an image of a representation of a statement, wherein the reflects the customer's selection of at least one product or service.

24. The system of claim 8 further comprising:
means for updating the database to reflect the customer's selection of at least one product or service; and
means for displaying an image of a representation of a statement, wherein the reflects the customer's selection of at least one product or service.
